(19) United States
(12) Patent Application Publication
(10) Pub. No.: US 2007/0015662 A1
(43) Pub. Date: Jan. 18, 2007

(54) Herbicide/safener combination

(75) Inventors: Chris Rosinger, Hofheim (DE); Hansjorg Dietrich, Hofheim (DE); Hendrik Helmke, Liederbach (DE); Wolfgang Schaper, Diedorf (DE); Paul Evans, Odenthal (DE); Erwin Hacker, Hochheim (DE)

Correspondence Address: STERNE, KESSLER, GOLDSTEIN & FOX PLLC, 1100 NEW YORK AVENUE, N.W., WASHINGTON, DC, 20005, US

(73) Assignee: Bayer CropScience GmbH, Frankfurt (DE)

(21) Appl. No.: 11/478,693

(22) Filed: Jul. 3, 2006

(30) Foreign Application Priority Data
Jul. 7, 2005 (DE) 102005031787.1
Sep. 13, 2005 (DE) 102005043459.2

(51) Int. Cl. A01N 25/32

(52) U.S. Cl. 504/106

(57) ABSTRACT

The present invention relates to a herbicide/safener combination comprising
(A) one or more compounds of the formula (I) or salts thereof 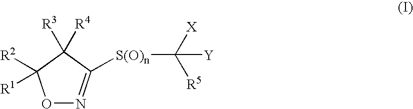 in which
R¹, R², R³, R⁴, and R⁵ are different radicals, n is 1 or 2,
X is H or (C₁-C₄)-alkyl, and Y is H; and (B) one or more safeners, and also to the use thereof for controlling harmful plants.

The invention relates to the technical field of the crop protection compositions, in particular herbicide/safener combinations, which are highly suitable for use against harmful plants in crops of useful plants.

It is known from various publications that certain isoxazoline derivatives possess herbicidal properties. Thus the patent specifications JP-A-08225548, JP-A-9328477, JP-A-9328483, WO 2001012613, WO 2002062770, WO 2003000686, WO 2003010165, WO 2004014138, JP 2005-035924 and JP-A-2005-145958 describe isoxazoline derivatives which bear a heteroarylmethylsulfonyl group or an arylmethylsulfonyl group as substituent at the 3-position on the isoxazoline ring, which control a broad spectrum of weeds. However, some of these active compounds are not entirely compatible with some important crop plants such as various cereals, corn or rice, for example. Accordingly, in some crops, they cannot be employed such that the desired broad herbicidal activity against harmful plants is ensured.

It was an object of the present invention to provide herbicidal compositions in which the selectivity of the abovementioned herbicides with respect to important crop plants is increased. Surprisingly, this object is achieved by the herbicide/safener combination of the present invention.

Accordingly, the present invention provides a herbicide/safener combination, comprising
(A) one or more compounds of the formula (I) or salts thereof 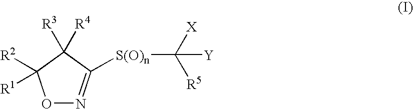
in which
R¹ and R² independently of one another are each H, cyano, (C₁-C₆)-alkyl, (C₂-C₆)-alkenyl, (C₂-C₆)-alkynyl, (C₃-C₈)-cycloalkyl, (C₁-C₆)-alkanoyl, (C₁-C₆)-alkoxycarbonyl, mono-((C₁-C₆)-alkyl)aminocarbonyl, di-((C₁-C₆)-alkyl)aminocarbonyl, each of the (C₁-C₆)-alkyl, (C₂-C₆)-alkenyl, (C₂-C₆)-alkynyl, (C₃-C₆)-cycloalkyl, (C₁-C₆)-alkanoyl, (C₁-C₆)-alkoxycarbonyl, mono-((C₁-C₆)-alkyl)aminocarbonyl, di-((C₁-C₆)-alkyl)aminocarbonyl radicals being unsubstituted or substituted by one or more identical or different radicals from the group of halogen, cyano, (C₃-C₈)-cycloalkyl or else by —OR⁶ or —S(O)ₘR⁶, in which m is the number 0, 1 or 2, R⁶ is a (C₁-C₆)-alkyl, (C₂-C₆)-alkenyl, (C₂-C₆)-alkynyl or (C₃-C₆)-cycloalkyl which is unsubstituted or substituted by one or more identical or different radicals from the group of halogen or cyano,
   or independently of one another are each unsubstituted or substituted phenyl or heterocyclyl, of which the heterocyclyl may be saturated or unsaturated and contains preferably one or more, especially 1, 2 or 3 heteroatoms in the heterocyclic ring, preferably from the group of N, O, and S, and is preferably an aliphatic heterocyclyl radical having 3 to 7 ring atoms or a heteroaromatic radical having 5 or 6 ring atoms, each of the aforementioned radicals being unsubstituted or substituted if desired by one or more identical or different radicals from the group of (C₁-C₆)-alkyl, (C₁-C₆)-haloalkyl, halogen, cyano, (C₃-C₈)-cycloalkyl, or —OC(R⁷)₃, or else —SC(R⁷)₃, R⁷ in the two last-mentioned groups being, independently at each occurrence, H, F or Cl,
   or else R¹+R² together form a spiro linkage of 3 to 7 carbon atoms, together with the carbon atom to which they are attached in unison,
R³ and R⁴ are H, (C₁-C₆)-alkyl, (C₂-C₆)-alkenyl, (C₂-C₆)-alkynyl or (C₃-C₈)-cycloalkyl, the aforementioned alkyls, cycloalkyls, alkenyls or alkynyls being substituted if desired by one or more identical or different radicals from the group of halogen, nitro, cyano, (C₃-C₆)-cycloalkyl, (C₁-C₆)-alkoxy, (C₁-C₆)-haloalkoxy or (C₁-C₆)-alkylthio,
   or else R³+R⁴ together form a spiro linkage of 3 to 7 carbon atoms, together with the carbon atom to which they are attached in unison, or else
R¹+R³ together with the carbon atoms to which they are attached form a ring structure composed of 5-8 carbon atoms,
R⁵ is unsubstituted or substituted aryl, preferably having 6 to 14 carbon atoms, or unsubstituted or substituted heteroaryl, having preferably 1 to 9 carbon atoms and one or more heteroatoms, preferably having 1 to 4 heteroatoms, in particular having 1 to 4 heteroatoms from the group of N, O, and S, each of the above carbocyclic or heterocyclic radicals being substituted if desired by OH, halogen, cyano, (C₁-C₆)-alkyl, (C₁-C₆)-haloalkyl, (C₂-C₆)-alkenyl, (C₂-C₆)-alkynyl, (C₃-C₆)-cycloalkyl, (C₃-C₆)-cycloalkenyl, mono-(C₁-C₆)-alkylamino, di-((C₁-C₆)-alkyl)amino, N—((C₁-C₆)-alkanoyl)amino, (C₁-C₆)-alkoxy, (C₁-C₆)-haloalkoxy, (C₃-C₆)-alkenyloxy, (C₃-C₆)-alkynyloxy, (C₃-C₆)-cycloalkoxy, (C₄-C₆)-cycloalkenyloxy, (C₁-C₆)-alkylthio, (C₁-C₆)-haloalkylthio, (C₃-C₆)-cycloalkylthio, (C₃-C₆)-alkenylthio, (C₄-C₆)-cycloalkenylthio, (C₃-C₆)-alkynylthio, (C₁-C₆)-alkanoyl, (C₂-C₆)-alkenylcarbonyl, (C₂-C₆)-alkynylcarbonyl, arylcarbonyl, (C₁-C₆)-alkoxycarbonyl, (C₃-C₆)-alkenyloxycarbonyl, (C₃-C₆)-alkynoxycarbonyl, aryloxycarbonyl, (C₁-C₆)-alkylsulfinyl, (C₁-C₆)-alkylsulfonyl, (C₁-C₆)-haloalkylsulfinyl or (C₁-C₆)-haloalkylsulfonyl, and aforementioned alkyl, alkoxy or haloalkoxy radicals being, if desired, linked cyclically with one another, with the proviso that they are in ortho position,
n is 1, or 2,
X is H or (C₁-C₄)-alkyl, and
Y is H;
   and
   (B) one or more safeners.

The herbicide/safener combinations according to the invention may additionally comprise further components, for example crop protection agents of a different type and/or formulation auxiliaries and/or additives customary in crop protection, or they may be employed together with these.

The herbicides (A) and the safeners (B) can be applied in a known manner, for example together (for example as a coformulation or as a tank mix), or else as a time-split application, for example to the plants, parts of plants, plant seeds or to the area on which the plants grow. It is possible, for example, to apply the individual active compounds or the herbicide/safener combination in a plurality of portions (sequential application), for example as pre-emergence applications followed by post-emergence applications or as early post-emergence applications followed by applications at medium or late post-emergence. Preference is given here to the simultaneous or nearly simultaneous application of the active compounds of the combination in question. It is also possible to use the individual active compounds or the herbicide/safener combination for seed dressing.

The above formula (I) encompasses all stereoisomers and mixtures thereof, including, in particular, also racemic mixtures and—if enantiomers are possible—the respective biologically active enantiomer.

Preferred as herbicide (A) are compounds of the formula (I) and salts thereof

in which

R¹ and R² independently of one another are each H, (C₁-C₄)-alkyl, (C₂-C₃)-alkenyl, (C₂-C₃)-alkynyl or (C₃-C₆)-cycloalkyl, each of the (C₁-C₄)-alkyl, (C₂-C₃)-alkenyl, (C₂-C₃)-alkynyl or (C₃-C₆)-cycloalkyl radicals being substituted if desired by one or more radicals from the group of halogen, (C₁-C₃)-alkoxy, cyano or (C₃-C₆)-cycloalkyl,
R³ and R⁴ are H or (C₁-C₄)-alkyl, the alkyl being substituted if desired by one or more identical or different radicals from the group of halogen or cyano,
R⁵ is an unsubstituted or substituted aryl, preferably having 6 to 10 carbon atoms, or unsubstituted or substituted heteroaryl, having preferably 1 to 9 carbon atoms, preferably 2 to 5 carbon atoms, with 1 to 3 heteroatoms from the group of N, O and S, each of the above carbocyclic or heterocyclic radicals being substituted if desired by OH, halogen, cyano, (C₁-C₄)-alkyl, (C₁-C₄)-haloalkyl, (C₂-C₄)-alkenyl, (C₂-C₄-alkynyl, (C₃-C₆)-cycloalkyl, (C₅-C₆)-cycloalkenyl, mono-(C₁-C₄)-alkylamino, di-((C₁-C₄)-alkyl)amino, N—((C₁-C₄)-alkanoyl)amino, (C₁-C₄)-alkoxy, (C₁-C₄)-haloalkoxy, (C₃-C₄)-alkenyloxy, (C₃-C₄)-alkynyloxy, (C₄-C₆)-cycloalkoxy, (C₅-C₆)-cycloalkenyloxy, (C₁-C₄)-alkylthio, (C₁-C₄)-haloalkylthio, (C₄-C₆)-cycloalkylthio, (C₃-C₄)-alkenylthio, (C₅-C₆)-cycloalkenylthio, (C₃-C₄)-alkynylthio, (C₁-C₄)-alkanoyl, (C₂-C₄)-alkenylcarbonyl, (C₂-C₄)-alkynylcarbonyl, arylcarbonyl, (C₁-C₄)-alkoxycarbonyl, (C₃-C₄)-alkenyloxycarbonyl, (C₃-C₄)-alkynoxycarbonyl, aryloxycarbonyl, (C₁-C₄)-alkylsulfinyl, (C₁-C₄)-alkylsulfonyl or (C₁-C₄)-haloalkylsulfinyl or (C₁-C₄)-haloalkylsulfonyl, and aforementioned alkyl, alkoxy or haloalkoxy radicals being, if desired, linked cyclically to one another, with the proviso that they are in ortho position,
X is an H or (C₁-C₄)-alkyl,
Y is an H, and
n is 1 or 2.

Particularly preferred as herbicide (A) are compounds of the formula (I) and salts thereof

in which

R¹ and R² independently of one another are (C₁-C₄)-alkyl, each of the (C₁-C₄)-alkyl radicals being substituted if desired by one or more identical or different halogens, preferably by chlorine, bromine or fluorine,
R³ and R⁴ are an H, methyl or ethyl,
R⁵ is an unsubstituted or substituted aryl, preferably having 6 to 10 carbon atoms, or unsubstituted or substituted heteroaryl having preferably 2 to 5 carbon atoms with 1 to 3 heteroatoms from the group of N, O, and S, each of the above carbocyclic or heterocyclic radicals being substituted if desired by one or more identical or different radicals from the group of halogen, cyano, ethyl, methyl, haloethyl, halomethyl, methoxy, ethoxy, trifluoromethylthio, trifluoromethylsulfinyl, trifluoromethylsulfonyl, halomethoxy or haloethoxy,
X is an H,
Y is an H, and
n is 2.

Particularly preferred as herbicide (A) are compounds of the formula (I) and salts thereof,

in which

R¹ and R² independently of one another are methyl or ethyl, which in turn may be present, if desired, independently of one another, in mono- or polyhalogenated form, preferably in mono- or polychlorinated or mono- or polyfluorinated form,
R³ and R⁴ are an H,
R⁵ is a substituted or unsubstituted phenyl, pyrazolyl, pyridinyl, pyrimidinyl, pyrazinyl, pyridazinyl, thienyl, furyl, imidazolyl, triazolyl, isothiazolyl, thiazolyl or oxazolyl, very particularly preferably a phenyl or pyrazole, which if substituted are substituted preferably by one or more identical or different radicals from the group of halogen, cyano, ethyl, methyl, methoxy, ethoxy, halomethoxy, haloethoxy, trifluoromethylthio, trifluoromethylsulfinyl, trifluoromethylsulfonyl, haloethyl or halomethyl, preference being given, among the halogens, to chlorine and fluorine, especially fluorine,
X is an H,
Y is an H, and
n is 2.

Likewise particularly preferred as herbicide (A) are compounds of the formula (I) and salts thereof

in which

R¹ is methyl and
R² is methyl, ethyl or chloromethyl, especially methyl or ethyl,
R³ and R⁴ are an H,
R⁵ is a phenyl or pyrazole bearing one, two or three, preferably one or two, identical or different substituents from the group of fluorine, chlorine, methyl, trifluoromethyl, methoxy, difluoromethoxy or trifluoromethoxy,
X is an H,
Y is an H, and
n is 2.

Derivatives in which R⁵ is a phenyl radical which is substituted at least twice and in which two alkyl, alkoxy, or haloalkoxy radicals in ortho position are linked cyclically to one another are not known from JP-A-08225548, JP-A-9328477, JP-A-9328483, WO 2001012613, WO 2002062770, WO 2003000686, WO 2003010165, WO 2004014138, JP 2005-035924 and JP-A-2005-145958 and are consequently likewise subject matter of this invention.

Preferred substituents of the phenyl are methyl, ethyl, methoxy, ethoxy, haloethoxy and halomethoxy.

The general or preferred radical definitions given above can be combined with one another as desired, i.e. including combinations between the given preferred ranges.

The compounds of the formula (I) can form salts by addition of a suitable organic or inorganic acid, such as HCl, HBr, H₂SO₄ or HNO₃, or else oxalic acids or sulfonic acids, onto a basic group, such as amino or alkylamino. Suitable substituents, which may be in deprotonated form, such as sulfonic acids or carboxylic acids, for example, may form inner salts with groups which can be protonated in turn, such as amino groups. Salts may likewise be formed as a result of the hydrogen, in the case of suitable substituents, such as sulfonic acids or carboxylic acids, for example, being replaced by an agriculturally appropriate cation. These salts are, for example, metal salts, especially alkali metal salts or alkaline earth metal salts, particularly sodium salts and potassium salts, or else ammonium salts, salts with organic amines or quaternary ammonium salts with cations of the formula [NRR′R″ R′″]⁺, in which R to R′″ are in each independently an organic radical, especially alkyl, aryl, aralkyl or alkylaryl.

Unless a different definition is given specifically, the definitions applying to the radicals of the formula (I) and the formulae (II) to (IX) below are generally as follows:

In formula (I) and all formulae (II)-(IX) given below the radicals alkyl, alkoxy, haloalkyl, haloalkoxy, alkylamino, alkylthio, haloalkylthio, alkylsulfinyl, alkylsulfonyl, haloalkylsulfinyl, and haloalkylsulfonyl, and also the corresponding unsaturated and/or substituted radicals in the carbon skeleton, may in each case be straight-chain or branched. Unless indicated specifically, preference is given for these radicals to the lower carbon skeletons, e.g. those having 1 to 6 carbon atoms, especially 1 to 4 carbon atoms, or in the case of unsaturated groups having 2 to 6 carbon atoms, especially 2 to 4 carbon atoms. Alkyl radicals, both alone and in composite definitions such as alkoxy, haloalkyl, etc., are for example methyl, ethyl, n-propyl or isopropyl, n-butyl, isobutyl, tert-butyl or 2-butyl, pentyls, hexyls, such as n-hexyl, isohexyl, and 1,3-dimethylbutyl, heptyls, such as n-heptyl, 1-methylhexyl, and 1,4-dimethylpentyl; alkenyl and alkynyl radicals have the definition of the possible unsaturated radicals corresponding to the alkyl radicals; at least one double bond or triple bond is present, preferably one double bond or triple bond, respectively. Alkenyl is for example vinyl, allyl, 1-methylprop-2-en-1-yl, 2-methylprop-2-en-1-yl, but-2-en-1-yl, but-3-en-1-yl, 1-methylbut-3-en-1-yl, and 1-methylbut-2-en-1-yl; alkynyl is for example ethynyl, propargyl, but-2-yn-1-yl, but-3-yn-1-yl, and 1-methylbut-3-yn-1-yl.

Halogen is fluorine, chlorine, bromine or iodine. Haloalkyl, haloalkenyl, and haloalkynyl are alkyl, alkenyl or alkynyl, respectively, which are fully or partly substituted by halogen, preferably by fluorine, chlorine or bromine, in particular by fluorine and/or chlorine, examples being monohaloalkyl (i.e., monohalogenalkyl), perhaloalkyl, CF₃, CHF₂, CH₂F, CF₃CF₂, CH₂FCHCl, CCl₃, CHCl₂, CH₂CH₂Cl; haloalkoxy is for example OCF₃, OCHF₂, OCH₂F, CF₃CF₂O, OCH₂CF₃, and OCH₂CH₂Cl; this correspondingly applies to haloalkenyl and other halogen-substituted radicals.

Aryl is a monocyclic, bicyclic or polycyclic aromatic system, phenyl or naphthyl for example, preferably phenyl.

A heterocyclic radical or ring (heterocyclyl or heteroaryl) can be saturated, unsaturated or heteroaromatic; unless otherwise defined, it preferably comprises one or more, especially 1, 2 or 3 heteroatoms in the heterocyclic ring, preferably from the group of N, O, and S; preferably it is an aliphatic heterocyclyl radical having 3 to 7 ring atoms or a heteroaromatic radical having 5 or 6 ring atoms. The heterocyclic radical may for example be a heteroaromatic radical or ring (heteroaryl), such as a monocyclic, bicyclic or polycyclic aromatic system in which at least 1 ring contains one or more heteroatoms. Preferably it is a heteroaromatic ring with a heteroatom from the group of N, O, and S, such as pyridyl, pyrrolyl, thienyl or furyl, for example; with further preference it is a corresponding heteroaromatic ring having 2 or 3 heteroatoms, such as pyrimidinyl, pyridazinyl, pyrazinyl, triazinyl, thiazolyl, thiadiazolyl, oxazolyl, isoxazolyl, pyrazolyl, imidazolyl, and triazolyl. Likewise preferably it is a partially or fully hydrogenated heterocyclic radical having a heteroatom from the group of N, O, and S, such as oxiranyl, oxetanyl, oxolanyl (=tetrahydrofuryl), oxanyl, pyrrolidyl(=pyrrolidinyl) or piperidyl or else pyrrolinyl such as Δ¹-pyrrolinyl, Δ²-pyrrolinyl or Δ³-pyrrolinyl, e.g., Δ¹-pyrrolin-2-yl, Δ¹-pyrrolin-3-yl, Δ¹-pyrrolin-4-yl or Δ¹-pyrrolin-5-yl or Δ²-pyrrolin-1-yl, Δ²-pyrrolin-2-yl, Δ²-pyrrolin-3-yl, Δ²-pyrrolin-4-yl, Δ²-pyrrolin-5-yl or Δ³-pyrrolin-1-yl, Δ³-pyrrolin-2-yl or Δ³-pyrrolin-3-yl. Likewise with preference it is a partially or fully hydrogenated heterocyclic radical having 2 heteroatoms from the group of N, O, and S, such as piperazinyl, dioxanyl, dioxolanyl, oxazolinyl, isoxazolinyl, oxazolidinyl, isoxazolidinyl, and morpholinyl.

By the formulation to the effect that, in the case of substituted aryl and heteroaryl radicals, “alkyl, alkoxy or haloalkoxy radicals are, if desired, linked cyclically to one another, with the proviso that they are in ortho position” is meant, for example, the groups benzo-1,4-dioxanyl, 1,3-benzodioxolyl, chromanyl, 3,4-dihydro-1H-chromanyl, 2,3-dihydro-1-benzofuran, 1,3-dihydro-1-benzofuranyl, indanyl, 1,2,3,4-tetrahydronaphthyl, and their analogs with halogenation, especially fluorination, on the saturated carbon units.

Suitable substituents for a substituted heterocyclic radical are the substituents specified later on below, and oxo as well. The oxo group may also occur on the hetero-ring atoms which are able to exist in different oxidation states, as in the case of N and S, for example.

The definition “substituted by one or more radicals” refers, unless otherwise defined, to one or more identical or different radicals.

The substituents given by way of example (“first substituent level”) can, if they include hydrocarbon-containing fractions, be further substituted therein if desired (“second substituent level”), by for example one of the substituents as defined for the first substituent level. Corresponding further substituent levels are possible. The term “substituted radical” preferably embraces just one or two substituent levels.

In the case of radicals having carbon atoms preference is given to those having 1 to 6 carbon atoms, preferably 1 to 4 carbon atoms, particularly 1 or 2 carbon atoms. Preference is generally given to substituents from the group of halogen, such as fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro, and cyano.

Unsubstituted or substituted phenyl is preferably phenyl which is unsubstituted or substituted one or more times, preferably up to three times, by identical or different radicals from the group of halogen, (C₁-C₄)-alkyl, (C₁-C₄)-alkoxy, (C₁-C₄)-haloalkyl, (C₁-C₄)-haloalkoxy, and nitro, examples being o-, m-, and p-tolyl, dimethylphenyls, 2-, 3-, and 4-chlorophenyl, 2-, 3-, and 4-trifluoromethyl- and 2-, 3-, and 4-trichloromethylphenyl, 2,4-, 3,5-, 2,5-, and 2,3-dichlorophenyl, and o-, m-, and p-methoxyphenyl.

An acid radical of an organic or inorganic oxygen acid is a radical formed formally by removal of a hydroxyl group from the acid function, an example being the sulfo radical —SO₃H, which is derived from sulfuric acid H₂SO₄, or the sulfino radical —SO₂H, which is derived from sulfurous acid H₂SO₃, or, correspondingly, the group SO₂NH₂, the phospho radical —PO(OH)₂, the group —PO(NH₂)₂, —PO(OH)(NH₂), —PS(OH)₂, —PS(NH₂)₂ or —PS(OH)(NH₂), the carboxyl radical COOH, which is derived from carbonic acid, radicals of the formula —CO—SH, —CS—OH, —CS—SH, —CO—NH₂, —CS—NH₂, —C(═NH)—OH or —C(═NH)—NH₂; also suitable are radicals with hydrocarbon radicals or substituted hydrocarbon radicals, i.e., acyl radicals in the wider sense (i.e., “acyl”).

The invention also provides all stereoisomers embraced by formula (I), and mixtures thereof. Such compounds of the formula (I) contain one or more asymmetric carbon atoms (i.e., asymmetrically substituted carbon atoms), and/or asymmetric sulfur atoms in the form of sulfoxides, or else double bonds, which are not specifically indicated in the general formulae (I). The possible stereoisomers defined by their specific three-dimensional form, such as enantiomers, diastereomers, and Z and E isomers, are all embraced by the formula (I) and can be obtained by standard methods from mixtures of the stereoisomers or else prepared by stereoselective reactions in combination with the use of stereochemically pure starting materials.

For reasons in particular of greater herbicidal effect, improved selectivity and/or greater ease of preparation, particular interest attaches to compounds of the invention, of the stated formula (I), or salts thereof, in which individual radicals have one of the preferred definitions already specified or specified below, or, in particular, to those in which one or more of the preferred definitions already specified or specified below occur in combination.

Examples of compounds used as herbicide (A) are specified in table A below, where the following abbreviations are used:

The abbreviations used in the table have the following meanings:

Me=methyl

Et=ethyl

Ph=phenyl

Pr=propyl

i-Pr=isopropyl

TABLE A

| | | | | | | | | (I) |
|---|---|---|---|---|---|---|---|---|
| 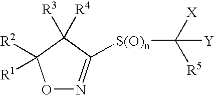 | | | | | | | | |
| No | R¹ | R² | R³ | R⁴ | R⁵ | X | Y | n |
| I-1.1 | Me | Me | H | H | Ph | H | H | 2 |
| I-1.2 | Me | Et | H | H | Ph | H | H | 2 |
| I-1.3 | Me | CH₂Cl | H | H | Ph | H | H | 2 |
| I-2.2 | Me | Et | H | H | 2,5-di-F-Ph | H | H | 2 |
| I-2.3 | Me | CH₂Cl | H | H | 2,5-di-F-Ph | H | H | 2 |
| I-3.1 | Me | Me | H | H | 2,6-di-F-Ph | H | H | 2 |
| I-3.2 | Me | Et | H | H | 2,6-di-F-Ph | H | H | 2 |
| I-3.3 | Me | CH₂Cl | H | H | 2,6-di-F-Ph | H | H | 2 |
| I-4.1 | Me | Me | H | H | 2-F-5-CF₃-Ph | H | H | 2 |
| I-4.2 | Me | Et | H | H | 2-F-5-CF₃-Ph | H | H | 2 |
| I-4.3 | Me | CH₂Cl | H | H | 2-F-5-CF₃-Ph | H | H | 2 |
| I-5.1 | Me | Me | H | H | 2-F-6-Cl-Ph | H | H | 2 |
| I-5.2 | Me | Et | H | H | 2-F-6-Cl-Ph | H | H | 2 |
| I-5.3 | Me | CH₂Cl | H | H | 2-F-6-Cl-Ph | H | H | 2 |
| I-6.1 | Me | Me | H | H | 2-Cl-Ph | H | H | 2 |
| I-6.2 | Me | Et | H | H | 2-Cl-Ph | H | H | 2 |
| I-6.3 | Me | CH₂Cl | H | H | 2-Cl-Ph | H | H | 2 |
| I-7.1 | Me | Me | H | H | 2-F-Ph | H | H | 2 |
| I-7.2 | Me | Et | H | H | 2-F-Ph | H | H | 2 |
| I-7.3 | Me | CH₂Cl | H | H | 2-F-Ph | H | H | 2 |
| I-8.1 | Me | Me | H | H | 2-Me-Ph | H | H | 2 |
| I-8.2 | Me | Et | H | H | 2-Me-Ph | H | H | 2 |
| I-8.3 | Me | CH₂Cl | H | H | 2-Me-Ph | H | H | 2 |
| I-9.1 | Me | Me | H | H | 2-CF₃-Ph | H | H | 2 |
| I-9.2 | Me | Et | H | H | 2-CF₃-Ph | H | H | 2 |
| I-9.3 | Me | CH₂Cl | H | H | 2-CF₃-Ph | H | H | 2 |
| I-10.1 | Me | Me | H | H | 2-OCF₃-Ph | H | H | 2 |
| I-10.2 | Me | Et | H | H | 2-OCF₃-Ph | H | H | 2 |
| I-10.3 | Me | CH₂Cl | H | H | 2-OCF₃-Ph | H | H | 2 |
| I-11.1 | Me | Me | H | H | 2-OCF₂H-Ph | H | H | 2 |
| I-11.2 | Me | Et | H | H | 2-OCF₂H-Ph | H | H | 2 |
| I-11.3 | Me | CH₂Cl | H | H | 2-OCF₂H-Ph | H | H | 2 |
| I-12.1 | Me | Me | H | H | 2-OMe-Ph | H | H | 2 |
| I-12.2 | Me | Et | H | H | 2-OMe-Ph | H | H | 2 |
| I-12.3 | Me | CH₂Cl | H | H | 2-OMe-Ph | H | H | 2 |
| I-13.1 | Me | Me | H | H | 2,3-di-F-Ph | H | H | 2 |
| I-13.2 | Me | Et | H | H | 2,3-di-F-Ph | H | H | 2 |
| I-13.3 | Me | CH₂Cl | H | H | 2,3-di-F-Ph | H | H | 2 |
| I-14.1 | Me | Me | H | H | 2,3-di-Cl-Ph | H | H | 2 |
| I-14.2 | Me | Et | H | H | 2,3-di-Cl-Ph | H | H | 2 |
| I-14.3 | Me | CH₂Cl | H | H | 2,3-di-Cl-Ph | H | H | 2 |
| I-15.1 | Me | Me | H | H | 2,3-di-Me-Ph | H | H | 2 |
| I-15.2 | Me | Et | H | H | 2,3-di-Me-Ph | H | H | 2 |
| I-15.3 | Me | CH₂Cl | H | H | 2,3-di-Me-Ph | H | H | 2 |
| I-16.1 | Me | Me | H | H | 2-F-6-I-Ph | H | H | 2 |
| I-16.2 | Me | Et | H | H | 2-F-6-I-Ph | H | H | 2 |
| I-16.3 | Me | CH₂Cl | H | H | 2-F-6-I-Ph | H | H | 2 |
| I-17.2 | Me | Et | H | H | 2-Me-5-Cl-Ph | H | H | 2 |
| I-17.3 | Me | CH₂Cl | H | H | 2-Me-5-Cl-Ph | H | H | 2 |
| I-18.1 | Me | Me | H | H | 2-F-3-CF₃-Ph | H | H | 2 |
| I-18.2 | Me | Et | H | H | 2-F-3-CF₃-Ph | H | H | 2 |
| I-18.3 | Me | CH₂Cl | H | H | 2-F-3-CF₃-Ph | H | H | 2 |
| I-19.1 | Me | Me | H | H | 2-F-3-Me-Ph | H | H | 2 |
| I-19.2 | Me | Et | H | H | 2-F-3-Me-Ph | H | H | 2 |
| I-19.3 | Me | CH₂Cl | H | H | 2-F-3-Me-Ph | H | H | 2 |
| I-20.1 | Me | Me | H | H | 2-F-3-Cl-Ph | H | H | 2 |
| I-20.2 | Me | Et | H | H | 2-F-3-Cl-Ph | H | H | 2 |
| I-20.3 | Me | CH₂Cl | H | H | 2-F-3-Cl-Ph | H | H | 2 |
| I-21.1 | Me | Me | H | H | 2,3-(O—CH₂—CH₂— | H | H | 2 |
| | | | | | O)-Ph | | | |
| I-21.2 | Me | Et | H | H | 2,3-(O—CH₂—CH₂— | H | H | 2 |
| | | | | | O)-Ph | | | |
| I-21.3 | Me | CH₂Cl | H | H | 2,3-(O—CH₂—CH₂— | H | H | 2 |
| | | | | | O)-Ph | | | |
| I-22.1 | Me | Me | H | H | 2,3-(O—CF₂—CF₂— | H | H | 2 |
| | | | | | O)-Ph | | | |
| I-22.2 | Me | Et | H | H | 2,3-(O—CF₂—CF₂— | H | H | 2 |
| | | | | | O)-Ph | | | |
| I-22.3 | Me | CH₂Cl | H | H | 2,3-(O—CF₂—CF₂— | H | H | 2 |
| | | | | | O)-Ph | | | |
| I-23.1 | Me | Me | H | H | 2,3-(O—CF₂—O)-Ph | H | H | 2 |
| I-23.2 | Me | Et | H | H | 2,3-(O—CF₂—O)-Ph | H | H | 2 |
| I-23.3 | Me | CH₂Cl | H | H | 2,3-(O—CF₂—O)-Ph | H | H | 2 |
| I-24.1 | Me | Me | H | H | 2,3-(O—CH₂—CH₂)-Ph | H | H | 2 |
| I-24.2 | Me | Et | H | H | 2,3-(O—CH₂—CH₂)-Ph | H | H | 2 |
| I-24.3 | Me | CH₂Cl | H | H | 2,3-(O—CH₂—CH₂)-Ph | H | H | 2 |
| I-25.1 | Me | Me | H | H | 2,4-di-F-Ph | H | H | 2 |
| I-25.2 | Me | Et | H | H | 2,4-di-F-Ph | H | H | 2 |
| I-25.3 | Me | CH₂Cl | H | H | 2,4-di-F-Ph | H | H | 2 |
| I-26.1 | Me | Me | H | H | 2,4-di-Cl-Ph | H | H | 2 |
| I-26.2 | Me | Et | H | H | 2,4-di-Cl-Ph | H | H | 2 |
| I-26.3 | Me | CH₂Cl | H | H | 2,4-di-Cl-Ph | H | H | 2 |
| I-27.1 | Me | Me | H | H | 2,4-di-Me-Ph | H | H | 2 |
| I-27.2 | Me | Et | H | H | 2,4-di-Me-Ph | H | H | 2 |
| I-27.3 | Me | CH₂Cl | H | H | 2,4-di-Me-Ph | H | H | 2 |
| I-28.1 | Me | Me | H | H | 2-Cl-4-F-Ph | H | H | 2 |
| I-28.2 | Me | Et | H | H | 2-Cl-4-F-Ph | H | H | 2 |
| I-28.3 | Me | CH₂Cl | H | H | 2-Cl-4-F-Ph | H | H | 2 |
| I-29.1 | Me | Me | H | H | 2-OCF₂H-4-Cl-Ph | H | H | 2 |
| I-29.2 | Me | Et | H | H | 2-OCF₂H-4-Cl-Ph | H | H | 2 |
| I-29.3 | Me | CH₂Cl | H | H | 2-OCF₂H-4-Cl-Ph | H | H | 2 |
| I-30.1 | Me | Me | H | H | 2-F-4-CF₃-Ph | H | H | 2 |
| I-30.2 | Me | Et | H | H | 2-F-4-CF₃-Ph | H | H | 2 |
| I-30.3 | Me | CH₂Cl | H | H | 2-F-4-CF₃-Ph | H | H | 2 |
| I-31.1 | Me | Me | H | H | 2-Me-5-OMe-Ph | H | H | 2 |
| I-31.2 | Me | Et | H | H | 2-Me-5-OMe-Ph | H | H | 2 |
| I-31.3 | Me | CH₂Cl | H | H | 2-Me-5-OMe-Ph | H | H | 2 |
| I-32.1 | Me | Me | H | H | 2-CF₃-4-F-Ph | H | H | 2 |
| I-32.2 | Me | Et | H | H | 2-CF₃-4-F-Ph | H | H | 2 |
| I-32.3 | Me | CH₂Cl | H | H | 2-CF₃-4-F-Ph | H | H | 2 |
| I-33.1 | Me | Me | H | H | 2-Cl-4-Me-Ph | H | H | 2 |
| I-33.2 | Me | Et | H | H | 2-Cl-4-Me-Ph | H | H | 2 |
| I-33.3 | Me | CH₂Cl | H | H | 2-Cl-4-Me-Ph | H | H | 2 |
| I-34.1 | Me | Me | H | H | 2,5-di-Cl-Ph | H | H | 2 |
| I-34.2 | Me | Et | H | H | 2,5-di-Cl-Ph | H | H | 2 |
| I-34.3 | Me | CH₂Cl | H | H | 2,5-di-Cl-Ph | H | H | 2 |
| I-35.1 | Me | Me | H | H | 2,5-di-Me-Ph | H | H | 2 |
| I-35.2 | Me | Et | H | H | 2,5-di-Me-Ph | H | H | 2 |
| I-35.3 | Me | CH₂Cl | H | H | 2,5-di-Me-Ph | H | H | 2 |
| I-36.1 | Me | Me | H | H | 2,5-di-CF₃-Ph | H | H | 2 |
| I-36.2 | Me | Et | H | H | 2,5-di-CF₃-Ph | H | H | 2 |
| I-36.3 | Me | CH₂Cl | H | H | 2,5-di-CF₃-Ph | H | H | 2 |
| I-37.1 | Me | Me | H | H | 2-OCF₂H-5-Cl-Ph | H | H | 2 |
| I-37.2 | Me | Et | H | H | 2-OCF₂H-5-Cl-Ph | H | H | 2 |
| I-37.3 | Me | CH₂Cl | H | H | 2-OCF₂H-5-Cl-Ph | H | H | 2 |
| I-38.1 | Me | Me | H | H | 2-OCF₂H-5-OMe-Ph | H | H | 2 |
| I-38.2 | Me | Et | H | H | 2-OCF₂H-5-OMe-Ph | H | H | 2 |
| I-38.3 | Me | CH₂Cl | H | H | 2-OCF₂H-5-OMe-Ph | H | H | 2 |
| I-39.1 | Me | Me | H | H | 2-Cl-5-OMe-Ph | H | H | 2 |
| I-39.2 | Me | Et | H | H | 2-Cl-5-OMe-Ph | H | H | 2 |
| I-39.3 | Me | CH₂Cl | H | H | 2-Cl-5-OMe-Ph | H | H | 2 |
| I-40.1 | Me | Me | H | H | 2-OMe-5-Cl-Ph | H | H | 2 |
| I-40.2 | Me | Et | H | H | 2-OMe-5-Cl-Ph | H | H | 2 |
| I-40.3 | Me | CH₂Cl | H | H | 2-OMe-5-Cl-Ph | H | H | 2 |
| I-41.1 | Me | Me | H | H | 2-CF₃-5-Cl-Ph | H | H | 2 |
| I-41.2 | Me | Et | H | H | 2-CF₃-5-Cl-Ph | H | H | 2 |
| I-41.3 | Me | CH₂Cl | H | H | 2-CF₃-5-Cl-Ph | H | H | 2 |
| I-42.1 | Me | Me | H | H | 2,6-di-Cl-Ph | H | H | 2 |
| I-42.2 | Me | Et | H | H | 2,6-di-Cl-Ph | H | H | 2 |
| I-42.3 | Me | CH₂Cl | H | H | 2,6-di-Cl-Ph | H | H | 2 |
| I-43.1 | Me | Me | H | H | 2,6-di-Me-Ph | H | H | 2 |
| I-43.2 | Me | Et | H | H | 2,6-di-Me-Ph | H | H | 2 |
| I-43.3 | Me | CH₂Cl | H | H | 2,6-di-Me-Ph | H | H | 2 |
| I-44.1 | Me | Me | H | H | 2,6-di-OMe-Ph | H | H | 2 |
| I-44.2 | Me | Et | H | H | 2,6-di-OMe-Ph | H | H | 2 |
| I-44.3 | Me | CH₂Cl | H | H | 2,6-di-OMe-Ph | H | H | 2 |
| I-45.1 | Me | Me | H | H | 2-F-6-CF₃-Ph | H | H | 2 |
| I-45.2 | Me | Et | H | H | 2-F-6-CF₃-Ph | H | H | 2 |
| I-45.3 | Me | CH₂Cl | H | H | 2-F-6-CF₃-Ph | H | H | 2 |
| I-46.1 | Me | Me | H | H | 2-Cl-6-Me-Ph | H | H | 2 |
| I-46.2 | Me | Et | H | H | 2-Cl-6-Me-Ph | H | H | 2 |
| I-46.3 | Me | CH₂Cl | H | H | 2-Cl-6-Me-Ph | H | H | 2 |
| I-47.1 | Me | Me | H | H | 2-Cl-6-OMe-Ph | H | H | 2 |
| I-47.2 | Me | Et | H | H | 2-Cl-6-OMe-Ph | H | H | 2 |
| I-47.3 | Me | CH₂Cl | H | H | 2-Cl-6-OMe-Ph | H | H | 2 |
| I-48.1 | Me | Me | H | H | 2-Cl-6-OCF₂H-Ph | H | H | 2 |
| I-48.2 | Me | Et | H | H | 2-Cl-6-OCF₂H-Ph | H | H | 2 |
| I-48.3 | Me | CH₂Cl | H | H | 2-Cl-6-OCF₂H-Ph | H | H | 2 |
| I-49.1 | Me | Me | H | H | 2,3,4-tri-F-Ph | H | H | 2 |
| I-49.2 | Me | Et | H | H | 2,3,4-tri-F-Ph | H | H | 2 |
| I-49.3 | Me | CH₂Cl | H | H | 2,3,4-tri-F-Ph | H | H | 2 |
| I-50.1 | Me | Me | H | H | 2,3,5-tri-F-Ph | H | H | 2 |
| I-50.2 | Me | Et | H | H | 2,3,5-tri-F-Ph | H | H | 2 |
| I-50.3 | Me | CH₂Cl | H | H | 2,3,5-tri-F-Ph | H | H | 2 |
| I-51.1 | Me | Me | H | H | 2,4,5-tri-F-Ph | H | H | 2 |
| I-51.2 | Me | Et | H | H | 2,4,5-tri-F-Ph | H | H | 2 |
| I-51.3 | Me | CH₂Cl | H | H | 2,4,5-tri-F-Ph | H | H | 2 |
| I-52.1 | Me | Me | H | H | 2-Cl-4,5-(O—CH₂— | H | H | 2 |
| | | | | | O)-Ph | | | |
| I-52.2 | Me | Et | H | H | 2-Cl-4,5-(O—CH₂— | H | H | 2 |
| | | | | | O)-Ph | | | |
| I-52.3 | Me | CH₂Cl | H | H | 2-Cl-4,5-(O—CH₂— | H | H | 2 |
| | | | | | O)-Ph | | | |
| I-53.1 | Me | Me | H | H | 2,3,6-tri-F-Ph | H | H | 2 |
| I-53.2 | Me | Et | H | H | 2,3,6-tri-F-Ph | H | H | 2 |
| I-53.3 | Me | CH₂Cl | H | H | 2,3,6-tri-F-Ph | H | H | 2 |
| I-54.1 | Me | Me | H | H | 2-F-3-Cl-6-CF₃-Ph | H | H | 2 |
| I-54.2 | Me | Et | H | H | 2-F-3-Cl-6-CF₃-Ph | H | H | 2 |
| I-54.3 | Me | CH₂Cl | H | H | 2-F-3-Cl-6-CF₃-Ph | H | H | 2 |
| I-55.1 | Me | Me | H | H | 2,4,6-tri-F-Ph | H | H | 2 |
| I-55.2 | Me | Et | H | H | 2,4,6-tri-F-Ph | H | H | 2 |
| I-55.3 | Me | CH₂Cl | H | H | 2,4,6-tri-F-Ph | H | H | 2 |
| I-56.1 | Me | Me | H | H | 1-naphthyl | H | H | 2 |
| I-56.2 | Me | Et | H | H | 1-naphthyl | H | H | 2 |
| I-56.3 | Me | CH₂Cl | H | H | 1-naphthyl | H | H | 2 |
| I-57.1 | Me | Me | H | H | 2-F-1-naphthyl | H | H | 2 |
| I-57.2 | Me | Et | H | H | 2-F-1 -naphthyl | H | H | 2 |
| I-57.3 | Me | CH₂Cl | H | H | 2-F-1-naphthyl | H | H | 2 |
| I-58.1 | Me | Me | H | H | 2-Cl-1-naphthyl | H | H | 2 |
| I-58.2 | Me | Et | H | H | 2-Cl-1-naphthyl | H | H | 2 |
| I-58.3 | Me | CH₂Cl | H | H | 2-Cl-1-naphthyl | H | H | 2 |
| I-59.1 | Me | Me | H | H | 2-Me-1-naphthyl | H | H | 2 |
| I-59.2 | Me | Et | H | H | 2-Me-1-naphthyl | H | H | 2 |
| I-59.3 | Me | CH₂Cl | H | H | 2-Me-1-naphthyl | H | H | 2 |
| I-60.1 | Me | Me | H | H | 2-CF₃-1-naphthyl | H | H | 2 |
| I-60.2 | Me | Et | H | H | 2-CF₃-1-naphthyl | H | H | 2 |
| I-60.3 | Me | CH₂Cl | H | H | 2-CF₃-1-naphthyl | H | H | 2 |
| I-61.1 | Me | Me | H | H | 2-OCF₂H-1-naphthyl | H | H | 2 |
| I-61.2 | Me | Et | H | H | 2-OCF₂H-1-naphthyl | H | H | 2 |
| I-61.3 | Me | CH₂Cl | H | H | 2-OCF₂H-1-naphthyl | H | H | 2 |
| I-62.1 | Me | Me | H | H | 2-OMe-1-naphthyl | H | H | 2 |
| I-62.2 | Me | Et | H | H | 2-OMe-1-naphthyl | H | H | 2 |
| I-62.3 | Me | CH₂Cl | H | H | 2-OMe-1-naphthyl | H | H | 2 |
| I-63.1 | Me | Me | H | H | 4-CF₃-6-OMe-pyrimidin- | H | H | 2 |
| | | | | | 5-yl | | | |
| I-63.2 | Me | Et | H | H | 4-CF₃-6-OMe-pyrimidin- | H | H | 2 |
| | | | | | 5-yl | | | |
| I-63.3 | Me | CH₂Cl | H | H | 4-CF₃-6-OMe-pyrimidin- | H | H | 2 |
| | | | | | 5-yl | | | |
| I-64.1 | Me | Me | H | H | 4-Me-2-OMe-pyridin- | H | H | 2 |
| | | | | | 3-yl | | | |
| I-64.2 | Me | Et | H | H | 4-Me-2-OMe-pyridin- | H | H | 2 |
| | | | | | 3-yl | | | |
| I-64.3 | Me | CH₂Cl | H | H | 4-Me-2-OMe-pyridin- | H | H | 2 |
| | | | | | 3-yl | | | |
| I-65.1 | Me | Me | H | H | 3,5-di-Me-isoxazol-4-yl | H | H | 2 |
| I-65.2 | Me | Et | H | H | 3,5-di-Me-isoxazol-4-yl | H | H | 2 |
| I-65.3 | Me | CH₂Cl | H | H | 3,5-di-Me-isoxazol-4-yl | H | H | 2 |
| I-66.1 | Me | Me | H | H | 1,3-di-Me-5-Cl-pyrazol- | H | H | 2 |
| | | | | | 4-yl | | | |
| I-66.2 | Me | Et | H | H | 1,3-di-Me-5-Cl-pyrazol- | H | H | 2 |
| | | | | | 4-yl | | | |
| I-66.3 | Me | CH₂Cl | H | H | 1,3-di-Me-5-Cl-pyrazol- | H | H | 2 |
| | | | | | 4-yl | | | |
| I-67.1 | Me | Me | H | H | 1-Me-3-CF₃-5-OCF₂H- | H | H | 2 |
| | | | | | pyrazol-4-yl | | | |
| I-67.2 | Me | Et | H | H | 1-Me-3-CF₃-5-OCF₂H- | H | H | 2 |
| | | | | | pyrazol-4-yl | | | |
| I-67.3 | Me | CH₂Cl | H | H | 1-Me-3-CF₃-5-OCF₂H- | H | H | 2 |
| | | | | | pyrazol-4-yl | | | |
| I-68.1 | Me | Me | H | H | 1-CHF₂-3-CF₃-5- | H | H | 2 |
| | | | | | OCF₂H-pyrazol-4-yl | | | |
| I-68.2 | Me | Et | H | H | 1-CHF₂-3-CF₃-5- | H | H | 2 |
| | | | | | OCF₂H-pyrazol-4-yl | | | |
| I-68.3 | Me | CH₂Cl | H | H | 1-CHF₂-3-CF₃-5- | H | H | 2 |
| | | | | | OCF₂H-pyrazol-4-yl | | | |
| I-69.1 | Me | Me | H | H | 1-Et-3-CF₃-5-OCF₂H- | H | H | 2 |
| | | | | | pyrazol-4-yl | | | |
| I-69.2 | Me | Et | H | H | 1-Et-3-CF₃-5-OCF₂H- | H | H | 2 |
| | | | | | pyrazol-4-yl | | | |
| I-69.3 | Me | CH₂Cl | H | H | 1-Et-3-CF₃-5-OCF₂H- | H | H | 2 |
| | | | | | pyrazol-4-yl | | | |
| I-70.1 | Me | Me | H | H | 1-Pr-3-CF₃-5-OCF₂H- | H | H | 2 |
| | | | | | pyrazol-4-yl | | | |
| I-70.2 | Me | Et | H | H | 1-Pr-3-CF₃-5-OCF₂H- | H | H | 2 |
| | | | | | pyrazol-4-yl | | | |
| I-70.3 | Me | CH₂Cl | H | H | 1-Pr-3-CF₃-5-OCF₂H- | H | H | 2 |
| | | | | | pyrazol-4-yl | | | |
| I-71.1 | Me | Me | H | H | 1-iPr-3-CF₃-5-OCF₂H- | H | H | 2 |
| | | | | | pyrazol-4-yl | | | |
| I-71.2 | Me | Et | H | H | 1-iPr-3-CF₃-5-OCF₂H- | H | H | 2 |
| | | | | | pyrazol-4-yl | | | |
| I-71.3 | Me | CH₂Cl | H | H | 1-iPr-3-CF₃-5-OCF₂H- | H | H | 2 |
| | | | | | pyrazol-4-yl | | | |
| I-72.1 | Me | Me | H | H | 1-Me-3-OCF₂H-5-CF₃- | H | H | 2 |
| | | | | | pyrazol-4-yl | | | |
| I-72.2 | Me | Et | H | H | 1-Me-3-OCF₂H-5- | H | H | 2 |
| | | | | | CF₃-pyrazol-4-yl | | | |
| I-72.3 | Me | CH₂Cl | H | H | 1-Me-3-OCF₂H-5- | H | H | 2 |
| | | | | | CF₃-pyrazol-4-yl | | | |
| I-73.1 | Me | Me | H | H | 1-CHF₂-3-OCF₂H-5- | H | H | 2 |
| | | | | | CF₃-pyrazol-4-yl | | | |
| I-73.2 | Me | Et | H | H | 1-CHF₂-3-OCF₂H- | H | H | 2 |
| | | | | | 5-CF₃-pyrazol-4-yl | | | |
| I-73.3 | Me | CH₂Cl | H | H | 1-CHF₂-3-OCF₂H-5- | H | H | 2 |
| | | | | | CF₃-pyrazol-4-yl | | | |
| I-74.1 | Me | Me | H | H | 1-Et-3-OCF₂H-5- | H | H | 2 |
| | | | | | CF₃-pyrazol-4-yl | | | |
| I-74.2 | Me | Et | H | H | 1-Et-3-OCF₂H-5-CF₃- | H | H | 2 |
| | | | | | pyrazol-4-yl | | | |
| I-74.3 | Me | CH₂Cl | H | H | 1-Et-3-OCF₂H-5-CF₃- | H | H | 2 |
| | | | | | pyrazol-4-yl | | | |
| I-75.1 | Me | Me | H | H | 1-Pr-3-OCF₂H-5-CF₃- | H | H | 2 |
| | | | | | pyrazol-4-yl | | | |
| I-75.2 | Me | Et | H | H | 1-Pr-3-OCF₂H-5-CF₃- | H | H | 2 |
| | | | | | pyrazol-4-yl | | | |
| I-75.3 | Me | CH₂Cl | H | H | 1-Pr-3-OCF₂H-5-CF₃- | H | H | 2 |
| | | | | | pyrazol-4-yl | | | |
| I-76.1 | Me | Me | H | H | 1-iPr-3-OCF₂H-5-CF₃- | H | H | 2 |
| | | | | | pyrazol-4-yl | | | |
| I-76.2 | Me | Et | H | H | 1-iPr-3-OCF₂H-5-CF₃- | H | H | 2 |
| | | | | | pyrazol-4-yl | | | |
| I-76.3 | Me | CH₂Cl | H | H | 1-iPr-3-OCF₂H-5-CF₃- | H | H | 2 |
| | | | | | pyrazol-4-yl | | | |
| I-77.1 | Me | Me | H | H | 1-Me-3-CF₃-5-Cl- | H | H | 2 |
| | | | | | pyrazol-4-yl | | | |
| 1-77.2 | Me | Et | H | H | 1-Me-3-CF₃-5-Cl- | H | H | 2 |
| | | | | | pyrazol-4-yl | | | |
| I-77.3 | Me | CH₂Cl | H | H | 1-Me-3-CF₃-5-Cl- | H | H | 2 |
| | | | | | pyrazol-4-yl | | | |
| I-78.1 | Me | Me | H | H | 1-CHF₂-3-CF₃-5-Cl- | H | H | 2 |
| | | | | | pyrazol-4-yl | | | |
| I-78.2 | Me | Et | H | H | 1-CHF₂-3-CF₃-5-Cl- | H | H | 2 |
| | | | | | pyrazol-4-yl | | | |
| I-78.3 | Me | CH₂Cl | H | H | 1-CHF₂-3-CF₃-5-Cl- | H | H | 2 |
| | | | | | pyrazol-4-yl | | | |
| I-79.1 | Me | Me | H | H | 1-Et-3-CF₃-5-Cl- | H | H | 2 |
| | | | | | pyrazol-4-yl | | | |
| I-79.2 | Me | Et | H | H | 1-Et-3-CF₃-5-Cl- | H | H | 2 |
| | | | | | pyrazol-4-yl | | | |
| I-79.3 | Me | CH₂Cl | H | H | 1-Et-3-CF₃-5-Cl- | H | H | 2 |
| | | | | | pyrazol-4-yl | | | |
| I-80.1 | Me | Me | H | H | 1-Pr-3-CF₃-5-Cl- | H | H | 2 |
| | | | | | pyrazol-4-yl | | | |
| I-80.2 | Me | Et | H | H | 1-Pr-3-CF₃-5-Cl- | H | H | 2 |
| | | | | | pyrazol-4-yl | | | |
| I-80.3 | Me | CH₂Cl | H | H | 1-Pr-3-CF₃-5-Cl- | H | H | 2 |
| | | | | | pyrazol-4-yl | | | |
| I-81.1 | Me | Me | H | H | 1-iPr-3-CF₃-5-Cl- | H | H | 2 |
| | | | | | pyrazol-4-yl | | | |
| I-81.2 | Me | Et | H | H | 1-iPr-3-CF₃-5-Cl- | H | H | 2 |
| | | | | | pyrazol-4-yl | | | |
| I-81.3 | Me | CH₂Cl | H | H | 1-iPr-3-CF₃-5-Cl- | H | H | 2 |
| | | | | | pyrazol-4-yl | | | |
| I-82.1 | Me | Me | H | H | 1-Me-3-Cl-5-CF₃- | H | H | 2 |
| | | | | | pyrazol-4-yl | | | |
| I-82.2 | Me | Et | H | H | 1-Me-3-Cl-5-CF₃- | H | H | 2 |
| | | | | | pyrazol-4-yl | | | |
| I-82.3 | Me | CH₂Cl | H | H | 1-Me-3-Cl-5-CF₃- | H | H | 2 |
| | | | | | pyrazol-4-yl | | | |
| I-83.1 | Me | Me | H | H | 1-CHF₂-3-Cl-5-CF₃- | H | H | 2 |
| | | | | | pyrazol-4-yl | | | |
| I-83.2 | Me | Et | H | H | 1-CHF₂-3-Cl-5-CF₃- | H | H | 2 |
| | | | | | pyrazol-4-yl | | | |
| I-83.3 | Me | CH₂Cl | H | H | 1-CHF₂-3-Cl-5-CF₃- | H | H | 2 |
| | | | | | pyrazol-4-yl | | | |
| I-84.1 | Me | Me | H | H | 1-Et-3-Cl-5-CF₃- | H | H | 2 |
| | | | | | pyrazol-4-yl | | | |
| I-84.2 | Me | Et | H | H | 1-Et-3-Cl-5-CF₃- | H | H | 2 |
| | | | | | pyrazol-4-yl | | | |
| I-84.3 | Me | CH₂Cl | H | H | 1-Et-3-Cl-5-CF₃- | H | H | 2 |
| | | | | | pyrazol-4-yl | | | |
| I-85.1 | Me | Me | H | H | 1-Pr-3-Cl-5-CF₃- | H | H | 2 |
| | | | | | pyrazol-4-yl | | | |
| I-85.2 | Me | Et | H | H | 1-Pr-3-Cl-5-CF₃- | H | H | 2 |
| | | | | | pyrazol-4-yl | | | |
| I-85.3 | Me | CH₂Cl | H | H | 1-Pr-3-Cl-5-CF₃- | H | H | 2 |
| | | | | | pyrazol-4-yl | | | |
| I-86.1 | Me | Me | H | H | 1-iPr-3-Cl-5-CF₃- | H | H | 2 |
| | | | | | pyrazol-4-yl | | | |
| I-86.2 | Me | Et | H | H | 1-iPr-3-Cl-5-CF₃- | H | H | 2 |
| | | | | | pyrazol-4-yl | | | |
| 1-86.3 | Me | CH₂Cl | H | H | 1-iPr-3-Cl-5-CF₃- | H | H | 2 |
| | | | | | pyrazol-4-yl | | | |
| I-87.1 | Me | Me | H | H | 1,5-di-Me-3-CF₃- | H | H | 2 |
| | | | | | pyrazol-4-yl | | | |
| I-87.2 | Me | Et | H | H | 1,5-di-Me-3-CF₃- | H | H | 2 |
| | | | | | pyrazol-4-yl | | | |
| I-87.3 | Me | CH₂Cl | H | H | 1,5-di-Me-3-CF₃- | H | H | 2 |
| | | | | | pyrazol-4-yl | | | |
| I-88.1 | Me | Me | H | H | 1-CHF₂-3-CF₃-5-Me- | H | H | 2 |
| | | | | | pyrazol-4-yl | | | |
| I-88.2 | Me | Et | H | H | 1-CHF₂-3-CF₃-5-Me- | H | H | 2 |
| | | | | | pyrazol-4-yl | | | |
| I-88.3 | Me | CH₂Cl | H | H | 1-CHF₂-3-CF₃-5-Me- | H | H | 2 |
| | | | | | pyrazol-4-yl | | | |
| I-89.1 | Me | Me | H | H | 1-Et-3-CF₃-5-Me- | H | H | 2 |
| | | | | | pyrazol-4-yl | | | |
| I-89.2 | Me | Et | H | H | 1-Et-3-CF₃-5-Me- | H | H | 2 |
| | | | | | pyrazol-4-yl | | | |
| I-89.3 | Me | CH₂Cl | H | H | 1-Et-3-CF₃-5-Me- | H | H | 2 |
| | | | | | pyrazol-4-yl | | | |
| I-90.1 | Me | Me | H | H | 1-Pr-3-CF₃-5-Me- | H | H | 2 |
| | | | | | pyrazol-4-yl | | | |
| I-90.2 | Me | Et | H | H | 1-Pr-3-CF₃-5-Me- | H | H | 2 |
| | | | | | pyrazol-4-yl | | | |
| I-90.3 | Me | CH₂Cl | H | H | 1-Pr-3-CF₃-5-Me- | H | H | 2 |
| | | | | | pyrazol-4-yl | | | |
| I-91.1 | Me | Me | H | H | 1-iPr-3-CF₃-5-Me- | H | H | 2 |
| | | | | | pyrazol-4-yl | | | |
| I-91.2 | Me | Et | H | H | 1-iPr-3-CF₃-5-Me- | H | H | 2 |
| | | | | | pyrazol-4-yl | | | |
| I-91.3 | Me | CH₂Cl | H | H | 1-iPr-3-CF₃-5-Me- | H | H | 2 |
| | | | | | pyrazol-4-yl | | | |
| I-92.1 | Me | Me | H | H | 1,3-di-Me-5-CF₃- | H | H | 2 |
| | | | | | pyrazol-4-yl | | | |
| 1-92.2 | Me | Et | H | H | 1,3-di-Me-5-CF₃- | H | H | 2 |
| | | | | | pyrazol-4-yl | | | |
| I-92.3 | Me | CH₂Cl | H | H | 1,3-di-Me-5-CF₃- | H | H | 2 |
| | | | | | pyrazol-4-yl | | | |
| I-93.1 | Me | Me | H | H | 1-CHF₂-3-Me-5-CF₃- | H | H | 2 |
| | | | | | pyrazol-4-yl | | | |
| I-93.2 | Me | Et | H | H | 1-CHF₂-3-Me-5-CF₃- | H | H | 2 |
| | | | | | pyrazol-4-yl | | | |
| I-93.3 | Me | CH₂Cl | H | H | 1-CHF₂-3-Me-5-CF₃- | H | H | 2 |
| | | | | | pyrazol-4-yl | | | |
| I-94.1 | Me | Me | H | H | 1-Et-3-Me-5-CF₃- | H | H | 2 |
| | | | | | pyrazol-4-yl | | | |
| I-94.2 | Me | Et | H | H | 1-Et-3-Me-5-CF₃- | H | H | 2 |
| | | | | | pyrazol-4-yl | | | |
| I-94.3 | Me | CH₂Cl | H | H | 1-Et-3-Me-5-CF₃- | H | H | 2 |
| | | | | | pyrazol-4-yl | | | |
| I-95.1 | Me | Me | H | H | 1-Pr-3-Me-5-CF₃- | H | H | 2 |
| | | | | | pyrazol-4-yl | | | |
| I-95.2 | Me | Et | H | H | 1-Pr-3-Me-5-CF₃- | H | H | 2 |
| | | | | | pyrazol-4-yl | | | |
| I-95.3 | Me | CH₂Cl | H | H | 1-Pr-3-Me-5-CF₃- | H | H | 2 |
| | | | | | pyrazol-4-yl | | | |
| I-96.1 | Me | Me | H | H | 1-iPr-3-Me-5-CF₃- | H | H | 2 |
| | | | | | pyrazol-4-yl | | | |
| I-96.2 | Me | Et | H | H | 1-iPr-3-Me-5-CF₃- | H | H | 2 |
| | | | | | pyrazol-4-yl | | | |
| I-96.3 | Me | CH₂Cl | H | H | 1-iPr-3-Me-5-CF₃- | H | H | 2 |
| | | | | | pyrazol-4-yl | | | |
| I-97.1 | Me | Me | H | H | 3-F-Ph | H | H | 2 |
| I-97.2 | Me | Et | H | H | 3-F-Ph | H | H | 2 |
| I-97.3 | Me | CH₂Cl | H | H | 3-F-Ph | H | H | 2 |
| I-98.1 | Me | Me | H | H | 4-F-Ph | H | H | 2 |
| I-98.2 | Me | Et | H | H | 4-F-Ph | H | H | 2 |
| I-98.3 | Me | CH₂Cl | H | H | 4-F-Ph | H | H | 2 |
| I-99.1 | Me | Me | H | H | 3,4-di-F-Ph | H | H | 2 |
| I-99.2 | Me | Et | H | H | 3,4-di-F-Ph | H | H | 2 |
| I-99.3 | Me | CH₂Cl | H | H | 3,4-di-F-Ph | H | H | 2 |
| I-100.1 | Me | Me | H | H | 3,5-di-F-Ph | H | H | 2 |
| I-100.2 | Me | Et | H | H | 3,5-di-F-Ph | H | H | 2 |
| I-100.3 | Me | CH₂Cl | H | H | 3,5-di-F-Ph | H | H | 2 |
| I-101.1 | Me | Me | H | H | 3,4,5-tri-F-Ph | H | H | 2 |
| I-101.2 | Me | Et | H | H | 3,4,5-tri-F-Ph | H | H | 2 |
| I-101.3 | Me | CH₂Cl | H | H | 3,4,5-tri-F-Ph | H | H | 2 |
| I-102.1 | Me | Me | H | H | 3-Cl-Ph | H | H | 2 |
| I-102.2 | Me | Et | H | H | 3-Cl-Ph | H | H | 2 |
| I-102.3 | Me | CH₂Cl | H | H | 3-Cl-Ph | H | H | 2 |
| I-103.1 | Me | Me | H | H | 4-Cl-Ph | H | H | 2 |
| I-103.2 | Me | Et | H | H | 4-Cl-Ph | H | H | 2 |
| I-103.3 | Me | CH₂Cl | H | H | 4-Cl-Ph | H | H | 2 |
| I-104.1 | Me | Me | H | H | 3-CF₃-Ph | H | H | 2 |
| I-104.2 | Me | Et | H | H | 3-CF₃-Ph | H | H | 2 |
| I-104.3 | Me | CH₂Cl | H | H | 3-CF₃-Ph | H | H | 2 |
| I-105.1 | Me | Me | H | H | 4-CF₃-Ph | H | H | 2 |
| I-105.2 | Me | Et | H | H | 4-CF₃-Ph | H | H | 2 |
| I-105.3 | Me | CH₂Cl | H | H | 4-CF₃-Ph | H | H | 2 |
| I-106.1 | Me | Me | H | H | 4-OMe-Ph | H | H | 2 |
| I-106.2 | Me | Et | H | H | 4-OMe-Ph | H | H | 2 |
| I-106.3 | Me | CH₂Cl | H | H | 4-OMe-Ph | H | H | 2 |
| I-107.1 | Me | Me | H | H | 4-OCF₃-Ph | H | H | 2 |
| I-107.2 | Me | Et | H | H | 4-OCF₃-Ph | H | H | 2 |
| I-107.3 | Me | CH₂Cl | H | H | 4-OCF₃-Ph | H | H | 2 |
| I-108.1 | Me | Me | H | H | 3,4-di-Cl-Ph | H | H | 2 |
| I-108.2 | Me | Et | H | H | 3,4-di-Cl-Ph | H | H | 2 |
| I-108.3 | Me | CH₂Cl | H | H | 3,4-di-Cl-Ph | H | H | 2 |

The isoxaline derivatives I-21.1, I-21.2, I-21.3, I-22.1, I-22.2, I-22.3, I-23.1, I-23.2, I-23.3, I-24.1, I-24.2, I-24.3, I-52.1, I-52.2 and I-52.3 specified in table A are not known from JP-A-08225548, JP-A-9328477, JP-A-9328483, WO 2001012613, WO 2002062770, WO 2003000686, WO 2003010165, WO 2004014138, JP 2005-035924 and JP-A-2005-145958 and are consequently likewise subject matter of this invention.

Preparation of Compound I-52.1 of Table A

### 3-{[(6-Chloro-1,3-benzodioxol-5-yl)methyl]sulfonyl}-5,5-dimethyl-4,5-dihydroisoxazole

A solution of 1.484 g (5 mmol) of 3-{[(6-chloro-1,3-benzodioxol-5-yl)methyl]thio}-5,5-dimethyl-4,5-dihydroisoxazole in 100 ml of dichloromethane was admixed in portions at 0° C. and with stirring with 2.685 g of 3-chloroperbenzoic acid (70% strength, 11 mmol). The mixture was allowed to warm to room temperature and stirred for 6 hours subsequently. The mixture was extracted by stirring with dilute sodium hydroxide solution and water and the organic phase was dried and concentrated. This gave 1.52 g of product in the form of a colorless solid (83.3% of theory). m.p. 170° C.

Preparation of the Reactant 3-{[(6-chloro-1,3-benzodioxol-5-yl)methyl]thio}-5,5-dimethyl-4,5-dihydroisoxazole

A mixture of 50 ml of toluene and 28 g of 50% strength sodium hydroxide solution was admixed with vigorous stirring at room temperature with 4.210 g (15 mmol) of 6-chloropiperonylisothiuronium chloride (prepared by heating equimolar amounts of thiourea and 6-chloropiperonyl chloride in ethanol), 1.351 g (4 mmol) of tetra-n-butylammonium bromide and subsequently 2.000 g (15 mmol) of 3-chloro-5,5-dimethyl-4,5-dihydroisoxazole (WO 2001 012613). The mixture was stirred vigorously for 6 hours and diluted with water. Following the addition of further toluene, the phases were separated and the organic phase was dried and concentrated. The oily crude product was chromatographed on silica gel for purification (heptane/ethyl acetate 10:1). This gave 1.64 g of product (34.7% of theory) as a solid with an m.p. of 88° C.

In a similar way it is possible to prepare the further new compounds of the formula (I), i.e., the compounds of the formula I-21.1, I-21.2, I-21.3 I-22.1, I-22.2, I-22.3, I-23.1, I-23.2, I-23.3, I-24.1, I-24.2, I-24.3, I-52.2 and I-52.3.

The application rate of the herbicides (A) may vary within a wide range depending on external conditions, such as temperature and humidity, and the type of herbicide used, for example between 0.001 g and 1000 g of ai/ha (hereinbelow, ai/ha means “active ingredient per hectare”=based on 100% pure active compound).

On application using application rates of from 0.01 g to 800 g of ai/ha of the herbicides (A), preferably the compounds I-1.1 to I-108.3, a relatively broad spectrum of harmful plants, for example annual and perennial monocotyledonous or dicotyledonous weeds, and also of unwanted crop plants is controlled by the pre-emergence and the post-emergence method. In the combinations according to the invention, the application rates are generally lower, for example in the range from 0.1 g to 500 g of ai/ha, preferably from 10 g to 400 g of ai/ha, particularly preferably from 20 g to 300 g of ai/ha.

The herbicides (A) are suitable for controlling harmful plants, for example in crop plants, for example in economically important farm crops, for example monocotyledonous farm crops, such as cereals (for example wheat, barley, rye, oats), rice, corn, millet, or dicotyledonous farm crops, such as sugar beet, oilseed rape, cotton, sunflower and legumes, for example of the genera glycine (for example Glycine max. (soybean), such as non-transgenic Glycine max. (for example conventional cultivars, such as STS cultivars) or transgenic Glycine max. (for example RR soybean or LL soybean) and crossbreeds thereof), Phaseolus, Pisum, Vicia and Arachis, or vegetable crops from various botanical groups, such as potato, leek, cabbage, carrot, tomato, onion, and also permanent crops and plantation crops, such as pome fruit and stone fruit, berry fruit, grapevines, Hevea, bananas, sugar cane, coffee, tea, citrus fruit, nut plantations, lawn, palm plantations and forest plantations. These crops are also preferred for the application of the herbicide/safener combinations (A)+(B) according to the invention; particularly preferred is the application in cereals (for example wheat, barley, rye, oats), rice, corn, millet, sugar beet, sugar cane, sunflower, oilseed rape and cotton. The herbicide/safener combinations (A)+(B) can also be used in tolerant and non-tolerant mutant crops and in tolerant and non-tolerant transgenic crops, for example of corn, rice, cereals, oilseed rape and soybean, for example those which are resistant to imidazolinone herbicides, atrazine, glufosinate or glyphosate.

The safeners present as component (B) are understood to be compounds which are capable of reducing phytotoxic effects of crop protection agents such as herbicides on crop plants.

The safeners (B) are preferably selected from the group consisting of:
a) compounds of the formulae (II) to (IV), 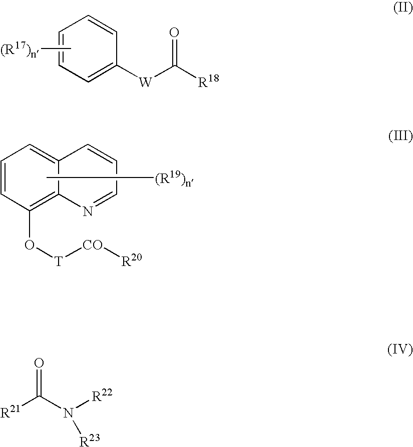
where the symbols and indices are as defined below:
n′ is a natural number from 0 to 5, preferably 0 to 3;
T is a (C₁ or C₂)-alkanediyl chain which is unsubstituted or substituted by one or two (C₁-C₄)-alkyl radicals or by [(C₁-C₃)-alkoxy]carbonyl;
W is an unsubstituted or substituted divalent heterocyclic radical from the group of the partially unsaturated or aromatic five-membered heterocycles having 1 to 3 nitrogen or oxygen hetero ring atoms, where the ring contains at least one nitrogen atom and at most one oxygen atom, preferably a radical from the group consisting of (W1) to (W4), 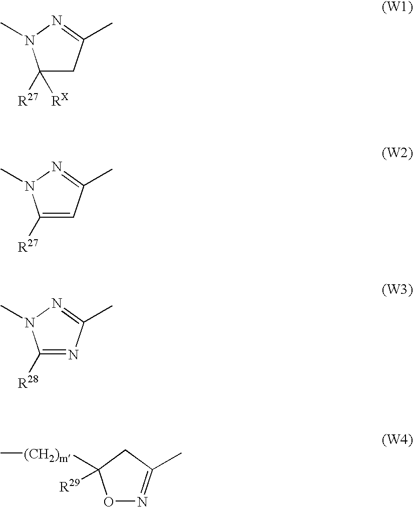
m′ is 0 or 1;
R¹⁷, R¹⁹ are identical or different and are halogen, (C₁-C₄)-alkyl, (C₁-C₄)-alkoxy, nitro or (C₁-C₄)-haloalkyl;
R¹⁸, R²⁰ are identical or different and are OR²⁴, SR²⁴ or NR²⁴R²⁵ or a saturated or unsaturated 3- to 7-membered heterocycle having at least one nitrogen atom and up to 3 heteroatoms, preferably from the group consisting of oxygen and sulfur, which is attached to the carbonyl group in (II) or (III) via the nitrogen atom and which is unsubstituted or substituted by radicals from the group consisting of (C₁-C₄)-alkyl, (C₁-C₄)-alkoxy and optionally substituted phenyl, preferably a radical of the formula OR²⁴, NH R²⁵ or N(CH₃)₂, in particular of the formula OR²⁴;
R²⁴ is hydrogen or an unsubstituted or substituted aliphatic hydrocarbon radical having preferably a total of 1 to 18 carbon atoms;
R²⁵ is hydrogen, (C₁-C₆)-alkyl, (C₁-C₆)-alkoxy or substituted or unsubstituted phenyl;
R^{X} is H, (C₁-C₈)-alkyl, (C₁-C₈)-haloalkyl, (C₁-C₄)-alkoxy-(C₁-C₈)-alkyl, cyano or COOR²⁶, where R²⁶ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkylsilyl;
R²⁷, R²⁸, R²⁹ are identical or different and are hydrogen, (C₁-C₈)-alkyl, (C₁-C₈)-haloalkyl, (C₃-C₁₂)-haloalkyl or substituted or unsubstituted phenyl;
R²¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;
R²², R²³ are identical or different and are hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R²² and R²³ together form a substituted or unsubstituted heterocyclic ring, preferably an oxazolidine, thiazolidine, piperidine, morpholine, hexahydropyrimidine or benzoxazine ring;
   b) one or more compounds from the group consisting of:
1,8-naphthalic anhydride,
methyl diphenylmethoxyacetate,
1-(2-chlorobenzyl)-3-(1-methyl-1-phenylethyl)urea (cumyluron),
O,O-diethyl S-2-ethylthioethyl phosphorodithioate (disulfoton),
4-chlorophenyl methylcarbamate (mephenate),
O,O-diethyl O-phenyl phosphorothioate (dietholate),
4-carboxy-3,4-dihydro-2H-1-benzopyran-4-acetic acid (CL-304415, CAS-Regno: 31541-57-8),
cyanomethoxyimino(phenyl)acetonitrile (cyometrinil),
1,3-dioxolan-2-ylmethoxyimino(phenyl)acetonitrile (oxabetrinil),
4′-chloro-2,2,2-trifluoroacetophenone O-1,3-dioxolan-2-ylmethyloxime (fluxofenim),
4,6-dichloro-2-phenylpyrimidine (fenclorim),
benzyl 2-chloro-4-trifluoromethyl-1,3-thiazole-5-carboxylate (flurazole),
2-dichloromethyl-2-methyl-1,3-dioxolane (MG-191),
N-(4-methylphenyl)-N′-(1-methyl-1-phenylethyl)urea (dymron),
(2,4-dichlorophenoxy)acetic acid (2,4-D),
(4-chlorophenoxy)acetic acid,
(R,S)-2-(4-chloro-o-tolyloxy)propionic acid (mecoprop),
4-(2,4-dichlorophenoxy)butyric acid (2,4-DB),
(4-chloro-o-tolyloxy)acetic acid (MCPA),
4-(4-chloro-o-tolyloxy)butyric acid,
4-(4-chlorophenoxy)butyric acid,
3,6-dichloro-2-methoxybenzoic acid (dicamba),
1-(ethoxycarbonyl)ethyl 3,6-dichloro-2-methoxybenzoate (lactidichlor) and their salts and esters, preferably (C₁-C₈) esters;
   c) N-acylsulfonamides of the formula (V) and salts thereof 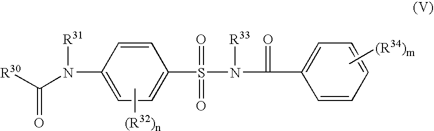
   in which
R³⁰ is hydrogen, a hydrocarbon radical, a hydrocarbon oxy radical, a hydrocarbon thio radical or a heterocyclyl radical which is preferably attached via a carbon atom, where each of the 4 last-mentioned radicals is unsubstituted or substituted by one or more identical or different radicals from the group consisting of halogen, cyano, nitro, amino, hydroxyl, carboxyl, formyl, carboxamide, sulfonamide and radicals of the formula -Z^{a}-R^{a}, where each hydrocarbon moiety has preferably 1 to 20 carbon atoms and a carbon-containing radical R³⁰ including substitutents has preferably 1 to 30 carbon atoms;
R³¹ is hydrogen or (C₁-C₄)-alkyl, preferably hydrogen, or
R³⁰ and R³¹ together with the group of the formula —CO—N— are the radical of a 3- to 8-membered saturated or unsaturated ring;
R³² are identical or different and are halogen, cyano, nitro, amino, hydroxyl, carboxyl, formyl, CONH₂, SO₂NH₂ or a radical of the formula -Z^{b}-R^{b};
R³³ is hydrogen or (C₁-C₄)-alkyl, preferably H;
R³⁴ are identical or different and are halogen, cyano, nitro, amino, hydroxyl, carboxyl, CHO, CONH₂, SO₂NH₂ or a radical of the formula -Z^{c}-R^{c};
R^{a} is a hydrocarbon radical or a heterocyclyl radical, where each of the two last-mentioned radicals is unsubstituted or substituted by one or more identical or different radicals from the group consisting of halogen, cyano, nitro, amino, hydroxyl, mono- and di-[(C₁-C₄)-alkyl]amino, or by an alkyl radical in which a plurality of, preferably 2 or 3, non-adjacent CH₂ groups are in each case replaced by an oxygen atom;
R^{b}, R^{c} are identical or different and are a hydrocarbon radical or a heterocyclyl radical, where each of the two last-mentioned radicals is unsubstituted or substituted by one or more identical or different radicals from the group consisting of halogen, cyano, nitro, amino, hydroxyl, phosphoryl, halo-(C₁-C₄)-alkoxy, mono- and di-[(C₁-C₄)-alkyl]amino, or an alkyl radical in which a plurality of, preferably 2 or 3, non-adjacent CH₂ groups are in each case replaced by an oxygen atom;
Z^{a} is a divalent group of the formula —O—, —S—, —CO—, —CS—, —CO—O—, —CO—S—, —O—CO—, —S—CO—, —SO—, —SO₂—, —NR*-, —CO—NR*-, —NR*-CO—, —SO₂—NR*- or —NR*—SO₂—, where the bond on the right of the divalent group in question is the bond to the radical R^{a} and where the R* in the 5 last-mentioned radicals independently of one another are each H, (C₁-C₄)-alkyl or halo-(C₁-C₄)-alkyl;
Z^{b}, Z^{c} independently of one another are a direct bond or a divalent group of the formula —O—, —S—, —CO—, —CS—, —CO—O—, —CO—S—, —O—CO—, —S—CO—, —SO—, —SO₂—, —NR*-, —SO₂—NR*-, —NR*-SO₂—, —CO—NR*- or —NR*-CO—, where the bond on the right of the divalent group in question is the bond to the radical R^{b} or R^{c} and where the R* in the 5 last-mentioned radicals independently of one another are each H, (C₁-C₄)-alkyl or halo-(C₁-C₄)-alkyl;
n is an integer from 0 to 4, preferably 0, 1 or 2, in particular 0 or 1, and
m is an integer from 0 to 5, preferably 0, 1, 2 or 3, in particular 0, 1 or 2;
   d) acylsulfamoylbenzamides of the formula (VI), if appropriate also in salt form, 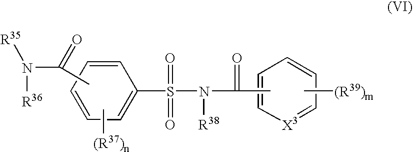
   where
X³ is CH or N;
R³⁵ is hydrogen, heterocyclyl or a hydrocarbon radical, where the two last-mentioned radicals are optionally substituted by one or more identical or different radicals from the group consisting of halogen, cyano, nitro, amino, hydroxyl, carboxyl, CHO, CHO, CONH₂, SO₂NH₂ and Z^{a}-R^{a};
R³⁶ is hydrogen, hydroxyl, (C₁-C₆)-alkyl, (C₂-C₆)-alkenyl, (C₂-C₆)alkynyl, (C₁-C₆)-alkoxy, (C₂-C₆)-alkenyloxy, where the five last-mentioned radicals are optionally substituted by one or more identical or different radicals from the group consisting of halogen, hydroxyl, (C₁-C₄)-alkyl, (C₁-C₄)-alkoxy and (C₁-C₄)-alkylthio, or
R³⁵ and R³⁶ together with the nitrogen atom that carries them are a 3- to 8-membered saturated or unsaturated ring;
R³⁷ is halogen, cyano, nitro, amino, hydroxyl, carboxyl, CHO, CONH₂, SO₂NH₂ or Z^{b}-R^{b};
R³⁸ is hydrogen, (C₁-C₄)-alkyl, (C₂-C₄)-alkenyl or (C₂-C₄)-alkynyl;
R³⁹ is halogen, cyano, nitro, amino, hydroxyl, carboxyl, phosphoryl, CHO, CONH₂, SO₂NH₂ or Z^{c}-R^{c};
R^{a} is a (C₂-C₂₀)-alkyl radical whose carbon chain is interrupted once or more than once by oxygen atoms, is heterocyclyl or a hydrocarbon radical, where the two last-mentioned radicals are optionally substituted by one or more identical or different radicals from the group consisting of halogen, cyano, nitro, amino, hydroxyl, mono- and di-[(C₁-C₄)-alkyl]amino;
R^{b}, R^{c} are identical or different and are a (C₂-C₂₀)-alkyl radical whose carbon chain is interrupted once or more than once by oxygen atoms, are heterocyclyl or a hydrocarbon radical, where the two last-mentioned radicals are optionally substituted by one or more identical or different radicals from the group consisting of halogen, cyano, nitro, amino, hydroxyl, phosphoryl, (C₁-C₄)-haloalkoxy, mono- and di-[(C₁-C₄)-alkyl]amino;
Z^{a} is a divalent unit from the group consisting of O, S, CO, CS, C(O)O, C(O)S, SO, SO₂, NR^{d}, C(O)NR^{d} and SO₂NR^{d};
Z^{b}, Z^{c} are identical or different and are a direct bond or a divalent unit from the group consisting of O, S, CO, CS, C(O)O, C(O)S, SO, SO₂, NR^{d}, SO₂NR^{d} and C(O)NR^{d};
R^{d} is hydrogen, (C₁-C₄)-alkyl or (C₁-C₄)-haloalkyl;
n is an integer from 0 to 4, and
m if X is CH, is an integer from 0 to 5, and if X is N, is an integer from 0 to 4;
   e) compounds of the type of the acylsulfamoylbenzamides, for example of the formula (VII) below, which are known, for example, from WO 99/16744, 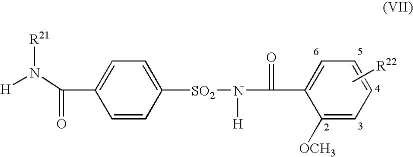
   for example those in which
R²¹=cyclopropyl and R²²=H (S3-1=4-cyclopropylaminocarbonyl-N-(2-methoxybenzoyl)benzenesulfonamide),
R²¹=cyclopropyl and R²²=5-Cl (S3-2),
R²¹=ethyl and R²²=H(S3-3),
R²¹=isopropyl and R²²=5-Cl (S3-4) and
R²¹=isopropyl and R²²=H(S3-5);
   f) compounds of the type of the N-acylsulfamoylphenylureas of the formula (VIII) which are known, for example, from EP-A-365484, 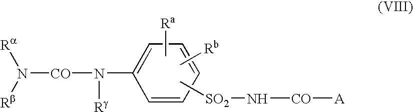
   in which
A is a radical from the group consisting of 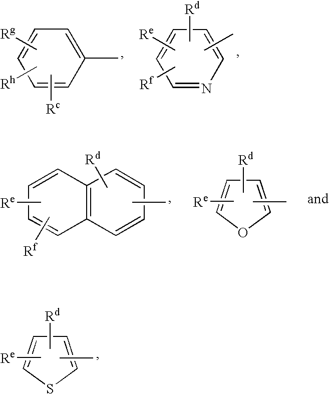
R^{α} and R^{β} independently of one another are hydrogen, C₁-C₈-alkyl, C₃-C₈-cycloalkyl, C₃-C₆-alkenyl, C₃-C₆-alkynyl, 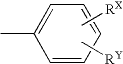
   or C₁-C₄-alkoxy which is substituted by 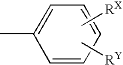
   or C₁-C₄-alkoxy, or
R^{α} and R^{β} together are a C₄-C₆-alkylene bridge or a C₄-C₆-alkylene bridge which is interrupted by oxygen, sulfur, SO, SO₂, NH or —N(C₁-C₄-alkyl)-,
R^{γ} is hydrogen or C₁-C₄-alkyl,
R^{a} and R^{b} independently of one another are hydrogen, halogen, cyano, nitro, trifluoromethyl, C₁-C₄-alkyl, C₁-C₄-alkoxy, C₁-C₄-alkylthio, C₁-C₄-alkylsulfinyl, C₁-C₄-alkylsulfonyl, —COOR^{j}, —CONR^{k}R^{m}, —CORⁿ, —SO₂NR^{k}R^{m} or —OSO₂—C₁-C₄-alkyl, or R^{a} and R^{b} together are a C₃-C₄-alkylene bridge which may be substituted by halogen or C₁-C₄-alkyl, or a C₃-C₄-alkenylene bridge which may be substituted by halogen or C₁-C₄-alkyl, or a C₄-alkadienylene bridge which may be substituted by halogen or C₁-C₄-alkyl, and
R^{g} and R^{h} independently of one another are hydrogen, halogen, C₁-C₄-alkyl, trifluoromethyl, methoxy, methylthio or —COOR^{j}, where
R^{c} is hydrogen, halogen, C₁-C₄-alkyl or methoxy,
R^{d} is hydrogen, halogen, nitro, C₁-C₄-alkyl, C₁-C₄-alkoxy, C₁-C₄-alkylthio, C₁-C₄-alkylsulfinyl, C₁-C₄-alkylsulfonyl, —COOR^{j} or —CONR^{k}R^{m},
R^{e} is hydrogen, halogen, C₁-C₄-alkyl, —COOR^{j}, trifluoromethyl or methoxy, or R^{d} and R^{e} together are a C₃-C₄-alkylene bridge,
R^{f} is hydrogen, halogen or C₁-C₄-alkyl,
R^{X} and R^{Y} independently of one another are hydrogen, halogen, C₁-C₄-alkyl, C₁-C₄-alkoxy, C₁-C₄-alkylthio, —COOR⁴, trifluoromethyl, nitro or cyano,
R^{j}, R^{k} and R^{m} independently of one another are hydrogen or C₁-C₄-alkyl,
R^{k} and R^{m} together are a C₄-C₆-alkylene bridge or a C₄-C₆-alkylene bridge which is interrupted by oxygen, NH or —N(C₁-C₄-alkyl)-, and
Rⁿ is C₁-C₄-alkyl, phenyl or phenyl which is substituted by halogen, C₁-C₄-alkyl, methoxy, nitro or trifluoromethyl,
preferably
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methyl urea,
1-[4-(N-naphthoylsulfamoyl)phenyl]-3,3-dimethylurea,
   g) compounds of the type of the acylsulfamoylbenzamides of the formula (IX), known from EP-A-1019368, including if desired in salt form, 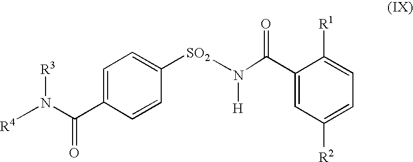
   in which
R¹ is methyl, methoxy or trifluoromethoxy;
R² is hydrogen, chlorine or methyl;
R³ is hydrogen, ethyl or propargyl;
R⁴ is ethyl, cyclopropyl, isopropyl or propargyl, or
R³ and R⁴ together form the group (CH₂)₄,
   including the stereoisomers and the agriculturally customary salts.

Preference is given to herbicide/safener combinations comprising (A) a herbicidally effective amount of one or more compounds of the formula (I) or salts thereof and (B) an amount, acting as an antidote, of one or more safeners.

Herbicidally effective amount in the sense of the invention is an amount of one or more herbicides sufficient to have a negative impact on plant growth. In the sense of the invention, an amount which acts as an antidote is an amount of one or more safeners sufficient to reduce the phytotoxic effect of crop protection agents (for example herbicides) on crop plants.

The compounds of the formula (II) are known, for example, from EP-A-0 333 131 (ZA-89/1960), EP-A-0 269 806 (U.S. Pat. No. 4,891,057), EP-A-0 346 620 (AU-A-89/34951), EP-A-0 174 562, EP-A-0 346 620 (WO-A-91/08 202), WO-A-91/07 874 or WO-A 95/07 897 (ZA 94/7120) and the literature cited therein or can be prepared by or analogously to the processes described therein. The compounds of the formula (III) are known from EP-A-0 086 750, EP-A-0 94349 (U.S. Pat. No. 4,902,340), EP-A-0 191736 (U.S. Pat. No. 4,881,966) and EP-A-0 492 366 and the literature cited therein or can be prepared by or analogously to the processes described therein. Furthermore, some compounds are described in EP-A-0 582 198 and WO 2002/34048. The compounds of the formula (IV) are known from numerous patent applications, for example U.S. Pat. No. 4,021,224 and U.S. Pat. No. 4,021,229.

Compounds of the group B (b) are also known from CN-A-87/102 789, EP-A-365484 and from “The Pesticide Manual”, The British Crop Protection Council and the Royal Society of Chemistry, 11th edition, Farnham 1997.

The compounds of the group B (c) are described in WO-A-97/45016, those of group B (d) in WO-A-99/16744 and those of group B (e) in EP-A-365484, and those of group B (g) in EP-A-1019368.

The publications cited contain detailed statements about preparation processes and starting materials and mention preferred compounds. These publications are expressly referred to; by reference, they form part of the present description.

Preference is given to herbicide/safener combinations comprising safeners of the formula (II) and/or (III) in which the symbols and indices are as defined below:

R²⁴ is hydrogen, (C₁-C₁₈)-alkyl, (C₃-C₁₂)-cycloalkyl, (C₂-C₈)-alkenyl and (C₂-C₁₈)-alkynyl, where the carbon-containing groups may be substituted by one or more, preferably up to three, radicals R⁵⁰;

R⁵⁰ are identical or different and are halogen, hydroxyl, (C₁-C₈)-alkoxy, (C₁-C₈)-alkylthio, (C₂-C₈)-alkenylthio, (C₂-C₈)-alkynylthio, (C₂-C₈)-alkenyloxy, (C₂-C₈)-alkynyloxy, (C₃-C₇)-cycloalkyl, (C₃-C₇)-cycloalkoxy, cyano, mono- and di-(C₁-C₄)-alkylamino, carboxyl, (C₁-C₈)-alkoxycarbonyl, (C₂-C₈)-alkenyloxycarbonyl, (C₁-C₈)-alkylthiocarbonyl, (C₂-C₈)-alkynyloxycarbonyl, (C₁-C₈)-alkylcarbonyl, (C₂-C₈)-alkenylcarbonyl, (C₂-C₈)-alkynylcarbonyl, 1-(hydroxyimino)-(C₁-C₆)-alkyl, 1-[(C₁-C₄)-alkylimino]-(C₁-C₄)-alkyl, 1-[(C₁-C₄)-alkoxyimino]-(C₁-C₆)-alkyl, (C₁-C₈)-alkylcarbonylamino, (C₂-C₈)-alkenylcarbonylamino, (C₂-C₈)-alkynylcarbonylamino, aminocarbonyl, (C₁-C₈)-alkylaminocarbonyl, di-(C₁-C₆)-alkylaminocarbonyl, (C₂-C₆)-alkenylaminocarbonyl, (C₂-C₆)-alkynylaminocarbonyl, (C₁-C₈)-alkoxycarbonylamino, (C₁-C₈)-alkylaminocarbonylamino, (C₁-C₆)-alkylcarbonyloxy which is unsubstituted or substituted by R⁵¹, (C₂-C₆)-alkenylcarbonyloxy, (C₂-C₆)-alkynylcarbonyloxy, (C₁-C₈)-alkylsulfonyl, phenyl, phenyl-(C₁-C₆)-alkoxy, phenyl-(C₁-C₆)-alkoxycarbonyl, phenoxy, phenoxy-(C₁-C₆)-alkoxy, phenoxy-(C₁-C₆)-alkoxycarbonyl, phenylcarbonyloxy, phenylcarbonylamino, phenyl-(C₁-C₆)-alkylcarbonylamino, where the phenyl ring of the 9 last-mentioned radicals is unsubstituted or mono- or polysubstituted, preferably up to trisubstituted, by radicals R⁵²; SiR′₃, —O—SiR′₃, R′₃Si—(C₁-C₈)-alkoxy, —CO—O—NR′₂, —O—N═CR′₂, —N═CR′₂, —O—NR′₂, —NR′₂, CH(OR′)₂, —O—(CH₂)ₘ—CH(OR′)₂, —CR′″ (OR′)₂, —O—(CH₂)ₘCR′″(OR″)₂ or by R″O—CHR′″CHCOR″—(C₁-C₆)-alkoxy,
R⁵¹ are identical or different and are halogen, nitro, (C₁-C₄)-alkoxy and phenyl which is unsubstituted or substituted by one or more, preferably up to three, radicals R⁵²;
R⁵² are identical or different and are halogen, (C₁-C₄)-alkyl, (C₁-C₄)-alkoxy, (C₁-C₄)-haloalkyl, (C₁-C₄)-haloalkoxy or nitro;
R′ are identical or different and are hydrogen, (C₁-C₄)-alkyl, phenyl which is unsubstituted or substituted by one or more, preferably up to three, radicals R⁵², or two radicals R′ together form a (C₂-C₆)-alkanediyl chain;
R″ are identical or different and are (C₁-C₄)-alkyl, or two radicals R″ together form a (C₂-C₆)-alkanediyl chain;
R′″ is hydrogen or (C₁-C₄)-alkyl;
m is 0, 1, 2, 3, 4, 5 or 6.

Particular preference is given to herbicide/safener combinations according to the invention comprising safeners of the formula (II) and/or (III) in which the symbols and indices are as defined below:
R²⁴ is hydrogen, (C₁-C₈)-alkyl or (C₃-C₇)-cycloalkyl, where the carbon-containing radicals above are unsubstituted or mono- or polysubstituted by halogen or mono- or disubstituted, preferably monosubstituted, by radicals R⁵⁰,
R⁵⁰ are identical or different and are hydroxyl, (C₁-C₄)-alkoxy, carboxyl, (C₁-C₄)-alkoxycarbonyl, (C₂-C₆)-alkenyloxycarbonyl, (C₂-C₆)-alkynyloxycarbonyl, 1-(hydroxyimino)-(C₁-C₄)-alkyl, 1-[(C₁-C₄)-alkylimino]-(C₁-C₄)-alkyl and 1-[(C₁-C₄)-alkoxyimino]-(C₁-C₄)-alkyl; —SiR′₃, —O—N═CR′₂, —N═CR′₂, —NR′₂ and —O—NR′₂, in which R′ are identical or different and are hydrogen, (C₁-C₄)-alkyl or, as a pair, are a (C₄-C₅)-alkanediyl chain,
R²⁷, R²⁸, R²⁹ are identical or different and are hydrogen, (C₁-C₈)-alkyl, (C₁-C₆)-haloalkyl, (C₃-C₇)-cycloalkyl or phenyl which is unsubstituted or substituted by one or more radicals from the group consisting of halogen, cyano, nitro, amino, mono- and di-[(C₁-C₄)-alkyl]amino, (C₁-C₄)-alkyl, (C₁-C₄)-haloalkyl, (C₁-C₄)-alkoxy, (C₁-C₄)-haloalkoxy, (C₁-C₄)-alkylthio and (C₁-C₄)-alkylsulfonyl;
R^{X} is hydrogen or COOR²⁴, where R²⁶ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₇)-cycloalkyl or tri-(C₁-C₄)-alkylsilyl,
R¹⁷, R¹⁹ are identical or different and are halogen, methyl, ethyl, methoxy, ethoxy, (C₁-C₂)-haloalkyl, preferably hydrogen, halogen or (C₁-C₂)-haloalkyl.

Very particular preference is given to safeners in which the symbols and indices in the formula (II) are as defined below:
R¹⁷ is halogen, nitro or (C₁-C₄)-haloalkyl;
n′ is 0, 1, 2 or 3;
R¹⁸ is a radical of the formula OR²⁴,
R²⁴ is hydrogen, (C₁-C₈)-alkyl or (C₃-C₇)-cycloalkyl, where the carbon-containing radicals above are unsubstituted or mono- or polysubstituted, preferably up to trisubstituted, by identical or different halogen radicals or up to disubstituted, preferably monosubstituted, by identical or different radicals from the group consisting of hydroxyl, (C₁-C₄)-alkoxy, (C₁-C₄)-alkoxycarbonyl, (C₂-C₆)-alkenyl-oxycarbonyl, (C₂-C₆)-alkynyloxycarbonyl, 1-(hydroxyimino)-(C₁-C₄)-alkyl, 1-[(C₁-C₄)-alkylimino]-(C₁-C₄)-alkyl, 1-[(C₁-C₄)-alkoxyimino]-(C₁-C₄)-alkyl and radicals of the formulae —SiR′₃, —O—N═R′₂, —N═CR′₂, —NR′₂ and —O—NR′₂, where the radicals R′ in the formulae mentioned are identical or different and are hydrogen, (C₁-C₄)-alkyl or, as a pair, are (C₄-C₅)-alkanediyl;
R²⁷, R²⁸, R²⁹ are identical or different and are hydrogen, (C₁-C₈)-alkyl, (C₁-C₆)-haloalkyl, (C₃-C₇)-cycloalkyl or phenyl which is unsubstituted or substituted by one or more radicals from the group consisting of halogen, (C₁-C₄)-alkyl, (C₁-C₄)-alkoxy, nitro, (C₁-C₄)-haloalkyl and (C₁-C₄)-haloalkoxy, and
R^{X} is hydrogen or COOR²⁶, where R²⁶ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₇)-cycloalkyl or tri-(C₁-C₄)-alkylsilyl.

Very particular preference is also given to safeners of the formula (III) in which the symbols and indices are as defined below:
R¹⁹ is halogen or (C₁-C₄)-haloalkyl;
n′ is 0, 1, 2 or 3, where (R¹⁹)_{n′} is preferably 5-Cl;
R²⁰ is a radical of the formula OR²⁴;
T is CH₂ or CH(COO—(C₁-C₃)-alkyl) and
R²⁴ is hydrogen, (C₁-C₈)-alkyl, (C₁-C₈)-haloalkyl or (C₁-C₄)-alkoxy-(C₁-C₄)-alkyl, preferably hydrogen or (C₁-C₈)-alkyl.

Especially preferred are safeners of the formula (II) in which the symbols and indices are as defined below:
W is (W1);
R¹⁷ is halogen or (C₁-C₂)-haloalkyl;
n′ is 0, 1, 2 or 3, where (R¹⁷)_{n′} is preferably 2,4-Cl₂;
R¹⁸ is a radical of the formula OR²⁴;
R²⁴ is hydrogen, (C₁-C₈)-alkyl, (C₁-C₄)-haloalkyl, (C₁-C₄)-hydroxyalkyl, (C₃-C₇)-cycloalkyl, (C₁-C₄)-alkoxy-(C₁-C₄)-alkyl or tri-(C₁-C₂)-alkylsilyl, preferably (C₁-C₄)-alkyl;
R²⁷ is hydrogen, (C₁-C₈)-alkyl, (C₁-C₄)-haloalkyl or (C₃-C₇)-cycloalkyl, preferably hydrogen or (C₁-C₄)-alkyl, and
R^{X} is COOR²⁶, where R²⁶ is hydrogen, (C₂-C₈)-alkyl, (C₁-C₄)-haloalkyl, (C₁-C₄)-hydroxyalkyl, (C₃-C₇)-cycloalkyl, (C₁-C₄)-alkoxy-(C₁-C₄)-alkyl or tri-(C₁-C₂)-alkylsilyl, preferably hydrogen or (C₁-C₄)-alkyl.

Also especially preferred are herbicidal compositions comprising a safener of the formula (II) in which the symbols and indices are as defined below:
W is (W2);
R¹⁷ is halogen or (C₁-C₂)-haloalkyl;
n′ is 0, 1, 2 or 3, where (R¹⁷)_{n′} is preferably 2,4-Cl₂;
R¹⁸ is a radical of the formula OR²⁴;
R²⁴ is hydrogen, (C₁-C₈)-alkyl, (C₁-C₄)-haloalkyl, (C₁-C₄)-hydroxyalkyl, (C₃-C₇)-cycloalkyl, (C₁-C₄)-alkoxy-(C₁-C₄)-alkyl or tri-(C₁-C₂)-alkylsilyl, preferably (C₁-C₄)-alkyl, and
R²⁷ is hydrogen, (C₁-C₈)-alkyl, (C₁-C₄)-haloalkyl, (C₃-C₇)-cycloalkyl or unsubstituted or substituted phenyl, preferably hydrogen, (C₁-C₄)-alkyl or phenyl which is unsubstituted or substituted by one or more radicals from the group consisting of halogen, (C₁-C₄)-alkyl, (C₁-C₄)-haloalkyl, nitro, cyano and (C₁-C₄)-alkoxy.

Especially preferred are also safeners of the formula (II) in which the symbols and indices are as defined below:
W is (W3);
R¹⁷ is halogen or (C₁-C₂)-haloalkyl;
n′ is 0, 1, 2 or 3, where (R¹⁷)_{n′} is preferably 2,4-Cl₂;
R¹⁸ is a radical of the formula OR²⁴;
R²⁴ is hydrogen, (C₁-C₈)-alkyl, (C₁-C₄)-haloalkyl, (C₁-C₄)-hydroxyalkyl, (C₃-C₇)- cycloalkyl, (C₁-C₄)-alkoxy-(C₁-C₄)-alkyl or tri-(C₁-C₂)-alkylsilyl, preferably (C₁-C₄)-alkyl, and
R²⁸ is (C₁-C₈)-alkyl or (C₁-C₄)-haloalkyl, preferably C₁-haloalkyl.

Especially preferred are also safeners of the formula (II) in which the symbols and indices are as defined below:
W is (W4);
R¹⁷ is halogen, nitro, (C₁-C₄)-alkyl, (C₁-C₂)-haloalkyl, preferably CF₃, or (C₁-C₄)-alkoxy;
n′ is 0, 1, 2 or 3;
m′ is 0 or 1;
R¹⁸ is a radical of the formula OR²⁴;
R²⁴ is hydrogen, (C₁-C₄)-alkyl, carboxy-(C₁-C₄)-alkyl, (C₁-C₄)-alkoxycarbonyl-(C₁-C₄)-alkyl, preferably (C₁-C₄)-alkoxy-CO—CH₂—, (C₁-C₄)-alkoxy-CO—C(CH₃)H—, HO—CO—CH₂— or HO—CO—C(CH₃)H—, and
R²⁹ is hydrogen, (C₁-C₄)-alkyl, (C₁-C₄)-haloalkyl, (C₃-C₇)-cycloalkyl or phenyl which is unsubstituted or substituted by one or more radicals from the group consisting of halogen, (C₁-C₄)-alkyl, (C₁-C₄)-haloalkyl, nitro, cyano and (C₁-C₄)-alkoxy.

Particularly suitable safeners for the herbicidally active compounds of the formula (I) are the following groups of compounds:
a) compounds of the type of dichlorophenylpyrazoline-3-carboxylic acid (i.e. of the formula (II) in which W=(W1) and (R¹⁷)_{n′}=2,4-Cl₂), preferably compounds such as ethyl 1-(2,4-dichlorophenyl)-5-(ethoxycarbonyl)-5-methyl-2-pyrazoline-3-carboxylate (II-1, mefenpyr-diethyl), mefenpyr-dimethyl and mefenpyr (II-0), and related compounds as described in WO-A 91/07874;
b) derivatives of dichlorophenylpyrazolecarboxylic acid (i.e. of the formula (II) in which W=(W2) and (R¹⁷)_{n′}=2,4-Cl₂), preferably compounds such as ethyl 1-(2,4-dichlorophenyl)-5-methylpyrazole-3-carboxylate (II-2), ethyl 1-(2,4-dichlorophenyl)-5-isopropylpyrazole-3-carboxylate (II-3), ethyl 1-(2,4-dichlorophenyl)-5-(1,1-dimethylethyl)pyrazole-3-carboxylate (II-4), ethyl 1-(2,4-dichlorophenyl)-5-phenylpyrazole-3-carboxylate (II-5) and related compounds, as described in EP-A-0 333 131 and EP-A-0 269 806;
c) compounds of the type of the triazolecarboxylic acids (i.e. of the formula (II) in which W=(W3) and (R¹⁷)_{n′}=2,4-Cl₂), preferably compounds such as fenchlorazole-ethyl, i.e. ethyl 1-(2,4-dichlorophenyl)-5-trichloromethyl-(1H)-1,2,4-triazole-3-carboxylate (II-6), and related compounds (see EP-A-0 174 562 and EP-A-0 346 620);
d) compounds of the type of 5-benzyl- or 5-phenyl-2-isoxazoline-3-carboxylic acid or of the 5,5-diphenyl-2-isoxazoline-3-carboxylic acid, such as isoxadifen (II-12), (in which W=(W4)), preferably compounds such as ethyl 5-(2,4-dichlorobenzyl)-2-isoxazoline-3-carboxylate (II-7) or ethyl 5-phenyl-2-isoxazoline-3-carboxylate (II-8) and related compounds, as described in WO-A-91/08202, or of ethyl 5,5-diphenyl-2-isoxazolinecarboxylate (II-9, isoxadifen-ethyl) or n-propyl 5,5-diphenyl-2-isoxazolinecarboxylate (II-10) or of ethyl 5-(4-fluorophenyl)-5-phenyl-2-isoxazoline-3-carboxylate (II-11), as described in WO-A-95/07897.
e) Compounds of the type of 8-quinolineoxyacetic acid, for example those of the formula (III) in which (R¹⁹)_{n′}=5-Cl, R²⁰=OR²⁴ and T=CH₂, preferably the compounds
1-methylhexyl(5-chloro-8-quinolineoxy)acetate (III-1, cloquintocet-mexyl),
1,3-dimethylbut-1-yl(5-chloro-8-quinolineoxy)acetate (III-2),
4-allyloxybutyl(5-chloro-8-quinolineoxy)acetate (III-3),
1-allyloxyprop-2-yl(5-chloro-8-quinolineoxy)acetate (III-4),
ethyl(5-chloro-8-quinolineoxy)acetate (III-5),
methyl(5-chloro-8-quinolineoxy)acetate (III-6),
allyl(5-chloro-8-quinolineoxy)acetate (III-7),
2-(2-propylideneiminoxy)-1-ethyl(5-chloro-8-quinolineoxy)acetate (III-8),
2-oxoprop-1-yl(5-chloro-8-quinolineoxy)acetate (III-9),
(5-chloro-8-quinolineoxy)acetic acid (III-10) and its salts, as described, for example, in WO-A-2002/34048,
   and related compounds as described in EP-A-0 860 750, EP-A-0 094 349 and EP-A-0 191 736 or EP-A-0 492 366.
f) Compounds of the type of (5-chloro-8-quinolineoxy)malonic acid, i.e. of the formula (III) in which (R¹⁹)_{n′}=5-Cl, R²⁰=OR²⁴, T=—CH(COO-alkyl)-, preferably the compounds diethyl(5-chloro-8-quinolineoxy)malonate (III-11), diallyl(5-chloro-8-quinolineoxy)malonate, methyl ethyl(5-chloro-8-quinolineoxy)malonate and related compounds, as described in EP-A-0 582 198.
g) Compounds of the type of dichloroacetamide, i.e. of the formula (IV), preferably:
N,N-diallyl-2,2-dichloroacetamide (dichlormid (IV-1), from U.S. Pat. No. 4,137,070),
4-dichloroacetyl-3,4-dihydro-3-methyl-2H-1,4-benzoxazine (IV-2, benoxacor, from EP 0 149 974),
N1,N2-diallyl-N-2-dichloroacetylglycinamide (DKA-24 (IV-3), from HU 2143821),
4-dichloroacetyl-1-oxa-4-azaspiro[4,5]decane (AD-67),
2,2-dichloro-N-(1,3-dioxolan-2-ylmethyl)-N-(2-propenyl)acetamide (PPG-1292),
3-dichloroacetyl-2,2,5-trimethyloxazolidine (R-29148, IV-4),
3-dichloroacetyl-2,2-dimethyl-5-phenyloxazolidine,
3-dichloroacetyl-2,2-dimethyl-5-(2-thienyl)oxazolidine,
3-dichloroacetyl-5-(2-furanyl)-2,2-dimethyloxazolidine (furilazole (IV-5), MON 13900),
1-dichloroacetylhexahydro-3,3,8a-trimethylpyrrolo[1,2-a]pyrimidin-6(2H)-one (dicyclonon, BAS 145138).
h) Compounds of the group B(b), preferably
1,8-naphthalic anhydride (b-1),
methyl diphenylmethoxyacetate (b-2),
cyanomethoxyimino(phenyl)acetonitrile (cyometrinil) (b-3),
1-(2-chlorobenzyl)-3-(1-methyl-1-phenylethyl)urea (cumyluron) (b-4),
O,O-diethyl S-2-ethylthioethyl phosphorodithioate (disulfoton) (b-5),
4-chlorophenyl methylcarbamate (mephenate) (b-6),
O,O-diethyl-O-phenyl phosphorothioate (dietholate) (b-7),
4-carboxy-3,4-dihydro-2H-1-benzopyran-4-acetic acid (CL-304415, CAS-Regno: 31541-57-8) (b-8),
1,3-dioxolan-2-ylmethoxyimino(phenyl)acetonitrile (oxabetrinil) (b-9),
4′-chloro-2,2,2-trifluoroacetophenone O-1,3-dioxolan-2-ylmethyloxime (fluxofenim) (b-10),
4,6-dichloro-2-phenylpyrimidine (fenclorim) (b-11),
benzyl 2-chloro-4-trifluoromethyl-1,3-thiazole-5-carboxylate (flurazole) (b-12),
2-dichloromethyl-2-methyl-1,3-dioxolane (MG-191) (b-13),
N-(4-methylphenyl)-N′-(1-methyl-1-phenylethyl)urea (dymron) (b-14),
(2,4-dichlorophenoxy)acetic acid (2,4-D),
(4-chlorophenoxy)acetic acid,
(R,S)-2-(4-chloro-o-tolyloxy)propionic acid (mecoprop),
4-(2,4-dichlorophenoxy)butyric acid (2,4-DB),
(4-chloro-o-tolyloxy)acetic acid (MCPA),
4-(4-chloro-o-tolyloxy)butyric acid,
4-(4-chlorophenoxy)butyric acid,
3,6-dichloro-2-methoxybenzoic acid (dicamba),
1-(ethoxycarbonyl)ethyl 3,6-dichloro-2-methoxybenzoate (lactidichlor) and their salts and esters, preferably their (C₁-C₈)-esters.

Preferred safeners are additionally compounds of the formula (V) or salts thereof in which
R³⁰ is hydrogen, (C₁-C₆)-alkyl, (C₃-C₆)-cycloalkyl, furanyl or thienyl, where each of the 4 last-mentioned radicals is unsubstituted or substituted by one or more substituents from the group consisting of halogen, (C₁-C₄)-alkoxy, halo-(C₁-C₆)-alkoxy and (C₁-C₄)-alkylthio and, in the case of cyclic radicals, also (C₁-C₄)-alkyl and (C₁-C₄)-haloalkyl,
R³¹ is hydrogen,
R³² is halogen, halo-(C₁-C₄)-alkyl, halo-(C₁-C₄)-alkoxy, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl, preferably halogen, (C₁-C₄)-haloalkyl, such as trifluoromethyl, (C₁-C₄)-alkoxy, halo-(C₁-C₄)-alkoxy, (C₁-C₄)-alkoxycarbonyl or (C₁-C₄)-alkylsulfonyl,
R³³ is hydrogen,
R³⁴ is halogen, (C₁-C₄)-alkyl, halo-(C₁-C₄)-alkyl, halo-(C₁-C₄)-alkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl, preferably halogen, (C₁-C₄)-alkyl, (C₁-C₄)-haloalkyl, such as trifluoromethyl, halo-(C₁-C₄)-alkoxy, (C₁-C₄)-alkoxy or (C₁-C₄)-alkylthio,
n is 0, 1 or 2 and
m is 1 or 2.

Particular preference is given to compounds of the formula (V) in which
R³⁰=H₃C—O—CH₂—, R³¹=R³³=H, R³⁴=2-OMe (V-1),
R³¹=H₃C—O—CH₂—, R³¹=R³³=H, R³⁴=2-OMe-5-Cl (V-2),
R³⁰=cyclopropyl, R³¹=R³³=H, R³⁴=2-OMe (V-3),
R³⁰=cyclopropyl, R³¹=R³³=H, R⁴=2-OMe-5-Cl (V-4)
R³⁰=cyclopropyl, R³¹=R³³=H, R³⁴=2-Me (V-5),
R³⁰=tert-butyl, R³¹=R³³=H, R³⁴=2-OMe (V-6).

Preference is further given to safeners of the formula (VI) in which
X³ is CH;
R³⁵ is hydrogen, (C₁-C₆)-alkyl, (C₃-C₆)-cycloalkyl, (C₂-C₆)-alkenyl, (C₅-C₆)-cycloalkenyl, phenyl or 3- to 6-membered heterocyclyl having up to 3 heteroatoms from the group consisting of nitrogen, oxygen and sulfur, where the six last-mentioned radicals are optionally substituted by one or more identical or different substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R³⁶ is hydrogen, (C₁-C₆)-alkyl, (C₂-C₆)-alkenyl, (C₂-C₆)-alkynyl, where the three last-mentioned radicals are optionally substituted by one or more identical or different substituents from the group consisting of halogen, hydroxyl, (C₁-C₄)-alkyl, (C₁-C₄)-alkoxy and (C₁-C₄)-alkylthio;
R³⁷ is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R³⁸ is hydrogen;
R³⁹ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
n is 0, 1 or 2 and
m is 1 or 2.

Preferred safeners of the formula (VII) are (S3-1), (S3-2), (S3-3), (S3-4) and (S3-5).

Preferred safeners of the formula (VII) are
1-[4-(N-2-methoxybenzoylsulfamoyl)phenyl]-3-methylurea (h-1),
1-[4-(N-2-methoxybenzoylsulfamoyl)phenyl]-3,3-dimethylurea (h-2),
1-[4-(N-4,5-dimethylbenzoylsulfamoyl)phenyl]-3-methylurea (h-3) and
1-[4-(N-naphthoylsulfamoyl)phenyl]-3,3-dimethylurea.

Preferred safeners are compounds of the formulae (IX-A1) to (IX-A4), 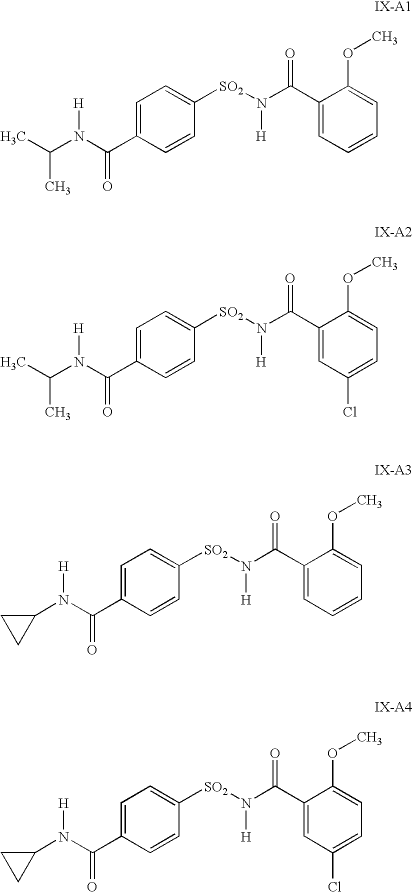
of which, in turn, compound IX-A3 is an especially preferred safener.

Particularly preferred combinations of herbicide active compounds (A) as named in Table (I) and safeners (B) are those in which the safener (B) is selected from the group of safeners consisting of the compounds of the formulae II-1 (mefenpyr-diethyl), II-9 (isoxadifen-ethyl), III-1 (chloquintocet-mexyl), b-11 (fenclorim), b-14 (dymron), IX-A3 (4-cyclopropylaminocarbonyl-N-(2-methoxybenzoyl)benzenesulfonamide N-({4-[(cyclopropylamino)carbonyl]phenyl}sulfonyl)-2-methoxybenzamide; especially preferred as safeners (B) are compounds II-1 and IX-A3).

For application in rice particular preference is given to isoxadifen-ethyl. For application in cereals particular preference is given to mefenpyr-diethyl, cloquintocet-mexyl, and 4-cyclopropylaminocarbonyl-N-(2-methoxybenzoyl)benzenesulfonamide N-({4-[(cyclopropylamino)carbonyl]phenyl}sulfonyl)-2-methoxybenzamide; in corn, particularly isoxadifen-ethyl and 4-cyclopropylaminocarbonyl-N-(2-methoxybenzoyl)benzenesulfonamide N-({4-[(cyclopropylamino)carbonyl]phenyl}sulfonyl)-2-methoxybenzamide. For application in sugar cane preference is given to isoxadifen-ethyl.

Examples of preferred combinations of herbicidal active compounds (A) and safeners (B) are:

(I-1.1)+(II-0), (I-1.1)+(I-1.1)+(II-2), (I-1.1)+(II-3), (I-1.1)+(II-4), (I-1.1)+(II-5), (I-1.1)+(II-6), (I-1.1)+(II-9), (I-1.1)+(II-12), (I-1.1)+(III-1), (I-1.1)+(III-4), (I-1.1)+(II-10), (I-1.1)+(III-11), (I-1.1)+(IV-1), (I-1.1)+(IV-2), (I-1.1)+(IV-3), (I-1.1)+(IV-4), (I-1.1)+(IV-5), (I-1.1)+(b-1), (I-1.1)+(b-2), (I-1.1)+(b-3), (I-1.1)+(b-4), (I-1.1)+(b-5), (I-1.1)+(b-6), (I-1.1)+(b-7), (I-1.1)+(b-8), (I-1.1)+(b-9), (I-1.1)+(b-10), (I-1.1)+(b-11), (I-1.1)+(b-12), (I-1.1)+(b-13), (I-1.1)+(b-14), (I-1.1)+(S3-1), (I-1.1)+(S3-2), (I-1.1)+(S3-3), (I-1.1)+(S3-4), (I-1.1)+(S3-5), (I-1.1)+(h-1), (I-1.1)+(h-2), (I-1.1)+(V-1), (I-1.1)+(V-2), (I-1.1)+(V-3), (I-1.1)+(V-4), (I-1.1)+(V-5), (I-1.1)+(V-6), (I-1.1)+(IX-A1), (I-1.1)+(IX-A2), (I-1.1)+(IX-A3), and (I-1.1)+(IX-A4).

(I-1.2)+(II-0), (I-1.2)+(II-1), (I-1.2)+(II-2), (I-1.2)+(II-3), (I-1.2)+(II-4), (I-1.2)+(II-5), (I-1.2)+(II-6), (I-1.2)+(II-9), (I-1.2)+(II-12), (I-1.2)+(III-1), (I-1.2)+(III-4), (I-1.2)+(III-10), (I-1.2)+(III-11), (I-1.2)+(IV-1), (I-1.2)+(IV-2), (I-1.2)+(IV-3), (I-1.2)+(IV-4), (I-1.2)+(IV-5), (I-1.2)+(b-1), (I-1.2)+(b-2), (I-1.2)+(b-3), (I-1.2)+(b-4), (I-1.2)+(b-5), (I-1.2)+(b-6), (I-1.2)+(b-7), (I-1.2)+(b-8), (I-1.2)+(b-9), (I-1.2)+(b-10), (I-1.2)+(b-11), (I-1.2)+(b-12), (I-1.2)+(b-13), (I-1.2)+(b-14), (I-1.2)+(S3-1), (I-1.2)+(S3-2), (I-1.2)+(S3-3), (I-1.2)+(S3-4), (I-1.2)+(S3-5), (I-1.2)+(h-1), (I-1.2)+(h-2), (I-1.2)+(V-1), (I-1.2)+(V-2), (I-1.2)+(V-3), (I-1.2)+(V-4), (I-1.2)+(V-5), (I-1.2)+(V-6), (I-1.2)+(IX-A1), (I-1.2)+(IX-A2), (I-1.2)+(IX-A3), and (I-1.2)+(IX-A4).

(I-1.3)+(II-0), (I-1.3)+(II-1), (I-1.3)+(II-2), (I-1.3)+(II-3), (I-1.3)+(II-4), (I-1.3)+(II-5)+(I-1.3)+(II-6), (I-1.3)+(II-9), (I-1.3)+(II-12), (I-1.3)+(III-1), (I-1.3)+(III-4), (I-1.3)++(III-11), (I-1.3)+(IV-1), (I-1.3)+(IV-2), (I-1.3)+(IV-3), (I-1.3)+(IV-4), (I-1.3)+(IV-5), (I-1.3)+(b-1), (I-1.3)+(b-2), (I-1.3)+(b-3), (I-1.3)+(b-4), (I-1.3)+(b-5), (I-1.3)+(b-6), (I-1.3)+(b-7), (I-1.3)+(b-8), (I-1.3)+(b-9), (I-1.3)+(b-10), (I-1.3)+(b-11), (I-1.3)+(b-12), (I-1.3)+(b-13), (I-1.3)+(b-14), (I-1.3)+(S3-1), (I-1.3)+(S3-2), (I-1.3)+(S3-3), (I-1.3)+(S3-4), (I-1.3)+(S3-5), (I-1.3)+(h-1), (I-1.3)+(h-2), (I-1.3)+(V-1), (I-1.3)+(V-2), (I-1.3)+(V-3), (I-1.3)+(V-4), (I-1.3)+(V-5), (I-1.3)+(V-6), (I-1.3)+(IX-A1), (I-1.3)+(IX-A2), (I-1.3)+(IX-A3), and (I-1.3)+(IX-A4).

(I-2.2)+(II-0), (I-2.2)+(II-1), (I-2.2)+(II-2), (I-2.2)+(II-3), (I-2.2)+(II-4), (I-2.2)+(II-5), (I-2.2)+(II-6), (I-2.2)+(II-9), (I-2.2)+(II-12), (I-2.2)+(III-1), (I-2.2)+(III-4), (I-2.2)+(III-10), (I-2.2)+(III-11), (I-2.2)+(IV-1), (I-2.2)+(IV-2), (I-2.2)+(IV-3), (I-2.2)+(IV-4), (I-2.2)+(IV-5), (I-2.2)+(b-1), (I-2.2)+(b-2), (I-2.2)+(b-3), (I-2.2)+(b-4), (I-2.2)+(b-5), (I-2.2)+(b-6), (I-2.2)+(b-7), (I-2.2)+(b-8), (I-2.2)+(b-9), (I-2.2)+(b-10), (I-2.2)+(b-11), (I-2.2)+(b-12), (I-2.2)+(b-13), (I-2.2)+(b-14), (I-2.2)+(S3-1), (I-2.2)+(S3-2), (I-2.2)+(S3-3), (I-2.2)+(S3-4), (I-2.2)+(S3-5), (I-2.2)+(h-1), (I-2.2)+(h-2), (I-2.2)+(V-1), (I-2.2)+(V-2), (I-2.2)+(V-3), (I-2.2)+(V-4), (I-2.2)+(V-5), (I-2.2)+(V-6), (I-2.2)+(IX-A1), (I-2.2)+(IX-A2), (I-2.2)+(IX-A3), and (I-2.2)+(IX-A4).

(I-2.3)+(II-0), (I-2.3)+(II-1), (I-2.3)+(II-2), (I-2.3)+(II-3), (I-2.3)+(II-4), (I-2.3)+(II-5), (I-2.3)+(II-6), (I-2.3)+(II-9), (I-2.3)+(II-12), (I-2.3)+(III-1), (I-2.3)+(III-4), (I-2.3)+(III-10), (I-2.3)+(III-11), (I-2.3)+(IV-1), (I-2.3)+(IV-2), (I-2.3)+(IV-3), (I-2.3)+(IV-4), (I-2.3)+(IV-5), (I-2.3)+(b-1), (I-2.3)+(b-2), (I-2.3)+(b-3), (I-2.3)+(b-4), (I-2.3)+(b-5), (I-2.3)+(b-6), (I-2.3)+(b-7), (I-2.3)+(b-8), (I-2.3)+(b-9), (I-2.3)+(b-10), (I-2.3)+(b-11), (I-2.3)+(b-12), (I-2.3)+(b-13), (I-2.3)+(b-14), (I-2.3)+(S3-1), (I-2.3)+(S3-2), (I-2.3)+(S3-3), (I-2.3)+(S3-4), (I-2.3)+(S3-5), (I-2.3)+(h-1), (I-2.3)+(h-2), (I-2.3)+(V-1), (I-2.3)+(V-2), (I-2.3)+(V-3), (I-2.3)+(V-4), (I-2.3)+(V-5), (I-2.3)+(V-6), (I-2.3)+(IX-A1), (I-2.3)+(IX-A2), (I-2.3)+(IX-A3), and (I-2.3)+(XI-A4).

(I-3.1)+(II-0), (I-3.1)+(II-1), (I-3.1)+(II-2), (I-3.1)+(II-3), (I-3.1)+(II-4), (I-3.1)+(II-5), (I-3.1)+(II-6), (I-3.1)+(II-9), (I-3.1)+(II-12), (I-3.1)+(III-1), (I-3.1)+(I-3.1)+1-3.1)+(III-10), (I-3.1)+(III-11), (I-3.1)+(IV-1), (I-3.1)+(IV-2), (I-3.1)+(IV-3), (I-3.1)+(IV-4), (I-3.1)+(IV-5), (I-3.1)+(b-1), (I-3.1)+(b-2), (I-3.1)+(b-3), (I-3.1)+(b-4), (I-3.1)+(b-5), (I-3.1)+(b-6), (I-3.1)+(b-7), (I-3.1)+(b-8), (I-3.1)+(b-9), (I-3.1)+(b-10), (I-3.1)+(b-11), (I-3.1)+(b-12), (I-3.1)+(b-13), (I-3.1)+(b-14), (I-3.1)+(S3-1), (I-3.1)+(S3-2), (I-3.1)+(S3-3), (I-3.1)+(S3-4), (I-3.1)+(S3-5), (I-3.1)+(h-1), (I-3.1)+(h-2), (I-3.1)+(V-1), (I-3.1)+(V-2), (I-3.1)+(V-3), (I-3.1)+(V-4), (I-3.1)+(V-5), (I-3.1)+(V-6), (I-3.1)+(IX-A1), (I-3.1)+(IX-A2), (I-3.1)+(IX-A3), and (I-3.1)+(IX-A4).

(I-3.2)+(II-0), (I-3.2)+(II-1), (I-3.2)+(II-2), (I-3.2)+(II-3), (I-3.2)+(II-4), (I-3.2)+(II-5), (I-3.2)+(II-6), (I-3.2)+(II-9), (I-3.2)+(II-12), (I-3.2)+(II-1), (I-3.2)+(III-4), (I-3.2)+(III-10), (I-3.2)+(III-11), (I-3.2)+(IV-1), (I-3.2)+(IV-2), (I-3.2)+(IV-3), (I-3.2)+(IV-4), (I-3.2)+(IV-5), (I-3.2)+(b-1), (I-3.2)+(b-2), (I-3.2)+(b-3), (I-3.2)+(b-4), (I-3.2)+(b-5), (I-3.2)+(b-6), (I-3.2)+(b-7), (I-3.2)+(b-8), (I-3.2)+(b-9), (I-3.2)+(b-10), (I-3.2)+(b-11), (I-3.2)+(b-12), (I-3.2)+(b-13), (I-3.2)+(b-14), (I-3.2)+(S3-1), (I-3.2)+(S3-2), (I-3.2)+(S3-3), (I-3.2)+(S3-4), (I-3.2)+(S3-5), (I-3.2)+(h-1), (I-3.2)+(h-2), (I-3.2)+(V-1), (I-3.2)+(V-2), (I-3.2)+(V-3), (I-3.2)+(V-4), (I-3.2)+(V-5), (I-3.2)+(V-6), (I-3.2)+(IX-A1), (I-3.2)+(IX-A2), (I-3.2)+(IX-A3), and (I-3.2)+(IX-A4).

(I-3.3)+(II-0), (I-3.3)+(II-1), (I-3.3)+(II-2), (I-3.3)+(II-3), (I-3.3)+(II-4), (I-3.3)+(II-5), (I-3.3)+(II-6), (I-3.3)+(II-9), (I-3.3)+(II-12), (I-3.3)+(III-1), (I-3.3)+(III-4), (I-3.3)+(III-10), (I-3.3)+(III-11), (I-3.3)+(IV-1), (I-3.3)+(IV-2), (I-3.3)+(IV-3), (I-3.3)+(IV-4), (I-3.3)+(IV-5), (I-3.3)+(b-1), (I-3.3)+(b-2), (I-3.3)+(b-3), (I-3.3)+(b-4), (I-3.3)+(b-5), (I-3.3)+(b-6), (I-3.3)+(b-7), (I-3.3)+(b-8), (I-3.3)+(b-9), (I-3.3)+(b-10), (I-3.3)+(b-11), (I-3.3)+(b-12), (I-3.3)+(b-13), (I-3.3)+(b-14), (I-3.3)+(S3-1), (I-3.3)+(S3-2), (I-3.3)+(S3-3), (I-3.3)+(S3-4), (I-3.3)+(S3-5), (I-3.3)+(h-1), (I-3.3)+(h-2), (I-3.3)+(V-1), (I-3.3)+(V-2), (I-3.3)+(V-3), (I-3.3)+(V-4), (I-3.3)+(V-5), (I-3.3)+(V-6), (I-3.3)+(IX-A1), (I-3.3)+(IX-A2), (I-3.3)+(IX-A3), and (I-3.3)+(IX-A4).

(I-4.1)+(II-0), (I-4.1)+(II-1), (I-4.1)+(II-2), (I-4.1)+(II-3), (I-4.1)+(II-4), (I-4.1)+(II-5), (I-4.1)+(II-6), (I-4.1)+(II-9), (I-4.1)+(II-12), (I-4.1)+(III-1), (I-4.1)+(I-4.1)+(I-4.1)+(III-10), (I-4.1)+(III-11), (I-4.1)+(IV-1), (I-4.1)+(IV-2), (I-4.1)+(IV-3), (I-4.1)+(IV-4), (I-4.1)+(IV-5), (I-4.1)+(b-1), (I-4.1)+(b-2), (I-4.1)+(b-3), (I-4.1)+(b-4), (I-4.1)+(b-5), (I-4.1)+(b-6), (I-4.1)+(b-7), (I-4.1)+(b-8), (I-4.1)+(b-9), (I-4.1)+(b-10), (I-4.1)+(b-11), (I-4.1)+(b-12), (I-4.1)+(b-13), (I-4.1)+(b-14), (I-4.1)+(S3-1), (I-4.1)+(S3-2), (I-4.1)+(S3-3), (I-4.1)+(S3-4), (I-4.1)+(S3-5), (I-4.1)+(h-1), (I-4.1)+(h-2), (I-4.1)+(V-1), (I-4.1)+(V-2), (I-4.1)+(V-3), (I-4.1)+(V-4), (I-4.1)+(V-5), (I-4.1)+(V-6), (I-4.1)+(IX-A1), (I-4.1)+(IX-A2), (I-4.1)+(IX-A3), and (I-4.1)+(IX-A4).

(I-4.2)+(II-0), (I-4.2)+(II-1), (I-4.2)+(II-2), (I-4.2)+(II-3), (I-4.2)+(II-4), (I-4.2)+(II-5), (I-4.2)+(II-6), (I-4.2)+(II-9), (I-4.2)+(II-12), (I-4.2)+(III-1), (I-4.2)+(III-4), (I-4.2)+(III-10), (I-4.2)+(III-11), (I-4.2)+(IV-1), (I-4.2)+(IV-2), (I-4.2)+(IV-3), (I-4.2)+(IV-4), (I-4.2)+(IV-5), (I-4.2)+(b-1), (I-4.2)+(b-2), (I-4.2)+(b-3), (I-4.2)+(b-4), (I-4.2)+(b-5), (I-4.2)+(b-6), (I-4.2)+(b-7), (I-4.2)+(b-8), (I-4.2)+(b-9), (I-4.2)+(b-10), (I-4.2)+(b-11), (I-4.2)+(b-12), (I-4.2)+(b-13), (I-4.2)+(b-14), (I-4.2)+(S3-1), (I-4.2)+(S3-2), (I-4.2)+(S3-3), (I-4.2)+(S3-4), (I-4.2)+(S3-5), (I-4.2)+(h-1), (I-4.2)+(h-2), (I-4.2)+(V-1), (I-4.2)+(V-2), (I-4.2)+(V-3), (I-4.2)+(V-4), (I-4.2)+(V-5), (I-4.2)+(V-6), (I-4.2)+(IX-A1), (I-4.2)+(IX-A2), (I-4.2)+(IX-A3), and (I-4.2)+(IX-A4).

(I-4.3)+(II-0), (I-4.3)+(II-1), (I-4.3)+(II-2), (I-4.3)+(II-3), (I-4.3)+(II-4), (I-4.3)+(II-5), (I-4.3)+(II-6), (I-4.3)+(II-9), (I-4.3)+(II-12), (I-4.3)+(III-1), (I-4.3)+(III-4), (I-4.3)+(III-10), (I-4.3)+(III-11), (I-4.3)+(IV-1), (I-4.3)+(IV-2), (I-4.3)+(IV-3), (I-4.3)+(IV-4), (I-4.3)+(IV-5), (I-4.3)+(b-1), (I-4.3)+(b-2), (I-4.3)+(b-3), (I-4.3)+(b-4), (I-4.3)+(b-5), (I-4.3)+(b-6), (I-4.3)+(b-7), (I-4.3)+(b-8), (I-4.3)+(b-9), (I-4.3)+(b-10), (I-4.3)+(b-11), (I-4.3)+(b-12), (I-4.3)+(b-13), (I-4.3)+(b-14), (I-4.3)+(S3-1), (I-4.3)+(S3-2), (I-4.3)+(S3-3), (I-4.3)+(S3-4), (I-4.3)+(S3-5), (I-4.3)+(h-1), (I-4.3)+(h-2), (I-4.3)+(V-1), (I-4.3)+(V-2), (I-4.3)+(V-3), (I-4.3)+(V-4), (I-4.3)+(V-5), (I-4.3)+(V-6), (I-4.3)+(IX-A1), (I-4.3)+(IX-A2), (I-4.3)+(IX-A3), and (I-4.3)+(IX-A4).

(I-5.1)+(II-0), (I-5.1)+(II-1), (I-5.1)+(II-2), (I-5.1)+(II-3), (I-5.1)+(II-4), (I-5.1)+(II-5), (I-5.1)+(II-6), (I-5.1)+(II-9), (I-5.1)+(II-12), (I-5.1)+(III-1), (I-5.1)+(III-4), (I-5.1)+(III-10), (I-5.1)+(III-11), (I-5.1)+(IV-1), (I-5.1)+(IV-2), (I-5.1)+(IV-3), (I-5.1)+(IV-4), (I-5.1)+(IV-5), (I-5.1)+(b-1), (I-5.1)+(b-2), (I-5.1)+(b-3), (I-5.1)+(b-4), (I-5.1)+(b-5), (I-5.1)+(b-6), (I-5.1)+(b-7), (I-5.1)+(b-8), (I-5.1)+(b-9), (I-5.1)+(b-10), (I-5.1)+(b-11), (I-5.1)+(b-12), (I-5.1)+(b-13), (I-5.1)+(b-14), (I-5.1)+(S3-1), (I-5.1)+(S3-2), (I-5.1)+(S3-3), (I-5.1)+(S3-4), (I-5.1)+(S3-5), (I-5.1)+(h-1), (I-5.1)+(h-2), (I-5.1)+(V-1), (I-5.1)+(V-2), (I-5.1)+(V-3), (I-5.1)+(V-4), (I-5.1)+(V-5), (I-5.1)+(V-6), (I-5.1)+(IX-A1), (I-5.1)+(IX-A2), (I-5.1)+(IX-A3), and (I-5.1)+(IX-A4).

(I-5.2)+(II-0), (I-5.2)+(II-1), (I-5.2)+(II-2), (I-5.2)+(II-3), (I-5.2)+(II-4), (I-5.2)+(II-5), (I-5.2)+(II-6), (I-5.2)+(II-9), (I-5.2)+(II-12), (I-5.2)+(III-1), (I-5.2)+(III-4), (I-5.2)+(III-10), (I-5.2)+(III-11), (I-5.2)+(IV-1), (I-5.2)+(IV-2), (I-5.2)+(IV-3), (I-5.2)+(IV-4), (I-5.2)+(IV-5), (I-5.2)+(b-1), (I-5.2)+(b-2), (I-5.2)+(b-3), (I-5.2)+(b-4), (I-5.2)+(b-5), (I-5.2)+(b-6), (I-5.2)+(b-7), (I-5.2)+(b-8), (I-5.2)+(b-9), (I-5.2)+(b-10), (I-5.2)+(b-11), (I-5.2)+(b-12), (I-5.2)+(b-13), (I-5.2)+(b-14), (I-5.2)+(S3-1), (I-5.2)+(S3-2), (I-5.2)+(S3-3), (I-5.2)+(S3-4), (I-5.2)+(S3-5), (I-5.2)+(h-1), (I-5.2)+(h-2), (I-5.2)+(V-1), (I-5.2)+(V-2), (I-5.2)+(V-3), (I-5.2)+(V-4), (I-5.2)+(V-5), (I-5.2)+(V-6), (I-5.2)+(IX-A1), (I-5.2)+(IX-A2), (I-5.2)+(IX-A3), and (I-5.2)+(IX-A4).

(I-5.3)+(II-0), (I-5.3)+(II-1), (I-5.3)+(II-2), (I-5.3)+(II-3), (I-5.3)+(II-4), (I-5.3)+(II-5), (I-5.3)+(II-6), (I-5.3)+(II-9), (I-5.3)+(II-12), (I-5.3)+(III-1), (I-5.3)+(III-4), (I-5.3)+(III-10), (I-5.3)+(III-11), (I-5.3)+(IV-1), (I-5.3)+(IV-2), (I-5.3)+(IV-3), (I-5.3)+(IV-4), (I-5.3)+(IV-5), (I-5.3)+(b-1), (I-5.3)+(b-2), (I-5.3)+(b-3), (I-5.3)+(b-4), (I-5.3)+(b-5), (I-5.3)+(b-6), (I-5.3)+(b-7), (I-5.3)+(b-8), (I-5.3)+(b-9), (I-5.3)+(b-10), (I-5.3)+(b-11), (I-5.3)+(b-12), (I-5.3)+(b-13), (I-5.3)+(b-14), (I-5.3)+(S3-1), (I-5.3)+(S3-2), (I-5.3)+(S3-3), (I-5.3)+(S3-4), (I-5.3)+(S3-5), (I-5.3)+(h-1), (I-5.3)+(h-2), (I-5.3)+(V-1), (I-5.3)+(V-2), (I-5.3)+(V-3), (I-5.3)+(V-4), (I-5.3)+(V-5), (I-5.3)+(V-6), (I-5.3)+(IX-A1), (I-5.3)+(IX-A2), (I-5.3)+(IX-A3), and (I-5.3)+(IX-A4).

(I-6.1)+(II-0), (I-6.1)+(II-1), (I-6.1)+(II-2), (I-6.1)+(II-3), (I-6.1)+(II-4), (I-6.1)+(II-5), (I-6.1)+(II-6), (I-6.1)+(II-9), (I-6.1)+(II-12), (I-6.1)+(II-1), (I-6.1)+(III-4), (I-6.1)+(III-10), (I-6.1)+(III-11), (I-6.1)+(IV-1), (I-6.1)+(IV-2), (I-6.1)+(IV-3), (I-6.1)+(IV-4), (I-6.1)+(IV-5), (I-6.1)+(b-1), (I-6.1)+(b-2), (I-6.1)+(b-3), (I-6.1)+(b-4), (I-6.1)+(b-5), (I-6.1)+(b-6), (I-6.1)+(b-7), (I-6.1)+(b-8), (I-6.1)+(b-9), (I-6.1)+(b-10), (I-6.1)+(b-11), (I-6.1)+(b-12), (I-6.1)+(b-13), (I-6.1)+(b-14), (I-6.1)+(S3-1), (I-6.1)+(S3-2), (I-6.1)+(S3-3), (I-6.1)+(S3-4), (I-6.1)+(S3-5), (I-6.1)+(h-1), (I-6.1)+(h-2), (I-6.1)+(V-1), (I-6.1)+(V-2), (I-6.1)+(V-3), (I-6.1)+(V-4), (I-6.1)+(V-5), (I-6.1)+(V-6), (I-6.1)+(IX-A1), (I-6.1)+(IX-A2), (I-6.1)+(IX-A3), and (I-6.1)+(IX-A4).

(I-6.2)+(II-0), (I-6.2)+(II-1), (I-6.2)+(II-2), (I-6.2)+(II-3), (I-6.2)+(II-4), (I-6.2)+(II-5), (I-6.2)+(II-6), (I-6.2)+(II-9), (I-6.2)+(II-12), (I-6.2)+(II-1), (I-6.2)+(III-4), (I-6.2)+(III-10), (I-6.2)+(III-11), (I-6.2)+(IV-1), (I-6.2)+(IV-2), (I-6.2)+(IV-3), (I-6.2)+(IV-4), (I-6.2)+(IV-5), (I-6.2)+(b-1), (I-6.2)+(b-2), (I-6.2)+(b-3), (I-6.2)+(b-4), (I-6.2)+(b-5), (I-6.2)+(b-6), (I-6.2)+(b-7), (I-6.2)+(b-8), (I-6.2)+(b-9), (I-6.2)+(b-10), (I-6.2)+(b-11), (I-6.2)+(b-12), (I-6.2)+(b-13), (I-6.2)+(b-14), (I-6.2)+(S3-1), (I-6.2)+(S3-2), (I-6.2)+(S3-3), (I-6.2)+(S3-4), (I-6.2)+(S3-5), (I-6.2)+(h-1), (I-6.2)+(h-2), (I-6.2)+(V-1), (I-6.2)+(V-2), (I-6.2)+(V-3), (I-6.2)+(V-4), (I-6.2)+(V-5), (I-6.2)+(V-6), (I-6.2)+(IX-A1), (I-6.2)+(IX-A2), (I-6.2)+(IX-A3), and (I-6.2)+(IX-A4).

(I-6.3)+(II-0), (I-6.3)+(II-1), (I-6.3)+(II-2), (I-6.3)+(II-3), (I-6.3)+(II-4), (I-6.3)+(II-5), (I-6.3)+(II-6), (I-6.3)+(II-9), (I-6.3)+(II-12), (I-6.3)+(III-1), (I-6.3)+(III-4), (I-6.3)+(III-10), (I-6.3)+(III-11), (I-6.3)+(IV-1), (I-6.3)+(IV-2), (I-6.3)+(IV-3), (I-6.3)+(IV-4), (I-6.3)+(IV-5), (I-6.3)+(b-1), (I-6.3)+(b-2), (I-6.3)+(b-3), (I-6.3)+(b-4), (I-6.3)+(b-5), (I-6.3)+(b-6), (I-6.3)+(b-7), (I-6.3)+(b-8), (I-6.3)+(b-9), (I-6.3)+(b-10), (I-6.3)+(b-11), (I-6.3)+(b-12), (I-6.3)+(b-13), (I-6.3)+(b-14), (I-6.3)+(S3-1), (I-6.3)+(S3-2), (I-6.3)+(S3-3), (I-6.3)+(S3-4), (I-6.3)+(S3-5), (I-6.3)+(h-1), (I-6.3)+(h-2), (I-6.3)+(V-1), (I-6.3)+(V-2), (I-6.3)+(V-3), (I-6.3)+(V-4), (I-6.3)+(V-5), (I-6.3)+(V-6), (I-6.3)+(IX-A1), (I-6.3)+(IX-A2), (I-6.3)+(IX-A3), and (I-6.3)+(IX-A4).

(I-7.1)+(II-0), (I-7.1)+(II-1), (I-7.1)+(II-2), (I-7.1)+(II-3), (I-7.1)+(II-4), (I-7.1)+(II-5), (I-7.1)+(II-6), (I-7.1)+(II-9), (I-7.1)+(II-12), (I-7.1)+(III-1), (I-7.1)+(III-4), (I-7.1)+(III-10), (I-7.1)+(III-11), (I-7.1)+(IV-1), (I-7.1)+(IV-2), (I-7.1)+(IV-3), (I-7.1)+(IV-4), (I-7.1)+(IV-5), (I-7.1)+(b-1), (I-7.1)+(b-2), (I-7.1)+(b-3), (I-7.1)+(b-4), (I-7.1)+(b-5), (I-7.1)+(b-6), (I-7.1)+(b-7), (I-7.1)+(b-8), (I-7.1)+(b-9), (I-7.1)+(b-10), (I-7.1)+(b-11), (I-7.1)+(b-12), (I-7.1)+(b-13), (I-7.1)+(b-14), (I-7.1)+(S3-1), (I-7.1)+(S3-2), (I-7.1)+(S3-3), (I-7.1)+(S3-4), (I-7.1)+(S3-5), (I-7.1)+(h-1), (I-7.1)+(h-2), (I-7.1)+(V-1), (I-7.1)+(V-2), (I-7.1)+(V-3), (I-7.1)+(V-4), (I-7.1)+(V-5), (I-7.1)+(V-6), (I-7.1)+(IX-A1), (I-7.1)+(IX-A2), (I-7.1)+(IX-A3), and (I-7.1)+(IX-A4).

(I-7.2)+(II-0), (I-7.2)+(II-1), (I-7.2)+(II-2), (I-7.2)+(II-3), (I-7.2)+(II-4), (I-7.2)+(II-5), (I-7.2)+(II-6), (I-7.2)+(II-9), (I-7.2)+(II-12), (I-7.2)+(III-1), (I-7.2)+(III-4), (I-7.2)+(III-10), (I-7.2)+(III-11), (I-7.2)+(IV-1), (I-7.2)+(IV-2), (I-7.2)+(IV-3), (I-7.2)+(IV-4), (I-7.2)+(IV-5), (I-7.2)+(b-1), (I-7.2)+(b-2), (I-7.2)+(b-3), (I-7.2)+(b-4), (I-7.2)+(b-5), (I-7.2)+(b-6), (I-7.2)+(b-7), (I-7.2)+(b-8), (I-7.2)+(b-9), (I-7.2)+(b-10), (I-7.2)+(b-11), (I-7.2)+(b-12), (I-7.2)+(b-13), (I-7.2)+(b-14), (I-7.2)+(S3-1), (I-7.2)+(S3-2), (I-7.2)+(S3-3), (I-7.2)+(S3-4), (I-7.2)+(S3-5), (I-7.2)+(h-1), (I-7.2)+(h-2), (I-7.2)+(V-1), (I-7.2)+(V-2), (I-7.2)+(V-3), (I-7.2)+(V-4), (I-7.2)+(V-5), (I-7.2)+(V-6), (I-7.2)+(IX-A1), (I-7.2)+(IX-A2), (I-7.2)+(IX-A3), and (I-7.2)+(IX-A4).

(I-7.3)+(II-0), (I-7.3)+(II-1), (I-7.3)+(II-2), (I-7.3)+(II-3), (I-7.3)+(II-4), (I-7.3)+(II-5), (I-7.3)+(II-6), (I-7.3)+(II-9), (I-7.3)+(II-12), (I-7.3)+(III-1), (I-7.3)+(III-4), (I-7.3)+(III-10), (I-7.3)+(III-11), (I-7.3)+(IV-1), (I-7.3)+(IV-2), (I-7.3)+(IV-3), (I-7.3)+(IV-4), (I-7.3)+(IV-5), (I-7.3)+(b-1), (I-7.3)+(b-2), (I-7.3)+(b-3), (I-7.3)+(b-4), (I-7.3)+(b-5), (I-7.3)+(b-6), (I-7.3)+(b-7), (I-7.3)+(b-8), (I-7.3)+(b-9), (I-7.3)+(b-10), (I-7.3)+(b-11), (I-7.3)+(b-12), (I-7.3)+(b-13), (I-7.3)+(b-14), (I-7.3)+(S3-1), (I-7.3)+(S3-2), (I-7.3)+(S3-3), (I-7.3)+(S3-4), (I-7.3)+(S3-5), (I-7.3)+(h-1), (I-7.3)+(h-2), (I-7.3)+(V-1), (I-7.3)+(V-2), (I-7.3)+(V-3), (I-7.3)+(V-4), (I-7.3)+(V-5), (I-7.3)+(V-6), (I-7.3)+(IX-A1), (I-7.3)+(IX-A2), (I-7.3)+(IX-A3), and (I-7.3)+(IX-A4).

(I-8.1)+(II-0), (I-8.1)+(II-1), (I-8.1)+(II-2), (I-8.1)+(II-3), (I-8.1)+(II-4), (I-8.1)+(II-5), (I-8.1)+(II-6), (I-8.1)+(II-9), (I-8.1)+(II-12), (I-8.1)+(III-1), (I-8.1)+(I-8.1)+1-8.1)+(III-10), (I-8.1)+(III-11), (I-8.1)+(IV-1), (I-8.1)+(IV-2), (I-8.1)+(IV-3), (I-8.1)+(IV-4), (I-8.1)+(IV-5), (I-8.1)+(b-1), (I-8.1)+(b-2), (I-8.1)+(b-3), (I-8.1)+(b-4), (I-8.1)+(b-5), (I-8.1)+(b-6), (I-8.1)+(b-7), (I-8.1)+(b-8), (I-8.1)+(b-9), (I-8.1)+(b-10), (I-8.1)+(b-11), (I-8.1)+(b-12), (I-8.1)+(b-13), (I-8.1)+(b-14), (I-8.1)+(S3-1), (I-8.1)+(S3-2), (I-8.1)+(S3-3), (I-8.1)+(S3-4), (I-8.1)+(S3-5), (I-8.1)+(h-1), (I-8.1)+(h-2), (I-8.1)+(V-1), (I-8.1)+(V-2), (I-8.1)+(V-3), (I-8.1)+(V-4), (I-8.1)+(V-5), (I-8.1)+(V-6), (I-8.1)+(IX-A1), (I-8.1)+(IX-A2), (I-8.1)+(IX-A3), and (I-8.1)+(IX-A4).

(I-8.2)+(II-0), (I-8.2)+(II-1), (I-8.2)+(II-2), (I-8.2)+(II-3), (I-8.2)+(II-4), (I-8.2)+(II-5), (I-8.2)+(II-6), (I-8.2)+(II-9), (I-8.2)+(II-12), (I-8.2)+(III-1), (I-8.2)+(III-4), (I-8.2)+(III-10), (I-8.2)+(III-11), (I-8.2)+(IV-1), (I-8.2)+(IV-2), (I-8.2)+(IV-3), (I-8.2)+(IV-4), (I-8.2)+(IV-5), (I-8.2)+(b-1), (I-8.2)+(b-2), (I-8.2)+(b-3), (I-8.2)+(b-4), (I-8.2)+(b-5), (I-8.2)+(b-6), (I-8.2)+(b-7), (I-8.2)+(b-8), (I-8.2)+(b-9), (I-8.2)+(b-10), (I-8.2)+(b-11), (I-8.2)+(b-12), (I-8.2)+(b-13), (I-8.2)+(b-14), (I-8.2)+(S3-1), (I-8.2)+(S3-2), (I-8.2)+(S3-3), (I-8.2)+(S3-4), (I-8.2)+(S3-5), (I-8.2)+(h-1), (I-8.2)+(h-2), (I-8.2)+(V-1), (I-8.2)+(V-2), (I-8.2)+(V-3), (I-8.2)+(V-4), (I-8.2)+(V-5), (I-8.2)+(V-6), (I-8.2)+(IX-A1), (I-8.2)+(IX-A2), (I-8.2)+(IX-A3), and (I-8.2)+(IX-A4).

(I-8.3)+(II-0), (I-8.3)+(II-1), (I-8.3)+(II-2), (I-8.3)+(II-3), (I-8.3)+(II-4), (I-8.3)+(II-5), (I-8.3)+(II-6), (I-8.3)+(II-9), (I-8.3)+(II-12), (I-8.3)+(III-1), (I-8.3)+(III-4), (I-8.3)+(III-10), (I-8.3)+(III-11), (I-8.3)+(IV-1), (I-8.3)+(IV-2), (I-8.3)+(IV-3), (I-8.3)+(IV-4), (I-8.3)+(IV-5), (I-8.3)+(b-1), (I-8.3)+(b-2), (I-8.3)+(b-3), (I-8.3)+(b-4), (I-8.3)+(b-5), (I-8.3)+(b-6), (I-8.3)+(b-7), (I-8.3)+(b-8), (I-8.3)+(b-9), (I-8.3)+(b-10), (I-8.3)+(b-11), (I-8.3)+(b-12), (I-8.3)+(b-13), (I-8.3)+(b-14), (I-8.3)+(S3-1), (I-8.3)+(S3-2), (I-8.3)+(S3-3), (I-8.3)+(S3-4), (I-8.3)+(S3-5), (I-8.3)+(h-1), (I-8.3)+(h-2), (I-8.3)+(V-1), (I-8.3)+(V-2), (I-8.3)+(V-3), (I-8.3)+(V-4), (I-8.3)+(V-5), (I-8.3)+(V-6), (I-8.3)+(IX-A1), (I-8.3)+(IX-A2), (I-8.3)+(IX-A3), and (I-8.3)+(IX-A4).

(I-9.1)+(II-0), (I-9.1)+(II-1), (I-9.1)+(II-2), (I-9.1)+(II-3), (I-9.1)+(II-4), (I-9.1)+(II-5), (I-9.1)+(III-9), (I-9.1)+(II-12), (I-9.1)+(III-1), (I-9.1)+(III-4), (I-9.1)+(III-10), (I-9.1)+(III-11), (I-9.1)+(IV-1), (I-9.1)+(IV-2), (I-9.1)+(IV-3), (I-9.1)+(IV-4), (I-9.1)+(IV-5), (I-9.1)+(b-1), (I-9.1)+(b-2), (I-9.1)+(b-3), (I-9.1)+(b-4), (I-9.1)+(b-5), (I-9.1)+(b-6), (I-9.1)+(b-7), (I-9.1)+(b-8), (I-9.1)+(b-9), (I-9.1)+(b-10), (I-9.1)+(b-11), (I-9.1)+(b-12), (I-9.1)+(b-13), (I-9.1)+(b-14), (I-9.1)+(S3-1), (I-9.1)+(S3-2), (I-9.1)+(S3-3), (I-9.1)+(S3-4), (I-9.1)+(S3-5), (I-9.1)+(h-1), (I-9.1)+(h-2), (I-9.1)+(V-1), (I-9.1)+(V-2), (I-9.1)+(V-3), (I-9.1)+(V-4), (I-9.1)+(V-5), (I-9.1)+(V-6), (I-9.1)+(IX-A1), (I-9.1)+(IX-A2), (I-9.1)+(IX-A3), and (I-9.1)+(IX-A4).

(I-9.2)+(II-0), (I-9.2)+(II-1), (I-9.2)+(II-2), (I-9.2)+(II-3), (I-9.2)+(II-4), (I-9.2)+(II-5), (I-9.2)+(II-6), (I-9.2)+(II-9), (I-9.2)+(II-12), (I-9.2)+(III-1), (I-9.2)+(III-4), (I-9.2)+(III-10), (I-9.2)+(III-11), (I-9.2)+(IV-1), (I-9.2)+(IV-2), (I-9.2)+(IV-3), (I-9.2)+(IV-4), (I-9.2)+(IV-5), (I-9.2)+(b-1), (I-9.2)+(b-2), (I-9.2)+(b-3), (I-9.2)+(b-4), (I-9.2)+(b-5), (I-9.2)+(b-6), (I-9.2)+(b-7), (I-9.2)+(b-8), (I-9.2)+(b-9), (I-9.2)+(b-10), (I-9.2)+(b-11), (I-9.2)+(b-12), (I-9.2)+(b-13), (I-9.2)+(b-14), (I-9.2)+(S3-1), (I-9.2)+(S3-2), (I-9.2)+(S3-3), (I-9.2)+(S3-4), (I-9.2)+(S3-5), (I-9.2)+(h-1), (I-9.2)+(h-2), (I-9.2)+(V-1), (I-9.2)+(V-2), (I-9.2)+(V-3), (I-9.2)+(V-4), (I-9.2)+(V-5), (I-9.2)+(V-6), (I-9.2)+(IX-A1), (I-9.2)+(IX-A2), (I-9.2)+(IX-A3), and (I-9.2)+(IX-A4).

(I-9.3)+(II-0), (I-9.3)+(II-1), (I-9.3)+(II-2), (I-9.3)+(II-3), (I-9.3)+(II-4), (I-9.3)+(II-5), (I-9.3)+(II-6), (I-9.3)+(II-9), (I-9.3)+(II-12), (I-9.3)+(III-1), (I-9.3)+(III-4), (I-9.3)+(III-10), (I-9.3)+(III-11), (I-9.3)+(IV-1), (I-9.3)+(IV-2), (I-9.3)+(IV-3), (I-9.3)+(IV-4), (I-9.3)+(IV-5), (I-9.3)+(b-1), (I-9.3)+(b-2), (I-9.3)+(b-3), (I-9.3)+(b-4), (I-9.3)+(b-5), (I-9.3)+(b-6), (I-9.3)+(b-7), (I-9.3)+(b-8), (I-9.3)+(b-9), (I-9.3)+(b-10), (I-9.3)+(b-11), (I-9.3)+(b-12), (I-9.3)+(b-13), (I-9.3)+(b-14), (I-9.3)+(S3-1), (I-9.3)+(S3-2), (I-9.3)+(S3-3), (I-9.3)+(S3-4), (I-9.3)+(S3-5), (I-9.3)+(h-1), (I-9.3)+(h-2), (I-9.3)+(V-1), (I-9.3)+(V-2), (I-9.3)+(V-3), (I-9.3)+(V-4), (I-9.3)+(V-5), (I-9.3)+(V-6), (I-9.3)+(IX-A1), (I-9.3)+(IX-A2), (I-9.3)+(IX-A3), and (I-9.3)+(IX-A4).

(I-10.1)+(II-0), (I-10.1)+(II-1), (I-10.1)+(II-2), (I-10.1)+(II-3), (I-10.1)+(II-4), (I-10.1)+(II-5), (I-10.1)+(II-6), (I-10.1)+(II-9), (I-10.1)+(II-12), (I-10.1)+(III-1), (I-10.1)+(III-4), (I-10.1)+(III-10), (I-10.1)+(III-11), (I-10.1)+(IV-1), (I-10.1)+(IV-2), (I-10.1)+(IV-3), (I-10.1)+(IV-4), (I-10.1)+(IV-5), (I-10.1)+(b-1), (I-10.1)+(b-2), (I-10.1)+(b-3), (I-10.1)+(b-4), (I-10.1)+(b-5), (I-10.1)+(b-6), (I-10.1)+(b-7), (I-10.1)+(b-8), (I-10.1)+(b-9), (I-10.1)+(b-10), (I-10.1)+(b-11), (I-10.1)+(b-12), (I-10.1)+(b-13), (I-10.1)+(b-14), (I-10.1)+(S3-1), (I-10.1)+(S3-2), (I-10.1)+(S3-3), (I-10.1)+(S3-4), (I-10.1)+(S3-5), (I-10.1)+(h-1), (I-10.1)+(h-2), (I-10.1)+(V-1), (I-10.1)+(V-2), (I-10.1)+(V-3), (I-10.1)+(V-4), (I-10.1)+(V-5), (I-10.1)+(V-6), (I-10.1)+(IX-A1), (I-10.1)+(IX-A2), (I-10.1)+(IX-A3), and (I-10.1)+(IX-A4).

(I-10.2)+(II-0), (I-10.2)+(II-1), (I-10.2)+(II-2), (I-10.2)+(II-3), (I-10.2)+(II-4), (I-10.2)+(II-5), (I-10.2)+(II-6), (I-10.2)+(II-9), (I-10.2)+(II-12), (I-10.2)+(III-1), (I-10.2)+(III-4), (I-10.2)+(III-10), (I-10.2)+(III-11), (I-10.2)+(IV-1), (I-10.2)+(IV-2), (I-10.2)+(IV-3), (I-10.2)+(IV-4), (I-10.2)+(IV-5), (I-10.2)+(b-1), (I-10.2)+(b-2), (I-10.2)+(b-3), (I-10.2)+(b-4), (I-10.2)+(b-5), (I-10.2)+(b-6), (I-10.2)+(b-7), (I-10.2)+(b-8), (I-10.2)+(b-9), (I-10.2)+(b-10), (I-10.2)+(b-11), (I-10.2)+(b-12), (I-10.2)+(b-13), (I-10.2)+(b-14), (I-10.2)+(S3-1), (I-10.2)+(S3-2), (I-10.2)+(S3-3), (I-10.2)+(S3-4), (I-10.2)+(S3-5), (I-10.2)+(h-1), (I-10.2)+(h-2), (I-10.2)+(V-1), (I-10.2)+(V-2), (I-10.2)+(V-3), (I-10.2)+(V-4), (I-10.2)+(V-5), (I-10.2)+(V-6), (I-10.2)+(IX-A1), (I-10.2)+(IX-A2), (I-10.2)+(IX-A3), and (I-10.2)+(IX-A4).

(I-10.3)+(II-0), (I-10.3)+(II-1), (I-10.3)+(II-2), (I-10.3)+(II-3), (I-10.3)+(II-4), (I-10.3)+(II-5), (I-10.3)+(II-6), (I-10.3)+(II-9), (I-10.3)+(II-12), (I-10.3)+(III-1), (I-10.3)+(III-4), (I-10.3)+(III-10), (I-10.3)+(III-11), (I-10.3)+(IV-1), (I-10.3)+(IV-2), (I-10.3)+(IV-3), (I-10.3)+(IV-4), (I-10.3)+(IV-5), (I-10.3)+(b-1), (I-10.3)+(b-2), (I-10.3)+(b-3), (I-10.3)+(b-4), (I-10.3)+(b-5), (I-10.3)+(b-6), (I-10.3)+(b-7), (I-10.3)+(b-8), (I-10.3)+(b-9), (I-10.3)+(b-10), (I-10.3)+(b-11), (I-10.3)+(b-12), (I-10.3)+(b-13), (I-10.3)+(b-14), (I-10.3)+(S3-1), (I-10.3)+(S3-2), (I-10.3)+(S3-3), (I-10.3)+(S3-4), (I-10.3)+(S3-5), (I-10.3)+(h-1), (I-10.3)+(h-2), (I-10.3)+(V-1), (I-10.3)+(V-2), (I-10.3)+(V-3), (I-10.3)+(V-4), (I-10.3)+(V-5), (I-10.3)+(V-6), (I-10.3)+(IX-A1), (I-10.3)+(IX-A2), (I-10.3)+(IX-A3), and (I-10.2)+(IX-A4).

(I-11.1)+(II-0), (I-11.1)+(II-1), (I-11.1)+(II-2), (I-11.1)+(II-3), (I-11.1)+(II-4), (I-11.1)+(II-5), (I-11.1)+(II-6), (I-11.1)+(II-9), (I-11.1)+(II-12), (I-11.1)+(III-1), (I-11.1)+(III-4), (I-11.1)+(II-10), (I-11.1)+(III-11), (I-11.1)+(IV-1), (I-11.1)+(IV-2), (I-11.1)+(IV-3), (I-11.1)+(IV-4), (I-11.1)+(IV-5), (I-11.1)+(b-1), (I-11.1)+(b-2), (I-11.1)+(b-3), (I-11.1)+(b-4), (I-11.1)+(b-5), (I-11.1)+(b-6), (I-11.1)+(b-7), (I-11.1)+(b-8), (I-11.1)+(b-9), (I-11.1)+(b-10), (I-11.1)+(b-11), (I-11.1)+(b-12), (I-11.1)+(b-13), (I-11.1)+(b-14), (I-11.1)+(S3-1), (I-11.1)+(S3-2), (I-11.1)+(S3-3), (I-11.1)+(S3-4), (I-11.1)+(S3-5), (I-11.1)+(h-1), (I-11.1)+(h-2), (I-11.1)+(V-1), (I-11.1)+(V-2), (I-11.1)+(V-3), (I-11.1)+(V-4), (I-11.1)+(V-5), (I-11.1)+(V-6), (I-11.1)+(IX-A1), (I-11.1)+(IX-A2), (I-11.1)+(IX-A3), and (I-11.1)+(IX-A4).

(I-11.2)+(II-0), (I-11.2)+(II-1), (I-11.2)+(II-2), (I-11.2)+(II-3), (I-11.2)+(II-4), (I-11.2)+(II-5), (I-11.2)+(II-6), (I-11.2)+(II-9), (I-11.2)+(II-12), (I-11.2)+(III-1), (I-11.2)+(III-4), (I-11.2)+(III-10), (I-11.2)+(III-11), (I-11.2)+(IV-1), (I-11.2)+(IV-2), (I-11.2)+(IV-3), (I-11.2)+(IV-4), (I-11.2)+(IV-5), (I-11.2)+(b-1), (I-11.2)+(b-2), (I-11.2)+(b-3), (I-11.2)+(b-4), (I-11.2)+(b-5), (I-11.2)+(b-6), (I-11.2)+(b-7), (I-11.2)+(b-8), (I-11.2)+(b-9), (I-11.2)+(b-10), (I-11.2)+(b-11), (I-11.2)+(b-12), (I-11.2)+(b-13), (I-11.2)+(b-14), (I-11.2)+(S3-1), (I-11.2)+(S3-2), (I-11.2)+(S3-3), (I-11.2)+(S3-4), (I-11.2)+(S3-5), (I-11.2)+(h-1), (I-11.2)+(h-2), (I-11.2)+(V-1), (I-11.2)+(V-2), (I-11.2)+(V-3), (I-11.2)+(V-4), (I-11.2)+(V-5), (I-11.2)+(V-6), (I-11.2)+(IX-A1), (I-11.2)+(IX-A2), (I-11.2)+(IX-A3), and (I-11.2)+(IX-A4).

(I-11.3)+(II-0), (I-11.3)+(II-1), (I-11.3)+(II-2), (I-11.3)+(II-3), (I-11.3)+(II-4), (I-11.3)+(II-5), (I-11.3)+(II-6), (I-11.3)+(II-9), (I-11.3)+(II-12), (I-11.3)+(III-1), (I-11.3)+(III-4), (I-11.3)+(III-10), (I-11.3)+(III-11), (I-11.3)+(IV-1), (I-11.3)+(IV-2), (I-11.3)+(IV-3), (I-11.3)+(IV-4), (I-11.3)+(IV-5), (I-11.3)+(b-1), (I-11.3)+(b-2), (I-11.3)+(b-3), (I-11.3)+(b-4), (I-11.3)+(b-5), (I-11.3)+(b-6), (I-11.3)+(b-7), (I-11.3)+(b-8), (I-11.3)+(b-9), (I-11.3)+(b-10), (I-11.3)+(b-11), (I-11.3)+(b-12), (I-11.3)+(b-13), (I-11.3)+(b-14), (I-11.3)+(S3-1), (I-11.3)+(S3-2), (I-11.3)+(S3-3), (I-11.3)+(S3-4), (I-11.3)+(S3-5), (I-11.3)+(h-1), (I-11.3)+(h-2), (I-11.3)+(V-1), (I-11.3)+(V-2), (I-11.3)+(V-3), (I-11.3)+(V-4), (I-11.3)+(V-5), (I-11.3)+(V-6), (I-11.3)+(IX-A1), (I-11.3)+(IX-A2), (I-11.3)+(IX-A3), and (I-11.3)+(IX-A4).

(I-12.1)+(II-0), (I-12.1)+(II-1), (I-12.1)+(II-2), (I-12.1)+(II-3), (I-12.1)+(II-4), (I-12.1)+(II-5), (I-12.1)+(II-6), (I-12.1)+(II-9), (I-12.1)+(II-12), (I-12.1)+(III-1), (I-12.1)+(III-4), (I-12.1)+(III-10), (I-12.1)+(III-11), (I-12.1)+(IV-1), (I-12.1)+(IV-2), (I-12.1)+(IV-3), (I-12.1)+(IV-4), (I-12.1)+(IV-5), (I-12.1)+(b-1), (I-12.1)+(b-2), (I-12.1)+(b-3), (I-12.1)+(b-4), (I-12.1)+(b-5), (I-12.1)+(b-6), (I-12.1)+(b-7), (I-12.1)+(b-8), (I-12.1)+(b-9), (I-12.1)+(b-10), (I-12.1)+(b-11), (I-12.1)+(b-12), (I-12.1)+(b-13), (I-12.1)+(b-14), (I-12.1)+(S3-1), (I-12.1)+(S3-2), (I-12.1)+(S3-3), (I-12.1)+(S3-4), (I-12.1)+(S3-5), (I-12.1)+(h-1), (I-12.1)+(h-2), (I-12.1)+(V-1), (I-12.1)+(V-2), (I-12.1)+(V-3), (I-12.1)+(V-4), (I-12.1)+(V-5), (I-12.1)+(V-6), (I-12.1)+(IX-A1), (I-12.1)+(IX-A2), (I-12.1)+(IX-A3), and (I-12.1)+(IX-A4).

(I-12.2)+(II-0), (I-12.2)+(II-1), (I-12.2)+(II-2), (I-12.2)+(II-3), (I-12.2)+(II-4), (I-12.2)+(II-5), (I-12.2)+(II-6), (I-12.2)+(II-9), (I-12.2)+(II-12), (I-12.2)+(III-1), (I-12.2)+(III-4), (I-12.2)+(III-10), (I-12.2)+(III-11), (I-12.2)+(IV-1), (I-12.2)+(IV-2), (I-12.2)+(IV-3), (I-12.2)+(IV-4), (I-12.2)+(IV-5), (I-12.2)+(b-1), (I-12.2)+(b-2), (I-12.2)+(b-3), (I-12.2)+(b-4), (I-12.2)+(b-5), (I-12.2)+(b-6), (I-12.2)+(b-7), (I-12.2)+(b-8), (I-12.2)+(b-9), (I-12.2)+(b-10), (I-12.2)+(b-11), (I-12.2)+(b-12), (I-12.2)+(b-13), (I-12.2)+(b-14), (I-12.2)+(S3-1), (I-12.2)+(S3-2), (I-12.2)+(S3-3), (I-12.2)+(S3-4), (I-12.2)+(S3-5), (I-12.2)+(h-1), (I-12.2)+(h-2), (I-12.2)+(V-1), (I-12.2)+(V-2), (I-12.2)+(V-3), (I-12.2)+(V-4), (I-12.2)+(V-5), (I-12.2)+(V-6), (I-12.2)+(IX-A1), (I-12.2)+(IX-A2), (I-12.2)+(IX-A3), and (I-12.2)+(IX-A4).

(I-12.3)+(II-0), (I-12.3)+(II-1), (I-12.3)+(II-2), (I-12.3)+(II-3), (I-12.3)+(II-4), (I-12.3)+(II-5), (I-12.3)+(II-6), (I-12.3)+(II-9), (I-12.3)+(II-12), (I-12.3)+(II-1), (I-12.3)+(III-4), (I-12.3)+(III-10), (I-12.3)+(III-11), (I-12.3)+(IV-1), (I-12.3)+(IV-2), (I-12.3)+(IV-3), (I-12.3)+(IV-4), (I-12.3)+(IV-5), (I-12.3)+(b-1), (I-12.3)+(b-2), (I-12.3)+(b-3), (I-12.3)+(b-4), (I-12.3)+(b-5), (I-12.3)+(b-6), (I-12.3)+(b-7), (I-12.3)+(b-8), (I-12.3)+(b-9), (I-12.3)+(b-10), (I-12.3)+(b-11), (I-12.3)+(b-12), (I-12.3)+(b-13), (I-12.3)+(b-14), (I-12.3)+(S3-1), (I-12.3)+(S3-2), (I-12.3)+(S3-3), (I-12.3)+(S3-4), (I-12.3)+(S3-5), (I-12.3)+(h-1), (I-12.3)+(h-2), (I-12.3)+(V-1), (I-12.3)+(V-2), (I-12.3)+(V-3), (I-12.3)+(V-4), (I-12.3)+(V-5), (I-12.3)+(V-6), (I-12.3)+(IX-A1), (I-12.3)+(IX-A2), (I-12.3)+(IX-A3), and (I-12.3)+(IX-A4).

(I-13.1)+(II-0), (I-13.1)+(II-1), (I-13.1)+(II-2), (I-13.1)+(II-3), (I-13.1)+(II-4), (I-13.1)+(II-5), (I-13.1)+(II-6), (I-13.1)+(II-9), (I-13.1)+(II-12), (I-13.1)+(III-1), (I-13.1)+(III-4), (I-13.1)+(III-10), (I-13.1)+(III-11), (I-13.1)+(IV-1), (I-13.1)+(IV-2), (I-13.1)+(IV-3), (I-13.1)+(IV-4), (I-13.1)+(IV-5), (I-13.1)+(b-1), (I-13.1)+(b-2), (I-13.1)+(b-3), (I-13.1)+(b-4), (I-13.1)+(b-5), (I-13.1)+(b-6), (I-13.1)+(b-7), (I-13.1)+(b-8), (I-13.1)+(b-9), (I-13.1)+(b-10), (I-13.1)+(b-11), (I-13.1)+(b-12), (I-13.1)+(b-13), (I-13.1)+(b-14), (I-13.1)+(S3-1), (I-13.1)+(S3-2), (I-13.1)+(S3-3), (I-13.1)+(S3-4), (I-13.1)+(S3-5), (I-13.1)+(h-1), (I-13.1)+(h-2), (I-13.1)+(V-1), (I-13.1)+(V-2), (I-13.1)+(V-3), (I-13.1)+(V-4), (I-13.1)+(V-5), (I-13.1)+(V-6), (I-13.1)+(IX-A1), (I-13.1)+(IX-A2), (I-13.1)+(IX-A3), and (I-13.1)+(IX-A4).

(I-13.2)+(II-0), (I-13.2)+(II-1), (I-13.2)+(II-2), (I-13.2)+(II-3), (I-13.2)+(II-4), (I-13.2)+(II-5), (I-13.2)+(II-6), (I-13.2)+(II-9), (I-13.2)+(II-12), (I-13.2)+(III-1), (I-13.2)+(III-4), (I-13.2)+(III-10), (I-13.2)+(III-11), (I-13.2)+(IV-1), (I-13.2)+(IV-2), (I-13.2)+(IV-3), (I-13.2)+(IV-4), (I-13.2)+(IV-5), (I-13.2)+(b-1), (I-13.2)+(b-2), (I-13.2)+(b-3), (I-13.2)+(b-4), (I-13.2)+(b-5), (I-13.2)+(b-6), (I-13.2)+(b-7), (I-13.2)+(b-8), (I-13.2)+(b-9), (I-13.2)+(b-10), (I-13.2)+(b-11), (I-13.2)+(b-12), (I-13.2)+(b-13), (I-13.2)+(b-14), (I-13.2)+(S3-1), (I-13.2)+(S3-2), (I-13.2)+(S3-3), (I-13.2)+(S3-4), (I-13.2)+(S3-5), (I-13.2)+(h-1), (I-13.2)+(h-2), (I-13.2)+(V-1), (I-13.2)+(V-2), (I-13.2)+(V-3), (I-13.2)+(V-4), (I-13.2)+(V-5), (I-13.2)+(V-6), (I-13.2)+(IX-A1), (I-13.2)+(IX-A2), (I-13.2)+(IX-A3), and (I-13.2)+(IX-A4).

(I-13.3)+(II-0), (I-13.3)+(II-1), (I-13.3)+(II-2), (I-13.3)+(II-3), (I-13.3)+(II-4), (I-13.3)+(II-5), (I-13.3)+(II-6), (I-13.3)+(II-9), (I-13.3)+(II-12), (I-13.3)+(III-1), (I-13.3)+(III-4), (I-13.3)+(III-10), (I-13.3)+(III-11), (I-13.3)+(IV-1), (I-13.3)+(IV-2), (I-13.3)+(IV-3), (I-13.3)+(IV-4), (I-13.3)+(IV-5), (I-13.3)+(b-1), (I-13.3)+(b-2), (I-13.3)+(b-3), (I-13.3)+(b-4), (I-13.3)+(b-5), (I-13.3)+(b-6), (I-13.3)+(b-7), (I-13.3)+(b-8), (I-13.3)+(b-9), (I-13.3)+(b-10), (I-13.3)+(b-11), (I-13.3)+(b-12), (I-13.3)+(b-13), (I-13.3)+(b-14), (I-13.3)+(S3-1), (I-13.3)+(S3-2), (I-13.3)+(S3-3), (I-13.3)+(S3-4), (I-13.3)+(S3-5), (I-13.3)+(h-1), (I-13.3)+(h-2), (I-13.3)+(V-1), (I-13.3)+(V-2), (I-13.3)+(V-3), (I-13.3)+(V-4), (I-13.3)+(V-5), (I-13.3)+(V-6), (I-13.3)+(IX-A1), (I-13.3)+(IX-A2), (I-13.3)+(IX-A3), and (I-13.3)+(IX-A4).

(I-14.1)+(II-0), (I-14.1)+(II-1), (I-14.1)+(II-2), (I-14.1)+(II-3), (I-14.1)+(II-4), (I-14.1)+(II-5), (I-14.1)+(II-6), (I-14.1)+(II-9), (I-14.1)+(II-12), (I-14.1)+(III-1), (I-14.1)+(III-4), (I-14.1)+(III-10), (I-14.1)+(III-11), (I-14.1)+(IV-1), (I-14.1)+(IV-2), (I-14.1)+(IV-3), (I-14.1)+(IV-4), (I-14.1)+(IV-5), (I-14.1)+(b-1), (I-14.1)+(b-2), (I-14.1)+(b-3), (I-14.1)+(b-4), (I-14.1)+(b-5), (I-14.1)+(b-6), (I-14.1)+(b-7), (I-14.1)+(b-8), (I-14.1)+(b-9), (I-14.1)+(b-10), (I-14.1)+(b-11), (I-14.1)+(b-12), (I-14.1)+(b-13), (I-14.1)+(b-14), (I-14.1)+(S3-1), (I-14.1)+(S3-2), (I-14.1)+(S3-3), (I-14.1)+(S3-4), (I-14.1)+(S3-5), (I-14.1)+(h-1), (I-14.1)+(h-2), (I-14.1)+(V-1), (I-14.1)+(V-2), (I-14.1)+(V-3), (I-14.1)+(V-4), (I-14.1)+(V-5), (I-14.1)+(V-6), (I-14.1)+(IX-A1), (I-14.1)+(IX-A2), (I-14.1)+(IX-A3), and (I-14.1)+(IX-A4).

(I-14.2)+(II-0), (I-14.2)+(II-1), (I-14.2)+(II-2), (I-14.2)+(II-3), (I-14.2)+(II-4), (I-14.2)+(II-5), (I-14.2)+(II-6), (I-14.2)+(II-9), (I-14.2)+(II-12), (I-14.2)+(III-1), (I-14.2)+(III-4), (I-14.2)+(III-10), (I-14.2)+(III-11), (I-14.2)+(IV-1), (I-14.2)+(IV-2), (I-14.2)+(IV-3), (I-14.2)+(IV-4), (I-14.2)+(IV-5), (I-14.2)+(b-1), (I-14.2)+(b-2), (I-14.2)+(b-3), (I-14.2)+(b-4), (I-14.2)+(b-5), (I-14.2)+(b-6), (I-14.2)+(b-7), (I-14.2)+(b-8), (I-14.2)+(b-9), (I-14.2)+(b-10), (I-14.2)+(b-11), (I-14.2)+(b-12), (I-14.2)+(b-13), (I-14.2)+(b-14), (I-14.2)+(S3-1), (I-14.2)+(S3-2), (I-14.2)+(S3-3), (I-14.2)+(S3-4), (I-14.2)+(S3-5), (I-14.2)+(h-1), (I-14.2)+(h-2), (I-14.2)+(V-1), (I-14.2)+(V-2), (I-14.2)+(V-3), (I-14.2)+(V-4), (I-14.2)+(V-5), (I-14.2)+(V-6), (I-14.2)+(IX-A1), (I-14.2)+(IX-A2), (I-14.2)+(IX-A3), and (I-14.2)+(IX-A4).

(I-14.3)+(II-0), (I-14.3)+(II-1), (I-14.3)+(II-2), (I-14.3)+(II-3), (I-14.3)+(II-4), (I-14.3)+(II-5), (I-14.3)+(II-6), (I-14.3)+(II-9), (I-14.3)+(II-12), (I-14.3)+(III-1), (I-14.3)+(III-4), (I-14.3)+(III-10), (I-14.3)+(III-11), (I-14.3)+(IV-1), (I-14.3)+(IV-2), (I-14.3)+(IV-3), (I-14.3)+(IV-4), (I-14.3)+(IV-5), (I-14.3)+(b-1), (I-14.3)+(b-2), (I-14.3)+(b-3), (I-14.3)+(b-4), (I-14.3)+(b-5), (I-14.3)+(b-6), (I-14.3)+(b-7), (I-14.3)+(b-8), (I-14.3)+(b-9), (I-14.3)+(b-10), (I-14.3)+(b-11), (I-14.3)+(b-12), (I-14.3)+(b-13), (I-14.3)+(b-14), (I-14.3)+(S3-1), (I-14.3)+(S3-2), (I-14.3)+(S3-3), (I-14.3)+(S3-4), (I-14.3)+(S3-5), (I-14.3)+(h-1), (I-14.3)+(h-2), (I-14.3)+(V-1), (I-14.3)+(V-2), (I-14.3)+(V-3), (I-14.3)+(V-4), (I-14.3)+(V-5), (I-14.3)+(V-6), (I-14.3)+(IX-A1), (I-14.3)+(IX-A2), (I-14.3)+(IX-A3), and (I-14.3)+(IX-A4).

(I-15.1)+(II-0), (I-15.1)+(II-1), (I-15.1)+(II-2), (I-15.1)+(II-3), (I-15.1)+(II-4), (I-15.1)+(II-5), (I-15.1)+(II-6), (I-15.1)+(II-9), (I-15.1)+(II-12), (I-15.1)+(III-1), (I-15.1)+(III-4), (I-15.1)+(III-10), (I-15.1)+(III-11), (I-15.1)+(IV-1), (I-15.1)+(IV-2), (I-15.1)+(IV-3), (I-15.1)+(IV-4), (I-15.1)+(IV-5), (I-15.1)+(b-1), (I-15.1)+(b-2), (I-15.1)+(b-3), (I-15.1)+(b-4), (I-15.1)+(b-5), (I-15.1)+(b-6), (I-15.1)+(b-7), (I-15.1)+(b-8), (I-15.1)+(b-9), (I-15.1)+(b-10), (I-15.1)+(b-11), (I-15.1)+(b-12), (I-15.1)+(b-13), (I-15.1)+(b-14), (I-15.1)+(S3-1), (I-15.1)+(S3-2), (I-15.1)+(S3-3), (I-15.1)+(S3-4), (I-15.1)+(S3-5), (I-15.1)+(h-1), (I-15.1)+(h-2), (I-15.1)+(V-1), (I-15.1)+(V-2), (I-15.1)+(V-3), (I-15.1)+(V-4), (I-15.1)+(V-5), (I-15.1)+(V-6), (I-15.1)+(IX-A1), (I-15.1)+(IX-A2), (I-15.1)+(IX-A3), and (I-15.1)+(IX-A4).

(I-15.2)+(II-0), (I-15.2)+(II-1), (I-15.2)+(II-2), (I-15.2)+(II-3), (I-15.2)+(II-4), (I-15.2)+(II-5), (I-15.2)+(II-6), (I-15.2)+(II-9), (I-15.2)+(II-12), (I-15.2)+(III-1), (I-15.2)+(III-4), (I-15.2)+(III-10), (I-15.2)+(III-11), (I-15.2)+(IV-1), (I-15.2)+(IV-2), (I-15.2)+(IV-3), (I-15.2)+(IV-4), (I-15.2)+(IV-5), (I-15.2)+(b-1), (I-15.2)+(b-2), (I-15.2)+(b-3), (I-15.2)+(b-4), (I-15.2)+(b-5), (I-15.2)+(b-6), (I-15.2)+(b-7), (I-15.2)+(b-8), (I-15.2)+(b-9), (I-15.2)+(b-10), (I-15.2)+(b-11), (I-15.2)+(b-12), (I-15.2)+(b-13), (I-15.2)+(b-14), (I-15.2)+(S3-1), (I-15.2)+(S3-2), (I-15.2)+(S3-3), (I-15.2)+(S3-4), (I-15.2)+(S3-5), (I-15.2)+(h-1), (I-15.2)+(h-2), (I-15.2)+(V-1), (I-15.2)+(V-2), (I-15.2)+(V-3), (I-15.2)+(V-4), (I-15.2)+(V-5), (I-15.2)+(V-6), (I-15.2)+(IX-A1), (I-15.2)+(IX-A2), (I-15.2)+(IX-A3), and (I-15.2)+(IX-A4).

(I-15.3)+(II-0), (I-15.3)+(II-1), (I-15.3)+(II-2), (I-15.3)+(II-3), (I-15.3)+(II-4), (I-15.3)+(II-5), (I-15.3)+(II-6), (I-15.3)+(II-9), (I-15.3)+(II-12), (I-15.3)+(III-1), (I-15.3)+(III-4), (I-15.3)+(III-10), (I-15.3)+(III-11), (I-15.3)+(IV-1), (I-15.3)+(IV-2), (I-15.3)+(IV-3), (I-15.3)+(IV-4), (I-15.3)+(IV-5), (I-15.3)+(b-1), (I-15.3)+(b-2), (I-15.3)+(b-3), (I-15.3)+(b-4), (I-15.3)+(b-5), (I-15.3)+(b-6), (I-15.3)+(b-7), (I-15.3)+(b-8), (I-15.3)+(b-9), (I-15.3)+(b-10), (I-15.3)+(b-11), (I-15.3)+(b-12), (I-15.3)+(b-13), (I-15.3)+(b-14), (I-15.3)+(S3-1), (I-15.3)+(S3-2), (I-15.3)+(S3-3), (I-15.3)+(S3-4), (I-15.3)+(S3-5), (I-15.3)+(h-1), (I-15.3)+(h-2), (I-15.3)+(V-1), (I-15.3)+(V-2), (I-15.3)+(V-3), (I-15.3)+(V-4), (I-15.3)+(V-5), (I-15.3)+(V-6), (I-15.3)+(IX-A1), (I-15.3)+(IX-A2), (I-15.3)+(IX-A3), and (I-15.3)+(IX-A4).

(I-16.1)+(II-0), (I-16.1)+(II-1), (I-16.1)+(II-2), (I-16.1)+(II-3), (I-16.1)+(II-4), (I-16.1)+(II-5), (I-16.1)+(II-6), (I-16.1)+(II-9), (I-16.1)+(II-12), (I-16.1)+(III-1), (I-16.1)+(III-4), (I-16.1)+(III-10), (I-16.1)+(III-11), (I-16.1)+(IV-1), (I-16.1)+(IV-2), (I-16.1)+(IV-3), (I-16.1)+(IV-4), (I-16.1)+(IV-5), (I-16.1)+(b-1), (I-16.1)+(b-2), (I-16.1)+(b-3), (I-16.1)+(b-4), (I-16.1)+(b-5), (I-16.1)+(b-6), (I-16.1)+(b-7), (I-16.1)+(b-8), (I-16.1)+(b-9), (I-16.1)+(b-10), (I-16.1)+(b-11), (I-16.1)+(b-12), (I-16.1)+(b-13), (I-16.1)+(b-14), (I-16.1)+(S3-1), (I-16.1)+(S3-2), (I-16.1)+(S3-3), (I-16.1)+(S3-4), (I-16.1)+(S3-5), (I-16.1)+(h-1), (I-16.1)+(h-2), (I-16.1)+(V-1), (I-16.1)+(V-2), (I-16.1)+(V-3), (I-16.1)+(V-4), (I-16.1)+(V-5), (I-16.1)+(V-6), (I-16.1)+(IX-A1), (I-16.1)+(IX-A2), (I-16.1)+(IX-A3), and (I-16.1)+(IX-A4).

(I-16.2)+(II-0), (I-16.2)+(II-1), (I-16.2)+(II-2), (I-16.2)+(II-3), (I-16.2)+(II-4), (I-16.2)+(II-5), (I-16.2)+(II-6), (I-16.2)+(II-9), (I-16.2)+(II-12), (I-16.2)+(III-1), (I-16.2)+(III-4), (I-16.2)+(III-10), (I-16.2)+(III-11), (I-16.2)+(IV-1), (I-16.2)+(IV-2), (I-16.2)+(IV-3), (I-16.2)+(IV-4), (I-16.2)+(IV-5), (I-16.2)+(b-1), (I-16.2)+(b-2), (I-16.2)+(b-3), (I-16.2)+(b-4), (I-16.2)+(b-5), (I-16.2)+(b-6), (I-16.2)+(b-7), (I-16.2)+(b-8), (I-16.2)+(b-9), (I-16.2)+(b-10), (I-16.2)+(b-11), (I-16.2)+(b-12), (I-16.2)+(b-13), (I-16.2)+(b-14), (I-16.2)+(S3-1), (I-16.2)+(S3-2), (I-16.2)+(S3-3), (I-16.2)+(S3-4), (I-16.2)+(S3-5), (I-16.2)+(h-1), (I-16.2)+(h-2), (I-16.2)+(V-1), (I-16.2)+(V-2), (I-16.2)+(V-3), (I-16.2)+(V-4), (I-16.2)+(V-5), (I-16.2)+(V-6), (I-16.2)+(IX-A1), (I-16.2)+(IX-A2), (I-16.2)+(IX-A3), and (I-16.2)+(IX-A4).

(I-16.3)+(II-0), (I-16.3)+(II-1), (I-16.3)+(II-2), (I-16.3)+(II-3), (I-16.3)+(II-4), (I-16.3)+(II-5), (I-16.3)+(II-6), (I-16.3)+(II-9), (I-16.3)+(II-12), (I-16.3)+(III-1), (I-16.3)+(III-4), (I-16.3)+(III-10), (I-16.3)+(III-11), (I-16.3)+(IV-1), (I-16.3)+(IV-2), (I-16.3)+(IV-3), (I-16.3)+(IV-4), (I-16.3)+(IV-5), (I-16.3)+(b-1), (I-16.3)+(b-2), (I-16.3)+(b-3), (I-16.3)+(b-4), (I-16.3)+(b-5), (I-16.3)+(b-6), (I-16.3)+(b-7), (I-16.3)+(b-8), (I-16.3)+(b-9), (I-16.3)+(b-10), (I-16.3)+(b-11), (I-16.3)+(b-12), (I-16.3)+(b-13), (I-16.3)+(b-14), (I-16.3)+(S3-1), (I-16.3)+(S3-2), (I-16.3)+(S3-3), (I-16.3)+(S3-4), (I-16.3)+(S3-5), (I-16.3)+(h-1), (I-16.3)+(h-2), (I-16.3)+(V-1), (I-16.3)+(V-2), (I-16.3)+(V-3), (I-16.3)+(V-4), (I-16.3)+(V-5), (I-16.3)+(V-6), (I-16.3)+(IX-A1), (I-16.3)+(IX-A2), (I-16.3)+(IX-A3), and (I-16.3)+(IX-A4).

(I-17.2)+(II-0), (I-17.2)+(II-1), (I-17.2)+(II-2), (I-17.2)+(II-3), (I-17.2)+(II-4), (I-17.2)+(II-5), (I-17.2)+(II-6), (I-17.2)+(II-9), (I-17.2)+(II-12), (I-17.2)+(III-1), (I-17.2)+(III-4), (I-17.2)+(III-10), (I-17.2)+(III-11), (I-17.2)+(IV-1), (I-17.2)+(IV-2), (I-17.2)+(IV-3), (I-17.2)+(IV-4), (I-17.2)+(IV-5), (I-17.2)+(b-1), (I-17.2)+(b-2), (I-17.2)+(b-3), (I-17.2)+(b-4), (I-17.2)+(b-5), (I-17.2)+(b-6), (I-17.2)+(b-7), (I-17.2)+(b-8), (I-17.2)+(b-9), (I-17.2)+(b-10), (I-17.2)+(b-11), (I-17.2)+(b-12), (I-17.2)+(b-13), (I-17.2)+(b-14), (I-17.2)+(S3-1), (I-17.2)+(S3-2), (I-17.2)+(S3-3), (I-17.2)+(S3-4), (I-17.2)+(S3-5), (I-17.2)+(h-1), (I-17.2)+(h-2), (I-17.2)+(V-1), (I-17.2)+(V-2), (I-17.2)+(V-3), (I-17.2)+(V-4), (I-17.2)+(V-5), (I-17.2)+(V-6), (I-17.2)+(IX-A1), (I-17.2)+(IX-A2), (I-17.2)+(IX-A3), and (I-17.2)+(IX-A4).

(I-17.3)+(II-0), (I-17.3)+(II-1), (I-17.3)+(II-2), (I-17.3)+(II-3), (I-17.3)+(II-4), (I-17.3)+(II-5), (I-17.3)+(II-6), (I-17.3)+(II-9), (I-17.3)+(II-12), (I-17.3)+(III-1), (I-17.3)+(III-4), (I-17.3)+(III-10), (I-17.3)+(III-11), (I-17.3)+(IV-1), (I-17.3)+(IV-2), (I-17.3)+(IV-3), (I-17.3)+(IV-4), (I-17.3)+(IV-5), (I-17.3)+(b-1), (I-17.3)+(b-2), (I-17.3)+(b-3), (I-17.3)+(b-4), (I-17.3)+(b-5), (I-17.3)+(b-6), (I-17.3)+(b-7), (I-17.3)+(b-8), (I-17.3)+(b-9), (I-17.3)+(b-10), (I-17.3)+(b-11), (I-17.3)+(b-12), (I-17.3)+(b-13), (I-17.3)+(b-14), (I-17.3)+(S3-1), (I-17.3)+(S3-2), (I-17.3)+(S3-3), (I-17.3)+(S3-4), (I-17.3)+(S3-5), (I-17.3)+(h-1), (I-17.3)+(h-2), (I-17.3)+(V-1), (I-17.3)+(V-2), (I-17.3)+(V-3), (I-17.3)+(V-4), (I-17.3)+(V-5), (I-17.3)+(V-6), (I-17.3)+(IX-A1), (I-17.3)+(IX-A2), (I-17.3)+(IX-A3), and (I-17.3)+(IX-A4).

(I-18.1)+(II-0), (I-18.1)+(II-1), (I-18.1)+(II-2), (I-18.1)+(II-3), (I-18.1)+(II-4), (I-18.1)+(II-5), (I-18.1)+(II-6), (I-18.1)+(II-9), (I-18.1)+(II-12), (I-18.1)+(III-1), (I-18.1)+(III-4), (I-18.1)+(III-10), (I-18.1)+(III-11), (I-18.1)+(IV-1), (I-18.1)+(IV-2), (I-18.1)+(IV-3), (I-18.1)+(IV-4), (I-18.1)+(IV-5), (I-18.1)+(b-1), (I-18.1)+(b-2), (I-18.1)+(b-3), (I-18.1)+(b-4), (I-18.1)+(b-5), (I-18.1)+(b-6), (I-18.1)+(b-7), (I-18.1)+(b-8), (I-18.1)+(b-9), (I-18.1)+(b-10), (I-18.1)+(b-11), (I-18.1)+(b-12), (I-18.1)+(b-13), (I-18.1)+(b-14), (I-18.1)+(S3-1), (I-18.1)+(S3-2), (I-18.1)+(S3-3), (I-18.1)+(S3-4), (I-18.1)+(S3-5), (I-18.1)+(h-1), (I-18.1)+(h-2), (I-18.1)+(V-1), (I-18.1)+(V-2), (I-18.1)+(V-3), (I-18.1)+(V-4), (I-18.1)+(V-5), (I-18.1)+(V-6), (I-18.1)+(IX-A1), (I-18.1)+(IX-A2), (I-18.1)+(IX-A3), and (I-18.1)+(IX-A4).

(I-18.2)+(II-0), (I-18.2)+(II-1), (I-18.2)+(II-2), (I-18.2)+(II-3), (I-18.2)+(II-4), (I-18.2)+(II-5), (I-18.2)+(II-6), (I-18.2)+(II-9), (I-18.2)+(II-12), (I-18.2)+(III-1), (I-18.2)+(III-4), (I-18.2)+(III-10), (I-18.2)+(III-11), (I-18.2)+(IV-1), (I-18.2)+(IV-2), (I-18.2)+(IV-3), (I-18.2)+(IV-4), (I-18.2)+(IV-5), (I-18.2)+(b-1), (I-18.2)+(b-2), (I-18.2)+(b-3), (I-18.2)+(b-4), (I-18.2)+(b-5), (I-18.2)+(b-6), (I-18.2)+(b-7), (I-18.2)+(b-8), (I-18.2)+(b-9), (I-18.2)+(b-10), (I-18.2)+(b-11), (I-18.2)+(b-12), (I-18.2)+(b-13), (I-18.2)+(b-14), (I-18.2)+(S3-1), (I-18.2)+(S3-2), (I-18.2)+(S3-3), (I-18.2)+(S3-4), (I-18.2)+(S3-5), (I-18.2)+(h-1), (I-18.2)+(h-2), (I-18.2)+(V-1), (I-18.2)+(V-2), (I-18.2)+(V-3), (I-18.2)+(V-4), (I-18.2)+(V-5), (I-18.2)+(V-6), (I-18.2)+(IX-A1), (I-18.2)+(IX-A2), (I-18.2)+(IX-A3), and (I-18.2)+(IX-A4).

(I-18.3)+(II-0), (I-18.3)+(II-1), (I-18.3)+(II-2), (I-18.3)+(II-3), (I-18.3)+(II-4), (I-18.3)+(II-5), (I-18.3)+(II-6), (I-18.3)+(II-9), (I-18.3)+(II-12), (I-18.3)+(III-1), (I-18.3)+(III-4), (I-18.3)+(III-10), (I-18.3)+(III-11), (I-18.3)+(IV-1), (I-18.3)+(IV-2), (I-18.3)+(IV-3), (I-18.3)+(IV-4), (I-18.3)+(IV-5), (I-18.3)+(b-1), (I-18.3)+(b-2), (I-18.3)+(b-3), (I-18.3)+(b-4), (I-18.3)+(b-5), (I-18.3)+(b-6), (I-18.3)+(b-7), (I-18.3)+(b-8), (I-18.3)+(b-9), (I-18.3)+(b-10), (I-18.3)+(b-11), (I-18.3)+(b-12), (I-18.3)+(b-13), (I-18.3)+(b-14), (I-18.3)+(S3-1), (I-18.3)+(S3-2), (I-18.3)+(S3-3), (I-18.3)+(S3-4), (I-18.3)+(S3-5), (I-18.3)+(h-1), (I-18.3)+(h-2), (I-18.3)+(V-1), (I-18.3)+(V-2), (I-18.3)+(V-3), (I-18.3)+(V-4), (I-18.3)+(V-5), (I-18.3)+(V-6), (I-18.3)+(IX-A1), (I-18.3)+(IX-A2), (I-18.3)+(IX-A3), and (I-18.3)+(IX-A4).

(I-19.1)+(II-0), (I-19.1)+(II-1), (I-19.1)+(II-2), (I-19.1)+(II-3), (I-19.1)+(II-4), (I-19.1)+(II-5), (I-19.1)+(II-6), (I-19.1)+(II-9), (I-19.1)+(II-12), (I-19.1)+(III-1), (I-19.1)+(III-4), (I-19.1)+(III-10), (I-19.1)+(III-11), (I-19.1)+(IV-1), (I-19.1)+(IV-2), (I-19.1)+(IV-3), (I-19.1)+(IV-4), (I-19.1)+(IV-5), (I-19.1)+(b-1), (I-19.1)+(b-2), (I-19.1)+(b-3), (I-19.1)+(b-4), (I-19.1)+(b-5), (I-19.1)+(b-6), (I-19.1)+(b-7), (I-19.1)+(b-8), (I-19.1)+(b-9), (I-19.1)+(b-10), (I-19.1)+(b-11), (I-19.1)+(b-12), (I-19.1)+(b-13), (I-19.1)+(b-14), (I-19.1)+(S3-1), (I-19.1)+(S3-2), (I-19.1)+(S3-3), (I-19.1)+(S3-4), (I-19.1)+(S3-5), (I-19.1)+(h-1), (I-19.1)+(h-2), (I-19.1)+(V-1), (I-19.1)+(V-2), (I-19.1)+(V-3), (I-19.1)+(V-4), (I-19.1)+(V-5), (I-19.1)+(V-6), (I-19.1)+(IX-A1), (I-19.1)+(IX-A2), (I-19.1)+(IX-A3), and (I-19.1)+(IX-A4).

(I-19.2)+(II-0), (I-19.2)+(II-1), (I-19.2)+(II-2), (I-19.2)+(II-3), (I-19.2)+(II-4), (I-19.2)+(II-5), (I-19.2)+(II-6), (I-19.2)+(II-9), (I-19.2)+(II-12), (I-19.2)+(III-1), (I-19.2)+(III-4), (I-19.2)+(III-10), (I-19.2)+(III-11), (I-19.2)+(IV-1), (I-19.2)+(IV-2), (I-19.2)+(IV-3), (I-19.2)+(IV-4), (I-19.2)+(IV-5), (I-19.2)+(b-1), (I-19.2)+(b-2), (I-19.2)+(b-3), (I-19.2)+(b-4), (I-19.2)+(b-5), (I-19.2)+(b-6), (I-19.2)+(b-7), (I-19.2)+(b-8), (I-19.2)+(b-9), (I-19.2)+(b-10), (I-19.2)+(b-11), (I-19.2)+(b-12), (I-19.2)+(b-13), (I-19.2)+(b-14), (I-19.2)+(S3-1), (I-19.2)+(S3-2), (I-19.2)+(S3-3), (I-19.2)+(S3-4), (I-19.2)+(S3-5), (I-19.2)+(h-1), (I-19.2)+(h-2), (I-19.2)+(V-1), (I-19.2)+(V-2), (I-19.2)+(V-3), (I-19.2)+(V-4), (I-19.2)+(V-5), (I-19.2)+(V-6), (I-19.2)+(IX-A1), (I-19.2)+(IX-A2), (I-19.2)+(IX-A3), and (I-19.2)+(IX-A4).

(I-19.3)+(II-0), (I-19.3)+(II-1), (I-19.3)+(II-2), (I-19.3)+(II-3), (I-19.3)+(II-4), (I-19.3)+(II-5), (I-19.3)+(II-6), (I-19.3)+(II-9), (I-19.3)+(II-12), (I-19.3)+(III-1), (I-19.3)+(III-4), (I-19.3)+(III-10), (I-19.3)+(III-11), (I-19.3)+(IV-1), (I-19.3)+(IV-2), (I-19.3)+(IV-3), (I-19.3)+(IV-4), (I-19.3)+(IV-5), (I-19.3)+(b-1), (I-19.3)+(b-2), (I-19.3)+(b-3), (I-19.3)+(b-4), (I-19.3)+(b-5), (I-19.3)+(b-6), (I-19.3)+(b-7), (I-19.3)+(b-8), (I-19.3)+(b-9), (I-19.3)+(b-10), (I-19.3)+(b-11), (I-19.3)+(b-12), (I-19.3)+(b-13), (I-19.3)+(b-14), (I-19.3)+(S3-1), (I-19.3)+(S3-2), (I-19.3)+(S3-3), (I-19.3)+(S3-4), (I-19.3)+(S3-5), (I-19.3)+(h-1), (I-19.3)+(h-2), (I-19.3)+(V-1), (I-19.3)+(V-2), (I-19.3)+(V-3), (I-19.3)+(V-4), (I-19.3)+(V-5), (I-19.3)+(V-6), (I-19.3)+(IX-A1), (I-19.3)+(IX-A2), (I-19.3)+(IX-A3), and (I-19.3)+(IX-A4).

(I-20.1)+(II-0), (I-20.1)+(II-1), (I-20.1)+(II-2), (I-20.1)+(II-3), (I-20.1)+(II-4), (I-20.1)+(II-5), (I-20.1)+(II-6), (I-20.1)+(II-9), (I-20.1)+(II-12), (I-20.1)+(III-1), (I-20.1)+(III-4), (I-20.1)+(III-10), (I-20.1)+(III-11), (I-20.1)+(IV-1), (I-20.1)+(IV-2), (I-20.1)+(IV-3), (I-20.1)+(IV-4), (I-20.1)+(IV-5), (I-20.1)+(b-1), (I-20.1)+(b-2), (I-20.1)+(b-3), (I-20.1)+(b-4), (I-20.1)+(b-5), (I-20.1)+(b-6), (I-20.1)+(b-7), (I-20.1)+(b-8), (I-20.1)+(b-9), (I-20.1)+(b-10), (I-20.1)+(b-11), (I-20.1)+(b-12), (I-20.1)+(b-13), (I-20.1)+(b-14), (I-20.1)+(S3-1), (I-20.1)+(S3-2), (I-20.1)+(S3-3), (I-20.1)+(S3-4), (I-20.1)+(S3-5), (I-20.1)+(h-1), (I-20.1)+(h-2), (I-20.1)+(V-1), (I-20.1)+(V-2), (I-20.1)+(V-3), (I-20.1)+(V-4), (I-20.1)+(V-5), (I-20.1)+(V-6), (I-20.1)+(IX-A1), (I-20.1)+(IX-A2), (I-20.1)+(IX-A3), and (I-20.1)+(IX-A4).

(I-20.2)+(II-0), (I-20.2)+(II-1), (I-20.2)+(II-2), (I-20.2)+(II-3), (I-20.2)+(II-4), (I-20.2)+(II-5), (I-20.2)+(II-6), (I-20.2)+(II-9), (I-20.2)+(II-12), (I-20.2)+(II-1), (I-20.2)+(III-4), (I-20.2)+(III-10), (I-20.2)+(III-11), (I-20.2)+(IV-1), (I-20.2)+(IV-2), (I-20.2)+(IV-3), (I-20.2)+(IV-4), (I-20.2)+(IV-5), (I-20.2)+(b-1), (I-20.2)+(b-2), (I-20.2)+(b-3), (I-20.2)+(b-4), (I-20.2)+(b-5), (I-20.2)+(b-6), (I-20.2)+(b-7), (I-20.2)+(b-8), (I-20.2)+(b-9), (I-20.2)+(b-10), (I-20.2)+(b-11), (I-20.2)+(b-12), (I-20.2)+(b-13), (I-20.2)+(b-14), (I-20.2)+(S3-1), (I-20.2)+(S3-2), (I-20.2)+(S3-3), (I-20.2)+(S3-4), (I-20.2)+(S3-5), (I-20.2)+(h-1), (I-20.2)+(h-2), (I-20.2)+(V-1), (I-20.2)+(V-2), (I-20.2)+(V-3), (I-20.2)+(V-4), (I-20.2)+(V-5), (I-20.2)+(V-6), (I-20.2)+(IX-A1), (I-20.2)+(IX-A2), (I-20.2)+(IX-A3), and (1-20.2+(IX-A4).

(I-20.3)+(II-0), (I-20.3)+(II-1), (I-20.3)+(II-2), (I-20.3)+(II-3), (I-20.3)+(II-4), (I-20.3)+(II-5), (I-20.3)+(II-6), (I-20.3)+(II-9), (I-20.3)+(II-12), (I-20.3)+(III-1), (I-20.3)+(III-4), (I-20.3)+(III-10), (I-20.3)+(III-11), (I-20.3)+(IV-1), (I-20.3)+(IV-2), (I-20.3)+(IV-3), (I-20.3)+(IV-4), (I-20.3)+(IV-5), (I-20.3)+(b-1), (I-20.3)+(b-2), (I-20.3)+(b-3), (I-20.3)+(b-4), (I-20.3)+(b-5), (I-20.3)+(b-6), (I-20.3)+(b-7), (I-20.3)+(b-8), (I-20.3)+(b-9), (I-20.3)+(b-10), (I-20.3)+(b-11), (I-20.3)+(b-12), (I-20.3)+(b-13), (I-20.3)+(b-14), (I-20.3)+(S3-1), (I-20.3)+(S3-2), (I-20.3)+(S3-3), (I-20.3)+(S3-4), (I-20.3)+(S3-5), (I-20.3)+(h-1), (I-20.3)+(h-2), (I-20.3)+(V-1), (I-20.3)+(V-2), (I-20.3)+(V-3), (I-20.3)+(V-4), (I-20.3)+(V-5), (I-20.3)+(V-6), (I-20.3)+(IX-A1), (I-20.3)+(IX-A2), (I-20.3)+(IX-A3), and (I-20.3)+(IX-A4).

(I-21.1)+(II-0), (I-21.1)+(II-1), (I-21.1)+(II-2), (I-21.1)+(II-3), (I-21.1)+(II-4), (I-21.1)+(II-5), (I-21.1)+(II-6), (I-21.1)+(II-9), (I-21.1)+(II-12), (I-21.1)+(III-1), (I-21.1)+(III-4), (I-21.1)+(III-10), (I-21.1)+(III-11), (I-21.1)+(IV-1), (I-21.1)+(IV-2), (I-21.1)+(IV-3), (I-21.1)+(IV-4), (I-21.1)+(IV-5), (I-21.1)+(b-1), (I-21.1)+(b-2), (I-21.1)+(b-3), (I-21.1)+(b-4), (I-21.1)+(b-5), (I-21.1)+(b-6), (I-21.1)+(b-7), (I-21.1)+(b-8), (I-21.1)+(b-9), (I-21.1)+(b-10), (I-21.1)+(b-11), (I-21.1)+(b-12), (I-21.1)+(b-13), (I-21.1)+(b-14), (I-21.1)+(S3-1), (I-21.1)+(S3-2), (I-21.1)+(S3-3), (I-21.1)+(S3-4), (I-21.1)+(S3-5), (I-21.1)+(h-1), (I-21.1)+(h-2), (I-21.1)+(V-1), (I-21.1)+(V-2), (I-21.1)+(V-3), (I-21.1)+(V-4), (I-21.1)+(V-5), (I-21.1)+(V-6), (I-21.1)+(IX-A1), (I-21.1)+(IX-A2), (I-21.1)+(IX-A3), and (I-21.1)+(IX-A4).

(I-21.2)+(II-0), (I-21.2)+(II-1), (I-21.2)+(II-2), (I-21.2)+(II-3), (I-21.2)+(II-4), (I-21.2)+(II-5), (I-21.2)+(II-6), (I-21.2)+(II-9), (I-21.2)+(II-12), (I-21.2)+(III-1), (I-21.2)+(III-4), (I-21.2)+(III-10), (I-21.2)+(III-11), (I-21.2)+(IV-1), (I-21.2)+(IV-2), (I-21.2)+(IV-3), (I-21.2)+(IV-4), (I-21.2)+(IV-5), (I-21.2)+(b-1), (I-21.2)+(b-2), (I-21.2)+(b-3), (I-21.2)+(b-4), (I-21.2)+(b-5), (I-21.2)+(b-6), (I-21.2)+(b-7), (I-21.2)+(b-8), (I-21.2)+(b-9), (I-21.2)+(b-10), (I-21.2)+(b-11), (I-21.2)+(b-12), (I-21.2)+(b-13), (I-21.2)+(b-14), (I-21.2)+(S3-1), (I-21.2)+(S3-2), (I-21.2)+(S3-3), (I-21.2)+(S3-4), (I-21.2)+(S3-5), (I-21.2)+(h-1), (I-21.2)+(h-2), (I-21.2)+(V-1), (I-21.2)+(V-2), (I-21.2)+(V-3), (I-21.2)+(V-4), (I-21.2)+(V-5), (I-21.2)+(V-6), (I-21.2)+(IX-A1), (I-21.2)+(IX-A2), (I-21.2)+(IX-A3), and (I-21.2)+(IX-A4).

(I-21.3)+(II-0), (I-21.3)+(II-1), (I-21.3)+(II-2), (I-21.3)+(II-3), (I-21.3)+(II-4), (I-21.3)+(II-5), (I-21.3)+(II-6), (I-21.3)+(II-9), (I-21.3)+(II-12), (I-21.3)+(III-1), (I-21.3)+(III-4), (I-21.3)+(III-10), (I-21.3)+(III-11), (I-21.3)+(IV-1), (I-21.3)+(IV-2), (I-21.3)+(IV-3), (I-21.3)+(IV-4), (I-21.3)+(IV-5), (I-21.3)+(b-1), (I-21.3)+(b-2), (I-21.3)+(b-3), (I-21.3)+(b-4), (I-21.3)+(b-5), (I-21.3)+(b-6), (I-21.3)+(b-7), (I-21.3)+(b-8), (I-21.3)+(b-9), (I-21.3)+(b-10), (I-21.3)+(b-11), (I-21.3)+(b-12), (I-21.3)+(b-13), (I-21.3)+(b-14), (I-21.3)+(S3-1), (I-21.3)+(S3-2), (I-21.3)+(S3-3), (I-21.3)+(S3-4), (I-21.3)+(S3-5), (I-21.3)+(h-1), (I-21.3)+(h-2), (I-21.3)+(V-1), (I-21.3)+(V-2), (I-21.3)+(V-3), (I-21.3)+(V-4), (I-21.3)+(V-5), (I-21.3)+(V-6), (I-21.3)+(IX-A1), (I-21.3)+(IX-A2), (I-21.3)+(IX-A3), and (I-21.3)+(IX-A4).

(I-22.1)+(II-0), (I-22.1)+(II-1), (I-22.1)+(II-2), (I-22.1)+(II-3), (I-22.1)+(II-4), (I-22.1)+(II-5), (I-22.1)+(II-6), (I-22.1)+(II-9), (I-22.1)+(II-12), (I-22.1)+(III-1), (I-22.1)+(III-4), (I-22.1)+(III-10), (I-22.1)+(III-11), (I-22.1)+(IV-1), (I-22.1)+(IV-2), (I-22.1)+(IV-3), (I-22.1)+(IV-4), (I-22.1)+(IV-5), (I-22.1)+(b-1), (I-22.1)+(b-2), (I-22.1)+(b-3), (I-22.1)+(b-4), (I-22.1)+(b-5), (I-22.1)+(b-6), (I-22.1)+(b-7), (I-22.1)+(b-8), (I-22.1)+(b-9), (I-22.1)+(b-10), (I-22.1)+(b-11), (I-22.1)+(b-12), (I-22.1)+(b-13), (I-22.1)+(b-14), (I-22.1)+(S3-1), (I-22.1)+(S3-2), (I-22.1)+(S3-3), (I-22.1)+(S3-4), (I-22.1)+(S3-5), (I-22.1)+(h-1), (I-22.1)+(h-2), (I-22.1)+(V-1), (I-22.1)+(V-2), (I-22.1)+(V-3), (I-22.1)+(V-4), (I-22.1)+(V-5), (I-22.1)+(V-6), (I-22.1)+(IX-A1), (I-22.1)+(IX-A2), (I-22.1)+(IX-A3), and (I-22.1)+(IX-A4).

(I-22.2)+(II-0), (I-22.2)+(II-1), (I-22.2)+(II-2), (I-22.2)+(II-3), (I-22.2)+(II-4), (I-22.2)+(II-5), (I-22.2)+(II-6), (I-22.2)+(II-9), (I-22.2)+(II-12), (I-22.2)+(III-1), (I-22.2)+(III-4), (I-22.2)+(III-10), (I-22.2)+(III-11), (I-22.2)+(IV-1), (I-22.2)+(IV-2), (I-22.2)+(IV-3), (I-22.2)+(IV-4), (I-22.2)+(IV-5), (I-22.2)+(b-1), (I-22.2)+(b-2), (I-22.2)+(b-3), (I-22.2)+(b-4), (I-22.2)+(b-5), (I-22.2)+(b-6), (I-22.2)+(b-7), (I-22.2)+(b-8), (I-22.2)+(b-9), (I-22.2)+(b-10), (I-22.2)+(b-11), (I-22.2)+(b-12), (I-22.2)+(b-13), (I-22.2)+(b-14), (I-22.2)+(S3-1), (I-22.2)+(S3-2), (I-22.2)+(S3-3), (I-22.2)+(S3-4), (I-22.2)+(S3-5), (I-22.2)+(h-1), (I-22.2)+(h-2), (I-22.2)+(V-1), (I-22.2)+(V-2), (I-22.2)+(V-3), (I-22.2)+(V-4), (I-22.2)+(V-5), (I-22.2)+(V-6), (I-22.2)+(IX-A1), (I-22.2)+(IX-A2), (I-22.2)+(IX-A3), and (I-22.2)+(IX-A4).

(I-22.3)+(II-0), (I-22.3)+(II-1), (I-22.3)+(II-2), (I-22.3)+(II-3), (I-22.3)+(II-4), (I-22.3)+(II-5), (I-22.3)+(II-6), (I-22.3)+(II-9), (I-22.3)+(II-12), (I-22.3)+(II-1), (I-22.3)+(III-4), (I-22.3)+(III-10), (I-22.3)+(III-11), (I-22.3)+(IV-1), (I-22.3)+(IV-2), (I-22.3)+(IV-3), (I-22.3)+(IV-4), (I-22.3)+(IV-5), (I-22.3)+(b-1), (I-22.3)+(b-2), (I-22.3)+(b-3), (I-22.3)+(b-4), (I-22.3)+(b-5), (I-22.3)+(b-6), (I-22.3)+(b-7), (I-22.3)+(b-8), (I-22.3)+(b-9), (I-22.3)+(b-10), (I-22.3)+(b-11), (I-22.3)+(b-12), (I-22.3)+(b-13), (I-22.3)+(b-14), (I-22.3)+(S3-1), (I-22.3)+(S3-2), (I-22.3)+(S3-3), (I-22.3)+(S3-4), (I-22.3)+(S3-5), (I-22.3)+(h-1), (I-22.3)+(h-2), (I-22.3)+(V-1), (I-22.3)+(V-2), (I-22.3)+(V-3), (I-22.3)+(V-4), (I-22.3)+(V-5), (I-22.3)+(V-6), (I-22.3)+(IX-A1), (I-22.3)+(IX-A2), (I-22.3)+(IX-A3), and (I-22.3)+(IX-A4).

(I-23.1)+(II-0), (I-23.1)+(II-1), (I-23.1)+(II-2), (I-23.1)+(II-3), (I-23.1)+(II-4), (I-23.1)+(II-5), (I-23.1)+(II-6), (I-23.1)+(II-9), (I-23.1)+(II-12), (I-23.1)+(III-1), (I-23.1)+(III-4), (I-23.1)+(III-10), (I-23.1)+(III-11), (I-23.1)+(IV-1), (I-23.1)+(IV-2), (I-23.1)+(IV-3), (I-23.1)+(IV-4), (I-23.1)+(IV-5), (I-23.1)+(b-1), (I-23.1)+(b-2), (I-23.1)+(b-3), (I-23.1)+(b-4), (I-23.1)+(b-5), (I-23.1)+(b-6), (I-23.1)+(b-7), (I-23.1)+(b-8), (I-23.1)+(b-9), (I-23.1)+(b-10), (I-23.1)+(b-11), (I-23.1)+(b-12), (I-23.1)+(b-13), (I-23.1)+(b-14), (I-23.1)+(S3-1), (I-23.1)+(S3-2), (I-23.1)+(S3-3), (I-23.1)+(S3-4), (I-23.1)+(S3-5), (I-23.1)+(h-1), (I-23.1)+(h-2), (I-23.1)+(V-1), (I-23.1)+(V-2), (I-23.1)+(V-3), (I-23.1)+(V-4), (I-23.1)+(V-5), (I-23.1)+(V-6), (I-23.1)+(IX-A1), (I-23.1)+(IX-A2), (I-23.1)+(IX-A3), and (I-23.1)+(IX-A4).

(I-23.2)+(II-0), (I-23.2)+(II-1), (I-23.2)+(II-2), (I-23.2)+(II-3), (I-23.2)+(II-4), (I-23.2)+(II-5), (I-23.2)+(II-6), (I-23.2)+(II-9), (I-23.2)+(II-12), (I-23.2)+(III-1), (I-23.2)+(III-4), (I-23.2)+(III-10), (I-23.2)+(III-11), (I-23.2)+(IV-1), (I-23.2)+(IV-2), (I-23.2)+(IV-3), (I-23.2)+(IV-4), (I-23.2)+(IV-5), (I-23.2)+(b-1), (I-23.2)+(b-2), (I-23.2)+(b-3), (I-23.2)+(b-4), (I-23.2)+(b-5), (I-23.2)+(b-6), (I-23.2)+(b-7), (I-23.2)+(b-8), (I-23.2)+(b-9), (I-23.2)+(b-10), (I-23.2)+(b-11), (I-23.2)+(b-12), (I-23.2)+(b-13), (I-23.2)+(b-14), (I-23.2)+(S3-1), (I-23.2)+(S3-2), (I-23.2)+(S3-3), (I-23.2)+(S3-4), (I-23.2)+(S3-5), (I-23.2)+(h-1), (I-23.2)+(h-2), (I-23.2)+(V-1), (I-23.2)+(V-2), (I-23.2)+(V-3), (I-23.2)+(V-4), (I-23.2)+(V-5), (I-23.2)+(V-6), (I-23.2)+(IX-A1), (I-23.2)+(IX-A2), (I-23.2)+(IX-A3), and (I-23.2)+(IX-A4).

(I-23.3)+(II-0), (I-23.3)+(II-1), (I-23.3)+(II-2), (I-23.3)+(II-3), (I-23.3)+(II-4), (I-23.3)+(II-5), (I-23.3)+(II-6), (I-23.3)+(II-9), (I-23.3)+(II-12), (I-23.3)+(III-1), (I-23.3)+(III-4), (I-23.3)+(III-10), (I-23.3)+(III-11), (I-23.3)+(IV-1), (I-23.3)+(IV-2), (I-23.3)+(IV-3), (I-23.3)+(IV-4), (I-23.3)+(IV-5), (I-23.3)+(b-1), (I-23.3)+(b-2), (I-23.3)+(b-3), (I-23.3)+(b-4), (I-23.3)+(b-5), (I-23.3)+(b-6), (I-23.3)+(b-7), (I-23.3)+(b-8), (I-23.3)+(b-9), (I-23.3)+(b-10), (I-23.3)+(b-11), (I-23.3)+(b-12), (I-23.3)+(b-13), (I-23.3)+(b-14), (I-23.3)+(S3-1), (I-23.3)+(S3-2), (I-23.3)+(S3-3), (I-23.3)+(S3-4), (I-23.3)+(S3-5), (I-23.3)+(h-1), (I-23.3)+(h-2), (I-23.3)+(V-1), (I-23.3)+(V-2), (I-23.3)+(V-3), (I-23.3)+(V-4), (I-23.3)+(V-5), (I-23.3)+(V-6), (I-23.3)+(IX-A1), (I-23.3)+(IX-A2), (I-23.3)+(IX-A3), and (I-23.3)+(IX-A4).

(I-24.1)+(II-0), (I-24.1)+(II-1), (I-24.1)+(II-2), (I-24.1)+(II-3), (I-24.1)+(II-4), (I-24.1)+(II-5), (I-24.1)+(II-6), (I-24.1)+(II-9), (I-24.1)+(II-12), (I-24.1)+(III-1), (I-24.1)+(III-4), (I-24.1)+(III-10), (I-24.1)+(III-11), (I-24.1)+(IV-1), (I-24.1)+(IV-2), (I-24.1)+(IV-3), (I-24.1)+(IV-4), (I-24.1)+(IV-5), (I-24.1)+(b-1), (I-24.1)+(b-2), (I-24.1)+(b-3), (I-24.1)+(b-4), (I-24.1)+(b-5), (I-24.1)+(b-6), (I-24.1)+(b-7), (I-24.1)+(b-8), (I-24.1)+(b-9), (I-24.1)+(b-10), (I-24.1)+(b-11), (I-24.1)+(b-12), (I-24.1)+(b-13), (I-24.1)+(b-14), (I-24.1)+(S3-1), (I-24.1)+(S3-2), (I-24.1)+(S3-3), (I-24.1)+(S3-4), (I-24.1)+(S3-5), (I-24.1)+(h-1), (I-24.1)+(h-2), (I-24.1)+(V-1), (I-24.1)+(V-2), (I-24.1)+(V-3), (I-24.1)+(V-4), (I-24.1)+(V-5), (I-24.1)+(V-6), (I-24.1)+(IX-A1), (I-24.1)+(IX-A2), (I-24.1)+(IX-A3), and (I-24.1)+(IX-A4).

(I-24.2)+(II-0), (I-24.2)+(II-1), (I-24.2)+(II-2), (I-24.2)+(II-3), (I-24.2)+(II-4), (I-24.2)+(II-5), (I-24.2)+(II-6), (I-24.2)+(II-9), (I-24.2)+(II-12), (I-24.2)+(II-1), (I-24.2)+(III-4), (I-24.2)+(III-10), (I-24.2)+(III-11), (I-24.2)+(IV-1), (I-24.2)+(IV-2), (I-24.2)+(IV-3), (I-24.2)+(IV-4), (I-24.2)+(IV-5), (I-24.2)+(b-1), (I-24.2)+(b-2), (I-24.2)+(b-3), (I-24.2)+(b-4), (I-24.2)+(b-5), (I-24.2)+(b-6), (I-24.2)+(b-7), (I-24.2)+(b-8), (I-24.2)+(b-9), (I-24.2)+(b-10), (I-24.2)+(b-11), (I-24.2)+(b-12), (I-24.2)+(b-13), (I-24.2)+(b-14), (I-24.2)+(S3-1), (I-24.2)+(S3-2), (I-24.2)+(S3-3), (I-24.2)+(S3-4), (I-24.2)+(S3-5), (I-24.2)+(h-1), (I-24.2)+(h-2), (I-24.2)+(V-1), (I-24.2)+(V-2), (I-24.2)+(V-3), (I-24.2)+(V-4), (I-24.2)+(V-5), (I-24.2)+(V-6), (I-24.2)+(IX-A1), (I-24.2)+(IX-A2), (I-24.2)+(IX-A3), and (I-24.2)+(IX-A4).

(I-24.3)+(II-0), (I-24.3)+(II-1), (I-24.3)+(II-2), (I-24.3)+(II-3), (I-24.3)+(II-4), (I-24.3)+(II-5), (I-24.3)+(II-6), (I-24.3)+(II-9), (I-24.3)+(II-12), (I-24.3)+(II-1), (I-24.3)+(III-4), (I-24.3)+(III-10), (I-24.3)+(III-11), (I-24.3)+(IV-1), (I-24.3)+(IV-2), (I-24.3)+(IV-3), (I-24.3)+(IV-4), (I-24.3)+(IV-5), (I-24.3)+(b-1), (I-24.3)+(b-2), (I-24.3)+(b-3), (I-24.3)+(b-4), (I-24.3)+(b-5), (I-24.3)+(b-6), (I-24.3)+(b-7), (I-24.3)+(b-8), (I-24.3)+(b-9), (I-24.3)+(b-10), (I-24.3)+(b-11), (I-24.3)+(b-12), (I-24.3)+(b-13), (I-24.3)+(b-14), (I-24.3)+(S3-1), (I-24.3)+(S3-2), (I-24.3)+(S3-3), (I-24.3)+(S3-4), (I-24.3)+(S3-5), (I-24.3)+(h-1), (I-24.3)+(h-2), (I-24.3)+(V-1), (I-24.3)+(V-2), (I-24.3)+(V-3), (I-24.3)+(V-4), (I-24.3)+(V-5), (I-24.3)+(V-6), (I-24.3)+(IX-A1), (I-24.3)+(IX-A2), (I-24.3)+(IX-A3), and (I-24.3)+(IX-A4).

(I-25.1)+(II-0), (I-25.1)+(II-1), (I-25.1)+(II-2), (I-25.1)+(II-3), (I-25.1)+(II-4), (I-25.1)+(II-5), (I-25.1)+(II-6), (I-25.1)+(II-9), (I-25.1)+(II-12), (I-25.1)+(III-1), (I-25.1)+(III-4), (I-25.1)+(III-10), (I-25.1)+(III-11), (I-25.1)+(IV-1), (I-25.1)+(IV-2), (I-25.1)+(IV-3), (I-25.1)+(IV-4), (I-25.1)+(IV-5), (I-25.1)+(b-1), (I-25.1)+(b-2), (I-25.1)+(b-3), (I-25.1)+(b-4), (I-25.1)+(b-5), (I-25.1)+(b-6), (I-25.1)+(b-7), (I-25.1)+(b-8), (I-25.1)+(b-9), (I-25.1)+(b-10), (I-25.1)+(b-11), (I-25.1)+(b-12), (I-25.1)+(b-13), (I-25.1)+(b-14), (I-25.1)+(S3-1), (I-25.1)+(S3-2), (I-25.1)+(S3-3), (I-25.1)+(S3-4), (I-25.1)+(S3-5), (I-25.1)+(h-1), (I-25.1)+(h-2), (I-25.1)+(V-1), (I-25.1)+(V-2), (I-25.1)+(V-3), (I-25.1)+(V-4), (I-25.1)+(V-5), (I-25.1)+(V-6), (I-25.1)+(IX-A1), (I-25.1)+(IX-A2), (I-25.1)+(IX-A3), and (I-25.1)+(IX-A4).

(I-25.2)+(II-0), (I-25.2)+(II-1), (I-25.2)+(II-2), (I-25.2)+(II-3), (I-25.2)+(II-4), (I-25.2)+(II-5), (I-25.2)+(II-6), (I-25.2)+(II-9), (I-25.2)+(II-12), (I-25.2)+(II-1), (I-25.2)+(III-4), (I-25.2)+(III-10), (I-25.2)+(III-11), (I-25.2)+(IV-1), (I-25.2)+(IV-2), (I-25.2)+(IV-3), (I-25.2)+(IV-4), (I-25.2)+(IV-5), (I-25.2)+(b-1), (I-25.2)+(b-2), (I-25.2)+(b-3), (I-25.2)+(b-4), (I-25.2)+(b-5), (I-25.2)+(b-6), (I-25.2)+(b-7), (I-25.2)+(b-8), (I-25.2)+(b-9), (I-25.2)+(b-10), (I-25.2)+(b-11), (I-25.2)+(b-12), (I-25.2)+(b-13), (I-25.2)+(b-14), (I-25.2)+(S3-1), (I-25.2)+(S3-2), (I-25.2)+(S3-3), (I-25.2)+(S3-4), (I-25.2)+(S3-5), (I-25.2)+(h-1), (I-25.2)+(h-2), (I-25.2)+(V-1), (I-25.2)+(V-2), (I-25.2)+(V-3), (I-25.2)+(V-4), (I-25.2)+(V-5), (I-25.2)+(V-6), (I-25.2)+(IX-A1), (I-25.2)+(IX-A2), (I-25.2)+(IX-A3), and (I-25.2)+(IX-A4).

(I-25.3)+(II-0), (I-25.3)+(II-1), (I-25.3)+(II-2), (I-25.3)+(II-3), (I-25.3)+(II-4), (I-25.3)+(II-5), (I-25.3)+(II-6), (I-25.3)+(II-9), (I-25.3)+(II-12), (I-25.3)+(III-1), (I-25.3)+(III-4), (I-25.3)+(III-10), (I-25.3)+(III-11), (I-25.3)+(IV-1), (I-25.3)+(IV-2), (I-25.3)+(IV-3), (I-25.3)+(IV-4), (I-25.3)+(IV-5), (I-25.3)+(b-1), (I-25.3)+(b-2), (I-25.3)+(b-3), (I-25.3)+(b-4), (I-25.3)+(b-5), (I-25.3)+(b-6), (I-25.3)+(b-7), (I-25.3)+(b-8), (I-25.3)+(b-9), (I-25.3)+(b-10), (I-25.3)+(b-11), (I-25.3)+(b-12), (I-25.3)+(b-13), (I-25.3)+(b-14), (I-25.3)+(S3-1), (I-25.3)+(S3-2), (I-25.3)+(S3-3), (I-25.3)+(S3-4), (I-25.3)+(S3-5), (I-25.3)+(h-1), (I-25.3)+(h-2), (I-25.3)+(V-1), (I-25.3)+(V-2), (I-25.3)+(V-3), (I-25.3)+(V-4), (I-25.3)+(V-5), (I-25.3)+(V-6), (I-25.3)+(IX-A1), (I-25.3)+(IX-A2), (I-25.3)+(IX-A3), and (I-25.3)+(IX-A4).

(I-26.1)+(II-0), (I-26.1)+(II-1), (I-26.1)+(II-2), (I-26.1)+(II-3), (I-26.1)+(II-4), (I-26.1)+(II-5), (I-26.1)+(II-6), (I-26.1)+(II-9), (I-26.1)+(II-12), (I-26.1)+(III-1), (I-26.1)+(III-4), (I-26.1)+(III-10), (I-26.1)+(III-11), (I-26.1)+(IV-1), (I-26.1)+(IV-2), (I-26.1)+(IV-3), (I-26.1)+(IV-4), (I-26.1)+(IV-5), (I-26.1)+(b-1), (I-26.1)+(b-2), (I-26.1)+(b-3), (I-26.1)+(b-4), (I-26.1)+(b-5), (I-26.1)+(b-6), (I-26.1)+(b-7), (I-26.1)+(b-8), (I-26.1)+(b-9), (I-26.1)+(b-10), (I-26.1)+(b-11), (I-26.1)+(b-12), (I-26.1)+(b-13), (I-26.1)+(b-14), (I-26.1)+(S3-1), (I-26.1)+(S3-2), (I-26.1)+(S3-3), (I-26.1)+(S3-4), (I-26.1)+(S3-5), (I-26.1)+(h-1), (I-26.1)+(h-2), (I-26.1)+(V-1), (I-26.1)+(V-2), (I-26.1)+(V-3), (I-26.1)+(V-4), (I-26.1)+(V-5), (I-26.1)+(V-6), (I-26.1)+(IX-A1), (I-26.1)+(IX-A2), (I-26.1)+(IX-A3), and (I-26.1)+(IX-A4).

(I-26.2)+(II-0), (I-26.2)+(II-1), (I-26.2)+(II-2), (I-26.2)+(II-3), (I-26.2)+(II-4), (I-26.2)+(II-5), (I-26.2)+(II-6), (I-26.2)+(II-9), (I-26.2)+(II-12), (I-26.2)+(II-1), (I-26.2)+(III-4), (I-26.2)+(III-10), (I-26.2)+(III-11), (I-26.2)+(IV-1), (I-26.2)+(IV-2), (I-26.2)+(IV-3), (I-26.2)+(IV-4), (I-26.2)+(IV-5), (I-26.2)+(b-1), (I-26.2)+(b-2), (I-26.2)+(b-3), (I-26.2)+(b-4), (I-26.2)+(b-5), (I-26.2)+(b-6), (I-26.2)+(b-7), (I-26.2)+(b-8), (I-26.2)+(b-9), (I-26.2)+(b-10), (I-26.2)+(b-11), (I-26.2)+(b-12), (I-26.2)+(b-13), (I-26.2)+(b-14), (I-26.2)+(S3-1), (I-26.2)+(S3-2), (I-26.2)+(S3-3), (I-26.2)+(S3-4), (I-26.2)+(S3-5), (I-26.2)+(h-1), (I-26.2)+(h-2), (I-26.2)+(V-1), (I-26.2)+(V-2), (I-26.2)+(V-3), (I-26.2)+(V-4), (I-26.2)+(V-5), (I-26.2)+(V-6), (I-26.2)+(IX-A1), (I-26.2)+(IX-A2), (I-26.2)+(IX-A3), and (I-26.2)+(IX-A4).

(I-26.3)+(II-0), (I-26.3)+(II-1), (I-26.3)+(II-2), (I-26.3)+(II-3), (I-26.3)+(II-4), (I-26.3)+(II-5), (I-26.3)+(II-6), (I-26.3)+(II-9), (I-26.3)+(II-12), (I-26.3)+(III-1), (I-26.3)+(III-4), (I-26.3)+(III-10), (I-26.3)+(III-11), (I-26.3)+(IV-1), (I-26.3)+(IV-2), (I-26.3)+(IV-3), (I-26.3)+(IV-4), (I-26.3)+(IV-5), (I-26.3)+(b-1), (I-26.3)+(b-2), (I-26.3)+(b-3), (I-26.3)+(b-4), (I-26.3)+(b-5), (I-26.3)+(b-6), (I-26.3)+(b-7), (I-26.3)+(b-8), (I-26.3)+(b-9), (I-26.3)+(b-10), (I-26.3)+(b-11), (I-26.3)+(b-12), (I-26.3)+(b-13), (I-26.3)+(b-14), (I-26.3)+(S3-1), (I-26.3)+(S3-2), (I-26.3)+(S3-3), (I-26.3)+(S3-4), (I-26.3)+(S3-5), (I-26.3)+(h-1), (I-26.3)+(h-2), (I-26.3)+(V-1), (I-26.3)+(V-2), (I-26.3)+(V-3), (I-26.3)+(V-4), (I-26.3)+(V-5), (I-26.3)+(V-6), (I-26.3)+(IX-A1), (I-26.3)+(IX-A2), (I-26.3)+(IX-A3), and (I-26.3)+(IX-A4).

(I-27.1)+(II-0), (I-27.1)+(II-1), (I-27.1)+(II-2), (I-27.1)+(II-3), (I-27.1)+(II-4), (I-27.1)+(II-5), (I-27.1)+(II-6), (I-27.1)+(II-9), (I-27.1)+(II-12), (I-27.1)+(III-1), (I-27.1)+(III-4), (I-27.1)+(III-10), (I-27.1)+(III-11), (I-27.1)+(IV-1), (I-27.1)+(IV-2), (I-27.1)+(IV-3), (I-27.1)+(IV-4), (I-27.1)+(IV-5), (I-27.1)+(b-1), (I-27.1)+(b-2), (I-27.1)+(b-3), (I-27.1)+(b-4), (I-27.1)+(b-5), (I-27.1)+(b-6), (I-27.1)+(b-7), (I-27.1)+(b-8), (I-27.1)+(b-9), (I-27.1)+(b-10), (I-27.1)+(b-11), (I-27.1)+(b-12), (I-27.1)+(b-13), (I-27.1)+(b-14), (I-27.1)+(S3-1), (I-27.1)+(S3-2), (I-27.1)+(S3-3), (I-27.1)+(S3-4), (I-27.1)+(S3-5), (I-27.1)+(h-1), (I-27.1)+(h-2), (I-27.1)+(V-1), (I-27.1)+(V-2), (I-27.1)+(V-3), (I-27.1)+(V-4), (I-27.1)+(V-5), (I-27.1)+(V-6), (I-27.1)+(IX-A1), (I-27.1)+(IX-A2), (I-27.1)+(IX-A3), and (I-27.1)+(IX-A4).

(I-27.2)+(II-0), (I-27.2)+(II-1), (I-27.2)+(II-2), (I-27.2)+(II-3), (I-27.2)+(II-4), (I-27.2)+(II-5), (I-27.2)+(II-6), (I-27.2)+(II-9), (I-27.2)+(II-12), (I-27.2)+(III-1), (I-27.2)+(III-4), (I-27.2)+(III-10), (I-27.2)+(III-11), (I-27.2)+(IV-1), (I-27.2)+(IV-2), (I-27.2)+(IV-3), (I-27.2)+(IV-4), (I-27.2)+(IV-5), (I-27.2)+(b-1), (I-27.2)+(b-2), (I-27.2)+(b-3), (I-27.2)+(b-4), (I-27.2)+(b-5), (I-27.2)+(b-6), (I-27.2)+(b-7), (I-27.2)+(b-8), (I-27.2)+(b-9), (I-27.2)+(b-10), (I-27.2)+(b-11), (I-27.2)+(b-12), (I-27.2)+(b-13), (I-27.2)+(b-14), (I-27.2)+(S3-1), (I-27.2)+(S3-2), (I-27.2)+(S3-3), (I-27.2)+(S3-4), (I-27.2)+(S3-5), (I-27.2)+(h-1), (I-27.2)+(h-2), (I-27.2)+(V-1), (I-27.2)+(V-2), (I-27.2)+(V-3), (I-27.2)+(V-4), (I-27.2)+(V-5), (I-27.2)+(V-6), (I-27.2)+(IX-A1), (I-27.2)+(IX-A2), (I-27.2)+(IX-A3), and (I-27.2)+(IX-A4).

(I-27.3)+(II-0), (I-27.3)+(II-1), (I-27.3)+(II-2), (I-27.3)+(II-3), (I-27.3)+(II-4), (I-27.3)+(II-5), (I-27.3)+(II-6), (I-27.3)+(II-9), (I-27.3)+(II-12), (I-27.3)+(III-1), (I-27.3)+(III-4), (I-27.3)+(III-10), (I-27.3)+(III-11), (I-27.3)+(IV-1), (I-27.3)+(IV-2), (I-27.3)+(IV-3), (I-27.3)+(IV-4), (I-27.3)+(IV-5), (I-27.3)+(b-1), (I-27.3)+(b-2), (I-27.3)+(b-3), (I-27.3)+(b-4), (I-27.3)+(b-5), (I-27.3)+(b-6), (I-27.3)+(b-7), (I-27.3)+(b-8), (I-27.3)+(b-9), (I-27.3)+(b-10), (I-27.3)+(b-11), (I-27.3)+(b-12), (I-27.3)+(b-13), (I-27.3)+(b-14), (I-27.3)+(S3-1), (I-27.3)+(S3-2), (I-27.3)+(S3-3), (I-27.3)+(S3-4), (I-27.3)+(S3-5), (I-27.3)+(h-1), (I-27.3)+(h-2), (I-27.3)+(V-1), (I-27.3)+(V-2), (I-27.3)+(V-3), (I-27.3)+(V-4), (I-27.3)+(V-5), (I-27.3)+(V-6), (I-27.3)+(IX-A1), (I-27.3)+(IX-A2), (I-27.3)+(IX-A3), and (I-27.3)+(IX-A4).

(I-28.1)+(II-0), (I-28.1)+(II-1), (I-28.1)+(II-2), (I-28.1)+(II-3), (I-28.1)+(II-4), (I-28.1)+(II-5), (I-28.1)+(II-6), (I-28.1)+(II-9), (I-28.1)+(II-12), (I-28.1)+(III-1), (I-28.1)+(III-4), (I-28.1)+(III-10), (I-28.1)+(III-11), (I-28.1)+(IV-1), (I-28.1)+(IV-2), (I-28.1)+(IV-3), (I-28.1)+(IV-4), (I-28.1)+(IV-5), (I-28.1)+(b-1), (I-28.1)+(b-2), (I-28.1)+(b-3), (I-28.1)+(b-4), (I-28.1)+(b-5), (I-28.1)+(b-6), (I-28.1)+(b-7), (I-28.1)+(b-8), (I-28.1)+(b-9), (I-28.1)+(b-10), (I-28.1)+(b-11), (I-28.1)+(b-12), (I-28.1)+(b-13), (I-28.1)+(b-14), (I-28.1)+(S3-1), (I-28.1)+(S3-2), (I-28.1)+(S3-3), (I-28.1)+(S3-4), (I-28.1)+(S3-5), (I-28.1)+(h-1), (I-28.1)+(h-2), (I-28.1)+(V-1), (I-28.1)+(V-2), (I-28.1)+(V-3), (I-28.1)+(V-4), (I-28.1)+(V-5), (I-28.1)+(V-6), (I-28.1)+(IX-A1), (I-28.1)+(IX-A2), (I-28.1)+(IX-A3), and (I-28.1)+(IX-A4).

(I-28.2)+(II-0), (I-28.2)+(II-1), (I-28.2)+(II-2), (I-28.2)+(II-3), (I-28.2)+(II-4), (I-28.2)+(II-5), (I-28.2)+(II-6), (I-28.2)+(II-9), (I-28.2)+(II-12), (I-28.2)+(III-1), (I-28.2)+(III-4), (I-28.2)+(III-10), (I-28.2)+(III-11), (I-28.2)+(IV-1), (I-28.2)+(IV-2), (I-28.2)+(IV-3), (I-28.2)+(IV-4), (I-28.2)+(IV-5), (I-28.2)+(b-1), (I-28.2)+(b-2), (I-28.2)+(b-3), (I-28.2)+(b-4), (I-28.2)+(b-5), (I-28.2)+(b-6), (I-28.2)+(b-7), (I-28.2)+(b-8), (I-28.2)+(b-9), (I-28.2)+(b-10), (I-28.2)+(b-11), (I-28.2)+(b-12), (I-28.2)+(b-13), (I-28.2)+(b-14), (I-28.2)+(S3-1), (I-28.2)+(S3-2), (I-28.2)+(S3-3), (I-28.2)+(S3-4), (I-28.2)+(S3-5), (I-28.2)+(h-1), (I-28.2)+(h-2), (I-28.2)+(V-1), (I-28.2)+(V-2), (I-28.2)+(V-3), (I-28.2)+(V-4), (I-28.2)+(V-5), (I-28.2)+(V-6), (I-28.2)+(IX-A1), (I-28.2)+(IX-A2), (I-28.2)+(IX-A3), and (I-28.2)+(IX-A4).

(I-28.3)+(II-0), (I-28.3)+(II-1), (I-28.3)+(II-2), (I-28.3)+(II-3), (I-28.3)+(II-4), (I-28.3)+(II-5), (I-28.3)+(II-6), (I-28.3)+(II-9), (I-28.3)+(II-12), (I-28.3)+(III-1), (I-28.3)+(III-4), (I-28.3)+(III-10), (I-28.3)+(III-11), (I-28.3)+(IV-1), (I-28.3)+(IV-2), (I-28.3)+(IV-3), (I-28.3)+(IV-4), (I-28.3)+(IV-5), (I-28.3)+(b-1), (I-28.3)+(b-2), (I-28.3)+(b-3), (I-28.3)+(b-4), (I-28.3)+(b-5), (I-28.3)+(b-6), (I-28.3)+(b-7), (I-28.3)+(b-8), (I-28.3)+(b-9), (I-28.3)+(b-10), (I-28.3)+(b-11), (I-28.3)+(b-12), (I-28.3)+(b-13), (I-28.3)+(b-14), (I-28.3)+(S3-1), (I-28.3)+(S3-2), (I-28.3)+(S3-3), (I-28.3)+(S3-4), (I-28.3)+(S3-5), (I-28.3)+(h-1), (I-28.3)+(h-2), (I-28.3)+(V-1), (I-28.3)+(V-2), (I-28.3)+(V-3), (I-28.3)+(V-4), (I-28.3)+(V-5), (I-28.3)+(V-6), (I-28.3)+(IX-A1), (I-28.3)+(IX-A2), (I-28.3)+(IX-A3), and (I-28.3)+(IX-A4).

(I-29.1)+(II-0), (I-29.1)+(II-1), (I-29.1)+(II-2), (I-29.1)+(II-3), (I-29.1)+(II-4), (I-29.1)+(II-5), (I-29.1)+(II-6), (I-29.1)+(II-9), (I-29.1)+(II-12), (I-29.1)+(III-1), (I-29.1)+(III-4), (I-29.1)+(III-10), (I-29.1)+(III-11), (I-29.1)+(IV-1), (I-29.1)+(IV-2), (I-29.1)+(IV-3), (I-29.1)+(IV-4), (I-29.1)+(IV-5), (I-29.1)+(b-1), (I-29.1)+(b-2), (I-29.1)+(b-3), (I-29.1)+(b-4), (I-29.1)+(b-5), (I-29.1)+(b-6), (I-29.1)+(b-7), (I-29.1)+(b-8), (I-29.1)+(b-9), (I-29.1)+(b-10), (I-29.1)+(b-11), (I-29.1)+(b-12), (I-29.1)+(b-13), (I-29.1)+(b-14), (I-29.1)+(S3-1), (I-29.1)+(S3-2), (I-29.1)+(S3-3), (I-29.1)+(S3-4), (I-29.1)+(S3-5), (I-29.1)+(h-1), (I-29.1)+(h-2), (I-29.1)+(V-1), (I-29.1)+(V-2), (I-29.1)+(V-3), (I-29.1)+(V-4), (I-29.1)+(V-5), (I-29.1)+(V-6), (I-29.1)+(IX-A1), (I-29.1)+(IX-A2), (I-29.1)+(IX-A3), and (I-29.1)+(IX-A4).

(I-29.2)+(II-0), (I-29.2)+(II-1), (I-29.2)+(II-2), (I-29.2)+(II-3), (I-29.2)+(II-4), (I-29.2)+(II-5), (I-29.2)+(II-6), (I-29.2)+(II-9), (I-29.2)+(II-12), (I-29.2)+(III-1), (I-29.2)+(III-4), (I-29.2)+(III-10), (I-29.2)+(III-11), (I-29.2)+(IV-1), (I-29.2)+(IV-2), (I-29.2)+(IV-3), (I-29.2)+(IV-4), (I-29.2)+(IV-5), (I-29.2)+(b-1), (I-29.2)+(b-2), (I-29.2)+(b-3), (I-29.2)+(b-4), (I-29.2)+(b-5), (I-29.2)+(b-6), (I-29.2)+(b-7), (I-29.2)+(b-8), (I-29.2)+(b-9), (I-29.2)+(b-10), (I-29.2)+(b-11), (I-29.2)+(b-12), (I-29.2)+(b-13), (I-29.2)+(b-14), (I-29.2)+(S3-1), (I-29.2)+(S3-2), (I-29.2)+(S3-3), (I-29.2)+(S3-4), (I-29.2)+(S3-5), (I-29.2)+(h-1), (I-29.2)+(h-2), (I-29.2)+(V-1), (I-29.2)+(V-2), (I-29.2)+(V-3), (I-29.2)+(V-4), (I-29.2)+(V-5), (I-29.2)+(V-6), (I-29.2)+(IX-A1), (I-29.2)+(IX-A2), (I-29.2)+(IX-A3), and (I-29.2)+(IX-A4).

(I-29.3)+(II-0), (I-29.3)+(II-1), (I-29.3)+(II-2), (I-29.3)+(II-3), (I-29.3)+(II-4), (I-29.3)+(II-5), (I-29.3)+(II-6), (I-29.3)+(II-9), (I-29.3)+(II-12), (I-29.3)+(II-1), (I-29.3)+(III-4), (I-29.3)+(III-10), (I-29.3)+(III-11), (I-29.3)+(IV-1), (I-29.3)+(IV-2), (I-29.3)+(IV-3), (I-29.3)+(IV-4), (I-29.3)+(IV-5), (I-29.3)+(b-1), (I-29.3)+(b-2), (I-29.3)+(b-3), (I-29.3)+(b-4), (I-29.3)+(b-5), (I-29.3)+(b-6), (I-29.3)+(b-7), (I-29.3)+(b-8), (I-29.3)+(b-9), (I-29.3)+(b-10), (I-29.3)+(b-11), (I-29.3)+(b-12), (I-29.3)+(b-13), (I-29.3)+(b-14), (I-29.3)+(S3-1), (I-29.3)+(S3-2), (I-29.3)+(S3-3), (I-29.3)+(S3-4), (I-29.3)+(S3-5), (I-29.3)+(h-1), (I-29.3)+(h-2), (I-29.3)+(V-1), (I-29.3)+(V-2), (I-29.3)+(V-3), (I-29.3)+(V-4), (I-29.3)+(V-5), (I-29.3)+(V-6), (I-29.3)+(IX-A1), (I-29.3)+(IX-A2), (I-29.3)+(IX-A3), and (I-29.3)+(IX-A4).

(I-30.1)+(II-0), (I-30.1)+(II-1), (I-30.1)+(II-2), (I-30.1)+(II-3), (I-30.1)+(II-4), (I-30.1)+(II-5), (I-30.1)+(II-6), (I-30.1)+(II-9), (I-30.1)+(II-12), (I-30.1)+(III-1), (I-30.1)+(III-4), (I-30.1)+(III-10), (I-30.1)+(III-11), (I-30.1)+(IV-1), (I-30.1)+(IV-2), (I-30.1)+(IV-3), (I-30.1)+(IV-4), (I-30.1)+(IV-5), (I-30.1)+(b-1), (I-30.1)+(b-2), (I-30.1)+(b-3), (I-30.1)+(b-4), (I-30.1)+(b-5), (I-30.1)+(b-6), (I-30.1)+(b-7), (I-30.1)+(b-8), (I-30.1)+(b-9), (I-30.1)+(b-10), (I-30.1)+(b-11), (I-30.1)+(b-12), (I-30.1)+(b-13), (I-30.1)+(b-14), (I-30.1)+(S3-1), (I-30.1)+(S3-2), (I-30.1)+(S3-3), (I-30.1)+(S3-4), (I-30.1)+(S3-5), (I-30.1)+(h-1), (I-30.1)+(h-2), (I-30.1)+(V-1), (I-30.1)+(V-2), (I-30.1)+(V-3), (I-30.1)+(V-4), (I-30.1)+(V-5), (I-30.1)+(V-6), (I-30.1)+(IX-A1), (I-30.1)+(IX-A2), (I-30.1)+(IX-A3), and (I-30.1)+(IX-A4).

(I-30.2)+(II-0), (I-30.2)+(II-1), (I-30.2)+(II-2), (I-30.2)+(II-3), (I-30.2)+(II-4), (I-30.2)+(II-5), (I-30.2)+(II-6), (I-30.2)+(II-9), (I-30.2)+(II-12), (I-30.2)+(III-1), (I-30.2)+(III-4), (I-30.2)+(III-10), (I-30.2)+(III-11), (I-30.2)+(IV-1), (I-30.2)+(IV-2), (I-30.2)+(IV-3), (I-30.2)+(IV-4), (I-30.2)+(IV-5), (I-30.2)+(b-1), (I-30.2)+(b-2), (I-30.2)+(b-3), (I-30.2)+(b-4), (I-30.2)+(b-5), (I-30.2)+(b-6), (I-30.2)+(b-7), (I-30.2)+(b-8), (I-30.2)+(b-9), (I-30.2)+(b-10), (I-30.2)+(b-11), (I-30.2)+(b-12), (I-30.2)+(b-13), (I-30.2)+(b-14), (I-30.2)+(S3-1), (I-30.2)+(S3-2), (I-30.2)+(S3-3), (I-30.2)+(S3-4), (I-30.2)+(S3-5), (I-30.2)+(h-1), (I-30.2)+(h-2), (I-30.2)+(V-1), (I-30.2)+(V-2), (I-30.2)+(V-3), (I-30.2)+(V-4), (I-30.2)+(V-5), (I-30.2)+(V-6), (I-30.2)+(IX-A1), (I-30.2)+(IX-A2), (I-30.2)+(IX-A3), and (I-30.2)+(IX-A4).

(I-30.3)+(II-0), (I-30.3)+(II-1), (I-30.3)+(II-2), (I-30.3)+(II-3), (I-30.3)+(II-4), (I-30.3)+(II-5), (I-30.3)+(II-6), (I-30.3)+(II-9), (I-30.3)+(II-12), (I-30.3)+(III-1), (I-30.3)+(III-4), (I-30.3)+(III-10), (I-30.3)+(III-11), (I-30.3)+(IV-1), (I-30.3)+(IV-2), (I-30.3)+(IV-3), (I-30.3)+(IV-4), (I-30.3)+(IV-5), (I-30.3)+(b-1), (I-30.3)+(b-2), (I-30.3)+(b-3), (I-30.3)+(b-4), (I-30.3)+(b-5), (I-30.3)+(b-6), (I-30.3)+(b-7), (I-30.3)+(b-8), (I-30.3)+(b-9), (I-30.3)+(b-10), (I-30.3)+(b-11), (I-30.3)+(b-12), (I-30.3)+(b-13), (I-30.3)+(b-14), (I-30.3)+(S3-1), (I-30.3)+(S3-2), (I-30.3)+(S3-3), (I-30.3)+(S3-4), (I-30.3)+(S3-5), (I-30.3)+(h-1), (I-30.3)+(h-2), (I-30.3)+(V-1), (I-30.3)+(V-2), (I-30.3)+(V-3), (I-30.3)+(V-4), (I-30.3)+(V-5), (I-30.3)+(V-6), (I-30.3)+(IX-A1), (I-30.3)+(IX-A2), (I-30.3)+(IX-A3), and (I-30.3)+(IX-A4).

(I-31.1)+(II-0), (I-31.1)+(II-1), (I-31.1)+(II-2), (I-31.1)+(II-3), (I-31.1)+(II-4), (I-31.1)+(II-5), (I-31.1)+(II-6), (I-31.1)+(II-9), (I-31.1)+(II-12), (I-31.1)+(III-1), (I-31.1)+(III-4), (I-31.1)+(III-10), (I-31.1)+(III-11), (I-31.1)+(I), (I-31.1)+(IV-2), (I-31.1)+(IV-3), (I-31.1)+(IV-4), (I-31.1)+(IV-5), (I-31.1)+(b-1), (I-31.1)+(b-2), (I-31.1)+(b-3), (I-31.1)+(b-4), (I-31.1)+(b-5), (I-31.1)+(b-6), (I-31.1)+(b-7), (I-31.1)+(b-8), (I-31.1)+(b-9), (I-31.1)+(b-10), (I-31.1)+(b-11), (I-31.1)+(b-12), (I-31.1)+(b-13), (I-31.1)+(b-14), (I-31.1)+(S3-1), (I-31.1)+(S3-2), (I-31.1)+(S3-3), (I-31.1)+(S3-4), (I-31.1)+(S3-5), (I-31.1)+(h-1), (I-31.1)+(h-2), (I-31.1)+(V-1), (I-31.1)+(V-2), (I-31.1)+(V-3), (I-31.1)+(V-4), (I-31.1)+(V-5), (I-31.1)+(V-6), (I-31.1)+(IX-A1), (I-31.1)+(IX-A2), (I-31.1)+(IX-A3), and (I-31.1)+(IX-A4).

(I-31.2)+(II-0), (I-31.2)+(II-1), (I-31.2)+(II-2), (I-31.2)+(II-3), (I-31.2)+(II-4), (I-31.2)+(II-5), (I-31.2)+(II-6), (I-31.2)+(II-9), (I-31.2)+(II-12), (I-31.2)+(III-1), (I-31.2)+(III-4), (I-31.2)+(III-10), (I-31.2)+(III-11), (I-31.2)+(IV-1), (I-31.2)+(IV-2), (I-31.2)+(IV-3), (I-31.2)+(IV-4), (I-31.2)+(IV-5), (I-31.2)+(b-1), (I-31.2)+(b-2), (I-31.2)+(b-3), (I-31.2)+(b-4), (I-31.2)+(b-5), (I-31.2)+(b-6), (I-31.2)+(b-7), (I-31.2)+(b-8), (I-31.2)+(b-9), (I-31.2)+(b-10), (I-31.2)+(b-11), (I-31.2)+(b-12), (I-31.2)+(b-13), (I-31.2)+(b-14), (I-31.2)+(S3-1), (I-31.2)+(S3-2), (I-31.2)+(S3-3), (I-31.2)+(S3-4), (I-31.2)+(S3-5), (I-31.2)+(h-1), (I-31.2)+(h-2), (I-31.2)+(V-1), (I-31.2)+(V-2), (I-31.2)+(V-3), (I-31.2)+(V-4), (I-31.2)+(V-5), (I-31.2)+(V-6), (I-31.2)+(IX-A1), (I-31.2)+(IX-A2), (I-31.2)+(IX-A3), and (I-31.2)+(IX-A4).

(I-31.3)+(II-0), (I-31.3)+(II-1), (I-31.3)+(II-2), (I-31.3)+(II-3), (I-31.3)+(II-4), (I-31.3)+(II-5), (I-31.3)+(II-6), (I-31.3)+(II-9), (I-31.3)+(II-12), (I-31.3)+(III-1), (I-31.3)+(III-4), (I-31.3)+(III-10), (I-31.3)+(III-11), (I-31.3)+(IV-1), (I-31.3)+(IV-2), (I-31.3)+(IV-3), (I-31.3)+(IV-4), (I-31.3)+(IV-5), (I-31.3)+(b-1), (I-31.3)+(b-2), (I-31.3)+(b-3), (I-31.3)+(b-4), (I-31.3)+(b-5), (I-31.3)+(b-6), (I-31.3)+(b-7), (I-31.3)+(b-8), (I-31.3)+(b-9), (I-31.3)+(b-10), (I-31.3)+(b-11), (I-31.3)+(b-12), (I-31.3)+(b-13), (I-31.3)+(b-14), (I-31.3)+(S3-1), (I-31.3)+(S3-2), (I-31.3)+(S3-3), (I-31.3)+(S3-4), (I-31.3)+(S3-5), (I-31.3)+(h-1), (I-31.3)+(h-2), (I-31.3)+(V-1), (I-31.3)+(V-2), (I-31.3)+(V-3), (I-31.3)+(V-4), (I-31.3)+(V-5), (I-31.3)+(V-6), (I-31.3)+(IX-A1), (I-31.3)+(IX-A2), (I-31.3)+(IX-A3), and (I-31.3)+(IX-A4).

(I-32.1)+(II-0), (I-32.1)+(II-1), (I-32.1)+(II-2), (I-32.1)+(II-3), (I-32.1)+(II-4), (I-32.1)+(II-5), (I-32.1)+(II-6), (I-32.1)+(II-9), (I-32.1)+(II-12), (I-32.1)+(III-1), (I-32.1)+(III-4), (I-32.1)+(III-10), (I-32.1)+(III-11), (I-32.1)+(IV-1), (I-32.1)+(IV-2), (I-32.1)+(IV-3), (I-32.1)+(IV-4), (I-32.1)+(IV-5), (I-32.1)+(b-1), (I-32.1)+(b-2), (I-32.1)+(b-3), (I-32.1)+(b-4), (I-32.1)+(b-5), (I-32.1)+(b-6), (I-32.1)+(b-7), (I-32.1)+(b-8), (I-32.1)+(b-9), (I-32.1)+(b-10), (I-32.1)+(b-11), (I-32.1)+(b-12), (I-32.1)+(b-13), (I-32.1)+(b-14), (I-32.1)+(S3-1), (I-32.1)+(S3-2), (I-32.1)+(S3-3), (I-32.1)+(S3-4), (I-32.1)+(S3-5), (I-32.1)+(h-1), (I-32.1)+(h-2), (I-32.1)+(V-1), (I-32.1)+(V-2), (I-32.1)+(V-3), (I-32.1)+(V-4), (I-32.1)+(V-5), (I-32.1)+(V-6), (I-32.1)+(IX-A1), (I-32.1)+(IX-A2), (I-32.1)+(IX-A3), and (I-32.1)+(IX-A4).

(I-32.2)+(II-0), (I-32.2)+(II-1), (I-32.2)+(II-2), (I-32.2)+(II-3), (I-32.2)+(II-4), (I-32.2)+(II-5), (I-32.2)+(II-6), (I-32.2)+(II-9), (I-32.2)+(II-12), (I-32.2)+(III-1), (I-32.2)+(III-4), (I-32.2)+(III-10), (I-32.2)+(III-11), (I-32.2)+(IV-1), (I-32.2)+(IV-2), (I-32.2)+(IV-3), (I-32.2)+(IV-4), (I-32.2)+(IV-5), (I-32.2)+(b-1), (I-32.2)+(b-2), (I-32.2)+(b-3), (I-32.2)+(b-4), (I-32.2)+(b-5), (I-32.2)+(b-6), (I-32.2)+(b-7), (I-32.2)+(b-8), (I-32.2)+(b-9), (I-32.2)+(b-10), (I-32.2)+(b-11), (I-32.2)+(b-12), (I-32.2)+(b-13), (I-32.2)+(b-14), (I-32.2)+(S3-1), (I-32.2)+(S3-2), (I-32.2)+(S3-3), (I-32.2)+(S3-4), (I-32.2)+(S3-5), (I-32.2)+(h-1), (I-32.2)+(h-2), (I-32.2)+(V-1), (I-32.2)+(V-2), (I-32.2)+(V-3), (I-32.2)+(V-4), (I-32.2)+(V-5), (I-32.2)+(V-6), (I-32.2)+(IX-A1), (I-32.2)+(IX-A2), (I-32.2)+(IX-A3), and (I-32.2)+(IX-A4).

(I-32.3)+(II-0), (I-32.3)+(II-1), (I-32.3)+(II-2), (I-32.3)+(II-3), (I-32.3)+(II-4), (I-32.3)+(II-5), (I-32.3)+(II-6), (I-32.3)+(II-9), (I-32.3)+(II-12), (I-32.3)+(III-1), (I-32.3)+(III-4), (I-32.3)+(III-10), (I-32.3)+(III-11), (I-32.3)+(IV-1), (I-32.3)+(IV-2), (I-32.3)+(IV-3), (I-32.3)+(IV-4), (I-32.3)+(IV-5), (I-32.3)+(b-1), (I-32.3)+(b-2), (I-32.3)+(b-3), (I-32.3)+(b-4), (I-32.3)+(b-5), (I-32.3)+(b-6), (I-32.3)+(b-7), (I-32.3)+(b-8), (I-32.3)+(b-9), (I-32.3)+(b-10), (I-32.3)+(b-11), (I-32.3)+(b-12), (I-32.3)+(b-13), (I-32.3)+(b-14), (I-32.3)+(S3-1), (I-32.3)+(S3-2), (I-32.3)+(S3-3), (I-32.3)+(S3-4), (I-32.3)+(S3-5), (I-32.3)+(h-1), (I-32.3)+(h-2), (I-32.3)+(V-1), (I-32.3)+(V-2), (I-32.3)+(V-3), (I-32.3)+(V-4), (I-32.3)+(V-5), (I-32.3)+(V-6), (I-32.3)+(IX-A1), (I-32.3)+(IX-A2), (I-32.3)+(IX-A3), and (I-32.3)+(IX-A4).

(I-33.1)+(II-0), (I-33.1)+(II-1), (I-33.1)+(II-2), (I-33.1)+(II-3), (I-33.1)+(II-4), (I-33.1)+(II-5), (I-33.1)+(II-6), (I-33.1)+(II-9), (I-33.1)+(II-12), (I-33.1)+(III-1), (I-33.1)+(III-4), (I-33.1)+(III-10), (I-33.1)+(III-11), (I-33.1)+(IV-1), (I-33.1)+(IV-2), (I-33.1)+(IV-3), (I-33.1)+(IV-4), (I-33.1)+(IV-5), (I-33.1)+(b-1), (I-33.1)+(b-2), (I-33.1)+(b-3), (I-33.1)+(b-4), (I-33.1)+(b-5), (I-33.1)+(b-6), (I-33.1)+(b-7), (I-33.1)+(b-8), (I-33.1)+(b-9), (I-33.1)+(b-10), (I-33.1)+(b-11), (I-33.1)+(b-12), (I-33.1)+(b-13), (I-33.1)+(b-14), (I-33.1)+(S3-1), (I-33.1)+(S3-2), (I-33.1)+(S3-3), (I-33.1)+(S3-4), (I-33.1)+(S3-5), (I-33.1)+(h-1), (I-33.1)+(h-2), (I-33.1)+(V-1), (I-33.1)+(V-2), (I-33.1)+(V-3), (I-33.1)+(V-4), (I-33.1)+(V-5), (I-33.1)+(V-6), (I-33.1)+(IX-A1), (I-33.1)+(IX-A2), (I-33.1)+(IX-A3), and (I-33.1)+(IX-A4).

(I-33.2)+(II-0), (I-33.2)+(II-1), (I-33.2)+(II-2), (I-33.2)+(II-3), (I-33.2)+(II-4), (I-33.2)+(II-5), (I-33.2)+(II-6), (I-33.2)+(II-9), (I-33.2)+(II-12), (I-33.2)+(III-1), (I-33.2)+(III-4), (I-33.2)+(III-10), (I-33.2)+(III-11), (I-33.2)+(IV-1), (I-33.2)+(IV-2), (I-33.2)+(IV-3), (I-33.2)+(IV-4), (I-33.2)+(IV-5), (I-33.2)+(b-1), (I-33.2)+(b-2), (I-33.2)+(b-3), (I-33.2)+(b-4), (I-33.2)+(b-5), (I-33.2)+(b-6), (I-33.2)+(b-7), (I-33.2)+(b-8), (I-33.2)+(b-9), (I-33.2)+(b-10), (I-33.2)+(b-11), (I-33.2)+(b-12), (I-33.2)+(b-13), (I-33.2)+(b-14), (I-33.2)+(S3-1), (I-33.2)+(S3-2), (I-33.2)+(S3-3), (I-33.2)+(S3-4), (I-33.2)+(S3-5), (I-33.2)+(h-1), (I-33.2)+(h-2), (I-33.2)+(V-1), (I-33.2)+(V-2), (I-33.2)+(V-3), (I-33.2)+(V-4), (I-33.2)+(V-5), (I-33.2)+(V-6), (I-33.2)+(IX-A1), (I-33.2)+(IX-A2), (I-33.2)+(IX-A3), and (I-33.2)+(IX-A4).

(I-33.3)+(II-0), (I-33.3)+(II-1), (I-33.3)+(II-2), (I-33.3)+(II-3), (I-33.3)+(II-4), (I-33.3)+(II-5), (I-33.3)+(II-6), (I-33.3)+(II-9), (I-33.3)+(II-12), (I-33.3)+(III-1), (I-33.3)+(III-4), (I-33.3)+(III-10), (I-33.3)+(III-11), (I-33.3)+(IV-1), (I-33.3)+(IV-2), (I-33.3)+(IV-3), (I-33.3)+(IV-4), (I-33.3)+(IV-5), (I-33.3)+(b-1), (I-33.3)+(b-2), (I-33.3)+(b-3), (I-33.3)+(b-4), (I-33.3)+(b-5), (I-33.3)+(b-6), (I-33.3)+(b-7), (I-33.3)+(b-8), (I-33.3)+(b-9), (I-33.3)+(b-10), (I-33.3)+(b-11), (I-33.3)+(b-12), (I-33.3)+(b-13), (I-33.3)+(b-14), (I-33.3)+(S3-1), (I-33.3)+(S3-2), (I-33.3)+(S3-3), (I-33.3)+(S3-4), (I-33.3)+(S3-5), (I-33.3)+(h-1), (I-33.3)+(h-2), (I-33.3)+(V-1), (I-33.3)+(V-2), (I-33.3)+(V-3), (I-33.3)+(V-4), (I-33.3)+(V-5), (I-33.3)+(V-6), (I-33.3)+(IX-A1), (I-33.3)+(IX-A2), (I-33.3)+(IX-A3), and (I-33.3)+(IX-A4).

(I-34.1)+(II-0), (I-34.1)+(II-1), (I-34.1)+(II-2), (I-34.1)+(II-3), (I-34.1)+(II-4), (I-34.1)+(II-5), (I-34.1)+(II-6), (I-34.1)+(II-9), (I-34.1)+(II-12), (I-34.1)+(III-1), (I-34.1)+(III-4), (I-34.1)+(III-10), (I-34.1)+(III-11), (I-34.1)+(IV-1), (I-34.1)+(IV-2), (I-34.1)+(IV-3), (I-34.1)+(IV-4), (I-34.1)+(IV-5), (I-34.1)+(b-1), (I-34.1)+(b-2), (I-34.1)+(b-3), (I-34.1)+(b-4), (I-34.1)+(b-5), (I-34.1)+(b-6), (I-34.1)+(b-7), (I-34.1)+(b-8), (I-34.1)+(b-9), (I-34.1)+(b-10), (I-34.1)+(b-11), (I-34.1)+(b-12), (I-34.1)+(b-13), (I-34.1)+(b-14), (I-34.1)+(S3-1), (I-34.1)+(S3-2), (I-34.1)+(S3-3), (I-34.1)+(S3-4), (I-34.1)+(S3-5), (I-34.1)+(h-1), (I-34.1)+(h-2), (I-34.1)+(V-1), (I-34.1)+(V-2), (I-34.1)+(V-3), (I-34.1)+(V-4), (I-34.1)+(V-5), (I-34.1)+(V-6), (I-34.1)+(IX-A1), (I-34.1)+(IX-A2), (I-34.1)+(IX-A3), and (I-34.1)+(IX-A4).

(I-34.2)+(II-0), (I-34.2)+(II-1), (I-34.2)+(II-2), (I-34.2)+(II-3), (I-34.2)+(II-4), (I-34.2)+(II-5), (I-34.2)+(II-6), (I-34.2)+(II-9), (I-34.2)+(II-12), (I-34.2)+(III-1), (I-34.2)+(III-4), (I-34.2)+(III-10), (I-34.2)+(III-11), (I-34.2)+(IV-1), (I-34.2)+(IV-2), (I-34.2)+(IV-3), (I-34.2)+(IV-4), (I-34.2)+(IV-5), (I-34.2)+(b-1), (I-34.2)+(b-2), (I-34.2)+(b-3), (I-34.2)+(b-4), (I-34.2)+(b-5), (I-34.2)+(b-6), (I-34.2)+(b-7), (I-34.2)+(b-8), (I-34.2)+(b-9), (I-34.2)+(b-10), (I-34.2)+(b-11), (I-34.2)+(b-12), (I-34.2)+(b-13), (I-34.2)+(b-14), (I-34.2)+(S3-1), (I-34.2)+(S3-2), (I-34.2)+(S3-3), (I-34.2)+(S3-4), (I-34.2)+(S3-5), (I-34.2)+(h-1), (I-34.2)+(h-2), (I-34.2)+(V-1), (I-34.2)+(V-2), (I-34.2)+(V-3), (I-34.2)+(V-4), (I-34.2)+(V-5), (I-34.2)+(V-6), (I-34.2)+(IX-A1), (I-34.2)+(IX-A2), (I-34.2)+(IX-A3), and (I-34.2)+(IX-A4).

(I-34.3)+(II-0), (I-34.3)+(II-1), (I-34.3)+(II-2), (I-34.3)+(II-3), (I-34.3)+(II-4), (I-34.3)+(II-5), (I-34.3)+(II-6), (I-34.3)+(II-9), (I-34.3)+(II-12), (I-34.3)+(III-1), (I-34.3)+(III-4), (I-34.3)+(III-10), (I-34.3)+(III-11), (I-34.3)+(IV-1), (I-34.3)+(IV-2), (I-34.3)+(IV-3), (I-34.3)+(IV-4), (I-34.3)+(IV-5), (I-34.3)+(b-1), (I-34.3)+(b-2), (I-34.3)+(b-3), (I-34.3)+(b-4), (I-34.3)+(b-5), (I-34.3)+(b-6), (I-34.3)+(b-7), (I-34.3)+(b-8), (I-34.3)+(b-9), (I-34.3)+(b-10), (I-34.3)+(b-11), (I-34.3)+(b-12), (I-34.3)+(b-13), (I-34.3)+(b-14), (I-34.3)+(S3-1), (I-34.3)+(S3-2), (I-34.3)+(S3-3), (I-34.3)+(S3-4), (I-34.3)+(S3-5), (I-34.3)+(h-1), (I-34.3)+(h-2), (I-34.3)+(V-1), (I-34.3)+(V-2), (I-34.3)+(V-3), (I-34.3)+(V-4), (I-34.3)+(V-5), (I-34.3)+(V-6), (I-34.3)+(IX-A1), (I-34.3)+(IX-A2), (I-34.3)+(IX-A3), and (I-34.3)+(IX-A4).

(I-35.1)+(II-0), (I-35.1)+(II-1), (I-35.1)+(II-2), (I-35.1)+(II-3), (I-35.1)+(II-4), (I-35.1)+(II-5), (I-35.1)+(II-6), (I-35.1)+(II-9), (I-35.1)+(II-12), (I-35.1)+(III-1), (I-35.1)+(III-4), (I-35.1)+(III-10), (I-35.1)+(III-11), (I-35.1)+(IV-1), (I-35.1)+(IV-2), (I-35.1)+(IV-3), (I-35.1)+(IV-4), (I-35.1)+(IV-5), (I-35.1)+(b-1), (I-35.1)+(b-2), (I-35.1)+(b-3), (I-35.1)+(b-4), (I-35.1)+(b-5), (I-35.1)+(b-6), (I-35.1)+(b-7), (I-35.1)+(b-8), (I-35.1)+(b-9), (I-35.1)+(b-10), (I-35.1)+(b-11), (I-35.1)+(b-12), (I-35.1)+(b-13), (I-35.1)+(b-14), (I-35.1)+(S3-1), (I-35.1)+(S3-2), (I-35.1)+(S3-3), (I-35.1)+(S3-4), (I-35.1)+(S3-5), (I-35.1)+(h-1), (I-35.1)+(h-2), (I-35.1)+(V-1), (I-35.1)+(V-2), (I-35.1)+(V-3), (I-35.1)+(V-4), (I-35.1)+(V-5), (I-35.1)+(V-6), (I-35.1)+(IX-A1), (I-35.1)+(IX-A2), (I-35.1)+(IX-A3), and (I-35.1)+(IX-A4).

(I-35.2)+(II-0), (I-35.2)+(II-1), (I-35.2)+(II-2), (I-35.2)+(II-3), (I-35.2)+(II-4), (I-35.2)+(II-5), (I-35.2)+(II-6), (I-35.2)+(II-9), (I-35.2)+(II-12), (I-35.2)+(III-1), (I-35.2)+(III-4), (I-35.2)+(III-10), (I-35.2)+(III-11), (I-35.2)+(IV-1), (I-35.2)+(IV-2), (I-35.2)+(IV-3), (I-35.2)+(IV-4), (I-35.2)+(IV-5), (I-35.2)+(b-1), (I-35.2)+(b-2), (I-35.2)+(b-3), (I-35.2)+(b-4), (I-35.2)+(b-5), (I-35.2)+(b-6), (I-35.2)+(b-7), (I-35.2)+(b-8), (I-35.2)+(b-9), (I-35.2)+(b-10), (I-35.2)+(b-11), (I-35.2)+(b-12), (I-35.2)+(b-13), (I-35.2)+(b-14), (I-35.2)+(S3-1), (I-35.2)+(S3-2), (I-35.2)+(S3-3), (I-35.2)+(S3-4), (I-35.2)+(S3-5), (I-35.2)+(h-1), (I-35.2)+(h-2), (I-35.2)+(V-1), (I-35.2)+(V-2), (I-35.2)+(V-3), (I-35.2)+(V-4), (I-35.2)+(V-5), (I-35.2)+(V-6), (I-35.2)+(IX-A1), (I-35.2)+(IX-A2), (I-35.2)+(IX-A3), and (I-35.2)+(IX-A4).

(I-35.3)+(II-0), (I-35.3)+(II-1), (I-35.3)+(II-2), (I-35.3)+(II-3), (I-35.3)+(II-4), (I-35.3)+(II-5), (I-35.3)+(II-6), (I-35.3)+(II-9), (I-35.3)+(II-12), (I-35.3)+(III-1), (I-35.3)+(III-4), (I-35.3)+(III-10), (I-35.3)+(III-11), (I-35.3)+(IV-1), (I-35.3)+(IV-2), (I-35.3)+(IV-3), (I-35.3)+(IV-4), (I-35.3)+(IV-5), (I-35.3)+(b-1), (I-35.3)+(b-2), (I-35.3)+(b-3), (I-35.3)+(b-4), (I-35.3)+(b-5), (I-35.3)+(b-6), (I-35.3)+(b-7), (I-35.3)+(b-8), (I-35.3)+(b-9), (I-35.3)+(b-10), (I-35.3)+(b-11), (I-35.3)+(b-12), (I-35.3)+(b-13), (I-35.3)+(b-14), (I-35.3)+(S3-1), (I-35.3)+(S3-2), (I-35.3)+(S3-3), (I-35.3)+(S3-4), (I-35.3)+(S3-5), (I-35.3)+(h-1), (I-35.3)+(h-2), (I-35.3)+(V-1), (I-35.3)+(V-2), (I-35.3)+(V-3), (I-35.3)+(V-4), (I-35.3)+(V-5), (I-35.3)+(V-6), (I-35.3)+(IX-A1), (I-35.3)+(IX-A2), (I-35.3)+(IX-A3), and (I-35.3)+(IX-A4).

(I-36.1)+(II-0), (I-36.1)+(II-1), (I-36.1)+(II-2), (I-36.1)+(II-3), (I-36.1)+(II-4), (I-36.1)+(II-5), (I-36.1)+(II-6), (I-36.1)+(II-9), (I-36.1)+(II-12), (I-36.1)+(III-1), (I-36.1)+(III-4), (I-36.1)+(III-10), (I-36.1)+(III-11), (I-36.1)+(IV-1), (I-36.1)+(IV-2), (I-36.1)+(IV-3), (I-36.1)+(IV-4), (I-36.1)+(IV-5), (I-36.1)+(b-1), (I-36.1)+(b-2), (I-36.1)+(b-3), (I-36.1)+(b-4), (I-36.1)+(b-5), (I-36.1)+(b-6), (I-36.1)+(b-7), (I-36.1)+(b-8), (I-36.1)+(b-9), (I-36.1)+(b-10), (I-36.1)+(b-11), (I-36.1)+(b-12), (I-36.1)+(b-13), (I-36.1)+(b-14), (I-36.1)+(S3-1), (I-36.1)+(S3-2), (I-36.1)+(S3-3), (I-36.1)+(S3-4), (I-36.1)+(S3-5), (I-36.1)+(h-1), (I-36.1)+(h-2), (I-36.1)+(V-1), (I-36.1)+(V-2), (I-36.1)+(V-3), (I-36.1)+(V-4), (I-36.1)+(V-5), (I-36.1)+(V-6), (I-36.1)+(IX-A1), (I-36.1)+(IX-A2), (I-36.1)+(IX-A3), and (I-36.1)+(IX-A4).

(I-36.2)+(II-0), (I-36.2)+(II-1), (I-36.2)+(II-2), (I-36.2)+(II-3), (I-36.2)+(II-4), (I-36.2)+(II-5), (I-36.2)+(II-6), (I-36.2)+(II-9), (I-36.2)+(II-12), (I-36.2)+(III-1), (I-36.2)+(III-4), (I-36.2)+(III-10), (I-36.2)+(III-11), (I-36.2)+(IV-1), (I-36.2)+(IV-2), (I-36.2)+(IV-3), (I-36.2)+(IV-4), (I-36.2)+(IV-5), (I-36.2)+(b-1), (I-36.2)+(b-2), (I-36.2)+(b-3), (I-36.2)+(b-4), (I-36.2)+(b-5), (I-36.2)+(b-6), (I-36.2)+(b-7), (I-36.2)+(b-8), (I-36.2)+(b-9), (I-36.2)+(b-10), (I-36.2)+(b-11), (I-36.2)+(b-12), (I-36.2)+(b-13), (I-36.2)+(b-14), (I-36.2)+(S3-1), (I-36.2)+(S3-2), (I-36.2)+(S3-3), (I-36.2)+(S3-4), (I-36.2)+(S3-5), (I-36.2)+(h-1), (I-36.2)+(h-2), (I-36.2)+(V-1), (I-36.2)+(V-2), (I-36.2)+(V-3), (I-36.2)+(V-4), (I-36.2)+(V-5), (I-36.2)+(V-6), (I-36.2)+(IX-A1), (I-36.2)+(IX-A2), (I-36.2)+(IX-A3), and (I-36.2)+(IX-A4).

(I-36.3)+(II-0), (I-36.3)+(II-1), (I-36.3)+(II-2), (I-36.3)+(II-3), (I-36.3)+(II-4), (I-36.3)+(II-5), (I-36.3)+(II-6), (I-36.3)+(II-9), (I-36.3)+(II-12), (I-36.3)+(III-1), (I-36.3)+(III-4), (I-36.3)+(III-10), (I-36.3)+(III-11), (I-36.3)+(IV-1), (I-36.3)+(IV-2), (I-36.3)+(IV-3), (I-36.3)+(IV-4), (I-36.3)+(IV-5), (I-36.3)+(b-1), (I-36.3)+(b-2), (I-36.3)+(b-3), (I-36.3)+(b-4), (I-36.3)+(b-5), (I-36.3)+(b-6), (I-36.3)+(b-7), (I-36.3)+(b-8), (I-36.3)+(b-9), (I-36.3)+(b-10), (I-36.3)+(b-11), (I-36.3)+(b-12), (I-36.3)+(b-13), (I-36.3)+(b-14), (I-36.3)+(S3-1), (I-36.3)+(S3-2), (I-36.3)+(S3-3), (I-36.3)+(S3-4), (I-36.3)+(S3-5), (I-36.3)+(h-1), (I-36.3)+(h-2), (I-36.3)+(V-1), (I-36.3)+(V-2), (I-36.3)+(V-3), (I-36.3)+(V-4), (I-36.3)+(V-5), (I-36.3)+(V-6), (I-36.3)+(IX-A1), (I-36.3)+(IX-A2), (I-36.3)+(IX-A3), and (I-36.3)+(IX-A4).

(I-37.1)+(II-0), (I-37.1)+(II-1), (I-37.1)+(II-2), (I-37.1)+(II-3), (I-37.1)+(II-4), (I-37.1)+(II-5), (I-37.1)+(II-6), (I-37.1)+(II-9), (I-37.1)+(II-12), (I-37.1)+(III-1), (I-37.1)+(III-4), (I-37.1)+(III-10), (I-37.1)+(III-11), (I-37.1)+(IV-1), (I-37.1)+(IV-2), (I-37.1)+(IV-3), (I-37.1)+(IV-4), (I-37.1)+(IV-5), (I-37.1)+(b-1), (I-37.1)+(b-2), (I-37.1)+(b-3), (I-37.1)+(b-4), (I-37.1)+(b-5), (I-37.1)+(b-6), (I-37.1)+(b-7), (I-37.1)+(b-8), (I-37.1)+(b-9), (I-37.1)+(b-10), (I-37.1)+(b-11), (I-37.1)+(b-12), (I-37.1)+(b-13), (I-37.1)+(b-14), (I-37.1)+(S3-1), (I-37.1)+(S3-2), (I-37.1)+(S3-3), (I-37.1)+(S3-4), (I-37.1)+(S3-5), (I-37.1)+(h-1), (I-37.1)+(h-2), (I-37.1)+(V-1), (I-37.1)+(V-2), (I-37.1)+(V-3), (I-37.1)+(V-4), (I-37.1)+(V-5), (I-37.1)+(V-6), (I-37.1)+(IX-A1), (I-37.1)+(IX-A2), (I-37.1)+(IX-A3), and (I-37.1)+(IX-A4).

(I-37.2)+(II-0), (I-37.2)+(II-1), (I-37.2)+(II-2), (I-37.2)+(II-3), (I-37.2)+(II-4), (I-37.2)+(II-5), (I-37.2)+(II-6), (I-37.2)+(II-9), (I-37.2)+(II-12), (I-37.2)+(III-1), (I-37.2)+(III-4), (I-37.2)+(III-10), (I-37.2)+(III-11), (I-37.2)+(IV-1), (I-37.2)+(IV-2), (I-37.2)+(IV-3), (I-37.2)+(IV-4), (I-37.2)+(IV-5), (I-37.2)+(b-1), (I-37.2)+(b-2), (I-37.2)+(b-3), (I-37.2)+(b-4), (I-37.2)+(b-5), (I-37.2)+(b-6), (I-37.2)+(b-7), (I-37.2)+(b-8), (I-37.2)+(b-9), (I-37.2)+(b-10), (I-37.2)+(b-11), (I-37.2)+(b-12), (I-37.2)+(b-13), (I-37.2)+(b-14), (I-37.2)+(S3-1), (I-37.2)+(S3-2), (I-37.2)+(S3-3), (I-37.2)+(S3-4), (I-37.2)+(S3-5), (I-37.2)+(h-1), (I-37.2)+(h-2), (I-37.2)+(V-1), (I-37.2)+(V-2), (I-37.2)+(V-3), (I-37.2)+(V-4), (I-37.2)+(V-5), (I-37.2)+(V-6), (I-37.2)+(IX-A1), (I-37.2)+(IX-A2), (I-37.2)+(IX-A3), and (I-37.2)+(IX-A4).

(I-37.3)+(II-0), (I-37.3)+(II-1), (I-37.3)+(II-2), (I-37.3)+(II-3), (I-37.3)+(II-4), (I-37.3)+(II-5), (I-37.3)+(II-6), (I-37.3)+(II-9), (I-37.3)+(II-12), (I-37.3)+(III-1), (I-37.3)+(III-4), (I-37.3)+(III-10), (I-37.3)+(III-11), (I-37.3)+(IV-1), (I-37.3)+(IV-2), (I-37.3)+(IV-3), (I-37.3)+(IV-4), (I-37.3)+(IV-5), (I-37.3)+(b-1), (I-37.3)+(b-2), (I-37.3)+(b-3), (I-37.3)+(b-4), (I-37.3)+(b-5), (I-37.3)+(b-6), (I-37.3)+(b-7), (I-37.3)+(b-8), (I-37.3)+(b-9), (I-37.3)+(b-10), (I-37.3)+(b-11), (I-37.3)+(b-12), (I-37.3)+(b-13), (I-37.3)+(b-14), (I-37.3)+(S3-1), (I-37.3)+(S3-2), (I-37.3)+(S3-3), (I-37.3)+(S3-4), (I-37.3)+(S3-5), (I-37.3)+(h-1), (I-37.3)+(h-2), (I-37.3)+(V-1), (I-37.3)+(V-2), (I-37.3)+(V-3), (I-37.3)+(V-4), (I-37.3)+(V-5), (I-37.3)+(V-6), (I-37.3)+(IX-A1), (I-37.3)+(IX-A2), (I-37.3)+(IX-A3), and (I-37.3)+(IX-A4).

(I-38.1)+(II-0), (I-38.1)+(II-1), (I-38.1)+(II-2), (I-38.1)+(II-3), (I-38.1)+(II-4), (I-38.1)+(II-5), (I-38.1)+(II-6), (I-38.1)+(II-9), (I-38.1)+(II-12), (I-38.1)+(II-1), (I-38.1)+(III-4), (I-38.1)+(III-10), (I-38.1)+(III-11), (I-38.1)+(IV-1), (I-38.1)+(IV-2), (I-38.1)+(IV-3), (I-38.1)+(IV-4), (I-38.1)+(IV-5), (I-38.1)+(b-1), (I-38.1)+(b-2), (I-38.1)+(b-3), (I-38.1)+(b-4), (I-38.1)+(b-5), (I-38.1)+(b-6), (I-38.1)+(b-7), (I-38.1)+(b-8), (I-38.1)+(b-9), (I-38.1)+(b-10), (I-38.1)+(b-11), (I-38.1)+(b-12), (I-38.1)+(b-13), (I-38.1)+(b-14), (I-38.1)+(S3-1), (I-38.1)+(S3-2), (I-38.1)+(S3-3), (I-38.1)+(S3-4), (I-38.1)+(S3-5), (I-38.1)+(h-1), (I-38.1)+(h-2), (I-38.1)+(V-1), (I-38.1)+(V-2), (I-38.1)+(V-3), (I-38.1)+(V-4), (I-38.1)+(V-5), (I-38.1)+(V-6), (I-38.1)+(IX-A1), (I-38.1)+(IX-A2), (I-38.1)+(IX-A3), and (I-38.1)+(IX-A4).

(I-38.2)+(II-0), (I-38.2)+(II-1), (I-38.2)+(II-2), (I-38.2)+(II-3), (I-38.2)+(II-4), (I-38.2)+(II-5), (I-38.2)+(II-6), (I-38.2)+(II-9), (I-38.2)+(II-12), (I-38.2)+(III-1), (I-38.2)+(III-4), (I-38.2)+(III-10), (I-38.2)+(III-11), (I-38.2)+(IV-1), (I-38.2)+(IV-2), (I-38.2)+(IV-3), (I-38.2)+(IV-4), (I-38.2)+(IV-5), (I-38.2)+(b-1), (I-38.2)+(b-2), (I-38.2)+(b-3), (I-38.2)+(b-4), (I-38.2)+(b-5), (I-38.2)+(b-6), (I-38.2)+(b-7), (I-38.2)+(b-8), (I-38.2)+(b-9), (I-38.2)+(b-10), (I-38.2)+(b-11), (I-38.2)+(b-12), (I-38.2)+(b-13), (I-38.2)+(b-14), (I-38.2)+(S3-1), (I-38.2)+(S3-2), (I-38.2)+(S3-3), (I-38.2)+(S3-4), (I-38.2)+(S3-5), (I-38.2)+(h-1), (I-38.2)+(h-2), (I-38.2)+(V-1), (I-38.2)+(V-2), (I-38.2)+(V-3), (I-38.2)+(V-4), (I-38.2)+(V-5), (I-38.2)+(V-6), (I-38.2)+(IX-A1), (I-38.2)+(IX-A2), (I-38.2)+(IX-A3), and (I-38.2)+(IX-A4).

(I-38.3)+(II-0), (I-38.3)+(II-1), (I-38.3)+(II-2), (I-38.3)+(II-3), (I-38.3)+(II-4), (I-38.3)+(II-5), (I-38.3)+(II-6), (I-38.3)+(II-9), (I-38.3)+(II-12), (I-38.3)+(III-1), (I-38.3)+(III-4), (I-38.3)+(III-10), (I-38.3)+(III-11), (I-38.3)+(IV-1), (I-38.3)+(IV-2), (I-38.3)+(IV-3), (I-38.3)+(IV-4), (I-38.3)+(IV-5), (I-38.3)+(b-1), (I-38.3)+(b-2), (I-38.3)+(b-3), (I-38.3)+(b-4), (I-38.3)+(b-5), (I-38.3)+(b-6), (I-38.3)+(b-7), (I-38.3)+(b-8), (I-38.3)+(b-9), (I-38.3)+(b-10), (I-38.3)+(b-11), (I-38.3)+(b-12), (I-38.3)+(b-13), (I-38.3)+(b-14), (I-38.3)+(S3-1), (I-38.3)+(S3-2), (I-38.3)+(S3-3), (I-38.3)+(S3-4), (I-38.3)+(S3-5), (I-38.3)+(h-1), (I-38.3)+(h-2), (I-38.3)+(V-1), (I-38.3)+(V-2), (I-38.3)+(V-3), (I-38.3)+(V-4), (I-38.3)+(V-5), (I-38.3)+(V-6), (I-38.3)+(IX-A1), (I-38.3)+(IX-A2), (I-38.3)+(IX-A3), and (I-38.3)+(IX-A4).

(I-39.1)+(II-0), (I-39.1)+(II-1), (I-39.1)+(II-2), (I-39.1)+(II-3), (I-39.1)+(II-4), (I-39.1)+(II-5), (I-39.1)+(II-6), (I-39.1)+(II-9), (I-39.1)+(II-12), (I-39.1)+(III-1), (I-39.1)+(III-4), (I-39.1)+(III-10), (I-39.1)+(III-11), (I-39.1)+(IV-1), (I-39.1)+(IV-2), (I-39.1)+(IV-3), (I-39.1)+(IV-4), (I-39.1)+(IV-5), (I-39.1)+(b-1), (I-39.1)+(b-2), (I-39.1)+(b-3), (I-39.1)+(b-4), (I-39.1)+(b-5), (I-39.1)+(b-6), (I-39.1)+(b-7), (I-39.1)+(b-8), (I-39.1)+(b-9), (I-39.1)+(b-10), (I-39.1)+(b-11), (I-39.1)+(b-12), (I-39.1)+(b-13), (I-39.1)+(b-14), (I-39.1)+(S3-1), (I-39.1)+(S3-2), (I-39.1)+(S3-3), (I-39.1)+(S3-4), (I-39.1)+(S3-5), (I-39.1)+(h-1), (I-39.1)+(h-2), (I-39.1)+(V-1), (I-39.1)+(V-2), (I-39.1)+(V-3), (I-39.1)+(V-4), (I-39.1)+(V-5), (I-39.1)+(V-6), (I-39.1)+(IX-A1), (I-39.1)+(IX-A2), (I-39.1)+(IX-A3), and (I-39.1)+(IX-A4).

(I-39.2)+(II-0), (I-39.2)+(II-1), (I-39.2)+(II-2), (I-39.2)+(II-3), (I-39.2)+(II-4), (I-39.2)+(II-5), (I-39.2)+(II-6), (I-39.2)+(II-9), (I-39.2)+(II-12), (I-39.2)+(III-1), (I-39.2)+(III-4), (I-39.2)+(III-10), (I-39.2)+(III-11), (I-39.2)+(IV-1), (I-39.2)+(IV-2), (I-39.2)+(IV-3), (I-39.2)+(IV-4), (I-39.2)+(IV-5), (I-39.2)+(b-1), (I-39.2)+(b-2), (I-39.2)+(b-3), (I-39.2)+(b-4), (I-39.2)+(b-5), (I-39.2)+(b-6), (I-39.2)+(b-7), (I-39.2)+(b-8), (I-39.2)+(b-9), (I-39.2)+(b-10), (I-39.2)+(b-11), (I-39.2)+(b-12), (I-39.2)+(b-13), (I-39.2)+(b-14), (I-39.2)+(S3-1), (I-39.2)+(S3-2), (I-39.2)+(S3-3), (I-39.2)+(S3-4), (I-39.2)+(S3-5), (I-39.2)+(h-1), (I-39.2)+(h-2), (I-39.2)+(V-1), (I-39.2)+(V-2), (I-39.2)+(V-3), (I-39.2)+(V-4), (I-39.2)+(V-5), (I-39.2)+(V-6), (I-39.2)+(IX-A1), (I-39.2)+(IX-A2), (I-39.2)+(IX-A3), and (I-39.2)+(IX-A4).

(I-39.3)+(II-0), (I-39.3)+(II-1), (I-39.3)+(II-2), (I-39.3)+(II-3), (I-39.3)+(II-4), (I-39.3)+(II-5), (I-39.3)+(II-6), (I-39.3)+(II-9), (I-39.3)+(II-12), (I-39.3)+(III-1), (I-39.3)+(III-4), (I-39.3)+(III-10), (I-39.3)+(III-11), (I-39.3)+(IV-1), (I-39.3)+(IV-2), (I-39.3)+(IV-3), (I-39.3)+(IV-4), (I-39.3)+(IV-5), (I-39.3)+(b-1), (I-39.3)+(b-2), (I-39.3)+(b-3), (I-39.3)+(b-4), (I-39.3)+(b-5), (I-39.3)+(b-6), (I-39.3)+(b-7), (I-39.3)+(b-8), (I-39.3)+(b-9), (I-39.3)+(b-10), (I-39.3)+(b-11), (I-39.3)+(b-12), (I-39.3)+(b-13), (I-39.3)+(b-14), (I-39.3)+(S3-1), (I-39.3)+(S3-2), (I-39.3)+(S3-3), (I-39.3)+(S3-4), (I-39.3)+(S3-5), (I-39.3)+(h-1), (I-39.3)+(h-2), (I-39.3)+(V-1), (I-39.3)+(V-2), (I-39.3)+(V-3), (I-39.3)+(V-4), (I-39.3)+(V-5), (I-39.3)+(V-6), (I-39.3)+(IX-A1), (I-39.3)+(IX-A2), (I-39.3)+(IX-A3), and (I-39.3)+(IX-A4).

(I-40.1)+(II-0), (I-40.1)+(II-1), (I-40.1)+(II-2), (I-40.1)+(II-3), (I-40.1)+(II-4), (I-40.1)+(II-5), (I-40.1)+(II-6), (I-40.1)+(II-9), (I-40.1)+(II-12), (I-40.1)+(III-1), (I-40.1)+(III-4), (I-40.1)+(III-10), (I-40.1)+(III-11), (I-40.1)+(IV-1), (I-40.1)+(IV-2), (I-40.1)+(IV-3), (I-40.1)+(IV-4), (I-40.1)+(IV-5), (I-40.1)+(b-1), (I-40.1)+(b-2), (I-40.1)+(b-3), (I-40.1)+(b-4), (I-40.1)+(b-5), (I-40.1)+(b-6), (I-40.1)+(b-7), (I-40.1)+(b-8), (I-40.1)+(b-9), (I-40.1)+(b-10), (I-40.1)+(b-11), (I-40.1)+(b-12), (I-40.1)+(b-13), (I-40.1)+(b-14), (I-40.1)+(S3-1), (I-40.1)+(S3-2), (I-40.1)+(S3-3), (I-40.1)+(S3-4), (I-40.1)+(S3-5), (I-40.1)+(h-1), (I-40.1)+(h-2), (I-40.1)+(V-1), (I-40.1)+(V-2), (I-40.1)+(V-3), (I-40.1)+(V-4), (I-40.1)+(V-5), (I-40.1)+(V-6), (I-40.1)+(IX-A1), (I-40.1)+(IX-A2), (I-40.1)+(IX-A3), and (I-40.1)+(IX-A4).

(I-40.2)+(II-0), (I-40.2)+(II-1), (I-40.2)+(II-2), (I-40.2)+(II-3), (I-40.2)+(II-4), (I-40.2)+(II-5), (I-40.2)+(II-6), (I-40.2)+(II-9), (I-40.2)+(II-12), (I-40.2)+(III-1), (I-40.2)+(III-4), (I-40.2)+(III-10), (I-40.2)+(III-11), (I-40.2)+(IV-1), (I-40.2)+(IV-2), (I-40.2)+(IV-3), (I-40.2)+(IV-4), (I-40.2)+(IV-5), (I-40.2)+(b-1), (I-40.2)+(b-2), (I-40.2)+(b-3), (I-40.2)+(b-4), (I-40.2)+(b-5), (I-40.2)+(b-6), (I-40.2)+(b-7), (I-40.2)+(b-8), (I-40.2)+(b-9), (I-40.2)+(b-10), (I-40.2)+(b-11), (I-40.2)+(b-12), (I-40.2)+(b-13), (I-40.2)+(b-14), (I-40.2)+(S3-1), (I-40.2)+(S3-2), (I-40.2)+(S3-3), (I-40.2)+(S3-4), (I-40.2)+(S3-5), (I-40.2)+(h-1), (I-40.2)+(h-2), (I-40.2)+(V-1), (I-40.2)+(V-2), (I-40.2)+(V-3), (I-40.2)+(V-4), (I-40.2)+(V-5), (I-40.2)+(V-6), (I-40.2)+(IX-A1), (I-40.2)+(IX-A2), (I-40.2)+(IX-A3), and (I-40.2)+(IX-A4).

(I-40.3)+(II-0), (140.3)+(II-1), (I-40.3)+(II-2), (I-40.3)+(II-3), (I-40.3)+(II-4), (I-40.3)+(II-5), (I-40.3)+(II-6), (I-40.3)+(II-9), (I-40.3)+(II-12), (I-40.3)+(III-1), (I-40.3)+(III-4), (I-40.3)+(III-10), (I-40.3)+(III-11), (I-40.3)+(IV-1), (I-40.3)+(IV-2), (I-40.3)+(IV-3), (I-40.3)+(IV-4), (I-40.3)+(IV-5), (I-40.3)+(b-1), (I-40.3)+(b-2), (I-40.3)+(b-3), (I-40.3)+(b-4), (I-40.3)+(b-5), (I-40.3)+(b-6), (I-40.3)+(b-7), (I-40.3)+(b-8), (I-40.3)+(b-9), (I-40.3)+(b-10), (I-40.3)+(b-11), (I-40.3)+(b-12), (I-40.3)+(b-13), (I-40.3)+(b-14), (I-40.3)+(S3-1), (I-40.3)+(S3-2), (I-40.3)+(S3-3), (I-40.3)+(S3-4), (I-40.3)+(S3-5), (I-40.3)+(h-1), (I-40.3)+(h-2), (I-40.3)+(V-1), (I-40.3)+(V-2), (I-40.3)+(V-3), (I-40.3)+(V-4), (I-40.3)+(V-5), (I-40.3)+(V-6), (I-40.3)+(IX-A1), (I-40.3)+(IX-A2), (I-40.3)+(IX-A3), and (I-40.3)+(IX-A4).

(I-41.1)+(II-0), (I-41.1)+(II-1), (I-41.1)+(II-2), (I-41.1)+(II-3), (I-41.1)+(II-4), (I-41.1)+(II-5), (I-41.1)+(II-6), (I-41.1)+(II-9), (I-41.1)+(II-12), (I-41.1)+(III-1), (I-41.1)+(III-4), (I-41.1)+(III-10), (I-41.1)+(III-11), (I-41.1)+(IV-1), (I-41.1)+(IV-2), (I-41.1)+(IV-3), (I-41.1)+(IV-4), (I-41.1)+(IV-5), (I-41.1)+(b-1), (I-41.1)+(b-2), (I-41.1)+(b-3), (I-41.1)+(b-4), (I-41.1)+(b-5), (I-41.1)+(b-6), (I-41.1)+(b-7), (I-41.1)+(b-8), (I-41.1)+(b-9), (I-41.1)+(b-10), (I-41.1)+(b-11), (I-41.1)+(b-12), (I-41.1)+(b-13), (I-41.1)+(b-14), (I-41.1)+(S3-1), (I-41.1)+(S3-2), (I-41.1)+(S3-3), (I-41.1)+(S3-4), (I-41.1)+(S3-5), (I-41.1)+(h-1), (I-41.1)+(h-2), (I-41.1)+(V-1), (I-41.1)+(V-2), (I-41.1)+(V-3), (I-41.1)+(V-4), (I-41.1)+(V-5), (I-41.1)+(V-6), (I-41.1)+(IX-A1), (I-41.1)+(IX-A2), (I-41.1)+(IX-A3), and (I-41.1)+(IX-A4).

(I-41.2)+(II-0), (I-41.2)+(II-1), (I-41.2)+(II-2), (I-41.2)+(II-3), (I-41.2)+(II-4), (I-41.2)+(II-5), (I-41.2)+(II-6), (I-41.2)+(II-9), (I-41.2)+(II-12), (I-41.2)+(III-1), (I-41.2)+(III-4), (I-41.2)+(III-10), (I-41.2)+(III-11), (I-41.2)+(IV-1), (I-41.2)+(IV-2), (I-41.2)+(IV-3), (I-41.2)+(IV-4), (I-41.2)+(IV-5), (I-41.2)+(b-1), (I-41.2)+(b-2), (I-41.2)+(b-3), (I-41.2)+(b-4), (I-41.2)+(b-5), (I-41.2)+(b-6), (I-41.2)+(b-7), (I-41.2)+(b-8), (I-41.2)+(b-9), (I-41.2)+(b-10), (I-41.2)+(b-11), (I-41.2)+(b-12), (I-41.2)+(b-13), (I-41.2)+(b-14), (I-41.2)+(S3-1), (I-41.2)+(S3-2), (I-41.2)+(S3-3), (I-41.2)+(S3-4), (I-41.2)+(S3-5), (I-41.2)+(h-1), (I-41.2)+(h-2), (I-41.2)+(V-1), (I-41.2)+(V-2), (I-41.2)+(V-3), (I-41.2)+(V-4), (I-41.2)+(V-5), (I-41.2)+(V-6), (I-41.2)+(IX-A1), (I-41.2)+(IX-A2), (I-41.2)+(IX-A3), and (I-41.2)+(IX-A4).

(I-41.3)+(II-0), (I-41.3)+(II-1), (I-41.3)+(II-2), (I-41.3)+(II-3), (I-41.3)+(II-4), (I-41.3)+(II-5), (I-41.3)+(II-6), (I-41.3)+(II-9), (I-41.3)+(II-12), (I-41.3)+(III-1), (I-41.3)+(III-4), (I-41.3)+(III-10), (I-41.3)+(III-11), (I-41.3)+(IV-1), (I-41.3)+(IV-2), (I-41.3)+(IV-3), (I-41.3)+(IV-4), (I-41.3)+(IV-5), (I-41.3)+(b-1), (I-41.3)+(b-2), (I-41.3)+(b-3), (I-41.3)+(b-4), (I-41.3)+(b-5), (I-41.3)+(b-6), (I-41.3)+(b-7), (I-41.3)+(b-8), (I-41.3)+(b-9), (I-41.3)+(b-10), (I-41.3)+(b-11), (I-41.3)+(b-12), (I-41.3)+(b-13), (I-41.3)+(b-14), (I-41.3)+(S3-1), (I-41.3)+(S3-2), (I-41.3)+(S3-3), (I-41.3)+(S3-4), (I-41.3)+(S3-5), (I-41.3)+(h-1), (I-41.3)+(h-2), (I-41.3)+(V-1), (I-41.3)+(V-2), (I-41.3)+(V-3), (I-41.3)+(V-4), (I-41.3)+(V-5), (I-41.3)+(V-6), (I-41.3)+(IX-A1), (I-41.3)+(IX-A2), (I-41.3)+(IX-A3), and (I-41.3)+(IX-A4).

(I-42.1)+(II-0), (I-42.1)+(II-1), (I-42.1)+(II-2), (I-42.1)+(II-3), (I-42.1)+(II-4), (I-42.1)+(II-5), (I-42.1)+(II-6), (I-42.1)+(II-9), (I-42.1)+(II-12), (I-42.1)+(III-1), (I-42.1)+(III-4), (I-42.1)+(III-10), (I-42.1)+(III-11), (I-42.1)+(IV-1), (I-42.1)+(IV-2), (I-42.1)+(IV-3), (I-42.1)+(IV-4), (I-42.1)+(IV-5), (I-42.1)+(b-1), (I-42.1)+(b-2), (I-42.1)+(b-3), (I-42.1)+(b-4), (I-42.1)+(b-5), (I-42.1)+(b-6), (I-42.1)+(b-7), (I-42.1)+(b-8), (I-42.1)+(b-9), (I-42.1)+(b-10), (I-42.1)+(b-11), (I-42.1)+(b-12), (I-42.1)+(b-13), (I-42.1)+(b-14), (I-42.1)+(S3-1), (I-42.1)+(S3-2), (I-42.1)+(S3-3), (I-42.1)+(S3-4), (I-42.1)+(S3-5), (I-42.1)+(h-1), (I-42.1)+(h-2), (I-42.1)+(V-1), (I-42.1)+(V-2), (I-42.1)+(V-3), (I-42.1)+(V-4), (I-42.1)+(V-5), (I-42.1)+(V-6), (I-42.1)+(IX-A1), (I-42.1)+(IX-A2), (I-42.1)+(IX-A3), and (I-42.1)+(IX-A4).

(I-42.2)+(II-0), (I-42.2)+(II-1), (I-42.2)+(II-2), (I-42.2)+(II-3), (I-42.2)+(II-4), (I-42.2)+(II-5), (I-42.2)+(II-6), (I-42.2)+(II-9), (I-42.2)+(II-12), (I-42.2)+(III-1), (I-42.2)+(III-4), (I-42.2)+(III-10), (I-42.2)+(III-11), (I-42.2)+(IV-1), (I-42.2)+(IV-2), (I-42.2)+(IV-3), (I-42.2)+(IV-4), (I-42.2)+(IV-5), (I-42.2)+(b-1), (I-42.2)+(b-2), (I-42.2)+(b-3), (I-42.2)+(b-4), (I-42.2)+(b-5), (I-42.2)+(b-6), (I-42.2)+(b-7), (I-42.2)+(b-8), (I-42.2)+(b-9), (I-42.2)+(b-10), (I-42.2)+(b-11), (I-42.2)+(b-12), (I-42.2)+(b-13), (I-42.2)+(b-14), (I-42.2)+(S3-1), (I-42.2)+(S3-2), (I-42.2)+(S3-3), (I-42.2)+(S3-4), (I-42.2)+(S3-5), (I-42.2)+(h-1), (I-42.2)+(h-2), (I-42.2)+(V-1), (I-42.2)+(V-2), (I-42.2)+(V-3), (I-42.2)+(V-4), (I-42.2)+(V-5), (I-42.2)+(V-6), (I-42.2)+(IX-A1), (I-42.2)+(IX-A2), (I-42.2)+(IX-A3), and (I-42.2)+(IX-A4).

(I-42.3)+(II-0), (I-42.3)+(II-1), (I-42.3)+(II-2), (I-42.3)+(II-3), (I-42.3)+(II-4), (I-42.3)+(II-5), (I-42.3)+(II-6), (I-42.3)+(II-9), (I-42.3)+(II-12), (I-42.3)+(III-1), (I-42.3)+(III-4), (I-42.3)+(III-10), (I-42.3)+(III-11), (I-42.3)+(IV-1), (I-42.3)+(IV-2), (I-42.3)+(IV-3), (I-42.3)+(IV-4), (I-42.3)+(IV-5), (I-42.3)+(b-1), (I-42.3)+(b-2), (I-42.3)+(b-3), (I-42.3)+(b-4), (I-42.3)+(b-5), (I-42.3)+(b-6), (I-42.3)+(b-7), (I-42.3)+(b-8), (I-42.3)+(b-9), (I-42.3)+(b-10), (I-42.3)+(b-11), (I-42.3)+(b-12), (I-42.3)+(b-13), (I-42.3)+(b-14), (I-42.3)+(S3-1), (I-42.3)+(S3-2), (I-42.3)+(S3-3), (I-42.3)+(S3-4), (I-42.3)+(S3-5), (I-42.3)+(h-1), (I-42.3)+(h-2), (I-42.3)+(V-1), (I-42.3)+(V-2), (I-42.3)+(V-3), (I-42.3)+(V-4), (I-42.3)+(V-5), (I-42.3)+(V-6), (I-42.3)+(IX-A1), (I-42.3)+(IX-A2), (I-42.3)+(IX-A3), and (I-42.3)+(IX-A4).

(I-43.1)+(II-0), (I-43.1)+(II-1), (I-43.1)+(II-2), (I-43.1)+(II-3), (I-43.1)+(II-4), (I-43.1)+(II-5), (I-43.1)+(II-6), (I-43.1)+(II-9), (I-43.1)+(II-12), (I-43.1)+(III-1), (I-43.1)+(III-4), (I-43.1)+(III-10), (I-43.1)+(III-11), (I-43.1)+(IV-1), (I-43.1)+(IV-2), (I-43.1)+(IV-3), (I-43.1)+(IV-4), (I-43.1)+(IV-5), (I-43.1)+(b-1), (I-43.1)+(b-2), (I-43.1)+(b-3), (I-43.1)+(b-4), (I-43.1)+(b-5), (I-43.1)+(b-6), (I-43.1)+(b-7), (I-43.1)+(b-8), (I-43.1)+(b-9), (I-43.1)+(b-10), (I-43.1)+(b-11), (I-43.1)+(b-12), (I-43.1)+(b-13), (I-43.1)+(b-14), (I-43.1)+(S3-1), (I-43.1)+(S3-2), (I-43.1)+(S3-3), (I-43.1)+(S3-4), (I-43.1)+(S3-5), (I-43.1)+(h-1), (I-43.1)+(h-2), (I-43.1)+(V-1), (I-43.1)+(V-2), (I-43.1)+(V-3), (I-43.1)+(V-4), (I-43.1)+(V-5), (I-43.1)+(V-6), (I-43.1)+(IX-A1), (I-43.1)+(IX-A2), (I-43.1)+(IX-A3), and (I-43.1)+(IX-A4).

(I-43.2)+(II-0), (I-43.2)+(II-1), (I-43.2)+(II-2), (I-43.2)+(II-3), (I-43.2)+(II-4), (I-43.2)+(II-5), (I-43.2)+(II-6), (I-43.2)+(II-9), (I-43.2)+(II-12), (I-43.2)+(II-1), (I-43.2)+(III-4), (I-43.2)+(III-10), (I-43.2)+(III-11), (I-43.2)+(IV-1), (I-43.2)+(IV-2), (I-43.2)+(IV-3), (I-43.2)+(IV-4), (I-43.2)+(IV-5), (I-43.2)+(b-1), (I-43.2)+(b-2), (I-43.2)+(b-3), (I-43.2)+(b-4), (I-43.2)+(b-5), (I-43.2)+(b-6), (I-43.2)+(b-7), (I-43.2)+(b-8), (I-43.2)+(b-9), (I-43.2)+(b-10), (I-43.2)+(b-11), (I-43.2)+(b-12), (I-43.2)+(b-13), (I-43.2)+(b-14), (I-43.2)+(S3-1), (I-43.2)+(S3-2), (I-43.2)+(S3-3), (I-43.2)+(S3-4), (I-43.2)+(S3-5), (I-43.2)+(h-1), (I-43.2)+(h-2), (I-43.2)+(V-1), (I-43.2)+(V-2), (I-43.2)+(V-3), (I-43.2)+(V-4), (I-43.2)+(V-5), (I-43.2)+(V-6), (I-43.2)+(IX-A1), (I-43.2)+(IX-A2), (I-43.2)+(IX-A3), and (I-43.2)+(IX-A4).

(I-43.3)+(II-0), (I-43.3)+(II-1), (I-43.3)+(II-2), (I-43.3)+(II-3), (I-43.3)+(II-4), (I-43.3)+(II-5), (I-43.3)+(II-6), (I-43.3)+(II-9), (I-43.3)+(II-12), (I-43.3)+(III-1), (I-43.3)+(III-4), (I-43.3)+(III-10), (I-43.3)+(III-11), (I-43.3)+(IV-1), (I-43.3)+(IV-2), (I-43.3)+(IV-3), (I-43.3)+(IV-4), (I-43.3)+(IV-5), (I-43.3)+(b-1), (I-43.3)+(b-2), (I-43.3)+(b-3), (I-43.3)+(b-4), (I-43.3)+(b-5), (I-43.3)+(b-6), (I-43.3)+(b-7), (I-43.3)+(b-8), (I-43.3)+(b-9), (I-43.3)+(b-10), (I-43.3)+(b-11), (I-43.3)+(b-12), (I-43.3)+(b-13), (I-43.3)+(b-14), (I-43.3)+(S3-1), (I-43.3)+(S3-2), (I-43.3)+(S3-3), (I-43.3)+(S3-4), (I-43.3)+(S3-5), (I-43.3)+(h-1), (I-43.3)+(h-2), (I-43.3)+(V-1), (I-43.3)+(V-2), (I-43.3)+(V-3), (I-43.3)+(V-4), (I-43.3)+(V-5), (I-43.3)+(V-6), (I-43.3)+(IX-A1), (I-43.3)+(IX-A2), (I-43.3)+(IX-A3), and (I-43.3)+(IX-A4).

(I-44.1)+(II-0), (I-44.1)+(II-1), (I-44.1)+(II-2), (I-44.1)+(II-3), (I-44.1)+(II-4), (I-44.1)+(II-5), (I-44.1)+(II-6), (I-44.1)+(II-9), (I-44.1)+(II-12), (I-44.1)+(III-1), (I-44.1)+(III-4), (I-44.1)+(III-10), (I-44.1)+(III-11), (I-44.1)+(IV-1), (I-44.1)+(IV-2), (I-44.1)+(IV-3), (I-44.1)+(IV-4), (I-44.1)+(IV-5), (I-44.1)+(b-1), (I-44.1)+(b-2), (I-44.1)+(b-3), (I-44.1)+(b-4), (I-44.1)+(b-5), (I-44.1)+(b-6), (I-44.1)+(b-7), (I-44.1)+(b-8), (I-44.1)+(b-9), (I-44.1)+(b-10), (I-44.1)+(b-11), (I-44.1)+(b-12), (I-44.1)+(b-13), (I-44.1)+(b-14), (I-44.1)+(S3-1), (I-44.1)+(S3-2), (I-44.1)+(S3-3), (I-44.1)+(S3-4), (I-44.1)+(S3-5), (I-44.1)+(h-1), (I-44.1)+(h-2), (I-44.1)+(V-1), (I-44.1)+(V-2), (I-44.1)+(V-3), (I-44.1)+(V-4), (I-44.1)+(V-5), (I-44.1)+(V-6), (I-44.1)+(IX-A1), (I-44.1)+(IX-A2), (I-44.1)+(IX-A3), and (I-44.1)+(IX-A4).

(I-44.2)+(II-0), (I-44.2)+(II-1), (I-44.2)+(II-2), (I-44.2)+(II-3), (I-44.2)+(II-4), (I-44.2)+(II-5), (I-44.2)+(II-6), (I-44.2)+(II-9), (I-44.2)+(II-12), (I-44.2)+(III-1), (I-44.2)+(III-4), (I-44.2)+(III-10), (I-44.2)+(III-11), (I-44.2)+(IV-1), (I-44.2)+(IV-2), (I-44.2)+(IV-3), (I-44.2)+(IV-4), (I-44.2)+(IV-5), (I-44.2)+(b-1), (I-44.2)+(b-2), (I-44.2)+(b-3), (I-44.2)+(b-4), (I-44.2)+(b-5), (I-44.2)+(b-6), (I-44.2)+(b-7), (I-44.2)+(b-8), (I-44.2)+(b-9), (I-44.2)+(b-10), (I-44.2)+(b-11), (I-44.2)+(b-12), (I-44.2)+(b-13), (I-44.2)+(b-14), (I-44.2)+(S3-1), (I-44.2)+(S3-2), (I-44.2)+(S3-3), (I-44.2)+(S3-4), (I-44.2)+(S3-5), (I-44.2)+(h-1), (I-44.2)+(h-2), (I-44.2)+(V-1), (I-44.2)+(V-2), (I-44.2)+(V-3), (I-44.2)+(V-4), (I-44.2)+(V-5), (I-44.2)+(V-6), (I-44.2)+(IX-A1), (I-44.2)+(IX-A2), (I-44.2)+(IX-A3), and (I-44.2)+(IX-A4).

(I-44.3)+(II-0), (I-44.3)+(II-1), (I-44.3)+(II-2), (I-44.3)+(II-3), (I-44.3)+(II-4), (I-44.3)+(II-5), (I-44.3)+(II-6), (I-44.3)+(II-9), (I-44.3)+(II-12), (I-44.3)+(III-1), (I-44.3)+(III-4), (I-44.3)+(III-10), (I-44.3)+(III-11), (I-44.3)+(IV-1), (I-44.3)+(IV-2), (I-44.3)+(IV-3), (I-44.3)+(IV-4), (I-44.3)+(IV-5), (I-44.3)+(b-1), (I-44.3)+(b-2), (I-44.3)+(b-3), (I-44.3)+(b-4), (I-44.3)+(b-5), (I-44.3)+(b-6), (I-44.3)+(b-7), (I-44.3)+(b-8), (I-44.3)+(b-9), (I-44.3)+(b-10), (I-44.3)+(b-11), (I-44.3)+(b-12), (I-44.3)+(b-13), (I-44.3)+(b-14), (I-44.3)+(S3-1), (I-44.3)+(S3-2), (I-44.3)+(S3-3), (I-44.3)+(S3-4), (I-44.3)+(S3-5), (I-44.3)+(h-1), (I-44.3)+(h-2), (I-44.3)+(V-1), (I-44.3)+(V-2), (I-44.3)+(V-3), (I-44.3)+(V-4), (I-44.3)+(V-5), (I-44.3)+(V-6), (I-44.3)+(IX-A1), (I-44.3)+(IX-A2), (I-44.3)+(IX-A3), and (I-44.3)+(IX-A4).

(I-45.1)+(II-0), (I-45.1)+(II-1), (I-45.1)+(II-2), (I-45.1)+(II-3), (I-45.1)+(II-4), (I-45.1)+(II-5), (I-45.1)+(II-6), (I-45.1)+(II-9), (I-45.1)+(II-12), (I-45.1)+(III-1), (I-45.1)+(III-4), (I-45.1)+(III-10), (I-45.1)+(III-11), (I-45.1)+(IV-1), (I-45.1)+(IV-2), (I-45.1)+(IV-3), (I-45.1)+(IV-4), (I-45.1)+(IV-5), (I-45.1)+(b-1), (I-45.1)+(b-2), (I-45.1)+(b-3), (I-45.1)+(b-4), (I-45.1)+(b-5), (I-45.1)+(b-6), (I-45.1)+(b-7), (I-45.1)+(b-8), (I-45.1)+(b-9), (I-45.1)+(b-10), (I-45.1)+(b-11), (I-45.1)+(b-12), (I-45.1)+(b-13), (I-45.1)+(b-14), (I-45.1)+(S3-1), (I-45.1)+(S3-2), (I-45.1)+(S3-3), (I-45.1)+(S3-4), (I-45.1)+(S3-5), (I-45.1)+(h-1), (I-45.1)+(h-2), (I-45.1)+(V-1), (I-45.1)+(V-2), (I-45.1)+(V-3), (I-45.1)+(V-4), (I-45.1)+(V-5), (I-45.1)+(V-6), (I-45.1)+(IX-A1), (I-45.1)+(IX-A2), (I-45.1)+(IX-A3), and (I-45.1)+(IX-A4).

(I-45.2)+(II-0), (I-45.2)+(II-1), (I-45.2)+(II-2), (I-45.2)+(II-3), (I-45.2)+(II-4), (I-45.2)+(II-5), (I-45.2)+(II-6), (I-45.2)+(II-9), (I-45.2)+(II-12), (I-45.2)+(III-1), (I-45.2)+(III-4), (I-45.2)+(III-10), (I-45.2)+(III-11), (I-45.2)+(IV-1), (I-45.2)+(IV-2), (I-45.2)+(IV-3), (I-45.2)+(IV-4), (I-45.2)+(IV-5), (I-45.2)+(b-1), (I-45.2)+(b-2), (I-45.2)+(b-3), (I-45.2)+(b-4), (I-45.2)+(b-5), (I-45.2)+(b-6), (I-45.2)+(b-7), (I-45.2)+(b-8), (I-45.2)+(b-9), (I-45.2)+(b-10), (I-45.2)+(b-11), (I-45.2)+(b-12), (I-45.2)+(b-13), (I-45.2)+(b-14), (I-45.2)+(S3-1), (I-45.2)+(S3-2), (I-45.2)+(S3-3), (I-45.2)+(S3-4), (I-45.2)+(S3-5), (I-45.2)+(h-1), (I-45.2)+(h-2), (I-45.2)+(V-1), (I-45.2)+(V-2), (I-45.2)+(V-3), (I-45.2)+(V-4), (I-45.2)+(V-5), (I-45.2)+(V-6), (I-45.2)+(IX-A1), (I-45.2)+(IX-A2), (I-45.2)+(IX-A3), and (I-45.2)+(IX-A4).

(I-45.3)+(II-0), (I-45.3)+(II-1), (I-45.3)+(II-2), (I-45.3)+(II-3), (I-45.3)+(II-4), (I-45.3)+(II-5), (I-45.3)+(II-6), (I-45.3)+(II-9), (I-45.3)+(II-12), (I-45.3)+(III-1), (I-45.3)+(III-4), (I-45.3)+(III-10), (I-45.3)+(III-11), (I-45.3)+(IV-1), (I-45.3)+(IV-2), (I-45.3)+(IV-3), (I-45.3)+(IV-4), (I-45.3)+(IV-5), (I-45.3)+(b-1), (I-45.3)+(b-2), (I-45.3)+(b-3), (I-45.3)+(b-4), (I-45.3)+(b-5), (I-45.3)+(b-6), (I-45.3)+(b-7), (I-45.3)+(b-8), (I-45.3)+(b-9), (I-45.3)+(b-10), (I-45.3)+(b-11), (I-45.3)+(b-12), (I-45.3)+(b-13), (I-45.3)+(b-14), (I-45.3)+(S3-1), (I-45.3)+(S3-2), (I-45.3)+(S3-3), (I-45.3)+(S3-4), (I-45.3)+(S3-5), (I-45.3)+(h-1), (I-45.3)+(h-2), (I-45.3)+(V-1), (I-45.3)+(V-2), (I-45.3)+(V-3), (I-45.3)+(V-4), (I-45.3)+(V-5), (I-45.3)+(V-6), (I-45.3)+(IX-A1), (I-45.3)+(IX-A2), (I-45.3)+(IX-A3), and (I-45.3)+(IX-A4).

(I-46.1)+(II-0), (I-46.1)+(II-1), (I-46.1)+(II-2), (I-46.1)+(II-3), (I-46.1)+(II-4), (I-46.1)+(II-5), (I-46.1)+(II-6), (I-46.1)+(II-9), (I-46.1)+(II-12), (I-46.1)+(III-1), (I-46.1)+(III-4), (I-46.1)+(III-10), (I-46.1)+(III-11), (I-46.1)+(IV-1), (I-46.1)+(IV-2), (I-46.1)+(IV-3), (I-46.1)+(IV-4), (I-46.1)+(IV-5), (I-46.1)+(b-1), (I-46.1)+(b-2), (I-46.1)+(b-3), (I-46.1)+(b-4), (I-46.1)+(b-5), (I-46.1)+(b-6), (I-46.1)+(b-7), (I-46.1)+(b-8), (I-46.1)+(b-9), (I-46.1)+(b-10), (I-46.1)+(b-11), (I-46.1)+(b-12), (I-46.1)+(b-13), (I-46.1)+(b-14), (I-46.1)+(S3-1), (I-46.1)+(S3-2), (I-46.1)+(S3-3), (I-46.1)+(S3-4), (I-46.1)+(S3-5), (I-46.1)+(h-1), (I-46.1)+(h-2), (I-46.1)+(V-1), (I-46.1)+(V-2), (I-46.1)+(V-3), (I-46.1)+(V-4), (I-46.1)+(V-5), (I-46.1)+(V-6), (I-46.1)+(IX-A1), (I-46.1)+(IX-A2), (I-46.1)+(IX-A3), and (I-46.1)+(IX-A4).

(I-46.2)+(II-0), (I-46.2)+(II-1), (I-46.2)+(II-2), (I-46.2)+(II-3), (I-46.2)+(II-4), (I-46.2)+(II-5), (I-46.2)+(II-6), (I-46.2)+(II-9), (I-46.2)+(II-12), (I-46.2)+(III-1), (I-46.2)+(III-4), (I-46.2)+(III-10), (I-46.2)+(III-11), (I-46.2)+(IV-1), (I-46.2)+(IV-2), (I-46.2)+(IV-3), (I-46.2)+(IV-4), (I-46.2)+(IV-5), (I-46.2)+(b-1), (I-46.2)+(b-2), (I-46.2)+(b-3), (I-46.2)+(b-4), (I-46.2)+(b-5), (I-46.2)+(b-6), (I-46.2)+(b-7), (I-46.2)+(b-8), (I-46.2)+(b-9), (I-46.2)+(b-10), (I-46.2)+(b-11), (I-46.2)+(b-12), (I-46.2)+(b-13), (I-46.2)+(b-14), (I-46.2)+(S3-1), (I-46.2)+(S3-2), (I-46.2)+(S3-3), (I-46.2)+(S3-4), (I-46.2)+(S3-5), (I-46.2)+(h-1), (I-46.2)+(h-2), (I-46.2)+(V-1), (I-46.2)+(V-2), (I-46.2)+(V-3), (I-46.2)+(V-4), (I-46.2)+(V-5), (I-46.2)+(V-6), (I-46.2)+(IX-A1), (I-46.2)+(IX-A2), (I-46.2)+(IX-A3), and (I-46.2)+(IX-A4).

(I-46.3)+(II-0), (I-46.3)+(II-1), (I-46.3)+(II-2), (I-46.3)+(II-3), (I-46.3)+(II-4), (I-46.3)+(II-5), (I-46.3)+(II-6), (I-46.3)+(II-9), (I-46.3)+(II-12), (I-46.3)+(III-1), (I-46.3)+(III-4), (I-46.3)+(III-10), (I-46.3)+(III-11), (I-46.3)+(IV-1), (I-46.3)+(IV-2), (I-46.3)+(IV-3), (I-46.3)+(IV-4), (I-46.3)+(IV-5), (I-46.3)+(b-1), (I-46.3)+(b-2), (I-46.3)+(b-3), (I-46.3)+(b-4), (I-46.3)+(b-5), (I-46.3)+(b-6), (I-46.3)+(b-7), (I-46.3)+(b-8), (I-46.3)+(b-9), (I-46.3)+(b-10), (I-46.3)+(b-11), (I-46.3)+(b-12), (I-46.3)+(b-13), (I-46.3)+(b-14), (I-46.3)+(S3-1), (I-46.3)+(S3-2), (I-46.3)+(S3-3), (I-46.3)+(S3-4), (I-46.3)+(S3-5), (I-46.3)+(h-1), (I-46.3)+(h-2), (I-46.3)+(V-1), (I-46.3)+(V-2), (I-46.3)+(V-3), (I-46.3)+(V-4), (I-46.3)+(V-5), (I-46.3)+(V-6), (I-46.3)+(IX-A1), (I-46.3)+(IX-A2), (I-46.3)+(IX-A3), and (I-46.3)+(IX-A4).

(I-47.1)+(II-0), (I-47.1)+(II-1), (I-47.1)+(II-2), (I-47.1)+(II-3), (I-47.1)+(II-4), (I-47.1)+(II-5), (I-47.1)+(II-6), (I-47.1)+(II-9), (I-47.1)+(II-12), (I-47.1)+(III-1), (I-47.1)+(III-4), (I-47.1)+(III-10), (I-47.1)+(III-11), (I-47.1)+(IV-1), (I-47.1)+(IV-2), (I-47.1)+(IV-3), (I-47.1)+(IV-4), (I-47.1)+(IV-5), (I-47.1)+(b-1), (I-47.1)+(b-2), (I-47.1)+(b-3), (I-47.1)+(b-4), (I-47.1)+(b-5), (I-47.1)+(b-6), (I-47.1)+(b-7), (I-47.1)+(b-8), (I-47.1)+(b-9), (I-47.1)+(b-10), (I-47.1)+(b-11), (I-47.1)+(b-12), (I-47.1)+(b-13), (I-47.1)+(b-14), (I-47.1)+(S3-1), (I-47.1)+(S3-2), (I-47.1)+(S3-3), (I-47.1)+(S3-4), (I-47.1)+(S3-5), (I-47.1)+(h-1), (I-47.1)+(h-2), (I-47.1)+(V-1), (I-47.1)+(V-2), (I-47.1)+(V-3), (I-47.1)+(V-4), (I-47.1)+(V-5), (I-47.1)+(V-6), (I-47.1)+(IX-A1), (I-47.1)+(IX-A2), (I-47.1)+(IX-A3), and (I-47.1)+(IX-A4).

(I-47.2)+(II-0), (I-47.2)+(II-1), (I-47.2)+(II-2), (I-47.2)+(II-3), (I-47.2)+(II-4), (I-47.2)+(II-5), (I-47.2)+(II-6), (I-47.2)+(II-9), (I-47.2)+(II-12), (I-47.2)+(III-1), (I-47.2)+(III-4), (I-47.2)+(III-10), (I-47.2)+(III-11), (I-47.2)+(IV-1), (I-47.2)+(IV-2), (I-47.2)+(IV-3), (I-47.2)+(IV-4), (I-47.2)+(IV-5), (I-47.2)+(b-1), (I-47.2)+(b-2), (I-47.2)+(b-3), (I-47.2)+(b-4), (I-47.2)+(b-5), (I-47.2)+(b-6), (I-47.2)+(b-7), (I-47.2)+(b-8), (I-47.2)+(b-9), (I-47.2)+(b-10), (I-47.2)+(b-11), (I-47.2)+(b-12), (I-47.2)+(b-13), (I-47.2)+(b-14), (I-47.2)+(S3-1), (I-47.2)+(S3-2), (I-47.2)+(S3-3), (I-47.2)+(S3-4), (I-47.2)+(S3-5), (I-47.2)+(h-1), (I-47.2)+(h-2), (I-47.2)+(V-1), (I-47.2)+(V-2), (I-47.2)+(V-3), (I-47.2)+(V-4), (I-47.2)+(V-5), (I-47.2)+(V-6), (I-47.2)+(IX-A1), (I-47.2)+(IX-A2), (I-47.2)+(IX-A3), and (I-47.2)+(IX-A4).

(I-47.3)+(II-0), (I-47.3)+(II-1), (I-47.3)+(II-2), (I-47.3)+(II-3), (I-47.3)+(II-4), (I-47.3)+(II-5), (I-47.3)+(II-6), (I-47.3)+(II-9), (I-47.3)+(II-12), (I-47.3)+(III-1), (I-47.3)+(III-4), (I-47.3)+(III-10), (I-47.3)+(III-11), (I-47.3)+(IV-1), (I-47.3)+(IV-2), (I-47.3)+(IV-3), (I-47.3)+(IV-4), (I-47.3)+(IV-5), (I-47.3)+(b-1), (I-47.3)+(b-2), (I-47.3)+(b-3), (I-47.3)+(b-4), (I-47.3)+(b-5), (I-47.3)+(b-6), (I-47.3)+(b-7), (I-47.3)+(b-8), (I-47.3)+(b-9), (I-47.3)+(b-10), (I-47.3)+(b-11), (I-47.3)+(b-12), (I-47.3)+(b-13), (I-47.3)+(b-14), (I-47.3)+(S3-1), (I-47.3)+(S3-2), (I-47.3)+(S3-3), (I-47.3)+(S3-4), (I-47.3)+(S3-5), (I-47.3)+(h-1), (I-47.3)+(h-2), (I-47.3)+(V-1), (I-47.3)+(V-2), (I-47.3)+(V-3), (I-47.3)+(V-4), (I-47.3)+(V-5), (I-47.3)+(V-6), (I-47.3)+(IX-A1), (I-47.3)+(IX-A2), (I-47.3)+(IX-A3), and (I-47.3)+(IX-A4).

(I-48.1)+(II-0), (I-48.1)+(II-1), (I-48.1)+(II-2), (I-48.1)+(II-3), (I-48.1)+(II-4), (I-48.1)+(II-5), (I-48.1)+(II-6), (I-48.1)+(II-9), (I-48.1)+(II-12), (I-48.1)+(III-1), (I-48.1)+(III-4), (I-48.1)+(III-10), (I-48.1)+(III-11), (I-48.1)+(IV-1), (I-48.1)+(IV-2), (I-48.1)+(IV-3), (I-48.1)+(IV-4), (I-48.1)+(IV-5), (I-48.1)+(b-1), (I-48.1)+(b-2), (I-48.1)+(b-3), (I-48.1)+(b-4), (I-48.1)+(b-5), (I-48.1)+(b-6), (I-48.1)+(b-7), (I-48.1)+(b-8), (I-48.1)+(b-9), (I-48.1)+(b-10), (I-48.1)+(b-11), (I-48.1)+(b-12), (I-48.1)+(b-13), (I-48.1)+(b-14), (I-48.1)+(S3-1), (I-48.1)+(S3-2), (I-48.1)+(S3-3), (I-48.1)+(S3-4), (I-48.1)+(S3-5), (I-48.1)+(h-1), (I-48.1)+(h-2), (I-48.1)+(V-1), (I-48.1)+(V-2), (I-48.1)+(V-3), (I-48.1)+(V-4), (I-48.1)+(V-5), (I-48.1)+(V-6), (I-48.1)+(IX-A1), (I-48.1)+(IX-A2), (I-48.1)+(IX-A3), and (I-48.1)+(IX-A4).

(I-48.2)+(II-0), (I-48.2)+(II-1), (I-48.2)+(II-2), (I-48.2)+(II-3), (I-48.2)+(II-4), (I-48.2)+(II-5), (I-48.2)+(II-6), (I-48.2)+(II-9), (I-48.2)+(II-12), (I-48.2)+(II-1), (I-48.2)+(III-4), (I-48.2)+(III-10), (I-48.2)+(III-11), (I-48.2)+(IV-1), (I-48.2)+(IV-2), (I-48.2)+(IV-3), (I-48.2)+(IV-4), (I-48.2)+(IV-5), (I-48.2)+(b-1), (I-48.2)+(b-2), (I-48.2)+(b-3), (I-48.2)+(b-4), (I-48.2)+(b-5), (I-48.2)+(b-6), (I-48.2)+(b-7), (I-48.2)+(b-8), (I-48.2)+(b-9), (I-48.2)+(b-10), (I-48.2)+(b-11), (I-48.2)+(b-12), (I-48.2)+(b-13), (I-48.2)+(b-14), (I-48.2)+(S3-1), (I-48.2)+(S3-2), (I-48.2)+(S3-3), (I-48.2)+(S3-4), (I-48.2)+(S3-5), (I-48.2)+(h-1), (I-48.2)+(h-2), (I-48.2)+(V-1), (I-48.2)+(V-2), (I-48.2)+(V-3), (I-48.2)+(V-4), (I-48.2)+(V-5), (I-48.2)+(V-6), (I-48.2)+(IX-A1), (I-48.2)+(IX-A2), (I-48.2)+(IX-A3), and (I-48.2)+(IX-A4).

(I-48.3)+(II-0), (I-48.3)+(II-1), (I-48.3)+(II-2), (I-48.3)+(II-3), (I-48.3)+(II-4), (I-48.3)+(II-5), (I-48.3)+(II-6), (I-48.3)+(II-9), (I-48.3)+(II-12), (I-48.3)+(III-1), (I-48.3)+(III-4), (I-48.3)+(III-10), (I-48.3)+(III-11), (I-48.3)+(IV-1), (I-48.3)+(IV-2), (I-48.3)+(IV-3), (I-48.3)+(IV-4), (I-48.3)+(IV-5), (I-48.3)+(b-1), (I-48.3)+(b-2), (I-48.3)+(b-3), (I-48.3)+(b-4), (I-48.3)+(b-5), (I-48.3)+(b-6), (I-48.3)+(b-7), (I-48.3)+(b-8), (I-48.3)+(b-9), (I-48.3)+(b-10), (I-48.3)+(b-11), (I-48.3)+(b-12), (I-48.3)+(b-13), (I-48.3)+(b-14), (I-48.3)+(S3-1), (I-48.3)+(S3-2), (I-48.3)+(S3-3), (I-48.3)+(S3-4), (I-48.3)+(S3-5), (I-48.3)+(h-1), (I-48.3)+(h-2), (I-48.3)+(V-1), (I-48.3)+(V-2), (I-48.3)+(V-3), (I-48.3)+(V-4), (I-48.3)+(V-5), (I-48.3)+(V-6), (I-48.3)+(IX-A1), (I-48.3)+(IX-A2), (I-48.3)+(IX-A3), and (I-48.3)+(IX-A4).

(I-49.1)+(II-0), (I-49.1)+(II-1), (I-49.1)+(II-2), (I-49.1)+(II-3), (I-49.1)+(II-4), (I-49.1)+(II-5), (I-49.1)+(II-6), (I-49.1)+(II-9), (I-49.1)+(II-12), (I-49.1)+(III-1), (I-49.1)+(III-4), (I-49.1)+(III-10), (I-49.1)+(III-11), (I-49.1)+(IV-1), (I-49.1)+(IV-2), (I-49.1)+(IV-3), (I-49.1)+(IV-4), (I-49.1)+(IV-5), (I-49.1)+(b-1), (I-49.1)+(b-2), (I-49.1)+(b-3), (I-49.1)+(b-4), (I-49.1)+(b-5), (I-49.1)+(b-6), (I-49.1)+(b-7), (I-49.1)+(b-8), (I-49.1)+(b-9), (I-49.1)+(b-10), (I-49.1)+(b-11), (I-49.1)+(b-12), (I-49.1)+(b-13), (I-49.1)+(b-14), (I-49.1)+(S3-1), (I-49.1)+(S3-2), (I-49.1)+(S3-3), (I-49.1)+(S3-4), (I-49.1)+(S3-5), (I-49.1)+(h-1), (I-49.1)+(h-2), (I-49.1)+(V-1), (I-49.1)+(V-2), (I-49.1)+(V-3), (I-49.1)+(V-4), (I-49.1)+(V-5), (I-49.1)+(V-6), (I-49.1)+(IX-A1), (I-49.1)+(IX-A2), (I-49.1)+(IX-A3), and (I-49.1)+(IX-A4).

(I-49.2)+(II-0), (I-49.2)+(II-1), (I-49.2)+(II-2), (I-49.2)+(II-3), (I-49.2)+(II-4), (I-49.2)+(II-5), (I-49.2)+(II-6), (I-49.2)+(II-9), (I-49.2)+(II-12), (I-49.2)+(III-1), (I-49.2)+(III-4), (I-49.2)+(III-10), (I-49.2)+(III-11), (I-49.2)+(IV-1), (I-49.2)+(IV-2), (I-49.2)+(IV-3), (I-49.2)+(IV-4), (I-49.2)+(IV-5), (I-49.2)+(b-1), (I-49.2)+(b-2), (I-49.2)+(b-3), (I-49.2)+(b-4), (I-49.2)+(b-5), (I-49.2)+(b-6), (I-49.2)+(b-7), (I-49.2)+(b-8), (I-49.2)+(b-9), (I-49.2)+(b-10), (I-49.2)+(b-11), (I-49.2)+(b-12), (I-49.2)+(b-13), (I-49.2)+(b-14), (I-49.2)+(S3-1), (I-49.2)+(S3-2), (I-49.2)+(S3-3), (I-49.2)+(S3-4), (I-49.2)+(S3-5), (I-49.2)+(h-1), (I-49.2)+(h-2), (I-49.2)+(V-1), (I-49.2)+(V-2), (I-49.2)+(V-3), (I-49.2)+(V-4), (I-49.2)+(V-5), (I-49.2)+(V-6), (I-49.2)+(IX-A1), (I-49.2)+(IX-A2), (I-49.2)+(IX-A3), and (I-49.2)+(IX-A4).

(I-49.3)+(II-0), (I-49.3)+(II-1), (I-49.3)+(II-2), (I-49.3)+(II-3), (I-49.3)+(II-4), (I-49.3)+(II-5), (I-49.3)+(II-6), (I-49.3)+(II-9), (I-49.3)+(II-12), (I-49.3)+(III-1), (I-49.3)+(III-4), (I-49.3)+(III-10), (I-49.3)+(III-11), (I-49.3)+(IV-1), (I-49.3)+(IV-2), (I-49.3)+(IV-3), (I-49.3)+(IV-4), (I-49.3)+(IV-5), (I-49.3)+(b-1), (I-49.3)+(b-2), (I-49.3)+(b-3), (I-49.3)+(b-4), (I-49.3)+(b-5), (I-49.3)+(b-6), (I-49.3)+(b-7), (I-49.3)+(b-8), (I-49.3)+(b-9), (I-49.3)+(b-10), (I-49.3)+(b-11), (I-49.3)+(b-12), (I-49.3)+(b-13), (I-49.3)+(b-14), (I-49.3)+(S3-1), (I-49.3)+(S3-2), (I-49.3)+(S3-3), (I-49.3)+(S3-4), (I-49.3)+(S3-5), (I-49.3)+(h-1), (I-49.3)+(h-2), (I-49.3)+(V-1), (I-49.3)+(V-2), (I-49.3)+(V-3), (I-49.3)+(V-4), (I-49.3)+(V-5), (I-49.3)+(V-6), (I-49.3)+(IX-A1), (I-49.3)+(IX-A2), (I-49.3)+(IX-A3), and (I-49.3)+(IX-A4).

(I-50.1)+(II-0), (I-50.1)+(II-1), (I-50.1)+(II-2), (I-50.1)+(II-3), (I-50.1)+(II-4), (I-50.1)+(II-5), (I-50.1)+(II-6), (I-50.1)+(II-9), (I-50.1)+(II-12), (I-50.1)+(III-1), (I-50.1)+(III-4), (I-50.1)+(III-10), (I-50.1)+(III-11), (I-50.1)+(IV-1), (I-50.1)+(IV-2), (I-50.1)+(IV-3), (I-50.1)+(IV-4), (I-50.1)+(IV-5), (I-50.1)+(b-1), (I-50.1)+(b-2), (I-50.1)+(b-3), (I-50.1)+(b-4), (I-50.1)+(b-5), (I-50.1)+(b-6), (I-50.1)+(b-7), (I-50.1)+(b-8), (I-50.1)+(b-9), (I-50.1)+(b-10), (I-50.1)+(b-11), (I-50.1)+(b-12), (I-50.1)+(b-13), (I-50.1)+(b-14), (I-50.1)+(S3-1), (I-50.1)+(S3-2), (I-50.1)+(S3-3), (I-50.1)+(S3-4), (I-50.1)+(S3-5), (I-50.1)+(h-1), (I-50.1)+(h-2), (I-50.1)+(V-1), (I-50.1)+(V-2), (I-50.1)+(V-3), (I-50.1)+(V-4), (I-50.1)+(V-5), (I-50.1)+(V-6), (I-50.1)+(IX-A1), (I-50.1)+(IX-A2), (I-50.1)+(IX-A3), and (I-50.1)+(IX-A4).

(I-50.2)+(II-0), (I-50.2)+(II-1), (I-50.2)+(II-2), (I-50.2)+(II-3), (I-50.2)+(II-4), (I-50.2)+(II-5), (I-50.2)+(II-6), (I-50.2)+(II-9), (I-50.2)+(II-12), (I-50.2)+(II-1), (I-50.2)+(III-4), (I-50.2)+(III-10), (I-50.2)+(III-11), (I-50.2)+(IV-1), (I-50.2)+(IV-2), (I-50.2)+(IV-3), (I-50.2)+(IV-4), (I-50.2)+(IV-5), (I-50.2)+(b-1), (I-50.2)+(b-2), (I-50.2)+(b-3), (I-50.2)+(b-4), (I-50.2)+(b-5), (I-50.2)+(b-6), (I-50.2)+(b-7), (I-50.2)+(b-8), (I-50.2)+(b-9), (I-50.2)+(b-10), (I-50.2)+(b-11), (I-50.2)+(b-12), (I-50.2)+(b-13), (I-50.2)+(b-14), (I-50.2)+(S3-1), (I-50.2)+(S3-2), (I-50.2)+(S3-3), (I-50.2)+(S3-4), (I-50.2)+(S3-5), (I-50.2)+(h-1), (I-50.2)+(h-2), (I-50.2)+(V-1), (I-50.2)+(V-2), (I-50.2)+(V-3), (I-50.2)+(V-4), (I-50.2)+(V-5), (I-50.2)+(V-6), (I-50.2)+(IX-A1), (I-50.2)+(IX-A2), (I-50.2)+(IX-A3), and (I-50.2)+(IX-A4).

(I-50.3)+(II-0), (I-50.3)+(II-1), (I-50.3)+(II-2), (I-50.3)+(II-3), (I-50.3)+(II-4), (I-50.3)+(II-5), (I-50.3)+(II-6), (I-50.3)+(II-9), (I-50.3)+(II-12), (I-50.3)+(III-1), (I-50.3)+(III-4), (I-50.3)+(III-10), (I-50.3)+(III-11), (I-50.3)+(IV-1), (I-50.3)+(IV-2), (I-50.3)+(IV-3), (I-50.3)+(IV-4), (I-50.3)+(IV-5), (I-50.3)+(b-1), (I-50.3)+(b-2), (I-50.3)+(b-3), (I-50.3)+(b-4), (I-50.3)+(b-5), (I-50.3)+(b-6), (I-50.3)+(b-7), (I-50.3)+(b-8), (I-50.3)+(b-9), (I-50.3)+(b-10), (I-50.3)+(b-11), (I-50.3)+(b-12), (I-50.3)+(b-13), (I-50.3)+(b-14), (I-50.3)+(S3-1), (I-50.3)+(S3-2), (I-50.3)+(S3-3), (I-50.3)+(S3-4), (I-50.3)+(S3-5), (I-50.3)+(h-1), (I-50.3)+(h-2), (I-50.3)+(V-1), (I-50.3)+(V-2), (I-50.3)+(V-3), (I-50.3)+(V-4), (I-50.3)+(V-5), (I-50.3)+(V-6), (I-50.3)+(IX-A1), (I-50.3)+(IX-A2), (I-50.3)+(IX-A3), and (I-50.3)+(IX-A4).

(I-51.1)+(II-0), (I-51.1)+(II-1), (I-51.1)+(II-2), (I-51.1)+(II-3), (I-51.1)+(II-4), (I-51.1)+(II-5), (I-51.1)+(II-6), (I-51.1)+(II-9), (I-51.1)+(II-12), (I-51.1)+(III-1), (I-51.1)+(III-4), (I-51.1)+(III-10), (I-51.1)+(III-11), (I-51.1)+(IV-1), (I-51.1)+(IV-2), (I-51.1)+(IV-3), (I-51.1)+(IV-4), (I-51.1)+(IV-5), (I-51.1)+(b-1), (I-51.1)+(b-2), (I-51.1)+(b-3), (I-51.1)+(b-4), (I-51.1)+(b-5), (I-51.1)+(b-6), (I-51.1)+(b-7), (I-51.1)+(b-8), (I-51.1)+(b-9), (I-51.1)+(b-10), (I-51.1)+(b-11), (I-51.1)+(b-12), (I-51.1)+(b-13), (I-51.1)+(b-14), (I-51.1)+(S3-1), (I-51.1)+(S3-2), (I-51.1)+(S3-3), (I-51.1)+(S3-4), (I-51.1)+(S3-5), (I-51.1)+(h-1), (I-51.1)+(h-2), (I-51.1)+(V-1), (I-51.1)+(V-2), (I-51.1)+(V-3), (I-51.1)+(V-4), (I-51.1)+(V-5), (I-51.1)+(V-6), (I-51.1)+(IX-A1), (I-51.1)+(IX-A2), (I-51.1)+(IX-A3), and (I-51.1)+(IX-A4).

(I-51.2)+(II-0), (I-51.2)+(II-1), (I-51.2)+(II-2), (I-51.2)+(II-3), (I-51.2)+(II-4), (I-51.2)+(II-5), (I-51.2)+(II-6), (I-51.2)+(II-9), (I-51.2)+(II-12), (I-51.2)+(III-1), (I-51.2)+(III-4), (I-51.2)+(III-10), (I-51.2)+(III-11), (I-51.2)+(IV-1), (I-51.2)+(IV-2), (I-51.2)+(IV-3), (I-51.2)+(IV-4), (I-51.2)+(IV-5), (I-51.2)+(b-1), (I-51.2)+(b-2), (I-51.2)+(b-3), (I-51.2)+(b-4), (I-51.2)+(b-5), (I-51.2)+(b-6), (I-51.2)+(b-7), (I-51.2)+(b-8), (I-51.2)+(b-9), (I-51.2)+(b-10), (I-51.2)+(b-11), (I-51.2)+(b-12), (I-51.2)+(b-13), (I-51.2)+(b-14), (I-51.2)+(S3-1), (I-51.2)+(S3-2), (I-51.2)+(S3-3), (I-51.2)+(S3-4), (I-51.2)+(S3-5), (I-51.2)+(h-1), (I-51.2)+(h-2), (I-51.2)+(V-1), (I-51.2)+(V-2), (I-51.2)+(V-3), (I-51.2)+(V-4), (I-51.2)+(V-5), (I-51.2)+(V-6), (I-51.2)+(IX-A1), (I-51.2)+(IX-A2), (I-51.2)+(IX-A3), and (I-51.2)+(IX-A4).

(I-51.3)+(II-0), (I-51.3)+(II-1), (I-51.3)+(II-2), (I-51.3)+(II-3), (I-51.3)+(II-4), (I-51.3)+(II-5), (I-51.3)+(II-6), (I-51.3)+(II-9), (I-51.3)+(II-12), (I-51.3)+(III-1), (I-51.3)+(III-4), (I-51.3)+(III-10), (I-51.3)+(III-11), (I-51.3)+(IV-1), (I-51.3)+(IV-2), (I-51.3)+(IV-3), (I-51.3)+(IV-4), (I-51.3)+(IV-5), (I-51.3)+(b-1), (I-51.3)+(b-2), (I-51.3)+(b-3), (I-51.3)+(b-4), (I-51.3)+(b-5), (I-51.3)+(b-6), (I-51.3)+(b-7), (I-51.3)+(b-8), (I-51.3)+(b-9), (I-51.3)+(b-10), (I-51.3)+(b-11), (I-51.3)+(b-12), (I-51.3)+(b-13), (I-51.3)+(b-14), (I-51.3)+(S3-1), (I-51.3)+(S3-2), (I-51.3)+(S3-3), (I-51.3)+(S3-4), (I-51.3)+(S3-5), (I-51.3)+(h-1), (I-51.3)+(h-2), (I-51.3)+(V-1), (I-51.3)+(V-2), (I-51.3)+(V-3), (I-51.3)+(V-4), (I-51.3)+(V-5), (I-51.3)+(V-6), (I-51.3)+(IX-A1), (I-51.3)+(IX-A2), (I-51.3)+(IX-A3), and (I-51.3)+(IX-A4).

(I-52.1)+(II-0), (I-52.1)+(II-1), (I-52.1)+(II-2), (I-52.1)+(II-3), (I-52.1)+(II-4), (I-52.1)+(II-5), (I-52.1)+(II-6), (I-52.1)+(II-9), (I-52.1)+(II-12), (I-52.1)+(II-1), (I-52.1)+(III-4), (I-52.1)+(III-10), (I-52.1)+(III-11), (I-52.1)+(IV-1), (I-52.1)+(IV-2), (I-52.1)+(IV-3), (I-52.1)+(IV-4), (I-52.1)+(IV-5), (I-52.1)+(b-1), (I-52.1)+(b-2), (I-52.1)+(b-3), (I-52.1)+(b-4), (I-52.1)+(b-5), (I-52.1)+(b-6), (I-52.1)+(b-7), (I-52.1)+(b-8), (I-52.1)+(b-9), (I-52.1)+(b-10), (I-52.1)+(b-11), (I-52.1)+(b-12), (I-52.1)+(b-13), (I-52.1)+(b-14), (I-52.1)+(S3-1), (I-52.1)+(S3-2), (I-52.1)+(S3-3), (I-52.1)+(S3-4), (I-52.1)+(S3-5), (I-52.1)+(h-1), (I-52.1)+(h-2), (I-52.1)+(V-1), (I-52.1)+(V-2), (I-52.1)+(V-3), (I-52.1)+(V-4), (I-52.1)+(V-5), (I-52.1)+(V-6), (I-52.1)+(IX-A1), (I-52.1)+(IX-A2), (I-52.1)+(IX-A3), and (I-52.1)+(IX-A4).

(I-52.2)+(II-0), (I-52.2)+(II-1), (I-52.2)+(II-2), (I-52.2)+(II-3), (I-52.2)+(II-4), (I-52.2)+(II-5), (I-52.2)+(II-6), (I-52.2)+(II-9), (I-52.2)+(II-12), (I-52.2)+(III-1), (I-52.2)+(III-4), (I-52.2)+(III-10), (I-52.2)+(III-11), (I-52.2)+(IV-1), (I-52.2)+(IV-2), (I-52.2)+(IV-3), (I-52.2)+(IV-4), (I-52.2)+(IV-5), (I-52.2)+(b-1), (I-52.2)+(b-2), (I-52.2)+(b-3), (I-52.2)+(b-4), (I-52.2)+(b-5), (I-52.2)+(b-6), (I-52.2)+(b-7), (I-52.2)+(b-8), (I-52.2)+(b-9), (I-52.2)+(b-10), (I-52.2)+(b-11), (I-52.2)+(b-12), (I-52.2)+(b-13), (I-52.2)+(b-14), (I-52.2)+(S3-1), (I-52.2)+(S3-2), (I-52.2)+(S3-3), (I-52.2)+(S3-4), (I-52.2)+(S3-5), (I-52.2)+(h-1), (I-52.2)+(h-2), (I-52.2)+(V-1), (I-52.2)+(V-2), (I-52.2)+(V-3), (I-52.2)+(V-4), (I-52.2)+(V-5), (I-52.2)+(V-6), (I-52.2)+(IX-A1), (I-52.2)+(IX-A2), (I-52.2)+(IX-A3), and (I-52.2)+(IX-A4).

(I-52.3)+(II-0), (I-52.3)+(II-1), (I-52.3)+(II-2), (I-52.3)+(II-3), (I-52.3)+(II-4), (I-52.3)+(II-5), (I-52.3)+(II-6), (I-52.3)+(II-9), (I-52.3)+(II-12), (I-52.3)+(III-1), (I-52.3)+(III-4), (I-52.3)+(III-10), (I-52.3)+(III-11), (I-52.3)+(IV-1), (I-52.3)+(IV-2), (I-52.3)+(IV-3), (I-52.3)+(IV-4), (I-52.3)+(IV-5), (I-52.3)+(b-1), (I-52.3)+(b-2), (I-52.3)+(b-3), (I-52.3)+(b-4), (I-52.3)+(b-5), (I-52.3)+(b-6), (I-52.3)+(b-7), (I-52.3)+(b-8), (I-52.3)+(b-9), (I-52.3)+(b-10), (I-52.3)+(b-11), (I-52.3)+(b-12), (I-52.3)+(b-13), (I-52.3)+(b-14), (I-52.3)+(S3-1), (I-52.3)+(S3-2), (I-52.3)+(S3-3), (I-52.3)+(S3-4), (I-52.3)+(S3-5), (I-52.3)+(h-1), (I-52.3)+(h-2), (I-52.3)+(V-1), (I-52.3)+(V-2), (I-52.3)+(V-3), (I-52.3)+(V-4), (I-52.3)+(V-5), (I-52.3)+(V-6), (I-52.3)+(IX-A1), (I-52.3)+(IX-A2), (I-52.3)+(IX-A3), and (I-52.3)+(IX-A4).

(I-53.1)+(II-0), (I-53.1)+(II-1), (I-53.1)+(II-2), (I-53.1)+(II-3), (I-53.1)+(II-4), (I-53.1)+(II-5), (I-53.1)+(II-6), (I-53.1)+(II-9), (I-53.1)+(II-12), (I-53.1)+(III-1), (I-53.1)+(III-4), (I-53.1)+(III-10), (I-53.1)+(III-11), (I-53.1)+(IV-1), (I-53.1)+(IV-2), (I-53.1)+(IV-3), (I-53.1)+(IV-4), (I-53.1)+(IV-5), (I-53.1)+(b-1), (I-53.1)+(b-2), (I-53.1)+(b-3), (I-53.1)+(b-4), (I-53.1)+(b-5), (I-53.1)+(b-6), (I-53.1)+(b-7), (I-53.1)+(b-8), (I-53.1)+(b-9), (I-53.1)+(b-10), (I-53.1)+(b-11), (I-53.1)+(b-12), (I-53.1)+(b-13), (I-53.1)+(b-14), (I-53.1)+(S3-1), (I-53.1)+(S3-2), (I-53.1)+(S3-3), (I-53.1)+(S3-4), (I-53.1)+(S3-5), (I-53.1)+(h-1), (I-53.1)+(h-2), (I-53.1)+(V-1), (I-53.1)+(V-2), (I-53.1)+(V-3), (I-53.1)+(V-4), (I-53.1)+(V-5), (I-53.1)+(V-6), (I-53.1)+(IX-A1), (I-53.1)+(IX-A2), (I-53.1)+(IX-A3), and (I-53.1)+(IX-A4).

(I-53.2)+(II-0), (I-53.2)+(II-1), (I-53.2)+(II-2), (I-53.2)+(II-3), (I-53.2)+(II-4), (I-53.2)+(II-5), (I-53.2)+(II-6), (I-53.2)+(II-9), (I-53.2)+(II-12), (I-53.2)+(II-1), (I-53.2)+(III-4), (I-53.2)+(III-10), (I-53.2)+(III-11), (I-53.2)+(IV-1), (I-53.2)+(IV-2), (I-53.2)+(IV-3), (I-53.2)+(IV-4), (I-53.2)+(IV-5), (I-53.2)+(b-1), (I-53.2)+(b-2), (I-53.2)+(b-3), (I-53.2)+(b-4), (I-53.2)+(b-5), (I-53.2)+(b-6), (I-53.2)+(b-7), (I-53.2)+(b-8), (I-53.2)+(b-9), (I-53.2)+(b-10), (I-53.2)+(b-11), (I-53.2)+(b-12), (I-53.2)+(b-13), (I-53.2)+(b-14), (I-53.2)+(S3-1), (I-53.2)+(S3-2), (I-53.2)+(S3-3), (I-53.2)+(S3-4), (I-53.2)+(S3-5), (I-53.2)+(h-1), (I-53.2)+(h-2), (I-53.2)+(V-1), (I-53.2)+(V-2), (I-53.2)+(V-3), (I-53.2)+(V-4), (I-53.2)+(V-5), (I-53.2)+(V-6), (I-53.2)+(IX-A1), (I-53.2)+(IX-A2), (I-53.2)+(IX-A3), and (I-53.2)+(IX-A4).

(I-53.3)+(II-0), (I-53.3)+(II-1), (I-53.3)+(II-2), (I-53.3)+(II-3), (I-53.3)+(II-4), (I-53.3)+(II-5), (I-53.3)+(II-6), (I-53.3)+(II-9), (I-53.3)+(II-12), (I-53.3)+(III-1), (I-53.3)+(III-4), (I-53.3)+(III-10), (I-53.3)+(III-11), (I-53.3)+(IV-1), (I-53.3)+(IV-2), (I-53.3)+(IV-3), (I-53.3)+(IV-4), (I-53.3)+(IV-5), (I-53.3)+(b-1), (I-53.3)+(b-2), (I-53.3)+(b-3), (I-53.3)+(b-4), (I-53.3)+(b-5), (I-53.3)+(b-6), (I-53.3)+(b-7), (I-53.3)+(b-8), (I-53.3)+(b-9), (I-53.3)+(b-10), (I-53.3)+(b-11), (I-53.3)+(b-12), (I-53.3)+(b-13), (I-53.3)+(b-14), (I-53.3)+(S3-1), (I-53.3)+(S3-2), (I-53.3)+(S3-3), (I-53.3)+(S3-4), (I-53.3)+(S3-5), (I-53.3)+(h-1), (I-53.3)+(h-2), (I-53.3)+(V-1), (I-53.3)+(V-2), (I-53.3)+(V-3), (I-53.3)+(V-4), (I-53.3)+(V-5), (I-53.3)+(V-6), (I-53.3)+(IX-A1), (I-53.3)+(IX-A2), (I-53.3)+(IX-A3), and (I-53.3)+(IX-A4).

(I-54.1)+(II-0), (I-54.1)+(II-1), (I-54.1)+(II-2), (I-54.1)+(II-3), (I-54.1)+(II-4), (I-54.1)+(II-5), (I-54.1)+(II-6), (I-54.1)+(II-9), (I-54.1)+(II-12), (I-54.1)+(III-1), (I-54.1)+(III-4), (I-54.1)+(III-10), (I-54.1)+(III-11), (I-54.1)+(IV-1), (I-54.1)+(IV-2), (I-54.1)+(IV-3), (I-54.1)+(IV-4), (I-54.1)+(IV-5), (I-54.1)+(b-1), (I-54.1)+(b-2), (I-54.1)+(b-3), (I-54.1)+(b-4), (I-54.1)+(b-5), (I-54.1)+(b-6), (I-54.1)+(b-7), (I-54.1)+(b-8), (I-54.1)+(b-9), (I-54.1)+(b-10), (I-54.1)+(b-11), (I-54.1)+(b-12), (I-54.1)+(b-13), (I-54.1)+(b-14), (I-54.1)+(S3-1), (I-54.1)+(S3-2), (I-54.1)+(S3-3), (I-54.1)+(S3-4), (I-54.1)+(S3-5), (I-54.1)+(h-1), (I-54.1)+(h-2), (I-54.1)+(V-1), (I-54.1)+(V-2), (I-54.1)+(V-3), (I-54.1)+(V-4), (I-54.1)+(V-5), (I-54.1)+(V-6), (I-54.1)+(IX-A1), (I-54.1)+(IX-A2), (I-54.1)+(IX-A3), and (I-54.1)+(IX-A4).

(I-54.2)+(II-0), (I-54.2)+(II-1), (I-54.2)+(II-2), (I-54.2)+(II-3), (I-54.2)+(II-4), (I-54.2)+(II-5), (I-54.2)+(II-6), (I-54.2)+(II-9), (I-54.2)+(II-12), (I-54.2)+(III-1), (I-54.2)+(III-4), (I-54.2)+(III-10), (I-54.2)+(III-11), (I-54.2)+(IV-1), (I-54.2)+(IV-2), (I-54.2)+(IV-3), (I-54.2)+(IV-4), (I-54.2)+(IV-5), (I-54.2)+(b-1), (I-54.2)+(b-2), (I-54.2)+(b-3), (I-54.2)+(b-4), (I-54.2)+(b-5), (I-54.2)+(b-6), (I-54.2)+(b-7), (I-54.2)+(b-8), (I-54.2)+(b-9), (I-54.2)+(b-10), (I-54.2)+(b-11), (I-54.2)+(b-12), (I-54.2)+(b-13), (I-54.2)+(b-14), (I-54.2)+(S3-1), (I-54.2)+(S3-2), (I-54.2)+(S3-3), (I-54.2)+(S3-4), (I-54.2)+(S3-5), (I-54.2)+(h-1), (I-54.2)+(h-2), (I-54.2)+(V-1), (I-54.2)+(V-2), (I-54.2)+(V-3), (I-54.2)+(V-4), (I-54.2)+(V-5), (I-54.2)+(V-6), (I-54.2)+(IX-A1), (I-54.2)+(IX-A2), (I-54.2)+(IX-A3), and (I-54.2)+(IX-A4).

(I-54.3)+(II-0), (I-54.3)+(II-1), (I-54.3)+(II-2), (I-54.3)+(II-3), (I-54.3)+(II-4), (I-54.3)+(II-5), (I-54.3)+(II-6), (I-54.3)+(II-9), (I-54.3)+(II-12), (I-54.3)+(III-1), (I-54.3)+(III-4), (I-54.3)+(III-10), (I-54.3)+(III-11), (I-54.3)+(IV-1), (I-54.3)+(IV-2), (I-54.3)+(IV-3), (I-54.3)+(IV-4), (I-54.3)+(IV-5), (I-54.3)+(b-1), (I-54.3)+(b-2), (I-54.3)+(b-3), (I-54.3)+(b-4), (I-54.3)+(b-5), (I-54.3)+(b-6), (I-54.3)+(b-7), (I-54.3)+(b-8), (I-54.3)+(b-9), (I-54.3)+(b-10), (I-54.3)+(b-11), (I-54.3)+(b-12), (I-54.3)+(b-13), (I-54.3)+(b-14), (I-54.3)+(S3-1), (I-54.3)+(S3-2), (I-54.3)+(S3-3), (I-54.3)+(S3-4), (I-54.3)+(S3-5), (I-54.3)+(h-1), (I-54.3)+(h-2), (I-54.3)+(V-1), (I-54.3)+(V-2), (I-54.3)+(V-3), (I-54.3)+(V-4), (I-54.3)+(V-5), (I-54.3)+(V-6), (I-54.3)+(IX-A1), (I-54.3)+(IX-A2), (I-54.3)+(IX-A3), and (I-54.3)+(IX-A4).

(I-55.1)+(II-0), (I-55.1)+(II-1), (I-55.1)+(II-2), (I-55.1)+(II-3), (I-55.1)+(II-4), (I-55.1)+(II-5), (I-55.1)+(II-6), (I-55.1)+(II-9), (I-55.1)+(II-12), (I-55.1)+(III-1), (I-55.1)+(III-4), (I-55.1)+(III-10), (I-55.1)+(III-11), (I-55.1)+(IV-1), (I-55.1)+(IV-2), (I-55.1)+(IV-3), (I-55.1)+(IV-4), (I-55.1)+(IV-5), (I-55.1)+(b-1), (I-55.1)+(b-2), (I-55.1)+(b-3), (I-55.1)+(b-4), (I-55.1)+(b-5), (I-55.1)+(b-6), (I-55.1)+(b-7), (I-55.1)+(b-8), (I-55.1)+(b-9), (I-55.1)+(b-10), (I-55.1)+(b-11), (I-55.1)+(b-12), (I-55.1)+(b-13), (I-55.1)+(b-14), (I-55.1)+(S3-1), (I-55.1)+(S3-2), (I-55.1)+(S3-3), (I-55.1)+(S3-4), (I-55.1)+(S3-5), (I-55.1)+(h-1), (I-55.1)+(h-2), (I-55.1)+(V-1), (I-55.1)+(V-2), (I-55.1)+(V-3), (I-55.1)+(V-4), (I-55.1)+(V-5), (I-55.1)+(V-6), (I-55.1)+(IX-A1), (I-55.1)+(IX-A2), (I-55.1)+(IX-A3), and (I-55.1)+(IX-A4).

(I-55.2)+(II-0), (I-55.2)+(II-1), (I-55.2)+(II-2), (I-55.2)+(II-3), (I-55.2)+(II-4), (I-55.2)+(II-5), (I-55.2)+(II-6), (I-55.2)+(II-9), (I-55.2)+(II-12), (I-55.2)+(III-1), (I-55.2)+(III-4), (I-55.2)+(III-10), (I-55.2)+(III-11), (I-55.2)+(IV-1), (I-55.2)+(IV-2), (I-55.2)+(IV-3), (I-55.2)+(IV-4), (I-55.2)+(IV-5), (I-55.2)+(b-1), (I-55.2)+(b-2), (I-55.2)+(b-3), (I-55.2)+(b-4), (I-55.2)+(b-5), (I-55.2)+(b-6), (I-55.2)+(b-7), (I-55.2)+(b-8), (I-55.2)+(b-9), (I-55.2)+(b-10), (I-55.2)+(b-11), (I-55.2)+(b-12), (I-55.2)+(b-13), (I-55.2)+(b-14), (I-55.2)+(S3-1), (I-55.2)+(S3-2), (I-55.2)+(S3-3), (I-55.2)+(S3-4), (I-55.2)+(S3-5), (I-55.2)+(h-1), (I-55.2)+(h-2), (I-55.2)+(V-1), (I-55.2)+(V-2), (I-55.2)+(V-3), (I-55.2)+(V-4), (I-55.2)+(V-5), (I-55.2)+(V-6), (I-55.2)+(IX-A1), (I-55.2)+(IX-A2), (I-55.2)+(IX-A3), and (I-55.2)+(IX-A4).

(I-55.3)+(II-0), (I-55.3)+(II-1), (I-55.3)+(II-2), (I-55.3)+(II-3), (I-55.3)+(II-4), (I-55.3)+(II-5), (I-55.3)+(II-6), (I-55.3)+(II-9), (I-55.3)+(II-12), (I-55.3)+(III-1), (I-55.3)+(III-4), (I-55.3)+(III-10), (I-55.3)+(III-11), (I-55.3)+(IV-1), (I-55.3)+(IV-2), (I-55.3)+(IV-3), (I-55.3)+(IV-4), (I-55.3)+(IV-5), (I-55.3)+(b-1), (I-55.3)+(b-2), (I-55.3)+(b-3), (I-55.3)+(b-4), (I-55.3)+(b-5), (I-55.3)+(b-6), (I-55.3)+(b-7), (I-55.3)+(b-8), (I-55.3)+(b-9), (I-55.3)+(b-10), (I-55.3)+(b-11), (I-55.3)+(b-12), (I-55.3)+(b-13), (I-55.3)+(b-14), (I-55.3)+(S3-1), (I-55.3)+(S3-2), (I-55.3)+(S3-3), (I-55.3)+(S3-4), (I-55.3)+(S3-5), (I-55.3)+(h-1), (I-55.3)+(h-2), (I-55.3)+(V-1), (I-55.3)+(V-2), (I-55.3)+(V-3), (I-55.3)+(V-4), (I-55.3)+(V-5), (I-55.3)+(V-6), (I-55.3)+(IX-A1), (I-55.3)+(IX-A2), (I-55.3)+(IX-A3), and (I-55.3)+(IX-A4).

(I-56.1)+(II-0), (I-56.1)+(II-1), (I-56.1)+(II-2), (I-56.1)+(II-3), (I-56.1)+(II-4), (I-56.1)+(II-5), (I-56.1)+(II-6), (I-56.1)+(II-9), (I-56.1)+(II-12), (I-56.1)+(III-1), (I-56.1)+(III-4), (I-56.1)+(III-10), (I-56.1)+(III-11), (I-56.1)+(IV-1), (I-56.1)+(IV-2), (I-56.1)+(IV-3), (I-56.1)+(IV-4), (I-56.1)+(IV-5), (I-56.1)+(b-1), (I-56.1)+(b-2), (I-56.1)+(b-3), (I-56.1)+(b-4), (I-56.1)+(b-5), (I-56.1)+(b-6), (I-56.1)+(b-7), (I-56.1)+(b-8), (I-56.1)+(b-9), (I-56.1)+(b-10), (I-56.1)+(b-11), (I-56.1)+(b-12), (I-56.1)+(b-13), (I-56.1)+(b-14), (I-56.1)+(S3-1), (I-56.1)+(S3-2), (I-56.1)+(S3-3), (I-56.1)+(S3-4), (I-56.1)+(S3-5), (I-56.1)+(h-1), (I-56.1)+(h-2), (I-56.1)+(V-1), (I-56.1)+(V-2), (I-56.1)+(V-3), (I-56.1)+(V-4), (I-56.1)+(V-5), (I-56.1)+(V-6), (I-56.1)+(IX-A1), (I-56.1)+(IX-A2), (I-56.1)+(IX-A3), and (I-56.1)+(IX-A4).

(I-56.2)+(II-0), (I-56.2)+(II-1), (I-56.2)+(II-2), (I-56.2)+(II-3), (I-56.2)+(II-4), (I-56.2)+(II-5), (I-56.2)+(II-6), (I-56.2)+(II-9), (I-56.2)+(II-12), (I-56.2)+(III-1), (I-56.2)+(III-4), (I-56.2)+(III-10), (I-56.2)+(III-11), (I-56.2)+(IV-1), (I-56.2)+(IV-2), (I-56.2)+(IV-3), (I-56.2)+(IV-4), (I-56.2)+(IV-5), (I-56.2)+(b-1), (I-56.2)+(b-2), (I-56.2)+(b-3), (I-56.2)+(b-4), (I-56.2)+(b-5), (I-56.2)+(b-6), (I-56.2)+(b-7), (I-56.2)+(b-8), (I-56.2)+(b-9), (I-56.2)+(b-10), (I-56.2)+(b-11), (I-56.2)+(b-12), (I-56.2)+(b-13), (I-56.2)+(b-14), (I-56.2)+(S3-1), (I-56.2)+(S3-2), (I-56.2)+(S3-3), (I-56.2)+(S3-4), (I-56.2)+(S3-5), (I-56.2)+(h-1), (I-56.2)+(h-2), (I-56.2)+(V-1), (I-56.2)+(V-2), (I-56.2)+(V-3), (I-56.2)+(V-4), (I-56.2)+(V-5), (I-56.2)+(V-6), (I-56.2)+(IX-A1), (I-56.2)+(IX-A2), (I-56.2)+(IX-A3), and (I-56.2)+(IX-A4).

(I-56.3)+(II-0), (I-56.3)+(II-1), (I-56.3)+(II-2), (I-56.3)+(II-3), (I-56.3)+(II-4), (I-56.3)+(II-5), (I-56.3)+(II-6), (I-56.3)+(II-9), (I-56.3)+(II-12), (I-56.3)+(III-1), (I-56.3)+(III-4), (I-56.3)+(III-10), (I-56.3)+(III-11), (I-56.3)+(IV-1), (I-56.3)+(IV-2), (I-56.3)+(IV-3), (I-56.3)+(IV-4), (I-56.3)+(IV-5), (I-56.3)+(b-1), (I-56.3)+(b-2), (I-56.3)+(b-3), (I-56.3)+(b-4), (I-56.3)+(b-5), (I-56.3)+(b-6), (I-56.3)+(b-7), (I-56.3)+(b-8), (I-56.3)+(b-9), (I-56.3)+(b-10), (I-56.3)+(b-11), (I-56.3)+(b-12), (I-56.3)+(b-13), (I-56.3)+(b-14), (I-56.3)+(S3-1), (I-56.3)+(S3-2), (I-56.3)+(S3-3), (I-56.3)+(S3-4), (I-56.3)+(S3-5), (I-56.3)+(h-1), (I-56.3)+(h-2), (I-56.3)+(V-1), (I-56.3)+(V-2), (I-56.3)+(V-3), (I-56.3)+(V-4), (I-56.3)+(V-5), (I-56.3)+(V-6), (I-56.3)+(IX-A1), (I-56.3)+(IX-A2), (I-56.3)+(IX-A3), and (I-56.3)+(IX-A4).

(I-57.1)+(II-0), (I-57.1)+(II-1), (I-57.1)+(II-2), (I-57.1)+(II-3), (I-57.1)+(II-4), (I-57.1)+(II-5), (I-57.1)+(II-6), (I-57.1)+(II-9), (I-57.1)+(II-12), (I-57.1)+(III-1), (I-57.1)+(III-4), (I-57.1)+(III-10), (I-57.1)+(III-11), (I-57.1)+(IV-1), (I-57.1)+(IV-2), (I-57.1)+(IV-3), (I-57.1)+(IV-4), (I-57.1)+(IV-5), (I-57.1)+(b-1), (I-57.1)+(b-2), (I-57.1)+(b-3), (I-57.1)+(b-4), (I-57.1)+(b-5), (I-57.1)+(b-6), (I-57.1)+(b-7), (I-57.1)+(b-8), (I-57.1)+(b-9), (I-57.1)+(b-10), (I-57.1)+(b-11), (I-57.1)+(b-12), (I-57.1)+(b-13), (I-57.1)+(b-14), (I-57.1)+(S3-1), (I-57.1)+(S3-2), (I-57.1)+(S3-3), (I-57.1)+(S3-4), (I-57.1)+(S3-5), (I-57.1)+(h-1), (I-57.1)+(h-2), (I-57.1)+(V-1), (I-57.1)+(V-2), (I-57.1)+(V-3), (I-57.1)+(V-4), (I-57.1)+(V-5), (I-57.1)+(V-6), (I-57.1)+(IX-A1), (I-57.1)+(IX-A2), (I-57.1)+(IX-A3), and (I-57.1)+(IX-A4).

(I-57.2)+(II-0), (I-57.2)+(II-1), (I-57.2)+(II-2), (I-57.2)+(II-3), (I-57.2)+(II-4), (I-57.2)+(II-5), (I-57.2)+(II-6), (I-57.2)+(II-9), (I-57.2)+(II-12), (I-57.2)+(III-1), (I-57.2)+(III-4), (I-57.2)+(III-10), (I-57.2)+(III-11), (I-57.2)+(IV-1), (I-57.2)+(IV-2), (I-57.2)+(IV-3), (I-57.2)+(IV-4), (I-57.2)+(IV-5), (I-57.2)+(b-1), (I-57.2)+(b-2), (I-57.2)+(b-3), (I-57.2)+(b-4), (I-57.2)+(b-5), (I-57.2)+(b-6), (I-57.2)+(b-7), (I-57.2)+(b-8), (I-57.2)+(b-9), (I-57.2)+(b-10), (I-57.2)+(b-11), (I-57.2)+(b-12), (I-57.2)+(b-13), (I-57.2)+(b-14), (I-57.2)+(S3-1), (I-57.2)+(S3-2), (I-57.2)+(S3-3), (I-57.2)+(S3-4), (I-57.2)+(S3-5), (I-57.2)+(h-1), (I-57.2)+(h-2), (I-57.2)+(V-1), (I-57.2)+(V-2), (I-57.2)+(V-3), (I-57.2)+(V-4), (I-57.2)+(V-5), (I-57.2)+(V-6), (I-57.2)+(IX-A1), (I-57.2)+(IX-A2), (I-57.2)+(IX-A3), and (I-57.2)+(IX-A4).

(I-57.3)+(II-0), (I-57.3)+(II-1), (I-57.3)+(II-2), (I-57.3)+(II-3), (I-57.3)+(II-4), (I-57.3)+(II-5), (I-57.3)+(II-6), (I-57.3)+(II-9), (I-57.3)+(II-12), (I-57.3)+(III-1), (I-57.3)+(III-4), (I-57.3)+(III-10), (I-57.3)+(III-11), (I-57.3)+(IV-1), (I-57.3)+(IV-2), (I-57.3)+(IV-3), (I-57.3)+(IV-4), (I-57.3)+(IV-5), (I-57.3)+(b-1), (I-57.3)+(b-2), (I-57.3)+(b-3), (I-57.3)+(b-4), (I-57.3)+(b-5), (I-57.3)+(b-6), (I-57.3)+(b-7), (I-57.3)+(b-8), (I-57.3)+(b-9), (I-57.3)+(b-10), (I-57.3)+(b-11), (I-57.3)+(b-12), (I-57.3)+(b-13), (I-57.3)+(b-14), (I-57.3)+(S3-1), (I-57.3)+(S3-2), (I-57.3)+(S3-3), (I-57.3)+(S3-4), (I-57.3)+(S3-5), (I-57.3)+(h-1), (I-57.3)+(h-2), (I-57.3)+(V-1), (I-57.3)+(V-2), (I-57.3)+(V-3), (I-57.3)+(V-4), (I-57.3)+(V-5), (I-57.3)+(V-6), (I-57.3)+(IX-A1), (I-57.3)+(IX-A2), (I-57.3)+(IX-A3), and (I-57.3)+(IX-A4).

(I-58.1)+(II-0), (I-58.1)+(II-1), (I-58.1)+(II-2), (I-58.1)+(II-3), (I-58.1)+(II-4), (I-58.1)+(II-5), (I-58.1)+(II-6), (I-58.1)+(II-9), (I-58.1)+(II-12), (I-58.1)+(III-1), (I-58.1)+(III-4), (I-58.1)+(III-10), (I-58.1)+(III-11), (I-58.1)+(IV-1), (I-58.1)+(IV-2), (I-58.1)+(IV-3), (I-58.1)+(IV-4), (I-58.1)+(IV-5), (I-58.1)+(b-1), (I-58.1)+(b-2), (I-58.1)+(b-3), (I-58.1)+(b-4), (I-58.1)+(b-5), (I-58.1)+(b-6), (I-58.1)+(b-7), (I-58.1)+(b-8), (I-58.1)+(b-9), (I-58.1)+(b-10), (I-58.1)+(b-11), (I-58.1)+(b-12), (I-58.1)+(b-13), (I-58.1)+(b-14), (I-58.1)+(S3-1), (I-58.1)+(S3-2), (I-58.1)+(S3-3), (I-58.1)+(S3-4), (I-58.1)+(S3-5), (I-58.1)+(h-1), (I-58.1)+(h-2), (I-58.1)+(V-1), (I-58.1)+(V-2), (I-58.1)+(V-3), (I-58.1)+(V-4), (I-58.1)+(V-5), (I-58.1)+(V-6), (I-58.1)+(IX-A1), (I-58.1)+(IX-A2), (I-58.1)+(IX-A3), and (I-58.1)+(IX-A4).

(I-58.2)+(II-0), (I-58.2)+(II-1), (I-58.2)+(II-2), (I-58.2)+(II-3), (I-58.2)+(II-4), (I-58.2)+(II-5), (I-58.2)+(II-6), (I-58.2)+(II-9), (I-58.2)+(II-12), (I-58.2)+(III-1), (I-58.2)+(III-4), (I-58.2)+(III-10), (I-58.2)+(III-11), (I-58.2)+(IV-1), (I-58.2)+(IV-2), (I-58.2)+(IV-3), (I-58.2)+(IV-4), (I-58.2)+(IV-5), (I-58.2)+(b-1), (I-58.2)+(b-2), (I-58.2)+(b-3), (I-58.2)+(b-4), (I-58.2)+(b-5), (I-58.2)+(b-6), (I-58.2)+(b-7), (I-58.2)+(b-8), (I-58.2)+(b-9), (I-58.2)+(b-10), (I-58.2)+(b-11), (I-58.2)+(b-12), (I-58.2)+(b-13), (I-58.2)+(b-14), (I-58.2)+(S3-1), (I-58.2)+(S3-2), (I-58.2)+(S3-3), (I-58.2)+(S3-4), (I-58.2)+(S3-5), (I-58.2)+(h-1), (I-58.2)+(h-2), (I-58.2)+(V-1), (I-58.2)+(V-2), (I-58.2)+(V-3), (I-58.2)+(V-4), (I-58.2)+(V-5), (I-58.2)+(V-6), (I-58.2)+(IX-A1), (I-58.2)+(IX-A2), (I-58.2)+(IX-A3), and (I-58.2)+(IX-A4).

(I-58.3)+(II-0), (I-58.3)+(II-1), (I-58.3)+(II-2), (I-58.3)+(II-3), (I-58.3)+(II-4), (I-58.3)+(II-5), (I-58.3)+(II-6), (I-58.3)+(II-9), (I-58.3)+(II-12), (I-58.3)+(III-1), (I-58.3)+(III-4), (I-58.3)+(III-10), (I-58.3)+(III-11), (I-58.3)+(IV-1), (I-58.3)+(IV-2), (I-58.3)+(IV-3), (I-58.3)+(IV-4), (I-58.3)+(IV-5), (I-58.3)+(b-1), (I-58.3)+(b-2), (I-58.3)+(b-3), (I-58.3)+(b-4), (I-58.3)+(b-5), (I-58.3)+(b-6), (I-58.3)+(b-7), (I-58.3)+(b-8), (I-58.3)+(b-9), (I-58.3)+(b-10), (I-58.3)+(b-11), (I-58.3)+(b-12), (I-58.3)+(b-13), (I-58.3)+(b-14), (I-58.3)+(S3-1), (I-58.3)+(S3-2), (I-58.3)+(S3-3), (I-58.3)+(S3-4), (I-58.3)+(S3-5), (I-58.3)+(h-1), (I-58.3)+(h-2), (I-58.3)+(V-1), (I-58.3)+(V-2), (I-58.3)+(V-3), (I-58.3)+(V-4), (I-58.3)+(V-5), (I-58.3)+(V-6), (I-58.3)+(IX-A1), (I-58.3)+(IX-A2), (I-58.3)+(IX-A3), and (I-58.3)+(IX-A4).

(I-59.1)+(II-0), (I-59.1)+(II-1), (I-59.1)+(II-2), (I-59.1)+(II-3), (I-59.1)+(II-4), (I-59.1)+(II-5), (I-59.1)+(II-6), (I-59.1)+(II-9), (I-59.1)+(II-12), (I-59.1)+(III-1), (I-59.1)+(III-4), (I-59.1)+(III-10), (I-59.1)+(III-11), (I-59.1)+(IV-1), (I-59.1)+(IV-2), (I-59.1)+(IV-3), (I-59.1)+(IV-4), (I-59.1)+(IV-5), (I-59.1)+(b-1), (I-59.1)+(b-2), (I-59.1)+(b-3), (I-59.1)+(b-4), (I-59.1)+(b-5), (I-59.1)+(b-6), (I-59.1)+(b-7), (I-59.1)+(b-8), (I-59.1)+(b-9), (I-59.1)+(b-10), (I-59.1)+(b-11), (I-59.1)+(b-12), (I-59.1)+(b-13), (I-59.1)+(b-14), (I-59.1)+(S3-1), (I-59.1)+(S3-2), (I-59.1)+(S3-3), (I-59.1)+(S3-4), (I-59.1)+(S3-5), (I-59.1)+(h-1), (I-59.1)+(h-2), (I-59.1)+(V-1), (I-59.1)+(V-2), (I-59.1)+(V-3), (I-59.1)+(V-4), (I-59.1)+(V-5), (I-59.1)+(V-6), (I-59.1)+(IX-A1), (I-59.1)+(IX-A2), (I-59.1)+(IX-A3), and (I-59.1)+(IX-A4).

(I-59.2)+(II-0), (I-59.2)+(II-1), (I-59.2)+(II-2), (I-59.2)+(II-3), (I-59.2)+(II-4), (I-59.2)+(II-5), (I-59.2)+(II-6), (I-59.2)+(II-9), (I-59.2)+(II-12), (I-59.2)+(III-1), (I-59.2)+(III-4), (I-59.2)+(III-10), (I-59.2)+(III-11), (I-59.2)+(IV-1), (I-59.2)+(IV-2), (I-59.2)+(IV-3), (I-59.2)+(IV-4), (I-59.2)+(IV-5), (I-59.2)+(b-1), (I-59.2)+(b-2), (I-59.2)+(b-3), (I-59.2)+(b-4), (I-59.2)+(b-5), (I-59.2)+(b-6), (I-59.2)+(b-7), (I-59.2)+(b-8), (I-59.2)+(b-9), (I-59.2)+(b-10), (I-59.2)+(b-11), (I-59.2)+(b-12), (I-59.2)+(b-13), (I-59.2)+(b-14), (I-59.2)+(S3-1), (I-59.2)+(S3-2), (I-59.2)+(S3-3), (I-59.2)+(S3-4), (I-59.2)+(S3-5), (I-59.2)+(h-1), (I-59.2)+(h-2), (I-59.2)+(V-1), (I-59.2)+(V-2), (I-59.2)+(V-3), (I-59.2)+(V-4), (I-59.2)+(V-5), (I-59.2)+(V-6), (I-59.2)+(IX-A1), (I-59.2)+(IX-A2), (I-59.2)+(IX-A3), and (I-59.2)+(IX-A4).

(I-59.3)+(II-0), (I-59.3)+(II-1), (I-59.3)+(II-2), (I-59.3)+(II-3), (I-59.3)+(II-4), (I-59.3)+(II-5), (I-59.3)+(II-6), (I-59.3)+(II-9), (I-59.3)+(II-12), (I-59.3)+(II-1), (I-59.3)+(III-4), (I-59.3)+(III-10), (I-59.3)+(III-11), (I-59.3)+(IV-1), (I-59.3)+(IV-2), (I-59.3)+(IV-3), (I-59.3)+(IV-4), (I-59.3)+(IV-5), (I-59.3)+(b-1), (I-59.3)+(b-2), (I-59.3)+(b-3), (I-59.3)+(b-4), (I-59.3)+(b-5), (I-59.3)+(b-6), (I-59.3)+(b-7), (I-59.3)+(b-8), (I-59.3)+(b-9), (I-59.3)+(b-10), (I-59.3)+(b-11), (I-59.3)+(b-12), (I-59.3)+(b-13), (I-59.3)+(b-14), (I-59.3)+(S3-1), (I-59.3)+(S3-2), (I-59.3)+(S3-3), (I-59.3)+(S3-4), (I-59.3)+(S3-5), (I-59.3)+(h-1), (I-59.3)+(h-2), (I-59.3)+(V-1), (I-59.3)+(V-2), (I-59.3)+(V-3), (I-59.3)+(V-4), (I-59.3)+(V-5), (I-59.3)+(V-6), (I-59.3)+(IX-A1), (I-59.3)+(IX-A2), (I-59.3)+(IX-A3), and (I-59.3)+(IX-A4).

(I-60.1)+(II-0), (I-60.1)+(II-1), (I-60.1)+(II-2), (I-60.1)+(II-3), (I-60.1)+(II-4), (I-60.1)+(II-5), (I-60.1)+(II-6), (I-60.1)+(II-9), (I-60.1)+(II-12), (I-60.1)+(III-1), (I-60.1)+(III-4), (I-60.1)+(III-10), (I-60.1)+(III-11), (I-60.1)+(IV-1), (I-60.1)+(IV-2), (I-60.1)+(IV-3), (I-60.1)+(IV-4), (I-60.1)+(IV-5), (I-60.1)+(b-1), (I-60.1)+(b-2), (I-60.1)+(b-3), (I-60.1)+(b-4), (I-60.1)+(b-5), (I-60.1)+(b-6), (I-60.1)+(b-7), (I-60.1)+(b-8), (I-60.1)+(b-9), (I-60.1)+(b-10), (I-60.1)+(b-11), (I-60.1)+(b-12), (I-60.1)+(b-13), (I-60.1)+(b-14), (I-60.1)+(S3-1), (I-60.1)+(S3-2), (I-60.1)+(S3-3), (I-60.1)+(S3-4), (I-60.1)+(S3-5), (I-60.1)+(h-1), (I-60.1)+(h-2), (I-60.1)+(V-1), (I-60.1)+(V-2), (I-60.1)+(V-3), (I-60.1)+(V-4), (I-60.1)+(V-5), (I-60.1)+(V-6), (I-60.1)+(IX-A1), (I-60.1)+(IX-A2), (I-60.1)+(IX-A3), and (I-60.1)+(IX-A4).

(I-60.2)+(II-0), (I-60.2)+(II-1), (I-60.2)+(II-2), (I-60.2)+(II-3), (I-60.2)+(II-4), (I-60.2)+(II-5), (I-60.2)+(II-6), (I-60.2)+(II-9), (I-60.2)+(II-12), (I-60.2)+(III-1), (I-60.2)+(III-4), (I-60.2)+(III-10), (I-60.2)+(III-11), (I-60.2)+(IV-1), (I-60.2)+(IV-2), (I-60.2)+(IV-3), (I-60.2)+(IV-4), (I-60.2)+(IV-5), (I-60.2)+(b-1), (I-60.2)+(b-2), (I-60.2)+(b-3), (I-60.2)+(b-4), (I-60.2)+(b-5), (I-60.2)+(b-6), (I-60.2)+(b-7), (I-60.2)+(b-8), (I-60.2)+(b-9), (I-60.2)+(b-10), (I-60.2)+(b-11), (I-60.2)+(b-12), (I-60.2)+(b-13), (I-60.2)+(b-14), (I-60.2)+(S3-1), (I-60.2)+(S3-2), (I-60.2)+(S3-3), (I-60.2)+(S3-4), (I-60.2)+(S3-5), (I-60.2)+(h-1), (I-60.2)+(h-2), (I-60.2)+(V-1), (I-60.2)+(V-2), (I-60.2)+(V-3), (I-60.2)+(V-4), (I-60.2)+(V-5), (I-60.2)+(V-6), (I-60.2)+(IX-A1), (I-60.2)+(IX-A2), (I-60.2)+(IX-A3), and (I-60.2)+(IX-A4).

(I-60.3)+(II-0), (I-60.3)+(II-1), (I-60.3)+(II-2), (I-60.3)+(II-3), (I-60.3)+(II-4), (I-60.3)+(II-5), (I-60.3)+(II-6), (I-60.3)+(II-9), (I-60.3)+(II-12), (I-60.3)+(II-1), (I-60.3)+(III-4), (I-60.3)+(III-10), (I-60.3)+(III-11), (I-60.3)+(IV-1), (I-60.3)+(IV-2), (I-60.3)+(IV-3), (I-60.3)+(IV-4), (I-60.3)+(IV-5), (I-60.3)+(b-1), (I-60.3)+(b-2), (I-60.3)+(b-3), (I-60.3)+(b-4), (I-60.3)+(b-5), (I-60.3)+(b-6), (I-60.3)+(b-7), (I-60.3)+(b-8), (I-60.3)+(b-9), (I-60.3)+(b-10), (I-60.3)+(b-11), (I-60.3)+(b-12), (I-60.3)+(b-13), (I-60.3)+(b-14), (I-60.3)+(S3-1), (I-60.3)+(S3-2), (I-60.3)+(S3-3), (I-60.3)+(S3-4), (I-60.3)+(S3-5), (I-60.3)+(h-1), (I-60.3)+(h-2), (I-60.3)+(V-1), (I-60.3)+(V-2), (I-60.3)+(V-3), (I-60.3)+(V-4), (I-60.3)+(V-5), (I-60.3)+(V-6), (I-60.3)+(IX-A1), (I-60.3)+(IX-A2), (I-60.3)+(IX-A3), and (I-60.3)+(IX-A4).

(I-61.1)+(II-0), (I-61.1)+(II-1), (I-61.1)+(II-2), (I-61.1)+(II-3), (I-61.1)+(II-4), (I-61.1)+(II-5), (I-61.1)+(II-6), (I-61.1)+(II-9), (I-61.1)+(II-12), (I-61.1)+(III-1), (I-61.1)+(III-4), (I-61.1)+(III-10), (I-61.1)+(III-11), (I-61.1)+(IV-1), (I-61.1)+(IV-2), (I-61.1)+(IV-3), (I-61.1)+(IV-4), (I-61.1)+(IV-5), (I-61.1)+(b-1), (I-61.1)+(b-2), (I-61.1)+(b-3), (I-61.1)+(b-4), (I-61.1)+(b-5), (I-61.1)+(b-6), (I-61.1)+(b-7), (I-61.1)+(b-8), (I-61.1)+(b-9), (I-61.1)+(b-10), (I-61.1)+(b-11), (I-61.1)+(b-12), (I-61.1)+(b-13), (I-61.1)+(b-14), (I-61.1)+(S3-1), (I-61.1)+(S3-2), (I-61.1)+(S3-3), (I-61.1)+(S3-4), (I-61.1)+(S3-5), (I-61.1)+(h-1), (I-61.1)+(h-2), (I-61.1)+(V-1), (I-61.1)+(V-2), (I-61.1)+(V-3), (I-61.1)+(V-4), (I-61.1)+(V-5), (I-61.1)+(V-6), (I-61.1)+(IX-A1), (I-61.1)+(IX-A2), (I-61.1)+(IX-A3), and (I-61.1)+(IX-A4).

(I-61.2)+(II-0), (I-61.2)+(II-1), (I-61.2)+(II-2), (I-61.2)+(II-3), (I-61.2)+(II-4), (I-61.2)+(II-5), (I-61.2)+(II-6), (I-61.2)+(II-9), (I-61.2)+(II-12), (I-61.2)+(II-1), (I-61.2)+(III-4), (I-61.2)+(III-10), (I-61.2)+(III-11), (I-61.2)+(IV-1), (I-61.2)+(IV-2), (I-61.2)+(IV-3), (I-61.2)+(IV-4), (I-61.2)+(IV-5), (I-61.2)+(b-1), (I-61.2)+(b-2), (I-61.2)+(b-3), (I-61.2)+(b-4), (I-61.2)+(b-5), (I-61.2)+(b-6), (I-61.2)+(b-7), (I-61.2)+(b-8), (I-61.2)+(b-9), (I-61.2)+(b-10), (I-61.2)+(b-11), (I-61.2)+(b-12), (I-61.2)+(b-13), (I-61.2)+(b-14), (I-61.2)+(S3-1), (I-61.2)+(S3-2), (I-61.2)+(S3-3), (I-61.2)+(S3-4), (I-61.2)+(S3-5), (I-61.2)+(h-1), (I-61.2)+(h-2), (I-61.2)+(V-1), (I-61.2)+(V-2), (I-61.2)+(V-3), (I-61.2)+(V-4), (I-61.2)+(V-5), (I-61.2)+(V-6), (I-61.2)+(IX-A1), (I-61.2)+(IX-A2), (I-61.2)+(IX-A3), and (I-61.2)+(IX-A4).

(I-61.3)+(II-0), (I-61.3)+(II-1), (I-61.3)+(II-2), (I-61.3)+(II-3), (I-61.3)+(II-4), (I-61.3)+(II-5), (I-61.3)+(II-6), (I-61.3)+(II-9), (I-61.3)+(II-12), (I-61.3)+(III-1), (I-61.3)+(III-4), (I-61.3)+(III-10), (I-61.3)+(III-11), (I-61.3)+(IV-1), (I-61.3)+(IV-2), (I-61.3)+(IV-3), (I-61.3)+(IV-4), (I-61.3)+(IV-5), (I-61.3)+(b-1), (I-61.3)+(b-2), (I-61.3)+(b-3), (I-61.3)+(b-4), (I-61.3)+(b-5), (I-61.3)+(b-6), (I-61.3)+(b-7), (I-61.3)+(b-8), (I-61.3)+(b-9), (I-61.3)+(b-10), (I-61.3)+(b-11), (I-61.3)+(b-12), (I-61.3)+(b-13), (I-61.3)+(b-14), (I-61.3)+(S3-1), (I-61.3)+(S3-2), (I-61.3)+(S3-3), (I-61.3)+(S3-4), (I-61.3)+(S3-5), (I-61.3)+(h-1), (I-61.3)+(h-2), (I-61.3)+(V-1), (I-61.3)+(V-2), (I-61.3)+(V-3), (I-61.3)+(V-4), (I-61.3)+(V-5), (I-61.3)+(V-6), (I-61.3)+(IX-A1), (I-61.3)+(IX-A2), (I-61.3)+(IX-A3), and (I-61.3)+(IX-A4).

(I-62.1)+(II-0), (I-62.1)+(II-1), (I-62.1)+(II-2), (I-62.1)+(II-3), (I-62.1)+(II-4), (I-62.1)+(II-5), (I-62.1)+(II-6), (I-62.1)+(II-9), (I-62.1)+(II-12), (I-62.1)+(III-1), (I-62.1)+(III-4), (I-62.1)+(III-10), (I-62.1)+(III-11), (I-62.1)+(IV-1), (I-62.1)+(IV-2), (I-62.1)+(IV-3), (I-62.1)+(IV-4), (I-62.1)+(IV-5), (I-62.1)+(b-1), (I-62.1)+(b-2), (I-62.1)+(b-3), (I-62.1)+(b-4), (I-62.1)+(b-5), (I-62.1)+(b-6), (I-62.1)+(b-7), (I-62.1)+(b-8), (I-62.1)+(b-9), (I-62.1)+(b-10), (I-62.1)+(b-11), (I-62.1)+(b-12), (I-62.1)+(b-13), (I-62.1)+(b-14), (I-62.1)+(S3-1), (I-62.1)+(S3-2), (I-62.1)+(S3-3), (I-62.1)+(S3-4), (I-62.1)+(S3-5), (I-62.1)+(h-1), (I-62.1)+(h-2), (I-62.1)+(V-1), (I-62.1)+(V-2), (I-62.1)+(V-3), (I-62.1)+(V-4), (I-62.1)+(V-5), (I-62.1)+(V-6), (I-62.1)+(IX-A1), (I-62.1)+(IX-A2), (I-62.1)+(IX-A3), and (I-62.1)+(IX-A4).

(I-62.2)+(II-0), (I-62.2)+(II-1), (I-62.2)+(II-2), (I-62.2)+(II-3), (I-62.2)+(II-4), (I-62.2)+(II-5), (I-62.2)+(II-6), (I-62.2)+(II-9), (I-62.2)+(II-12), (I-62.2)+(II-1), (I-62.2)+(III-4), (I-62.2)+(III-10), (I-62.2)+(III-11), (I-62.2)+(IV-1), (I-62.2)+(IV-2), (I-62.2)+(IV-3), (I-62.2)+(IV-4), (I-62.2)+(IV-5), (I-62.2)+(b-1), (I-62.2)+(b-2), (I-62.2)+(b-3), (I-62.2)+(b-4), (I-62.2)+(b-5), (I-62.2)+(b-6), (I-62.2)+(b-7), (I-62.2)+(b-8), (I-62.2)+(b-9), (I-62.2)+(b-10), (I-62.2)+(b-11), (I-62.2)+(b-12), (I-62.2)+(b-13), (I-62.2)+(b-14), (I-62.2)+(S3-1), (I-62.2)+(S3-2), (I-62.2)+(S3-3), (I-62.2)+(S3-4), (I-62.2)+(S3-5), (I-62.2)+(h-1), (I-62.2)+(h-2), (I-62.2)+(V-1), (I-62.2)+(V-2), (I-62.2)+(V-3), (I-62.2)+(V-4), (I-62.2)+(V-5), (I-62.2)+(V-6), (I-62.2)+(IX-A1), (I-62.2)+(IX-A2), (I-62.2)+(IX-A3), and (I-62.2)+(IX-A4).

(I-62.3)+(II-0), (I-62.3)+(II-1), (I-62.3)+(II-2), (I-62.3)+(II-3), (I-62.3)+(II-4), (I-62.3)+(II-5), (I-62.3)+(II-6), (I-62.3)+(II-9), (I-62.3)+(II-12), (I-62.3)+(II-1), (I-62.3)+(III-4), (I-62.3)+(III-10), (I-62.3)+(III-11), (I-62.3)+(IV-1), (I-62.3)+(IV-2), (I-62.3)+(IV-3), (I-62.3)+(IV-4), (I-62.3)+(IV-5), (I-62.3)+(b-1), (I-62.3)+(b-2), (I-62.3)+(b-3), (I-62.3)+(b-4), (I-62.3)+(b-5), (I-62.3)+(b-6), (I-62.3)+(b-7), (I-62.3)+(b-8), (I-62.3)+(b-9), (I-62.3)+(b-10), (I-62.3)+(b-11), (I-62.3)+(b-12), (I-62.3)+(b-13), (I-62.3)+(b-14), (I-62.3)+(S3-1), (I-62.3)+(S3-2), (I-62.3)+(S3-3), (I-62.3)+(S3-4), (I-62.3)+(S3-5), (I-62.3)+(h-1), (I-62.3)+(h-2), (I-62.3)+(V-1), (I-62.3)+(V-2), (I-62.3)+(V-3), (I-62.3)+(V-4), (I-62.3)+(V-5), (I-62.3)+(V-6), (I-62.3)+(IX-A1), (I-62.3)+(IX-A2), (I-62.3)+(IX-A3), and (I-62.3)+(IX-A4).

(I-63.1)+(II-0), (I-63.1)+(II-1), (I-63.1)+(II-2), (I-63.1)+(II-3), (I-63.1)+(II-4), (I-63.1)+(II-5), (I-63.1)+(II-6), (I-63.1)+(II-9), (I-63.1)+(II-12), (I-63.1)+(III-1), (I-63.1)+(III-4), (I-63.1)+(III-10), (I-63.1)+(III-11), (I-63.1)+(IV-1), (I-63.1)+(IV-2), (I-63.1)+(IV-3), (I-63.1)+(IV-4), (I-63.1)+(IV-5), (I-63.1)+(b-1), (I-63.1)+(b-2), (I-63.1)+(b-3), (I-63.1)+(b-4), (I-63.1)+(b-5), (I-63.1)+(b-6), (I-63.1)+(b-7), (I-63.1)+(b-8), (I-63.1)+(b-9), (I-63.1)+(b-10), (I-63.1)+(b-11), (I-63.1)+(b-12), (I-63.1)+(b-13), (I-63.1)+(b-14), (I-63.1)+(S3-1), (I-63.1)+(S3-2), (I-63.1)+(S3-3), (I-63.1)+(S3-4), (I-63.1)+(S3-5), (I-63.1)+(h-1), (I-63.1)+(h-2), (I-63.1)+(V-1), (I-63.1)+(V-2), (I-63.1)+(V-3), (I-63.1)+(V-4), (I-63.1)+(V-5), (I-63.1)+(V-6), (I-63.1)+(IX-A1), (I-63.1)+(IX-A2), (I-63.1)+(IX-A3), and (I-63.1)+(IX-A4).

(I-63.2)+(II-0), (I-63.2)+(II-1), (I-63.2)+(II-2), (I-63.2)+(II-3), (I-63.2)+(II-4), (I-63.2)+(II-5), (I-63.2)+(II-6), (I-63.2)+(II-9), (I-63.2)+(II-12), (I-63.2)+(III-1), (I-63.2)+(III-4), (I-63.2)+(III-10), (I-63.2)+(III-11), (I-63.2)+(IV-1), (I-63.2)+(IV-2), (I-63.2)+(IV-3), (I-63.2)+(IV-4), (I-63.2)+(IV-5), (I-63.2)+(b-1), (I-63.2)+(b-2), (I-63.2)+(b-3), (I-63.2)+(b-4), (I-63.2)+(b-5), (I-63.2)+(b-6), (I-63.2)+(b-7), (I-63.2)+(b-8), (I-63.2)+(b-9), (I-63.2)+(b-10), (I-63.2)+(b-11), (I-63.2)+(b-12), (I-63.2)+(b-13), (I-63.2)+(b-14), (I-63.2)+(S3-1), (I-63.2)+(S3-2), (I-63.2)+(S3-3), (I-63.2)+(S3-4), (I-63.2)+(S3-5), (I-63.2)+(h-1), (I-63.2)+(h-2), (I-63.2)+(V-1), (I-63.2)+(V-2), (I-63.2)+(V-3), (I-63.2)+(V-4), (I-63.2)+(V-5), (I-63.2)+(V-6), (I-63.2)+(IX-A1), (I-63.2)+(IX-A2), (I-63.2)+(IX-A3), and (I-63.2)+(IX-A4).

(I-63.3)+(II-0), (I-63.3)+(II-1), (I-63.3)+(II-2), (I-63.3)+(II-3), (I-63.3)+(II-4), (I-63.3)+(II-5), (I-63.3)+(II-6), (I-63.3)+(II-9), (I-63.3)+(II-12), (I-63.3)+(III-1), (I-63.3)+(III-4), (I-63.3)+(III-10), (I-63.3)+(III-11), (I-63.3)+(IV-1), (I-63.3)+(IV-2), (I-63.3)+(IV-3), (I-63.3)+(IV-4), (I-63.3)+(IV-5), (I-63.3)+(b-1), (I-63.3)+(b-2), (I-63.3)+(b-3), (I-63.3)+(b-4), (I-63.3)+(b-5), (I-63.3)+(b-6), (I-63.3)+(b-7), (I-63.3)+(b-8), (I-63.3)+(b-9), (I-63.3)+(b-10), (I-63.3)+(b-11), (I-63.3)+(b-12), (I-63.3)+(b-13), (I-63.3)+(b-14), (I-63.3)+(S3-1), (I-63.3)+(S3-2), (I-63.3)+(S3-3), (I-63.3)+(S3-4), (I-63.3)+(S3-5), (I-63.3)+(h-1), (I-63.3)+(h-2), (I-63.3)+(V-1), (I-63.3)+(V-2), (I-63.3)+(V-3), (I-63.3)+(V-4), (I-63.3)+(V-5), (I-63.3)+(V-6), (I-63.3)+(IX-A1), (I-63.3)+(IX-A2), (I-63.3)+(IX-A3), and (I-63.3)+(IX-A4).

(I-64.1)+(II-0), (I-64.1)+(II-1), (I-64.1)+(II-2), (I-64.1)+(II-3), (I-64.1)+(II-4), (I-64.1)+(II-5), (I-64.1)+(II-6), (I-64.1)+(II-9), (I-64.1)+(II-12), (I-64.1)+(III-1), (I-64.1)+(III-4), (I-64.1)+(III-10), (I-64.1)+(III-11), (I-64.1)+(IV-1), (I-64.1)+(IV-2), (I-64.1)+(IV-3), (I-64.1)+(IV-4), (I-64.1)+(IV-5), (I-64.1)+(b-1), (I-64.1)+(b-2), (I-64.1)+(b-3), (I-64.1)+(b-4), (I-64.1)+(b-5), (I-64.1)+(b-6), (I-64.1)+(b-7), (I-64.1)+(b-8), (I-64.1)+(b-9), (I-64.1)+(b-10), (I-64.1)+(b-11), (I-64.1)+(b-12), (I-64.1)+(b-13), (I-64.1)+(b-14), (I-64.1)+(S3-1), (I-64.1)+(S3-2), (I-64.1)+(S3-3), (I-64.1)+(S3-4), (I-64.1)+(S3-5), (I-64.1)+(h-1), (I-64.1)+(h-2), (I-64.1)+(V-1), (I-64.1)+(V-2), (I-64.1)+(V-3), (I-64.1)+(V-4), (I-64.1)+(V-5), (I-64.1)+(V-6), (I-64.1)+(IX-A1), (I-64.1)+(IX-A2), (I-64.1)+(IX-A3), and (I-64.1)+(IX-A4).

(I-64.2)+(II-0), (I-64.2)+(II-1), (I-64.2)+(II-2), (I-64.2)+(II-3), (I-64.2)+(II-4), (I-64.2)+(II-5), (I-64.2)+(II-6), (I-64.2)+(II-9), (I-64.2)+(II-12), (I-64.2)+(III-1), (I-64.2)+(III-4), (I-64.2)+(III-10), (I-64.2)+(III-11), (I-64.2)+(IV-1), (I-64.2)+(IV-2), (I-64.2)+(IV-3), (I-64.2)+(IV-4), (I-64.2)+(IV-5), (I-64.2)+(b-1), (I-64.2)+(b-2), (I-64.2)+(b-3), (I-64.2)+(b-4), (I-64.2)+(b-5), (I-64.2)+(b-6), (I-64.2)+(b-7), (I-64.2)+(b-8), (I-64.2)+(b-9), (I-64.2)+(b-10), (I-64.2)+(b-11), (I-64.2)+(b-12), (I-64.2)+(b-13), (I-64.2)+(b-14), (I-64.2)+(S3-1), (I-64.2)+(S3-2), (I-64.2)+(S3-3), (I-64.2)+(S3-4), (I-64.2)+(S3-5), (I-64.2)+(h-1), (I-64.2)+(h-2), (I-64.2)+(V-1), (I-64.2)+(V-2), (I-64.2)+(V-3), (I-64.2)+(V-4), (I-64.2)+(V-5), (I-64.2)+(V-6), (I-64.2)+(IX-A1), (I-64.2)+(IX-A2), (I-64.2)+(IX-A3), and (I-64.2)+(IX-A4).

(I-64.3)+(II-0), (I-64.3)+(II-1), (I-64.3)+(II-2), (I-64.3)+(II-3), (I-64.3)+(II-4), (I-64.3)+(II-5), (I-64.3)+(II-6), (I-64.3)+(II-9), (I-64.3)+(II-12), (I-64.3)+(III-1), (I-64.3)+(III-4), (I-64.3)+(III-10), (I-64.3)+(III-11), (I-64.3)+(IV-1), (I-64.3)+(IV-2), (I-64.3)+(IV-3), (I-64.3)+(IV-4), (I-64.3)+(IV-5), (I-64.3)+(b-1), (I-64.3)+(b-2), (I-64.3)+(b-3), (I-64.3)+(b-4), (I-64.3)+(b-5), (I-64.3)+(b-6), (I-64.3)+(b-7), (I-64.3)+(b-8), (I-64.3)+(b-9), (I-64.3)+(b-10), (I-64.3)+(b-11), (I-64.3)+(b-12), (I-64.3)+(b-13), (I-64.3)+(b-14), (I-64.3)+(S3-1), (I-64.3)+(S3-2), (I-64.3)+(S3-3), (I-64.3)+(S3-4), (I-64.3)+(S3-5), (I-64.3)+(h-1), (I-64.3)+(h-2), (I-64.3)+(V-1), (I-64.3)+(V-2), (I-64.3)+(V-3), (I-64.3)+(V-4), (I-64.3)+(V-5), (I-64.3)+(V-6), (I-64.3)+(IX-A1), (I-64.3)+(IX-A2), (I-64.3)+(IX-A3), and (I-64.3)+(IX-A4).

(I-65.1)+(II-0), (I-65.1)+(II-1), (I-65.1)+(II-2), (I-65.1)+(II-3), (I-65.1)+(II-4), (I-65.1)+(II-5), (I-65.1)+(II-6), (I-65.1)+(II-9), (I-65.1)+(II-12), (I-65.1)+(II-1), (I-65.1)+(III-4), (I-65.1)+(III-10), (I-65.1)+(III-11), (I-65.1)+(IV-1), (I-65.1)+(IV-2), (I-65.1)+(IV-3), (I-65.1)+(IV-4), (I-65.1)+(IV-5), (I-65.1)+(b-1), (I-65.1)+(b-2), (I-65.1)+(b-3), (I-65.1)+(b-4), (I-65.1)+(b-5), (I-65.1)+(b-6), (I-65.1)+(b-7), (I-65.1)+(b-8), (I-65.1)+(b-9), (I-65.1)+(b-10), (I-65.1)+(b-11), (I-65.1)+(b-12), (I-65.1)+(b-13), (I-65.1)+(b-14), (I-65.1)+(S3-1), (I-65.1)+(S3-2), (I-65.1)+(S3-3), (I-65.1)+(S3-4), (I-65.1)+(S3-5), (I-65.1)+(h-1), (I-65.1)+(h-2), (I-65.1)+(V-1), (I-65.1)+(V-2), (I-65.1)+(V-3), (I-65.1)+(V-4), (I-65.1)+(V-5), (I-65.1)+(V-6), (I-65.1)+(IX-A1), (I-65.1)+(IX-A2), (I-65.1)+(IX-A3), and (I-65.1)+(IX-A4).

(I-65.2)+(II-0), (I-65.2)+(II-1), (I-65.2)+(II-2), (I-65.2)+(II-3), (I-65.2)+(II-4), (I-65.2)+(II-5), (I-65.2)+(II-6), (I-65.2)+(II-9), (I-65.2)+(II-12), (I-65.2)+(III-1), (I-65.2)+(III-4), (I-65.2)+(III-10), (I-65.2)+(III-11), (I-65.2)+(IV-1), (I-65.2)+(IV-2), (I-65.2)+(IV-3), (I-65.2)+(IV-4), (I-65.2)+(IV-5), (I-65.2)+(b-1), (I-65.2)+(b-2), (I-65.2)+(b-3), (I-65.2)+(b-4), (I-65.2)+(b-5), (I-65.2)+(b-6), (I-65.2)+(b-7), (I-65.2)+(b-8), (I-65.2)+(b-9), (I-65.2)+(b-10), (I-65.2)+(b-11), (I-65.2)+(b-12), (I-65.2)+(b-13), (I-65.2)+(b-14), (I-65.2)+(S3-1), (I-65.2)+(S3-2), (I-65.2)+(S3-3), (I-65.2)+(S3-4), (I-65.2)+(S3-5), (I-65.2)+(h-1), (I-65.2)+(h-2), (I-65.2)+(V-1), (I-65.2)+(V-2), (I-65.2)+(V-3), (I-65.2)+(V-4), (I-65.2)+(V-5), (I-65.2)+(V-6), (I-65.2)+(IX-A1), (I-65.2)+(IX-A2), (I-65.2)+(IX-A3), and (I-65.2)+(IX-A4).

(I-65.3)+(II-0), (I-65.3)+(II-1), (I-65.3)+(II-2), (I-65.3)+(II-3), (I-65.3)+(II-4), (I-65.3)+(II-5), (I-65.3)+(II-6), (I-65.3)+(II-9), (I-65.3)+(II-12), (I-65.3)+(III-1), (I-65.3)+(III-4), (I-65.3)+(III-10), (I-65.3)+(III-11), (I-65.3)+(IV-1), (I-65.3)+(IV-2), (I-65.3)+(IV-3), (I-65.3)+(IV-4), (I-65.3)+(IV-5), (I-65.3)+(b-1), (I-65.3)+(b-2), (I-65.3)+(b-3), (I-65.3)+(b-4), (I-65.3)+(b-5), (I-65.3)+(b-6), (I-65.3)+(b-7), (I-65.3)+(b-8), (I-65.3)+(b-9), (I-65.3)+(b-10), (I-65.3)+(b-11), (I-65.3)+(b-12), (I-65.3)+(b-13), (I-65.3)+(b-14), (I-65.3)+(S3-1), (I-65.3)+(S3-2), (I-65.3)+(S3-3), (I-65.3)+(S3-4), (I-65.3)+(S3-5), (I-65.3)+(h-1), (I-65.3)+(h-2), (I-65.3)+(V-1), (I-65.3)+(V-2), (I-65.3)+(V-3), (I-65.3)+(V-4), (I-65.3)+(V-5), (I-65.3)+(V-6), (I-65.3)+(IX-A1), (I-65.3)+(IX-A2), (I-65.3)+(IX-A3), and (I-65.3)+(IX-A4).

(I-66.1)+(II-0), (I-66.1)+(II-1), (I-66.1)+(II-2), (I-66.1)+(II-3), (I-66.1)+(II-4), (I-66.1)+(II-5), (I-66.1)+(II-6), (I-66.1)+(II-9), (I-66.1)+(II-12), (I-66.1)+(III-1), (I-66.1)+(III-4), (I-66.1)+(III-10), (I-66.1)+(III-11), (I-66.1)+(IV-1), (I-66.1)+(IV-2), (I-66.1)+(IV-3), (I-66.1)+(IV-4), (I-66.1)+(IV-5), (I-66.1)+(b-1), (I-66.1)+(b-2), (I-66.1)+(b-3), (I-66.1)+(b-4), (I-66.1)+(b-5), (I-66.1)+(b-6), (I-66.1)+(b-7), (I-66.1)+(b-8), (I-66.1)+(b-9), (I-66.1)+(b-10), (I-66.1)+(b-11), (I-66.1)+(b-12), (I-66.1)+(b-13), (I-66.1)+(b-14), (I-66.1)+(S3-1), (I-66.1)+(S3-2), (I-66.1)+(S3-3), (I-66.1)+(S3-4), (I-66.1)+(S3-5), (I-66.1)+(h-1), (I-66.1)+(h-2), (I-66.1)+(V-1), (I-66.1)+(V-2), (I-66.1)+(V-3), (I-66.1)+(V-4), (I-66.1)+(V-5), (I-66.1)+(V-6), (I-66.1)+(IX-A1), (I-66.1)+(IX-A2), (I-66.1)+(IX-A3), and (I-66.1)+(IX-A4).

(I-66.2)+(II-0), (I-66.2)+(II-1), (I-66.2)+(II-2), (I-66.2)+(II-3), (I-66.2)+(II-4), (I-66.2)+(II-5), (I-66.2)+(II-6), (I-66.2)+(II-9), (I-66.2)+(II-12), (I-66.2)+(III-1), (I-66.2)+(III-4), (I-66.2)+(III-10), (I-66.2)+(III-11), (I-66.2)+(IV-1), (I-66.2)+(IV-2), (I-66.2)+(IV-3), (I-66.2)+(IV-4), (I-66.2)+(IV-5), (I-66.2)+(b-1), (I-66.2)+(b-2), (I-66.2)+(b-3), (I-66.2)+(b-4), (I-66.2)+(b-5), (I-66.2)+(b-6), (I-66.2)+(b-7), (I-66.2)+(b-8), (I-66.2)+(b-9), (I-66.2)+(b-10), (I-66.2)+(b-11), (I-66.2)+(b-12), (I-66.2)+(b-13), (I-66.2)+(b-14), (I-66.2)+(S3-1), (I-66.2)+(S3-2), (I-66.2)+(S3-3), (I-66.2)+(S3-4), (I-66.2)+(S3-5), (I-66.2)+(h-1), (I-66.2)+(h-2), (I-66.2)+(V-1), (I-66.2)+(V-2), (I-66.2)+(V-3), (I-66.2)+(V-4), (I-66.2)+(V-5), (I-66.2)+(V-6), (I-66.2)+(IX-A1), (I-66.2)+(IX-A2), (I-66.2)+(IX-A3), and (I-66.2)+(IX-A4).

(I-66.3)+(II-0), (I-66.3)+(II-1), (I-66.3)+(II-2), (I-66.3)+(II-3), (I-66.3)+(II-4), (I-66.3)+(II-5), (I-66.3)+(II-6), (I-66.3)+(II-9), (I-66.3)+(II-12), (I-66.3)+(III-1), (I-66.3)+(III-4), (I-66.3)+(III-10), (I-66.3)+(III-11), (I-66.3)+(IV-1), (I-66.3)+(IV-2), (I-66.3)+(IV-3), (I-66.3)+(IV-4), (I-66.3)+(IV-5), (I-66.3)+(b-1), (I-66.3)+(b-2), (I-66.3)+(b-3), (I-66.3)+(b-4), (I-66.3)+(b-5), (I-66.3)+(b-6), (I-66.3)+(b-7), (I-66.3)+(b-8), (I-66.3)+(b-9), (I-66.3)+(b-10), (I-66.3)+(b-11), (I-66.3)+(b-12), (I-66.3)+(b-13), (I-66.3)+(b-14), (I-66.3)+(S3-1), (I-66.3)+(S3-2), (I-66.3)+(S3-3), (I-66.3)+(S3-4), (I-66.3)+(S3-5), (I-66.3)+(h-1), (I-66.3)+(h-2), (I-66.3)+(V-1), (I-66.3)+(V-2), (I-66.3)+(V-3), (I-66.3)+(V-4), (I-66.3)+(V-5), (I-66.3)+(V-6), (I-66.3)+(IX-A1), (I-66.3)+(IX-A2), (I-66.3)+(IX-A3), and (I-66.3)+(IX-A4).

(I-67.1)+(II-0), (I-67.1)+(II-1), (I-67.1)+(II-2), (I-67.1)+(II-3), (I-67.1)+(II-4), (I-67.1)+(II-5), (I-67.1)+(II-6), (I-67.1)+(II-9), (I-67.1)+(II-12), (I-67.1)+(III-1), (I-67.1)+(III-4), (I-67.1)+(III-10), (I-67.1)+(III-11), (I-67.1)+(IV-1), (I-67.1)+(IV-2), (I-67.1)+(IV-3), (I-67.1)+(IV-4), (I-67.1)+(IV-5), (I-67.1)+(b-1), (I-67.1)+(b-2), (I-67.1)+(b-3), (I-67.1)+(b-4), (I-67.1)+(b-5), (I-67.1)+(b-6), (I-67.1)+(b-7), (I-67.1)+(b-8), (I-67.1)+(b-9), (I-67.1)+(b-10), (I-67.1)+(b-11), (I-67.1)+(b-12), (I-67.1)+(b-13), (I-67.1)+(b-14), (I-67.1)+(S3-1), (I-67.1)+(S3-2), (I-67.1)+(S3-3), (I-67.1)+(S3-4), (I-67.1)+(S3-5), (I-67.1)+(h-1), (I-67.1)+(h-2), (I-67.1)+(V-1), (I-67.1)+(V-2), (I-67.1)+(V-3), (I-67.1)+(V-4), (I-67.1)+(V-5), (I-67.1)+(V-6), (I-67.1)+(IX-A1), (I-67.1)+(IX-A2), (I-67.1)+(IX-A3), and (I-67.1)+(IX-A4).

(I-67.2)+(II-0), (I-67.2)+(II-1), (I-67.2)+(II-2), (I-67.2)+(II-3), (I-67.2)+(II-4), (I-67.2)+(II-5), (I-67.2)+(II-6), (I-67.2)+(II-9), (I-67.2)+(II-12), (I-67.2)+(III-1), (I-67.2)+(III-4), (I-67.2)+(III-10), (I-67.2)+(III-11), (I-67.2)+(IV-1), (I-67.2)+(IV-2), (I-67.2)+(IV-3), (I-67.2)+(IV-4), (I-67.2)+(IV-5), (I-67.2)+(b-1), (I-67.2)+(b-2), (I-67.2)+(b-3), (I-67.2)+(b-4), (I-67.2)+(b-5), (I-67.2)+(b-6), (I-67.2)+(b-7), (I-67.2)+(b-8), (I-67.2)+(b-9), (I-67.2)+(b-10), (I-67.2)+(b-11), (I-67.2)+(b-12), (I-67.2)+(b-13), (I-67.2)+(b-14), (I-67.2)+(S3-1), (I-67.2)+(S3-2), (I-67.2)+(S3-3), (I-67.2)+(S3-4), (I-67.2)+(S3-5), (I-67.2)+(h-1), (I-67.2)+(h-2), (I-67.2)+(V-1), (I-67.2)+(V-2), (I-67.2)+(V-3), (I-67.2)+(V-4), (I-67.2)+(V-5), (I-67.2)+(V-6), (I-67.2)+(IX-A1), (I-67.2)+(IX-A2), (I-67.2)+(IX-A3), and (I-67.2)+(IX-A4).

(I-67.3)+(II-0), (I-67.3)+(II-1), (I-67.3)+(II-2), (I-67.3)+(II-3), (I-67.3)+(II-4), (I-67.3)+(II-5), (I-67.3)+(II-6), (I-67.3)+(II-9), (I-67.3)+(II-12), (I-67.3)+(III-1), (I-67.3)+(III-4), (I-67.3)+(III-10), (I-67.3)+(III-11), (I-67.3)+(IV-1), (I-67.3)+(IV-2), (I-67.3)+(IV-3), (I-67.3)+(IV-4), (I-67.3)+(IV-5), (I-67.3)+(b-1), (I-67.3)+(b-2), (I-67.3)+(b-3), (I-67.3)+(b-4), (I-67.3)+(b-5), (I-67.3)+(b-6), (I-67.3)+(b-7), (I-67.3)+(b-8), (I-67.3)+(b-9), (I-67.3)+(b-10), (I-67.3)+(b-11), (I-67.3)+(b-12), (I-67.3)+(b-13), (I-67.3)+(b-14), (I-67.3)+(S3-1), (I-67.3)+(S3-2), (I-67.3)+(S3-3), (I-67.3)+(S3-4), (I-67.3)+(S3-5), (I-67.3)+(h-1), (I-67.3)+(h-2), (I-67.3)+(V-1), (I-67.3)+(V-2), (I-67.3)+(V-3), (I-67.3)+(V-4), (I-67.3)+(V-5), (I-67.3)+(V-6), (I-67.3)+(IX-A1), (I-67.3)+(IX-A2), (I-67.3)+(IX-A3), and (I-67.3)+(IX-A4).

(I-68.1)+(II-0), (I-68.1)+(II-1), (I-68.1)+(II-2), (I-68.1)+(II-3), (I-68.1)+(II-4), (I-68.1)+(II-5), (I-68.1)+(II-6), (I-68.1)+(II-9), (I-68.1)+(II-12), (I-68.1)+(II-1), (I-68.1)+(III-4), (I-68.1)+(III-10), (I-68.1)+(III-11), (I-68.1)+(IV-1), (I-68.1)+(IV-2), (I-68.1)+(IV-3), (I-68.1)+(IV-4), (I-68.1)+(IV-5), (I-68.1)+(b-1), (I-68.1)+(b-2), (I-68.1)+(b-3), (I-68.1)+(b-4), (I-68.1)+(b-5), (I-68.1)+(b-6), (I-68.1)+(b-7), (I-68.1)+(b-8), (I-68.1)+(b-9), (I-68.1)+(b-10), (I-68.1)+(b-11), (I-68.1)+(b-12), (I-68.1)+(b-13), (I-68.1)+(b-14), (I-68.1)+(S3-1), (I-68.1)+(S3-2), (I-68.1)+(S3-3), (I-68.1)+(S3-4), (I-68.1)+(S3-5), (I-68.1)+(h-1), (I-68.1)+(h-2), (I-68.1)+(V-1), (I-68.1)+(V-2), (I-68.1)+(V-3), (I-68.1)+(V-4), (I-68.1)+(V-5), (I-68.1)+(V-6), (I-68.1)+(IX-A1), (I-68.1)+(IX-A2), (I-68.1)+(IX-A3), and (I-68.1)+(IX-A4).

(I-68.2)+(II-0), (I-68.2)+(II-1), (I-68.2)+(II-2), (I-68.2)+(II-3), (I-68.2)+(II-4), (I-68.2)+(II-5), (I-68.2)+(II-6), (I-68.2)+(II-9), (I-68.2)+(II-12), (I-68.2)+(III-1), (I-68.2)+(III-4), (I-68.2)+(III-10), (I-68.2)+(III-11), (I-68.2)+(IV-1), (I-68.2)+(IV-2), (I-68.2)+(IV-3), (I-68.2)+(IV-4), (I-68.2)+(IV-5), (I-68.2)+(b-1), (I-68.2)+(b-2), (I-68.2)+(b-3), (I-68.2)+(b-4), (I-68.2)+(b-5), (I-68.2)+(b-6), (I-68.2)+(b-7), (I-68.2)+(b-8), (I-68.2)+(b-9), (I-68.2)+(b-10), (I-68.2)+(b-11), (I-68.2)+(b-12), (I-68.2)+(b-13), (I-68.2)+(b-14), (I-68.2)+(S3-1), (I-68.2)+(S3-2), (I-68.2)+(S3-3), (I-68.2)+(S3-4), (I-68.2)+(S3-5), (I-68.2)+(h-1), (I-68.2)+(h-2), (I-68.2)+(V-1), (I-68.2)+(V-2), (I-68.2)+(V-3), (I-68.2)+(V-4), (I-68.2)+(V-5), (I-68.2)+(V-6), (I-68.2)+(IX-A1), (I-68.2)+(IX-A2), (I-68.2)+(IX-A3), and (I-68.2)+(IX-A4).

(I-68.3)+(II-0), (I-68.3)+(II-1), (I-68.3)+(II-2), (I-68.3)+(II-3), (I-68.3)+(II-4), (I-68.3)+(II-5), (I-68.3)+(II-6), (I-68.3)+(II-9), (I-68.3)+(II-12), (I-68.3)+(II-1), (I-68.3)+(III-4), (I-68.3)+(III-10), (I-68.3)+(III-11), (I-68.3)+(IV-1), (I-68.3)+(IV-2), (I-68.3)+(IV-3), (I-68.3)+(IV-4), (I-68.3)+(IV-5), (I-68.3)+(b-1), (I-68.3)+(b-2), (I-68.3)+(b-3), (I-68.3)+(b-4), (I-68.3)+(b-5), (I-68.3)+(b-6), (I-68.3)+(b-7), (I-68.3)+(b-8), (I-68.3)+(b-9), (I-68.3)+(b-10), (I-68.3)+(b-11), (I-68.3)+(b-12), (I-68.3)+(b-13), (I-68.3)+(b-14), (I-68.3)+(S3-1), (I-68.3)+(S3-2), (I-68.3)+(S3-3), (I-68.3)+(S3-4), (I-68.3)+(S3-5), (I-68.3)+(h-1), (I-68.3)+(h-2), (I-68.3)+(V-1), (I-68.3)+(V-2), (I-68.3)+(V-3), (I-68.3)+(V-4), (I-68.3)+(V-5), (I-68.3)+(V-6), (I-68.3)+(IX-A1), (I-68.3)+(IX-A2), (I-68.3)+(IX-A3), and (I-68.3)+(IX-A4).

(I-69.1)+(II-0), (I-69.1)+(II-1), (I-69.1)+(II-2), (I-69.1)+(II-3), (I-69.1)+(II-4), (I-69.1)+(II-5), (I-69.1)+(II-6), (I-69.1)+(II-9), (I-69.1)+(II-12), (I-69.1)+(III-1), (I-69.1)+(III-4), (I-69.1)+(III-10), (I-69.1)+(III-11), (I-69.1)+(IV-1), (I-69.1)+(IV-2), (I-69.1)+(IV-3), (I-69.1)+(IV-4), (I-69.1)+(IV-5), (I-69.1)+(b-1), (I-69.1)+(b-2), (I-69.1)+(b-3), (I-69.1)+(b-4), (I-69.1)+(b-5), (I-69.1)+(b-6), (I-69.1)+(b-7), (I-69.1)+(b-8), (I-69.1)+(b-9), (I-69.1)+(b-10), (I-69.1)+(b-11), (I-69.1)+(b-12), (I-69.1)+(b-13), (I-69.1)+(b-14), (I-69.1)+(S3-1), (I-69.1)+(S3-2), (I-69.1)+(S3-3), (I-69.1)+(S3-4), (I-69.1)+(S3-5), (I-69.1)+(h-1), (I-69.1)+(h-2), (I-69.1)+(V-1), (I-69.1)+(V-2), (I-69.1)+(V-3), (I-69.1)+(V-4), (I-69.1)+(V-5), (I-69.1)+(V-6), (I-69.1)+(IX-A1), (I-69.1)+(IX-A2), (I-69.1)+(IX-A3), and (I-69.1)+(IX-A4).

(I-69.2)+(II-0), (I-69.2)+(II-1), (I-69.2)+(II-2), (I-69.2)+(II-3), (I-69.2)+(II-4), (I-69.2)+(II-5), (I-69.2)+(II-6), (I-69.2)+(II-9), (I-69.2)+(II-12), (I-69.2)+(III-1), (I-69.2)+(III-4), (I-69.2)+(III-10), (I-69.2)+(III-11), (I-69.2)+(IV-1), (I-69.2)+(IV-2), (I-69.2)+(IV-3), (I-69.2)+(IV-4), (I-69.2)+(IV-5), (I-69.2)+(b-1), (I-69.2)+(b-2), (I-69.2)+(b-3), (I-69.2)+(b-4), (I-69.2)+(b-5), (I-69.2)+(b-6), (I-69.2)+(b-7), (I-69.2)+(b-8), (I-69.2)+(b-9), (I-69.2)+(b-10), (I-69.2)+(b-11), (I-69.2)+(b-12), (I-69.2)+(b-13), (I-69.2)+(b-14), (I-69.2)+(S3-1), (I-69.2)+(S3-2), (I-69.2)+(S3-3), (I-69.2)+(S3-4), (I-69.2)+(S3-5), (I-69.2)+(h-1), (I-69.2)+(h-2), (I-69.2)+(V-1), (I-69.2)+(V-2), (I-69.2)+(V-3), (I-69.2)+(V-4), (I-69.2)+(V-5), (I-69.2)+(V-6), (I-69.2)+(IX-A1), (I-69.2)+(IX-A2), (I-69.2)+(IX-A3), and (I-69.2)+(IX-A4).

(I-69.3)+(II-0), (I-69.3)+(II-1), (I-69.3)+(II-2), (I-69.3)+(II-3), (I-69.3)+(II-4), (I-69.3)+(II-5), (I-69.3)+(II-6), (I-69.3)+(II-9), (I-69.3)+(II-12), (I-69.3)+(II-1), (I-69.3)+(III-4), (I-69.3)+(III-10), (I-69.3)+(III-11), (I-69.3)+(IV-1), (I-69.3)+(IV-2), (I-69.3)+(IV-3), (I-69.3)+(IV-4), (I-69.3)+(IV-5), (I-69.3)+(b-1), (I-69.3)+(b-2), (I-69.3)+(b-3), (I-69.3)+(b-4), (I-69.3)+(b-5), (I-69.3)+(b-6), (I-69.3)+(b-7), (I-69.3)+(b-8), (I-69.3)+(b-9), (I-69.3)+(b-10), (I-69.3)+(b-11), (I-69.3)+(b-12), (I-69.3)+(b-13), (I-69.3)+(b-14), (I-69.3)+(S3-1), (I-69.3)+(S3-2), (I-69.3)+(S3-3), (I-69.3)+(S3-4), (I-69.3)+(S3-5), (I-69.3)+(h-1), (I-69.3)+(h-2), (I-69.3)+(V-1), (I-69.3)+(V-2), (I-69.3)+(V-3), (I-69.3)+(V-4), (I-69.3)+(V-5), (I-69.3)+(V-6), (I-69.3)+(IX-A1), (I-69.3)+(IX-A2), (I-69.3)+(IX-A3), and (I-69.3)+(IX-A4).

(I-70.1)+(II-0), (I-70.1)+(II-1), (I-70.1)+(II-2), (I-70.1)+(II-3), (I-70.1)+(II-4), (I-70.1)+(II-5), (I-70.1)+(II-6), (I-70.1)+(II-9), (I-70.1)+(II-12), (I-70.1)+(III-1), (I-70.1)+(III-4), (I-70.1)+(III-10), (I-70.1)+(III-11), (I-70.1)+(IV-1), (I-70.1)+(IV-2), (I-70.1)+(IV-3), (I-70.1)+(IV-4), (I-70.1)+(IV-5), (I-70.1)+(b-1), (I-70.1)+(b-2), (I-70.1)+(b-3), (I-70.1)+(b-4), (I-70.1)+(b-5), (I-70.1)+(b-6), (I-70.1)+(b-7), (I-70.1)+(b-8), (I-70.1)+(b-9), (I-70.1)+(b-10), (I-70.1)+(b-11), (I-70.1)+(b-12), (I-70.1)+(b-13), (I-70.1)+(b-14), (I-70.1)+(S3-1), (I-70.1)+(S3-2), (I-70.1)+(S3-3), (I-70.1)+(S3-4), (I-70.1)+(S3-5), (I-70.1)+(h-1), (I-70.1)+(h-2), (I-70.1)+(V-1), (I-70.1)+(V-2), (I-70.1)+(V-3), (I-70.1)+(V-4), (I-70.1)+(V-5), (I-70.1)+(V-6), (I-70.1)+(IX-A1), (I-70.1)+(IX-A2), (I-70.1)+(IX-A3), and (I-70.1)+(IX-A4).

(I-70.2)+(II-0), (I-70.2)+(II-1), (I-70.2)+(II-2), (I-70.2)+(II-3), (I-70.2)+(II-4), (I-70.2)+(II-5), (I-70.2)+(II-6), (I-70.2)+(II-9), (I-70.2)+(II-12), (I-70.2)+(III-1), (I-70.2)+(III-4), (I-70.2)+(III-10), (I-70.2)+(III-11), (I-70.2)+(IV-1), (I-70.2)+(IV-2), (I-70.2)+(IV-3), (I-70.2)+(IV-4), (I-70.2)+(IV-5), (I-70.2)+(b-1), (I-70.2)+(b-2), (I-70.2)+(b-3), (I-70.2)+(b-4), (I-70.2)+(b-5), (I-70.2)+(b-6), (I-70.2)+(b-7), (I-70.2)+(b-8), (I-70.2)+(b-9), (I-70.2)+(b-10), (I-70.2)+(b-11), (I-70.2)+(b-12), (I-70.2)+(b-13), (I-70.2)+(b-14), (I-70.2)+(S3-1), (I-70.2)+(S3-2), (I-70.2)+(S3-3), (I-70.2)+(S3-4), (I-70.2)+(S3-5), (I-70.2)+(h-1), (I-70.2)+(h-2), (I-70.2)+(V-1), (I-70.2)+(V-2), (I-70.2)+(V-3), (I-70.2)+(V-4), (I-70.2)+(V-5), (I-70.2)+(V-6), (I-70.2)+(IX-A1), (I-70.2)+(IX-A2), (I-70.2)+(IX-A3), and (I-70.2)+(IX-A4).

(I-70.3)+(II-0), (I-70.3)+(II-1), (I-70.3)+(II-2), (I-70.3)+(II-3), (I-70.3)+(II-4), (I-70.3)+(II-5), (I-70.3)+(II-6), (I-70.3)+(II-9), (I-70.3)+(II-12), (I-70.3)+(III-1), (I-70.3)+(III-4), (I-70.3)+(III-10), (I-70.3)+(III-11), (I-70.3)+(IV-1), (I-70.3)+(IV-2), (I-70.3)+(IV-3), (I-70.3)+(IV-4), (I-70.3)+(IV-5), (I-70.3)+(b-1), (I-70.3)+(b-2), (I-70.3)+(b-3), (I-70.3)+(b-4), (I-70.3)+(b-5), (I-70.3)+(b-6), (I-70.3)+(b-7), (I-70.3)+(b-8), (I-70.3)+(b-9), (I-70.3)+(b-10), (I-70.3)+(b-11), (I-70.3)+(b-12), (I-70.3)+(b-13), (I-70.3)+(b-14), (I-70.3)+(S3-1), (I-70.3)+(S3-2), (I-70.3)+(S3-3), (I-70.3)+(S3-4), (I-70.3)+(S3-5), (I-70.3)+(h-1), (I-70.3)+(h-2), (I-70.3)+(V-1), (I-70.3)+(V-2), (I-70.3)+(V-3), (I-70.3)+(V-4), (I-70.3)+(V-5), (I-70.3)+(V-6), (I-70.3)+(IX-A1), (I-70.3)+(IX-A2), (I-70.3)+(IX-A3), and (I-70.3)+(IX-A4).

(I-71.1)+(II-0), (I-71.1)+(II-1), (I-71.1)+(II-2), (I-71.1)+(II-3), (I-71.1)+(II-4), (I-71.1)+(II-5), (I-71.1)+(II-6), (I-71.1)+(II-9), (I-71.1)+(II-12), (I-71.1)+(III-1), (I-71.1)+(III-4), (I-71.1)+(III-10), (I-71.1)+(III-11), (I-71.1)+(IV-1), (I-71.1)+(IV-2), (I-71.1)+(IV-3), (I-71.1)+(IV-4), (I-71.1)+(IV-5), (I-71.1)+(b-1), (I-71.1)+(b-2), (I-71.1)+(b-3), (I-71.1)+(b-4), (I-71.1)+(b-5), (I-71.1)+(b-6), (I-71.1)+(b-7), (I-71.1)+(b-8), (I-71.1)+(b-9), (I-71.1)+(b-10), (I-71.1)+(b-11), (I-71.1)+(b-12), (I-71.1)+(b-13), (I-71.1)+(b-14), (I-71.1)+(S3-1), (I-71.1)+(S3-2), (I-71.1)+(S3-3), (I-71.1)+(S3-4), (I-71.1)+(S3-5), (I-71.1)+(h-1), (I-71.1)+(h-2), (I-71.1)+(V-1), (I-71.1)+(V-2), (I-71.1)+(V-3), (I-71.1)+(V-4), (I-71.1)+(V-5), (I-71.1)+(V-6), (I-71.1)+(IX-A1), (I-71.1)+(IX-A2), (I-71.1)+(IX-A3), and (I-71.1)+(IX-A4).

(I-71.2)+(II-0), (I-71.2)+(II-1), (I-71.2)+(II-2), (I-71.2)+(II-3), (I-71.2)+(II-4), (I-71.2)+(II-5), (I-71.2)+(II-6), (I-71.2)+(II-9), (I-71.2)+(II-12), (I-71.2)+(III-1), (I-71.2)+(III-4), (I-71.2)+(III-10), (I-71.2)+(III-11), (I-71.2)+(IV-1), (I-71.2)+(IV-2), (I-71.2)+(IV-3), (I-71.2)+(IV-4), (I-71.2)+(IV-5), (I-71.2)+(b-1), (I-71.2)+(b-2), (I-71.2)+(b-3), (I-71.2)+(b-4), (I-71.2)+(b-5), (I-71.2)+(b-6), (I-71.2)+(b-7), (I-71.2)+(b-8), (I-71.2)+(b-9), (I-71.2)+(b-10), (I-71.2)+(b-11), (I-71.2)+(b-12), (I-71.2)+(b-13), (I-71.2)+(b-14), (I-71.2)+(S3-1), (I-71.2)+(S3-2), (I-71.2)+(S3-3), (I-71.2)+(S3-4), (I-71.2)+(S3-5), (I-71.2)+(h-1), (I-71.2)+(h-2), (I-71.2)+(V-1), (I-71.2)+(V-2), (I-71.2)+(V-3), (I-71.2)+(V-4), (I-71.2)+(V-5), (I-71.2)+(V-6), (I-71.2)+(IX-A1), (I-71.2)+(IX-A2), (I-71.2)+(IX-A3), and (I-71.2)+(IX-A4).

(I-71.3)+(II-0), (I-71.3)+(II-1), (I-71.3)+(II-2), (I-71.3)+(II-3), (I-71.3)+(II-4), (I-71.3)+(II-5), (I-71.3)+(II-6), (I-71.3)+(II-9), (I-71.3)+(II-12), (I-71.3)+(III-1), (I-71.3)+(III-4), (I-71.3)+(III-10), (I-71.3)+(III-11), (I-71.3)+(IV-1), (I-71.3)+(IV-2), (I-71.3)+(IV-3), (I-71.3)+(IV-4), (I-71.3)+(IV-5), (I-71.3)+(b-1), (I-71.3)+(b-2), (I-71.3)+(b-3), (I-71.3)+(b-4), (I-71.3)+(b-5), (I-71.3)+(b-6), (I-71.3)+(b-7), (I-71.3)+(b-8), (I-71.3)+(b-9), (I-71.3)+(b-10), (I-71.3)+(b-11), (I-71.3)+(b-12), (I-71.3)+(b-13), (I-71.3)+(b-14), (I-71.3)+(S3-1), (I-71.3)+(S3-2), (I-71.3)+(S3-3), (I-71.3)+(S3-4), (I-71.3)+(S3-5), (I-71.3)+(h-1), (I-71.3)+(h-2), (I-71.3)+(V-1), (I-71.3)+(V-2), (I-71.3)+(V-3), (I-71.3)+(V-4), (I-71.3)+(V-5), (I-71.3)+(V-6), (I-71.3)+(IX-A1), (I-71.3)+(IX-A2), (I-71.3)+(IX-A3), and (I-71.3)+(IX-A4).

(I-72.1)+(II-0), (I-72.1)+(II-1), (I-72.1)+(II-2), (I-72.1)+(II-3), (I-72.1)+(II-4), (I-72.1)+(II-5), (I-72.1)+(II-6), (I-72.1)+(II-9), (I-72.1)+(II-12), (I-72.1)+(III-1), (I-72.1)+(III-4), (I-72.1)+(III-10), (I-72.1)+(III-11), (I-72.1)+(IV-1), (I-72.1)+(IV-2), (I-72.1)+(IV-3), (I-72.1)+(IV-4), (I-72.1)+(IV-5), (I-72.1)+(b-1), (I-72.1)+(b-2), (I-72.1)+(b-3), (I-72.1)+(b-4), (I-72.1)+(b-5), (I-72.1)+(b-6), (I-72.1)+(b-7), (I-72.1)+(b-8), (I-72.1)+(b-9), (I-72.1)+(b-10), (I-72.1)+(b-11), (I-72.1)+(b-12), (I-72.1)+(b-13), (I-72.1)+(b-14), (I-72.1)+(S3-1), (I-72.1)+(S3-2), (I-72.1)+(S3-3), (I-72.1)+(S3-4), (I-72.1)+(S3-5), (I-72.1)+(h-1), (I-72.1)+(h-2), (I-72.1)+(V-1), (I-72.1)+(V-2), (I-72.1)+(V-3), (I-72.1)+(V-4), (I-72.1)+(V-5), (I-72.1)+(V-6), (I-72.1)+(IX-A1), (I-72.1)+(IX-A2), (I-72.1)+(IX-A3), and (I-72.1)+(IX-A4).

(I-72.2)+(II-0), (I-72.2)+(II-1), (I-72.2)+(II-2), (I-72.2)+(II-3), (I-72.2)+(II-4), (I-72.2)+(II-5), (I-72.2)+(II-6), (I-72.2)+(II-9), (I-72.2)+(II-12), (I-72.2)+(III-1), (I-72.2)+(III-4), (I-72.2)+(III-10), (I-72.2)+(III-11), (I-72.2)+(IV-1), (I-72.2)+(IV-2), (I-72.2)+(IV-3), (I-72.2)+(IV-4), (I-72.2)+(IV-5), (I-72.2)+(b-1), (I-72.2)+(b-2), (I-72.2)+(b-3), (I-72.2)+(b-4), (I-72.2)+(b-5), (I-72.2)+(b-6), (I-72.2)+(b-7), (I-72.2)+(b-8), (I-72.2)+(b-9), (I-72.2)+(b-10), (I-72.2)+(b-11), (I-72.2)+(b-12), (I-72.2)+(b-13), (I-72.2)+(b-14), (I-72.2)+(S3-1), (I-72.2)+(S3-2), (I-72.2)+(S3-3), (I-72.2)+(S3-4), (I-72.2)+(S3-5), (I-72.2)+(h-1), (I-72.2)+(h-2), (I-72.2)+(V-1), (I-72.2)+(V-2), (I-72.2)+(V-3), (I-72.2)+(V-4), (I-72.2)+(V-5), (I-72.2)+(V-6), (I-72.2)+(IX-A1), (I-72.2)+(IX-A2), (I-72.2)+(IX-A3), and (I-72.2)+(IX-A4).

(I-72.3)+(II-0), (I-72.3)+(II-1), (I-72.3)+(II-2), (I-72.3)+(II-3), (I-72.3)+(II-4), (I-72.3)+(II-5), (I-72.3)+(II-6), (I-72.3)+(II-9), (I-72.3)+(II-12), (I-72.3)+(III-1), (I-72.3)+(III-4), (I-72.3)+(III-10), (I-72.3)+(III-11), (I-72.3)+(IV-1), (I-72.3)+(IV-2), (I-72.3)+(IV-3), (I-72.3)+(IV-4), (I-72.3)+(IV-5), (I-72.3)+(b-1), (I-72.3)+(b-2), (I-72.3)+(b-3), (I-72.3)+(b-4), (I-72.3)+(b-5), (I-72.3)+(b-6), (I-72.3)+(b-7), (I-72.3)+(b-8), (I-72.3)+(b-9), (I-72.3)+(b-10), (I-72.3)+(b-11), (I-72.3)+(b-12), (I-72.3)+(b-13), (I-72.3)+(b-14), (I-72.3)+(S3-1), (I-72.3)+(S3-2), (I-72.3)+(S3-3), (I-72.3)+(S3-4), (I-72.3)+(S3-5), (I-72.3)+(h-1), (I-72.3)+(h-2), (I-72.3)+(V-1), (I-72.3)+(V-2), (I-72.3)+(V-3), (I-72.3)+(V-4), (I-72.3)+(V-5), (I-72.3)+(V-6), (I-72.3)+(IX-A1), (I-72.3)+(IX-A2), (I-72.3)+(IX-A3), and (I-72.3)+(IX-A4).

(I-73.1)+(II-0), (I-73.1)+(II-1), (I-73.1)+(II-2), (I-73.1)+(II-3), (I-73.1)+(II-4), (I-73.1)+(II-5), (I-73.1)+(II-6), (I-73.1)+(II-9), (I-73.1)+(II-12), (I-73.1)+(III-1), (I-73.1)+(III-4), (I-73.1)+(III-10), (I-73.1)+(III-11), (I-73.1)+(IV-1), (I-73.1)+(IV-2), (I-73.1)+(IV-3), (I-73.1)+(IV-4), (I-73.1)+(IV-5), (I-73.1)+(b-1), (I-73.1)+(b-2), (I-73.1)+(b-3), (I-73.1)+(b-4), (I-73.1)+(b-5), (I-73.1)+(b-6), (I-73.1)+(b-7), (I-73.1)+(b-8), (I-73.1)+(b-9), (I-73.1)+(b-10), (I-73.1)+(b-11), (I-73.1)+(b-12), (I-73.1)+(b-13), (I-73.1)+(b-14), (I-73.1)+(S3-1), (I-73.1)+(S3-2), (I-73.1)+(S3-3), (I-73.1)+(S3-4), (I-73.1)+(S3-5), (I-73.1)+(h-1), (I-73.1)+(h-2), (I-73.1)+(V-1), (I-73.1)+(V-2), (I-73.1)+(V-3), (I-73.1)+(V-4), (I-73.1)+(V-5), (I-73.1)+(V-6), (I-73.1)+(IX-A1), (I-73.1)+(IX-A2), (I-73.1)+(IX-A3), and (I-73.1)+(IX-A4).

(I-73.2)+(II-0), (I-73.2)+(II-1), (I-73.2)+(II-2), (I-73.2)+(II-3), (I-73.2)+(II-4), (I-73.2)+(II-5), (I-73.2)+(II-6), (I-73.2)+(II-9), (I-73.2)+(II-12), (I-73.2)+(III-1), (I-73.2)+(III-4), (I-73.2)+(III-10), (I-73.2)+(III-11), (I-73.2)+(IV-1), (I-73.2)+(IV-2), (I-73.2)+(IV-3), (I-73.2)+(IV-4), (I-73.2)+(IV-5), (I-73.2)+(b-1), (I-73.2)+(b-2), (I-73.2)+(b-3), (I-73.2)+(b-4), (I-73.2)+(b-5), (I-73.2)+(b-6), (I-73.2)+(b-7), (I-73.2)+(b-8), (I-73.2)+(b-9), (I-73.2)+(b-10), (I-73.2)+(b-11), (I-73.2)+(b-12), (I-73.2)+(b-13), (I-73.2)+(b-14), (I-73.2)+(S3-1), (I-73.2)+(S3-2), (I-73.2)+(S3-3), (I-73.2)+(S3-4), (I-73.2)+(S3-5), (I-73.2)+(h-1), (I-73.2)+(h-2), (I-73.2)+(V-1), (I-73.2)+(V-2), (I-73.2)+(V-3), (I-73.2)+(V-4), (I-73.2)+(V-5), (I-73.2)+(V-6), (I-73.2)+(IX-A1), (I-73.2)+(IX-A2), (I-73.2)+(IX-A3), and (I-73.2)+(IX-A4).

(I-73.3)+(II-0), (I-73.3)+(II-1), (I-73.3)+(II-2), (I-73.3)+(II-3), (I-73.3)+(II-4), (I-73.3)+(II-5), (I-73.3)+(II-6), (I-73.3)+(II-9), (I-73.3)+(II-12), (I-73.3)+(III-1), (I-73.3)+(III-4), (I-73.3)+(III-10), (I-73.3)+(III-11), (I-73.3)+(IV-1), (I-73.3)+(IV-2), (I-73.3)+(IV-3), (I-73.3)+(IV-4), (I-73.3)+(IV-5), (I-73.3)+(b-1), (I-73.3)+(b-2), (I-73.3)+(b-3), (I-73.3)+(b-4), (I-73.3)+(b-5), (I-73.3)+(b-6), (I-73.3)+(b-7), (I-73.3)+(b-8), (I-73.3)+(b-9), (I-73.3)+(b-10), (I-73.3)+(b-11), (I-73.3)+(b-12), (I-73.3)+(b-13), (I-73.3)+(b-14), (I-73.3)+(S3-1), (I-73.3)+(S3-2), (I-73.3)+(S3-3), (I-73.3)+(S3-4), (I-73.3)+(S3-5), (I-73.3)+(h-1), (I-73.3)+(h-2), (I-73.3)+(V-1), (I-73.3)+(V-2), (I-73.3)+(V-3), (I-73.3)+(V-4), (I-73.3)+(V-5), (I-73.3)+(V-6), (I-73.3)+(IX-A1), (I-73.3)+(IX-A2), (I-73.3)+(IX-A3), and (I-73.3)+(IX-A4).

(I-74.1)+(II-0), (I-74.1)+(II-1), (I-74.1)+(II-2), (I-74.1)+(II-3), (I-74.1)+(II-4), (I-74.1)+(II-5), (I-74.1)+(II-6), (I-74.1)+(II-9), (I-74.1)+(II-12), (I-74.1)+(III-1), (I-74.1)+(III-4), (I-74.1)+(III-10), (I-74.1)+(III-11), (I-74.1)+(IV-1), (I-74.1)+(IV-2), (I-74.1)+(IV-3), (I-74.1)+(IV-4), (I-74.1)+(IV-5), (I-74.1)+(b-1), (I-74.1)+(b-2), (I-74.1)+(b-3), (I-74.1)+(b-4), (I-74.1)+(b-5), (I-74.1)+(b-6), (I-74.1)+(b-7), (I-74.1)+(b-8), (I-74.1)+(b-9), (I-74.1)+(b-10), (I-74.1)+(b-11), (I-74.1)+(b-12), (I-74.1)+(b-13), (I-74.1)+(b-14), (I-74.1)+(S3-1), (I-74.1)+(S3-2), (I-74.1)+(S3-3), (I-74.1)+(S3-4), (I-74.1)+(S3-5), (I-74.1)+(h-1), (I-74.1)+(h-2), (I-74.1)+(V-1), (I-74.1)+(V-2), (I-74.1)+(V-3), (I-74.1)+(V-4), (I-74.1)+(V-5), (I-74.1)+(V-6), (I-74.1)+(IX-A1), (I-74.1)+(IX-A2), (I-74.1)+(IX-A3), and (I-74.1)+(IX-A4).

(I-74.2)+(II-0), (I-74.2)+(II-1), (I-74.2)+(II-2), (I-74.2)+(II-3), (I-74.2)+(II-4), (I-74.2)+(II-5), (I-74.2)+(II-6), (I-74.2)+(II-9), (I-74.2)+(II-12), (I-74.2)+(III-1), (I-74.2)+(III-4), (I-74.2)+(III-10), (I-74.2)+(III-11), (I-74.2)+(IV-1), (I-74.2)+(IV-2), (I-74.2)+(IV-3), (I-74.2)+(IV-4), (I-74.2)+(IV-5), (I-74.2)+(b-1), (I-74.2)+(b-2), (I-74.2)+(b-3), (I-74.2)+(b-4), (I-74.2)+(b-5), (I-74.2)+(b-6), (I-74.2)+(b-7), (I-74.2)+(b-8), (I-74.2)+(b-9), (I-74.2)+(b-10), (I-74.2)+(b-11), (I-74.2)+(b-12), (I-74.2)+(b-13), (I-74.2)+(b-14), (I-74.2)+(S3-1), (I-74.2)+(S3-2), (I-74.2)+(S3-3), (I-74.2)+(S3-4), (I-74.2)+(S3-5), (I-74.2)+(h-1), (I-74.2)+(h-2), (I-74.2)+(V-1), (I-74.2)+(V-2), (I-74.2)+(V-3), (I-74.2)+(V-4), (I-74.2)+(V-5), (I-74.2)+(V-6), (I-74.2)+(IX-A1), (I-74.2)+(IX-A2), (I-74.2)+(IX-A3), and (I-74.2)+(IX-A4).

(I-74.3)+(II-0), (I-74.3)+(II-1), (I-74.3)+(II-2), (I-74.3)+(II-3), (I-74.3)+(II-4), (I-74.3)+(II-5), (I-74.3)+(II-6), (I-74.3)+(II-9), (I-74.3)+(II-12), (I-74.3)+(III-1), (I-74.3)+(III-4), (I-74.3)+(III-10), (I-74.3)+(III-11), (I-74.3)+(IV-1), (I-74.3)+(IV-2), (I-74.3)+(IV-3), (I-74.3)+(IV-4), (I-74.3)+(IV-5), (I-74.3)+(b-1), (I-74.3)+(b-2), (I-74.3)+(b-3), (I-74.3)+(b-4), (I-74.3)+(b-5), (I-74.3)+(b-6), (I-74.3)+(b-7), (I-74.3)+(b-8), (I-74.3)+(b-9), (I-74.3)+(b-10), (I-74.3)+(b-11), (I-74.3)+(b-12), (I-74.3)+(b-13), (I-74.3)+(b-14), (I-74.3)+(S3-1), (I-74.3)+(S3-2), (I-74.3)+(S3-3), (I-74.3)+(S3-4), (I-74.3)+(S3-5), (I-74.3)+(h-1), (I-74.3)+(h-2), (I-74.3)+(V-1), (I-74.3)+(V-2), (I-74.3)+(V-3), (I-74.3)+(V-4), (I-74.3)+(V-5), (I-74.3)+(V-6), (I-74.3)+(IX-A1), (I-74.3)+(IX-A2), (I-74.3)+(IX-A3), and (I-74.3)+(IX-A4).

(I-75.1)+(II-0), (I-75.1)+(II-1), (I-75.1)+(II-2), (I-75.1)+(II-3), (I-75.1)+(II-4), (I-75.1)+(II-5), (I-75.1)+(II-6), (I-75.1)+(II-9), (I-75.1)+(II-12), (I-75.1)+(III-1), (I-75.1)+(III-4), (I-75.1)+(III-10), (I-75.1)+(III-11), (I-75.1)+(IV-1), (I-75.1)+(IV-2), (I-75.1)+(IV-3), (I-75.1)+(IV-4), (I-75.1)+(IV-5), (I-75.1)+(b-1), (I-75.1)+(b-2), (I-75.1)+(b-3), (I-75.1)+(b-4), (I-75.1)+(b-5), (I-75.1)+(b-6), (I-75.1)+(b-7), (I-75.1)+(b-8), (I-75.1)+(b-9), (I-75.1)+(b-10), (I-75.1)+(b-11), (I-75.1)+(b-12), (I-75.1)+(b-13), (I-75.1)+(b-14), (I-75.1)+(S3-1), (I-75.1)+(S3-2), (I-75.1)+(S3-3), (I-75.1)+(S3-4), (I-75.1)+(S3-5), (I-75.1)+(h-1), (I-75.1)+(h-2), (I-75.1)+(V-1), (I-75.1)+(V-2), (I-75.1)+(V-3), (I-75.1)+(V-4), (I-75.1)+(V-5), (I-75.1)+(V-6), (I-75.1)+(IX-A1), (I-75.1)+(IX-A2), (I-75.1)+(IX-A3), and (I-75.1)+(IX-A4).

(I-75.2)+(II-0), (I-75.2)+(II-1), (I-75.2)+(II-2), (I-75.2)+(II-3), (I-75.2)+(II-4), (I-75.2)+(II-5), (I-75.2)+(II-6), (I-75.2)+(II-9), (I-75.2)+(II-12), (I-75.2)+(III-1), (I-75.2)+(III-4), (I-75.2)+(III-10), (I-75.2)+(III-11), (I-75.2)+(IV-1), (I-75.2)+(IV-2), (I-75.2)+(IV-3), (I-75.2)+(IV-4), (I-75.2)+(IV-5), (I-75.2)+(b-1), (I-75.2)+(b-2), (I-75.2)+(b-3), (I-75.2)+(b-4), (I-75.2)+(b-5), (I-75.2)+(b-6), (I-75.2)+(b-7), (I-75.2)+(b-8), (I-75.2)+(b-9), (I-75.2)+(b-10), (I-75.2)+(b-11), (I-75.2)+(b-12), (I-75.2)+(b-13), (I-75.2)+(b-14), (I-75.2)+(S3-1), (I-75.2)+(S3-2), (I-75.2)+(S3-3), (I-75.2)+(S3-4), (I-75.2)+(S3-5), (I-75.2)+(h-1), (I-75.2)+(h-2), (I-75.2)+(V-1), (I-75.2)+(V-2), (I-75.2)+(V-3), (I-75.2)+(V-4), (I-75.2)+(V-5), (I-75.2)+(V-6), (I-75.2)+(IX-A1), (I-75.2)+(IX-A2), (I-75.2)+(IX-A3), and (I-75.2)+(IX-A4).

(I-75.3)+(II-0), (I-75.3)+(II-1), (I-75.3)+(II-2), (I-75.3)+(II-3), (I-75.3)+(II-4), (I-75.3)+(II-5), (I-75.3)+(II-6), (I-75.3)+(II-9), (I-75.3)+(II-12), (I-75.3)+(III-1), (I-75.3)+(III-4), (I-75.3)+(III-10), (I-75.3)+(III-11), (I-75.3)+(IV-1), (I-75.3)+(IV-2), (I-75.3)+(IV-3), (I-75.3)+(IV-4), (I-75.3)+(IV-5), (I-75.3)+(b-1), (I-75.3)+(b-2), (I-75.3)+(b-3), (I-75.3)+(b-4), (I-75.3)+(b-5), (I-75.3)+(b-6), (I-75.3)+(b-7), (I-75.3)+(b-8), (I-75.3)+(b-9), (I-75.3)+(b-10), (I-75.3)+(b-11), (I-75.3)+(b-12), (I-75.3)+(b-13), (I-75.3)+(b-14), (I-75.3)+(S3-1), (I-75.3)+(S3-2), (I-75.3)+(S3-3), (I-75.3)+(S3-4), (I-75.3)+(S3-5), (I-75.3)+(h-1), (I-75.3)+(h-2), (I-75.3)+(V-1), (I-75.3)+(V-2), (I-75.3)+(V-3), (I-75.3)+(V-4), (I-75.3)+(V-5), (I-75.3)+(V-6), (I-75.3)+(IX-A1), (I-75.3)+(IX-A2), (I-75.3)+(IX-A3), and (I-75.3)+(IX-A4).

(I-76.1)+(II-0), (I-76.1)+(II-1), (I-76.1)+(II-2), (I-76.1)+(II-3), (I-76.1)+(II-4), (I-76.1)+(II-5), (I-76.1)+(II-6), (I-76.1)+(II-9), (I-76.1)+(II-12), (I-76.1)+(III-1), (I-76.1)+(III-4), (I-76.1)+(III-10), (I-76.1)+(III-11), (I-76.1)+(IV-1), (I-76.1)+(IV-2), (I-76.1)+(IV-3), (I-76.1)+(IV-4), (I-76.1)+(IV-5), (I-76.1)+(b-1), (I-76.1)+(b-2), (I-76.1)+(b-3), (I-76.1)+(b-4), (I-76.1)+(b-5), (I-76.1)+(b-6), (I-76.1)+(b-7), (I-76.1)+(b-8), (I-76.1)+(b-9), (I-76.1)+(b-10), (I-76.1)+(b-11), (I-76.1)+(b-12), (I-76.1)+(b-13), (I-76.1)+(b-14), (I-76.1)+(S3-1), (I-76.1)+(S3-2), (I-76.1)+(S3-3), (I-76.1)+(S3-4), (I-76.1)+(S3-5), (I-76.1)+(h-1), (I-76.1)+(h-2), (I-76.1)+(V-1), (I-76.1)+(V-2), (I-76.1)+(V-3), (I-76.1)+(V-4), (I-76.1)+(V-5), (I-76.1)+(V-6), (I-76.1)+(IX-A1), (I-76.1)+(IX-A2), (I-76.1)+(IX-A3), and (I-76.1)+(IX-A4).

(I-76.2)+(II-0), (I-76.2)+(II-1), (I-76.2)+(II-2), (I-76.2)+(II-3), (I-76.2)+(II-4), (I-76.2)+(II-5), (I-76.2)+(II-6), (I-76.2)+(II-9), (I-76.2)+(II-12), (I-76.2)+(III-1), (I-76.2)+(III-4), (I-76.2)+(III-10), (I-76.2)+(III-11), (I-76.2)+(IV-1), (I-76.2)+(IV-2), (I-76.2)+(IV-3), (I-76.2)+(IV-4), (I-76.2)+(IV-5), (I-76.2)+(b-1), (I-76.2)+(b-2), (I-76.2)+(b-3), (I-76.2)+(b-4), (I-76.2)+(b-5), (I-76.2)+(b-6), (I-76.2)+(b-7), (I-76.2)+(b-8), (I-76.2)+(b-9), (I-76.2)+(b-10), (I-76.2)+(b-11), (I-76.2)+(b-12), (I-76.2)+(b-13), (I-76.2)+(b-14), (I-76.2)+(S3-1), (I-76.2)+(S3-2), (I-76.2)+(S3-3), (I-76.2)+(S3-4), (I-76.2)+(S3-5), (I-76.2)+(h-1), (I-76.2)+(h-2), (I-76.2)+(V-1), (I-76.2)+(V-2), (I-76.2)+(V-3), (I-76.2)+(V-4), (I-76.2)+(V-5), (I-76.2)+(V-6), (I-76.2)+(IX-A1), (I-76.2)+(IX-A2), (I-76.2)+(IX-A3), and (I-76.2)+(IX-A4).

(I-76.3)+(II-0), (I-76.3)+(II-1), (I-76.3)+(II-2), (I-76.3)+(II-3), (I-76.3)+(II-4), (I-76.3)+(II-5), (I-76.3)+(II-6), (I-76.3)+(II-9), (I-76.3)+(II-12), (I-76.3)+(II-1), (I-76.3)+(III-4), (I-76.3)+(III-10), (I-76.3)+(III-11), (I-76.3)+(IV-1), (I-76.3)+(IV-2), (I-76.3)+(IV-3), (I-76.3)+(IV-4), (I-76.3)+(IV-5), (I-76.3)+(b-1), (I-76.3)+(b-2), (I-76.3)+(b-3), (I-76.3)+(b-4), (I-76.3)+(b-5), (I-76.3)+(b-6), (I-76.3)+(b-7), (I-76.3)+(b-8), (I-76.3)+(b-9), (I-76.3)+(b-10), (I-76.3)+(b-11), (I-76.3)+(b-12), (I-76.3)+(b-13), (I-76.3)+(b-14), (I-76.3)+(S3-1), (I-76.3)+(S3-2), (I-76.3)+(S3-3), (I-76.3)+(S3-4), (I-76.3)+(S3-5), (I-76.3)+(h-1), (I-76.3)+(h-2), (I-76.3)+(V-1), (I-76.3)+(V-2), (I-76.3)+(V-3), (I-76.3)+(V-4), (I-76.3)+(V-5), (I-76.3)+(V-6), (I-76.3)+(IX-A1), (I-76.3)+(IX-A2), (I-76.3)+(IX-A3), and (I-76.3)+(IX-A4).

(I-77.1)+(II-0), (I-77.1)+(II-1), (I-77.1)+(II-2), (I-77.1)+(II-3), (I-77.1)+(II-4), (I-77.1)+(II-5), (I-77.1)+(II-6), (I-77.1)+(II-9), (I-77.1)+(II-12), (I-77.1)+(III-1), (I-77.1)+(III-4), (I-77.1)+(III-10), (I-77.1)+(III-11), (I-77.1)+(IV-1), (I-77.1)+(IV-2), (I-77.1)+(IV-3), (I-77.1)+(IV-4), (I-77.1)+(IV-5), (I-77.1)+(b-1), (I-77.1)+(b-2), (I-77.1)+(b-3), (I-77.1)+(b-4), (I-77.1)+(b-5), (I-77.1)+(b-6), (I-77.1)+(b-7), (I-77.1)+(b-8), (I-77.1)+(b-9), (I-77.1)+(b-10), (I-77.1)+(b-11), (I-77.1)+(b-12), (I-77.1)+(b-13), (I-77.1)+(b-14), (I-77.1)+(S3-1), (I-77.1)+(S3-2), (I-77.1)+(S3-3), (I-77.1)+(S3-4), (I-77.1)+(S3-5), (I-77.1)+(h-1), (I-77.1)+(h-2), (I-77.1)+(V-1), (I-77.1)+(V-2), (I-77.1)+(V-3), (I-77.1)+(V-4), (I-77.1)+(V-5), (I-77.1)+(V-6), (I-77.1)+(IX-A1), (I-77.1)+(IX-A2), (I-77.1)+(IX-A3), and (I-77.1)+(IX-A4).

(I-77.2)+(II-0), (I-77.2)+(II-1), (I-77.2)+(II-2), (I-77.2)+(II-3), (I-77.2)+(II-4), (I-77.2)+(II-5), (I-77.2)+(II-6), (I-77.2)+(II-9), (I-77.2)+(II-12), (I-77.2)+(III-1), (I-77.2)+(III-4), (I-77.2)+(III-10), (I-77.2)+(III-11), (I-77.2)+(IV-1), (I-77.2)+(IV-2), (I-77.2)+(IV-3), (I-77.2)+(IV-4), (I-77.2)+(IV-5), (I-77.2)+(b-1), (I-77.2)+(b-2), (I-77.2)+(b-3), (I-77.2)+(b-4), (I-77.2)+(b-5), (I-77.2)+(b-6), (I-77.2)+(b-7), (I-77.2)+(b-8), (I-77.2)+(b-9), (I-77.2)+(b-10), (I-77.2)+(b-11), (I-77.2)+(b-12), (I-77.2)+(b-13), (I-77.2)+(b-14), (I-77.2)+(S3-1), (I-77.2)+(S3-2), (I-77.2)+(S3-3), (I-77.2)+(S3-4), (I-77.2)+(S3-5), (I-77.2)+(h-1), (I-77.2)+(h-2), (I-77.2)+(V-1), (I-77.2)+(V-2), (I-77.2)+(V-3), (I-77.2)+(V-4), (I-77.2)+(V-5), (I-77.2)+(V-6), (I-77.2)+(IX-A1), (I-77.2)+(IX-A2), (I-77.2)+(IX-A3), and (I-77.2)+(IX-A4).

(I-77.3)+(II-0), (I-77.3)+(II-1), (I-77.3)+(II-2), (I-77.3)+(II-3), (I-77.3)+(II-4), (I-77.3)+(II-5), (I-77.3)+(II-6), (I-77.3)+(II-9), (I-77.3)+(II-12), (I-77.3)+(III-1), (I-77.3)+(III-4), (I-77.3)+(III-10), (I-77.3)+(III-11), (I-77.3)+(IV-1), (I-77.3)+(IV-2), (I-77.3)+(IV-3), (I-77.3)+(IV-4), (I-77.3)+(IV-5), (I-77.3)+(b-1), (I-77.3)+(b-2), (I-77.3)+(b-3), (I-77.3)+(b-4), (I-77.3)+(b-5), (I-77.3)+(b-6), (I-77.3)+(b-7), (I-77.3)+(b-8), (I-77.3)+(b-9), (I-77.3)+(b-10), (I-77.3)+(b-11), (I-77.3)+(b-12), (I-77.3)+(b-13), (I-77.3)+(b-14), (I-77.3)+(S3-1), (I-77.3)+(S3-2), (I-77.3)+(S3-3), (I-77.3)+(S3-4), (I-77.3)+(S3-5), (I-77.3)+(h-1), (I-77.3)+(h-2), (I-77.3)+(V-1), (I-77.3)+(V-2), (I-77.3)+(V-3), (I-77.3)+(V-4), (I-77.3)+(V-5), (I-77.3)+(V-6), (I-77.3)+(IX-A1), (I-77.3)+(IX-A2), (I-77.3)+(IX-A3), and (I-77.3)+(IX-A4).

(I-78.1)+(II-0), (I-78.1)+(II-1), (I-78.1)+(II-2), (I-78.1)+(II-3), (I-78.1)+(II-4), (I-78.1)+(II-5), (I-78.1)+(II-6), (I-78.1)+(II-9), (I-78.1)+(II-12), (I-78.1)+(III-1), (I-78.1)+(III-4), (I-78.1)+(III-10), (I-78.1)+(III-11), (I-78.1)+(IV-1), (I-78.1)+(IV-2), (I-78.1)+(IV-3), (I-78.1)+(IV-4), (I-78.1)+(IV-5), (I-78.1)+(b-1), (I-78.1)+(b-2), (I-78.1)+(b-3), (I-78.1)+(b-4), (I-78.1)+(b-5), (I-78.1)+(b-6), (I-78.1)+(b-7), (I-78.1)+(b-8), (I-78.1)+(b-9), (I-78.1)+(b-10), (I-78.1)+(b-11), (I-78.1)+(b-12), (I-78.1)+(b-13), (I-78.1)+(b-14), (I-78.1)+(S3-1), (I-78.1)+(S3-2), (I-78.1)+(S3-3), (I-78.1)+(S3-4), (I-78.1)+(S3-5), (I-78.1)+(h-1), (I-78.1)+(h-2), (I-78.1)+(V-1), (I-78.1)+(V-2), (I-78.1)+(V-3), (I-78.1)+(V-4), (I-78.1)+(V-5), (I-78.1)+(V-6), (I-78.1)+(IX-A1), (I-78.1)+(IX-A2), (I-78.1)+(IX-A3), and (I-78.1)+(IX-A4).

(I-78.2)+(II-0), (I-78.2)+(II-1), (I-78.2)+(II-2), (I-78.2)+(II-3), (I-78.2)+(II-4), (I-78.2)+(II-5), (I-78.2)+(II-6), (I-78.2)+(II-9), (I-78.2)+(II-12), (I-78.2)+(II-1), (I-78.2)+(III-4), (I-78.2)+(III-10), (I-78.2)+(III-11), (I-78.2)+(IV-1), (I-78.2)+(IV-2), (I-78.2)+(IV-3), (I-78.2)+(IV-4), (I-78.2)+(IV-5), (I-78.2)+(b-1), (I-78.2)+(b-2), (I-78.2)+(b-3), (I-78.2)+(b-4), (I-78.2)+(b-5), (I-78.2)+(b-6), (I-78.2)+(b-7), (I-78.2)+(b-8), (I-78.2)+(b-9), (I-78.2)+(b-10), (I-78.2)+(b-11), (I-78.2)+(b-12), (I-78.2)+(b-13), (I-78.2)+(b-14), (I-78.2)+(S3-1), (I-78.2)+(S3-2), (I-78.2)+(S3-3), (I-78.2)+(S3-4), (I-78.2)+(S3-5), (I-78.2)+(h-1), (I-78.2)+(h-2), (I-78.2)+(V-1), (I-78.2)+(V-2), (I-78.2)+(V-3), (I-78.2)+(V-4), (I-78.2)+(V-5), (I-78.2)+(V-6), (I-78.2)+(IX-A1), (I-78.2)+(IX-A2), (I-78.2)+(IX-A3), and (I-78.2)+(IX-A4).

(I-78.3)+(II-0), (I-78.3)+(II-1), (I-78.3)+(II-2), (I-78.3)+(II-3), (I-78.3)+(II-4), (I-78.3)+(II-5), (I-78.3)+(II-6), (I-78.3)+(II-9), (I-78.3)+(II-12), (I-78.3)+(III-1), (I-78.3)+(III-4), (I-78.3)+(III-10), (I-78.3)+(III-11), (I-78.3)+(IV-1), (I-78.3)+(IV-2), (I-78.3)+(IV-3), (I-78.3)+(IV-4), (I-78.3)+(IV-5), (I-78.3)+(b-1), (I-78.3)+(b-2), (I-78.3)+(b-3), (I-78.3)+(b-4), (I-78.3)+(b-5), (I-78.3)+(b-6), (I-78.3)+(b-7), (I-78.3)+(b-8), (I-78.3)+(b-9), (I-78.3)+(b-10), (I-78.3)+(b-11), (I-78.3)+(b-12), (I-78.3)+(b-13), (I-78.3)+(b-14), (I-78.3)+(S3-1), (I-78.3)+(S3-2), (I-78.3)+(S3-3), (I-78.3)+(S3-4), (I-78.3)+(S3-5), (I-78.3)+(h-1), (I-78.3)+(h-2), (I-78.3)+(V-1), (I-78.3)+(V-2), (I-78.3)+(V-3), (I-78.3)+(V-4), (I-78.3)+(V-5), (I-78.3)+(V-6), (I-78.3)+(IX-A1), (I-78.3)+(IX-A2), (I-78.3)+(IX-A3), and (I-78.3)+(IX-A4).

(I-79.1)+(II-0), (I-79.1)+(II-1), (I-79.1)+(II-2), (I-79.1)+(II-3), (I-79.1)+(II-4), (I-79.1)+(II-5), (I-79.1)+(II-6), (I-79.1)+(II-9), (I-79.1)+(II-12), (I-79.1)+(III-1), (I-79.1)+(III-4), (I-79.1)+(III-10), (I-79.1)+(III-11), (I-79.1)+(IV-1), (I-79.1)+(IV-2), (I-79.1)+(IV-3), (I-79.1)+(IV-4), (I-79.1)+(IV-5), (I-79.1)+(b-1), (I-79.1)+(b-2), (I-79.1)+(b-3), (I-79.1)+(b-4), (I-79.1)+(b-5), (I-79.1)+(b-6), (I-79.1)+(b-7), (I-79.1)+(b-8), (I-79.1)+(b-9), (I-79.1)+(b-10), (I-79.1)+(b-11), (I-79.1)+(b-12), (I-79.1)+(b-13), (I-79.1)+(b-14), (I-79.1)+(S3-1), (I-79.1)+(S3-2), (I-79.1)+(S3-3), (I-79.1)+(S3-4), (I-79.1)+(S3-5), (I-79.1)+(h-1), (I-79.1)+(h-2), (I-79.1)+(V-1), (I-79.1)+(V-2), (I-79.1)+(V-3), (I-79.1)+(V-4), (I-79.1)+(V-5), (I-79.1)+(V-6), (I-79.1)+(IX-A1), (I-79.1)+(IX-A2), (I-79.1)+(IX-A3), and (I-79.1)+(IX-A4).

(I-79.2)+(II-0), (I-79.2)+(II-1), (I-79.2)+(II-2), (I-79.2)+(II-3), (I-79.2)+(II-4), (I-79.2)+(II-5), (I-79.2)+(II-6), (I-79.2)+(II-9), (I-79.2)+(II-12), (I-79.2)+(II-1), (I-79.2)+(III-4), (I-79.2)+(III-10), (I-79.2)+(III-11), (I-79.2)+(IV-1), (I-79.2)+(IV-2), (I-79.2)+(IV-3), (I-79.2)+(IV-4), (I-79.2)+(IV-5), (I-79.2)+(b-1), (I-79.2)+(b-2), (I-79.2)+(b-3), (I-79.2)+(b-4), (I-79.2)+(b-5), (I-79.2)+(b-6), (I-79.2)+(b-7), (I-79.2)+(b-8), (I-79.2)+(b-9), (I-79.2)+(b-10), (I-79.2)+(b-11), (I-79.2)+(b-12), (I-79.2)+(b-13), (I-79.2)+(b-14), (I-79.2)+(S3-1), (I-79.2)+(S3-2), (I-79.2)+(S3-3), (I-79.2)+(S3-4), (I-79.2)+(S3-5), (I-79.2)+(h-1), (I-79.2)+(h-2), (I-79.2)+(V-1), (I-79.2)+(V-2), (I-79.2)+(V-3), (I-79.2)+(V-4), (I-79.2)+(V-5), (I-79.2)+(V-6), (I-79.2)+(IX-A1), (I-79.2)+(IX-A2), (I-79.2)+(IX-A3), and (I-79.2)+(IX-A4).

(I-79.3)+(II-0), (I-79.3)+(II-1), (I-79.3)+(II-2), (I-79.3)+(II-3), (I-79.3)+(II-4), (I-79.3)+(II-5), (I-79.3)+(II-6), (I-79.3)+(II-9), (I-79.3)+(II-12), (I-79.3)+(III-1), (I-79.3)+(III-4), (I-79.3)+(III-10), (I-79.3)+(III-11), (I-79.3)+(IV-1), (I-79.3)+(IV-2), (I-79.3)+(IV-3), (I-79.3)+(IV-4), (I-79.3)+(IV-5), (I-79.3)+(b-1), (I-79.3)+(b-2), (I-79.3)+(b-3), (I-79.3)+(b-4), (I-79.3)+(b-5), (I-79.3)+(b-6), (I-79.3)+(b-7), (I-79.3)+(b-8), (I-79.3)+(b-9), (I-79.3)+(b-10), (I-79.3)+(b-11), (I-79.3)+(b-12), (I-79.3)+(b-13), (I-79.3)+(b-14), (I-79.3)+(S3-1), (I-79.3)+(S3-2), (I-79.3)+(S3-3), (I-79.3)+(S3-4), (I-79.3)+(S3-5), (I-79.3)+(h-1), (I-79.3)+(h-2), (I-79.3)+(V-1), (I-79.3)+(V-2), (I-79.3)+(V-3), (I-79.3)+(V-4), (I-79.3)+(V-5), (I-79.3)+(V-6), (I-79.3)+(IX-A1), (I-79.3)+(IX-A2), (I-79.3)+(IX-A3), and (I-79.3)+(IX-A4).

(I-80.1)+(II-0), (I-80.1)+(II-1), (I-80.1)+(II-2), (I-80.1)+(II-3), (I-80.1)+(II-4), (I-80.1)+(II-5), (I-80.1)+(II-6), (I-80.1)+(II-9), (I-80.1)+(II-12), (I-80.1)+(III-1), (I-80.1)+(III-4), (I-80.1)+(III-10), (I-80.1)+(III-11), (I-80.1)+(IV-1), (I-80.1)+(IV-2), (I-80.1)+(IV-3), (I-80.1)+(IV-4), (I-80.1)+(IV-5), (I-80.1)+(b-1), (I-80.1)+(b-2), (I-80.1)+(b-3), (I-80.1)+(b-4), (I-80.1)+(b-5), (I-80.1)+(b-6), (I-80.1)+(b-7), (I-80.1)+(b-8), (I-80.1)+(b-9), (I-80.1)+(b-10), (I-80.1)+(b-11), (I-80.1)+(b-12), (I-80.1)+(b-13), (I-80.1)+(b-14), (I-80.1)+(S3-1), (I-80.1)+(S3-2), (I-80.1)+(S3-3), (I-80.1)+(S3-4), (I-80.1)+(S3-5), (I-80.1)+(h-1), (I-80.1)+(h-2), (I-80.1)+(V-1), (I-80.1)+(V-2), (I-80.1)+(V-3), (I-80.1)+(V-4), (I-80.1)+(V-5), (I-80.1)+(V-6), (I-80.1)+(IX-A1), (I-80.1)+(IX-A2), (I-80.1)+(IX-A3), and (I-80.1)+(IX-A4).

(I-80.2)+(II-0), (I-80.2)+(II-1), (I-80.2)+(II-2), (I-80.2)+(II-3), (I-80.2)+(II-4), (I-80.2)+(II-5), (I-80.2)+(II-6), (I-80.2)+(II-9), (I-80.2)+(II-12), (I-80.2)+(III-1), (I-80.2)+(III-4), (I-80.2)+(III-10), (I-80.2)+(III-11), (I-80.2)+(IV-1), (I-80.2)+(IV-2), (I-80.2)+(IV-3), (I-80.2)+(IV-4), (I-80.2)+(IV-5), (I-80.2)+(b-1), (I-80.2)+(b-2), (I-80.2)+(b-3), (I-80.2)+(b-4), (I-80.2)+(b-5), (I-80.2)+(b-6), (I-80.2)+(b-7), (I-80.2)+(b-8), (I-80.2)+(b-9), (I-80.2)+(b-10), (I-80.2)+(b-11), (I-80.2)+(b-12), (I-80.2)+(b-13), (I-80.2)+(b-14), (I-80.2)+(S3-1), (I-80.2)+(S3-2), (I-80.2)+(S3-3), (I-80.2)+(S3-4), (I-80.2)+(S3-5), (I-80.2)+(h-1), (I-80.2)+(h-2), (I-80.2)+(V-1), (I-80.2)+(V-2), (I-80.2)+(V-3), (I-80.2)+(V-4), (I-80.2)+(V-5), (I-80.2)+(V-6), (I-80.2)+(IX-A1), (I-80.2)+(IX-A2), (I-80.2)+(IX-A3), and (I-80.2)+(IX-A4).

(I-80.3)+(II-0), (I-80.3)+(II-1), (I-80.3)+(II-2), (I-80.3)+(II-3), (I-80.3)+(II-4), (I-80.3)+(II-5), (I-80.3)+(II-6), (I-80.3)+(II-9), (I-80.3)+(II-12), (I-80.3)+(III-1), (I-80.3)+(III-4), (I-80.3)+(III-10), (I-80.3)+(III-11), (I-80.3)+(IV-1), (I-80.3)+(IV-2), (I-80.3)+(IV-3), (I-80.3)+(IV-4), (I-80.3)+(IV-5), (I-80.3)+(b-1), (I-80.3)+(b-2), (I-80.3)+(b-3), (I-80.3)+(b-4), (I-80.3)+(b-5), (I-80.3)+(b-6), (I-80.3)+(b-7), (I-80.3)+(b-8), (I-80.3)+(b-9), (I-80.3)+(b-10), (I-80.3)+(b-11), (I-80.3)+(b-12), (I-80.3)+(b-13), (I-80.3)+(b-14), (I-80.3)+(S3-1), (I-80.3)+(S3-2), (I-80.3)+(S3-3), (I-80.3)+(S3-4), (I-80.3)+(S3-5), (I-80.3)+(h-1), (I-80.3)+(h-2), (I-80.3)+(V-1), (I-80.3)+(V-2), (I-80.3)+(V-3), (I-80.3)+(V-4), (I-80.3)+(V-5), (I-80.3)+(V-6), (I-80.3)+(IX-A1), (I-80.3)+(IX-A2), (I-80.3)+(IX-A3), and (I-80.3)+(IX-A4).

(I-81.1)+(II-0), (I-81.1)+(II-1), (I-81.1)+(II-2), (I-81.1)+(II-3), (I-81.1)+(II-4), (I-81.1)+(II-5), (I-81.1)+(II-6), (I-81.1)+(II-9), (I-81.1)+(II-12), (I-81.1)+(III-1), (I-81.1)+(III-4), (I-81.1)+(III-10), (I-81.1)+(III-11), (I-81.1)+(IV-1), (I-81.1)+(IV-2), (I-81.1)+(IV-3), (I-81.1)+(IV-4), (I-81.1)+(IV-5), (I-81.1)+(b-1), (I-81.1)+(b-2), (I-81.1)+(b-3), (I-81.1)+(b-4), (I-81.1)+(b-5), (I-81.1)+(b-6), (I-81.1)+(b-7), (I-81.1)+(b-8), (I-81.1)+(b-9), (I-81.1)+(b-10), (I-81.1)+(b-11), (I-81.1)+(b-12), (I-81.1)+(b-13), (I-81.1)+(b-14), (I-81.1)+(S3-1), (I-81.1)+(S3-2), (I-81.1)+(S3-3), (I-81.1)+(S3-4), (I-81.1)+(S3-5), (I-81.1)+(h-1), (I-81.1)+(h-2), (I-81.1)+(V-1), (I-81.1)+(V-2), (I-81.1)+(V-3), (I-81.1)+(V-4), (I-81.1)+(V-5), (I-81.1)+(V-6), (I-81.1)+(IX-A1), (I-81.1)+(IX-A2), (I-81.1)+(IX-A3), and (I-81.1)+(IX-A4).

(I-81.2)+(II-0), (I-81.2)+(II-1), (I-81.2)+(II-2), (I-81.2)+(II-3), (I-81.2)+(II-4), (I-81.2)+(II-5), (I-81.2)+(II-6), (I-81.2)+(II-9), (I-81.2)+(II-12), (I-81.2)+(III-1), (I-81.2)+(III-4), (I-81.2)+(III-10), (I-81.2)+(III-11), (I-81.2)+(IV-1), (I-81.2)+(IV-2), (I-81.2)+(IV-3), (I-81.2)+(IV-4), (I-81.2)+(IV-5), (I-81.2)+(b-1), (I-81.2)+(b-2), (I-81.2)+(b-3), (I-81.2)+(b-4), (I-81.2)+(b-5), (I-81.2)+(b-6), (I-81.2)+(b-7), (I-81.2)+(b-8), (I-81.2)+(b-9), (I-81.2)+(b-10), (I-81.2)+(b-11), (I-81.2)+(b-12), (I-81.2)+(b-13), (I-81.2)+(b-14), (I-81.2)+(S3-1), (I-81.2)+(S3-2), (I-81.2)+(S3-3), (I-81.2)+(S3-4), (I-81.2)+(S3-5), (I-81.2)+(h-1), (I-81.2)+(h-2), (I-81.2)+(V-1), (I-81.2)+(V-2), (I-81.2)+(V-3), (I-81.2)+(V-4), (I-81.2)+(V-5), (I-81.2)+(V-6), (I-81.2)+(IX-A1), (I-81.2)+(IX-A2), (I-81.2)+(IX-A3), and (I-81.2)+(IX-A4).

(I-81.3)+(II-0), (I-81.3)+(II-1), (I-81.3)+(II-2), (I-81.3)+(II-3), (I-81.3)+(II-4), (I-81.3)+(II-5), (I-81.3)+(II-6), (I-81.3)+(II-9), (I-81.3)+(II-12), (I-81.3)+(III-1), (I-81.3)+(III-4), (I-81.3)+(III-10), (I-81.3)+(III-11), (I-81.3)+(IV-1), (I-81.3)+(IV-2), (I-81.3)+(IV-3), (I-81.3)+(IV-4), (I-81.3)+(IV-5), (I-81.3)+(b-1), (I-81.3)+(b-2), (I-81.3)+(b-3), (I-81.3)+(b-4), (I-81.3)+(b-5), (I-81.3)+(b-6), (I-81.3)+(b-7), (I-81.3)+(b-8), (I-81.3)+(b-9), (I-81.3)+(b-10), (I-81.3)+(b-11), (I-81.3)+(b-12), (I-81.3)+(b-13), (I-81.3)+(b-14), (I-81.3)+(S3-1), (I-81.3)+(S3-2), (I-81.3)+(S3-3), (I-81.3)+(S3-4), (I-81.3)+(S3-5), (I-81.3)+(h-1), (I-81.3)+(h-2), (I-81.3)+(V-1), (I-81.3)+(V-2), (I-81.3)+(V-3), (I-81.3)+(V-4), (I-81.3)+(V-5), (I-81.3)+(V-6), (I-81.3)+(IX-A1), (I-81.3)+(IX-A2), (I-81.3)+(IX-A3), and (I-81.3)+(IX-A4).

(I-82.1)+(II-0), (I-82.1)+(II-1), (I-82.1)+(II-2), (I-82.1)+(II-3), (I-82.1)+(II-4), (I-82.1)+(II-5), (I-82.1)+(II-6), (I-82.1)+(II-9), (I-82.1)+(II-12), (I-82.1)+(III-1), (I-82.1)+(III-4), (I-82.1)+(III-10), (I-82.1)+(III-11), (I-82.1)+(IV-1), (I-82.1)+(IV-2), (I-82.1)+(IV-3), (I-82.1)+(IV-4), (I-82.1)+(IV-5), (I-82.1)+(b-1), (I-82.1)+(b-2), (I-82.1)+(b-3), (I-82.1)+(b-4), (I-82.1)+(b-5), (I-82.1)+(b-6), (I-82.1)+(b-7), (I-82.1)+(b-8), (I-82.1)+(b-9), (I-82.1)+(b-10), (I-82.1)+(b-11), (I-82.1)+(b-12), (I-82.1)+(b-13), (I-82.1)+(b-14), (I-82.1)+(S3-1), (I-82.1)+(S3-2), (I-82.1)+(S3-3), (I-82.1)+(S3-4), (I-82.1)+(S3-5), (I-82.1)+(h-1), (I-82.1)+(h-2), (I-82.1)+(V-1), (I-82.1)+(V-2), (I-82.1)+(V-3), (I-82.1)+(V-4), (I-82.1)+(V-5), (I-82.1)+(V-6), (I-82.1)+(IX-A1), (I-82.1)+(IX-A2), (I-82.1)+(IX-A3), and (I-82.1)+(IX-A4).

(I-82.2)+(II-0), (I-82.2)+(II-1), (I-82.2)+(II-2), (I-82.2)+(II-3), (I-82.2)+(II-4), (I-82.2)+(II-5), (I-82.2)+(II-6), (I-82.2)+(II-9), (I-82.2)+(II-12), (I-82.2)+(III-1), (I-82.2)+(III-4), (I-82.2)+(III-10), (I-82.2)+(III-11), (I-82.2)+(IV-1), (I-82.2)+(IV-2), (I-82.2)+(IV-3), (I-82.2)+(IV-4), (I-82.2)+(IV-5), (I-82.2)+(b-1), (I-82.2)+(b-2), (I-82.2)+(b-3), (I-82.2)+(b-4), (I-82.2)+(b-5), (I-82.2)+(b-6), (I-82.2)+(b-7), (I-82.2)+(b-8), (I-82.2)+(b-9), (I-82.2)+(b-10), (I-82.2)+(b-11), (I-82.2)+(b-12), (I-82.2)+(b-13), (I-82.2)+(b-14), (I-82.2)+(S3-1), (I-82.2)+(S3-2), (I-82.2)+(S3-3), (I-82.2)+(S3-4), (I-82.2)+(S3-5), (I-82.2)+(h-1), (I-82.2)+(h-2), (I-82.2)+(V-1), (I-82.2)+(V-2), (I-82.2)+(V-3), (I-82.2)+(V-4), (I-82.2)+(V-5), (I-82.2)+(V-6), (I-82.2)+(IX-A1), (I-82.2)+(IX-A2), (I-82.2)+(IX-A3), and (I-82.2)+(IX-A4).

(I-82.3)+(II-0), (I-82.3)+(II-1), (I-82.3)+(II-2), (I-82.3)+(II-3), (I-82.3)+(II-4), (I-82.3)+(II-5), (I-82.3)+(II-6), (I-82.3)+(II-9), (I-82.3)+(II-12), (I-82.3)+(II-1), (I-82.3)+(III-4), (I-82.3)+(III-10), (I-82.3)+(III-11), (I-82.3)+(IV-1), (I-82.3)+(IV-2), (I-82.3)+(IV-3), (I-82.3)+(IV-4), (I-82.3)+(IV-5), (I-82.3)+(b-1), (I-82.3)+(b-2), (I-82.3)+(b-3), (I-82.3)+(b-4), (I-82.3)+(b-5), (I-82.3)+(b-6), (I-82.3)+(b-7), (I-82.3)+(b-8), (I-82.3)+(b-9), (I-82.3)+(b-10), (I-82.3)+(b-11), (I-82.3)+(b-12), (I-82.3)+(b-13), (I-82.3)+(b-14), (I-82.3)+(S3-1), (I-82.3)+(S3-2), (I-82.3)+(S3-3), (I-82.3)+(S3-4), (I-82.3)+(S3-5), (I-82.3)+(h-1), (I-82.3)+(h-2), (I-82.3)+(V-1), (I-82.3)+(V-2), (I-82.3)+(V-3), (I-82.3)+(V-4), (I-82.3)+(V-5), (I-82.3)+(V-6), (I-82.3)+(IX-A1), (I-82.3)+(IX-A2), (I-82.3)+(IX-A3), and (I-82.3)+(IX-A4).

(I-83.1)+(II-0), (I-83.1)+(II-1), (I-83.1)+(II-2), (I-83.1)+(II-3), (I-83.1)+(II-4), (I-83.1)+(II-5), (I-83.1)+(II-6), (I-83.1)+(II-9), (I-83.1)+(II-12), (I-83.1)+(II-1), (I-83.1)+(III-4), (I-83.1)+(III-10), (I-83.1)+(III-11), (I-83.1)+(IV-1), (I-83.1)+(IV-2), (I-83.1)+(IV-3), (I-83.1)+(IV-4), (I-83.1)+(IV-5), (I-83.1)+(b-1), (I-83.1)+(b-2), (I-83.1)+(b-3), (I-83.1)+(b-4), (I-83.1)+(b-5), (I-83.1)+(b-6), (I-83.1)+(b-7), (I-83.1)+(b-8), (I-83.1)+(b-9), (I-83.1)+(b-10), (I-83.1)+(b-11), (I-83.1)+(b-12), (I-83.1)+(b-13), (I-83.1)+(b-14), (I-83.1)+(S3-1), (I-83.1)+(S3-2), (I-83.1)+(S3-3), (I-83.1)+(S3-4), (I-83.1)+(S3-5), (I-83.1)+(h-1), (I-83.1)+(h-2), (I-83.1)+(V-1), (I-83.1)+(V-2), (I-83.1)+(V-3), (I-83.1)+(V-4), (I-83.1)+(V-5), (I-83.1)+(V-6), (I-83.1)+(IX-A1), (I-83.1)+(IX-A2), (I-83.1)+(IX-A3), and (I-83.1)+(IX-A4).

(I-83.2)+(II-0), (I-83.2)+(II-1), (I-83.2)+(II-2), (I-83.2)+(II-3), (I-83.2)+(II-4), (I-83.2)+(II-5), (I-83.2)+(II-6), (I-83.2)+(II-9), (I-83.2)+(II-12), (I-83.2)+(III-1), (I-83.2)+(III-4), (I-83.2)+(III-10), (I-83.2)+(III-11), (I-83.2)+(IV-1), (I-83.2)+(IV-2), (I-83.2)+(IV-3), (I-83.2)+(IV-4), (I-83.2)+(IV-5), (I-83.2)+(b-1), (I-83.2)+(b-2), (I-83.2)+(b-3), (I-83.2)+(b-4), (I-83.2)+(b-5), (I-83.2)+(b-6), (I-83.2)+(b-7), (I-83.2)+(b-8), (I-83.2)+(b-9), (I-83.2)+(b-10), (I-83.2)+(b-11), (I-83.2)+(b-12), (I-83.2)+(b-13), (I-83.2)+(b-14), (I-83.2)+(S3-1), (I-83.2)+(S3-2), (I-83.2)+(S3-3), (I-83.2)+(S3-4), (I-83.2)+(S3-5), (I-83.2)+(h-1), (I-83.2)+(h-2), (I-83.2)+(V-1), (I-83.2)+(V-2), (I-83.2)+(V-3), (I-83.2)+(V-4), (I-83.2)+(V-5), (I-83.2)+(V-6), (I-83.2)+(IX-A1), (I-83.2)+(IX-A2), (I-83.2)+(IX-A3), and (I-83.2)+(IX-A4).

(I-83.3)+(II-0), (I-83.3)+(II-1), (I-83.3)+(II-2), (I-83.3)+(II-3), (I-83.3)+(II-4), (I-83.3)+(II-5), (I-83.3)+(II-6), (I-83.3)+(II-9), (I-83.3)+(II-12), (I-83.3)+(III-1), (I-83.3)+(III-4), (I-83.3)+(III-10), (I-83.3)+(III-11), (I-83.3)+(IV-1), (I-83.3)+(IV-2), (I-83.3)+(IV-3), (I-83.3)+(IV-4), (I-83.3)+(IV-5), (I-83.3)+(b-1), (I-83.3)+(b-2), (I-83.3)+(b-3), (I-83.3)+(b-4), (I-83.3)+(b-5), (I-83.3)+(b-6), (I-83.3)+(b-7), (I-83.3)+(b-8), (I-83.3)+(b-9), (I-83.3)+(b-10), (I-83.3)+(b-11), (I-83.3)+(b-12), (I-83.3)+(b-13), (I-83.3)+(b-14), (I-83.3)+(S3-1), (I-83.3)+(S3-2), (I-83.3)+(S3-3), (I-83.3)+(S3-4), (I-83.3)+(S3-5), (I-83.3)+(h-1), (I-83.3)+(h-2), (I-83.3)+(V-1), (I-83.3)+(V-2), (I-83.3)+(V-3), (I-83.3)+(V-4), (I-83.3)+(V-5), (I-83.3)+(V-6), (I-83.3)+(IX-A1), (I-83.3)+(IX-A2), (I-83.3)+(IX-A3), and (I-83.3)+(IX-A4).

(I-84.1)+(II-0), (I-84.1)+(II-1), (I-84.1)+(II-2), (I-84.1)+(II-3), (I-84.1)+(II-4), (I-84.1)+(II-5), (I-84.1)+(II-6), (I-84.1)+(II-9), (I-84.1)+(II-12), (I-84.1)+(III-1), (I-84.1)+(III-4), (I-84.1)+(III-10), (I-84.1)+(III-11), (I-84.1)+(IV-1), (I-84.1)+(IV-2), (I-84.1)+(IV-3), (I-84.1)+(IV-4), (I-84.1)+(IV-5), (I-84.1)+(b-1), (I-84.1)+(b-2), (I-84.1)+(b-3), (I-84.1)+(b-4), (I-84.1)+(b-5), (I-84.1)+(b-6), (I-84.1)+(b-7), (I-84.1)+(b-8), (I-84.1)+(b-9), (I-84.1)+(b-10), (I-84.1)+(b-11), (I-84.1)+(b-12), (I-84.1)+(b-13), (I-84.1)+(b-14), (I-84.1)+(S3-1), (I-84.1)+(S3-2), (I-84.1)+(S3-3), (I-84.1)+(S3-4), (I-84.1)+(S3-5), (I-84.1)+(h-1), (I-84.1)+(h-2), (I-84.1)+(V-1), (I-84.1)+(V-2), (I-84.1)+(V-3), (I-84.1)+(V-4), (I-84.1)+(V-5), (I-84.1)+(V-6), (I-84.1)+(IX-A1), (I-84.1)+(IX-A2), (I-84.1)+(IX-A3), and (I-84.1)+(IX-A4).

(I-84.2)+(II-0), (I-84.2)+(II-1), (I-84.2)+(II-2), (I-84.2)+(II-3), (I-84.2)+(II-4), (I-84.2)+(II-5), (I-84.2)+(II-6), (I-84.2)+(II-9), (I-84.2)+(II-12), (I-84.2)+(III-1), (I-84.2)+(III-4), (I-84.2)+(III-10), (I-84.2)+(III-11), (I-84.2)+(IV-1), (I-84.2)+(IV-2), (I-84.2)+(IV-3), (I-84.2)+(IV-4), (I-84.2)+(IV-5), (I-84.2)+(b-1), (I-84.2)+(b-2), (I-84.2)+(b-3), (I-84.2)+(b-4), (I-84.2)+(b-5), (I-84.2)+(b-6), (I-84.2)+(b-7), (I-84.2)+(b-8), (I-84.2)+(b-9), (I-84.2)+(b-10), (I-84.2)+(b-11), (I-84.2)+(b-12), (I-84.2)+(b-13), (I-84.2)+(b-14), (I-84.2)+(S3-1), (I-84.2)+(S3-2), (I-84.2)+(S3-3), (I-84.2)+(S3-4), (I-84.2)+(S3-5), (I-84.2)+(h-1), (I-84.2)+(h-2), (I-84.2)+(V-1), (I-84.2)+(V-2), (I-84.2)+(V-3), (I-84.2)+(V-4), (I-84.2)+(V-5), (I-84.2)+(V-6), (I-84.2)+(IX-A1), (I-84.2)+(IX-A2), (I-84.2)+(IX-A3), and (I-84.2)+(IX-A4).

(I-84.3)+(II-0), (I-84.3)+(II-1), (I-84.3)+(II-2), (I-84.3)+(II-3), (I-84.3)+(II-4), (I-84.3)+(II-5), (I-84.3)+(II-6), (I-84.3)+(II-9), (I-84.3)+(II-12), (I-84.3)+(III-1), (I-84.3)+(III-4), (I-84.3)+(III-10), (I-84.3)+(III-11), (I-84.3)+(IV-1), (I-84.3)+(IV-2), (I-84.3)+(IV-3), (I-84.3)+(IV-4), (I-84.3)+(IV-5), (I-84.3)+(b-1), (I-84.3)+(b-2), (I-84.3)+(b-3), (I-84.3)+(b-4), (I-84.3)+(b-5), (I-84.3)+(b-6), (I-84.3)+(b-7), (I-84.3)+(b-8), (I-84.3)+(b-9), (I-84.3)+(b-10), (I-84.3)+(b-11), (I-84.3)+(b-12), (I-84.3)+(b-13), (I-84.3)+(b-14), (I-84.3)+(S3-1), (I-84.3)+(S3-2), (I-84.3)+(S3-3), (I-84.3)+(S3-4), (I-84.3)+(S3-5), (I-84.3)+(h-1), (I-84.3)+(h-2), (I-84.3)+(V-1), (I-84.3)+(V-2), (I-84.3)+(V-3), (I-84.3)+(V-4), (I-84.3)+(V-5), (I-84.3)+(V-6), (I-84.3)+(IX-A1), (I-84.3)+(IX-A2), (I-84.3)+(IX-A3), and (I-84.3)+(IX-A4).

(I-85.1)+(II-0), (I-85.1)+(II-1), (I-85.1)+(II-2), (I-85.1)+(II-3), (I-85.1)+(II-4), (I-85.1)+(II-5), (I-85.1)+(II-6), (I-85.1)+(II-9), (I-85.1)+(II-12), (I-85.1)+(III-1), (I-85.1)+(III-4), (I-85.1)+(III-10), (I-85.1)+(III-11), (I-85.1)+(IV-1), (I-85.1)+(IV-2), (I-85.1)+(IV-3), (I-85.1)+(IV-4), (I-85.1)+(IV-5), (I-85.1)+(b-1), (I-85.1)+(b-2), (I-85.1)+(b-3), (I-85.1)+(b-4), (I-85.1)+(b-5), (I-85.1)+(b-6), (I-85.1)+(b-7), (I-85.1)+(b-8), (I-85.1)+(b-9), (I-85.1)+(b-10), (I-85.1)+(b-11), (I-85.1)+(b-12), (I-85.1)+(b-13), (I-85.1)+(b-14), (I-85.1)+(S3-1), (I-85.1)+(S3-2), (I-85.1)+(S3-3), (I-85.1)+(S3-4), (I-85.1)+(S3-5), (I-85.1)+(h-1), (I-85.1)+(h-2), (I-85.1)+(V-1), (I-85.1)+(V-2), (I-85.1)+(V-3), (I-85.1)+(V-4), (I-85.1)+(V-5), (I-85.1)+(V-6), (I-85.1)+(IX-A1), (I-85.1)+(IX-A2), (I-85.1)+(IX-A3), and (I-85.1)+(IX-A4).

(I-85.2)+(II-0), (I-85.2)+(II-1), (I-85.2)+(II-2), (I-85.2)+(II-3), (I-85.2)+(II-4), (I-85.2)+(II-5), (I-85.2)+(II-6), (I-85.2)+(II-9), (I-85.2)+(II-12), (I-85.2)+(II-1), (I-85.2)+(III-4), (I-85.2)+(III-10), (I-85.2)+(III-11), (I-85.2)+(IV-1), (I-85.2)+(IV-2), (I-85.2)+(IV-3), (I-85.2)+(IV-4), (I-85.2)+(IV-5), (I-85.2)+(b-1), (I-85.2)+(b-2), (I-85.2)+(b-3), (I-85.2)+(b-4), (I-85.2)+(b-5), (I-85.2)+(b-6), (I-85.2)+(b-7), (I-85.2)+(b-8), (I-85.2)+(b-9), (I-85.2)+(b-10), (I-85.2)+(b-11), (I-85.2)+(b-12), (I-85.2)+(b-13), (I-85.2)+(b-14), (I-85.2)+(S3-1), (I-85.2)+(S3-2), (I-85.2)+(S3-3), (I-85.2)+(S3-4), (I-85.2)+(S3-5), (I-85.2)+(h-1), (I-85.2)+(h-2), (I-85.2)+(V-1), (I-85.2)+(V-2), (I-85.2)+(V-3), (I-85.2)+(V-4), (I-85.2)+(V-5), (I-85.2)+(V-6), (I-85.2)+(IX-A1), (I-85.2)+(IX-A2), (I-85.2)+(IX-A3), and (I-85.2)+(IX-A4).

(I-85.3)+(II-0), (I-85.3)+(II-1), (I-85.3)+(II-2), (I-85.3)+(II-3), (I-85.3)+(II-4), (I-85.3)+(II-5), (I-85.3)+(II-6), (I-85.3)+(II-9), (I-85.3)+(II-12), (I-85.3)+(III-1), (I-85.3)+(III-4), (I-85.3)+(III-10), (I-85.3)+(III-11), (I-85.3)+(IV-1), (I-85.3)+(IV-2), (I-85.3)+(IV-3), (I-85.3)+(IV-4), (I-85.3)+(IV-5), (I-85.3)+(b-1), (I-85.3)+(b-2), (I-85.3)+(b-3), (I-85.3)+(b-4), (I-85.3)+(b-5), (I-85.3)+(b-6), (I-85.3)+(b-7), (I-85.3)+(b-8), (I-85.3)+(b-9), (I-85.3)+(b-10), (I-85.3)+(b-11), (I-85.3)+(b-12), (I-85.3)+(b-13), (I-85.3)+(b-14), (I-85.3)+(S3-1), (I-85.3)+(S3-2), (I-85.3)+(S3-3), (I-85.3)+(S3-4), (I-85.3)+(S3-5), (I-85.3)+(h-1), (I-85.3)+(h-2), (I-85.3)+(V-1), (I-85.3)+(V-2), (I-85.3)+(V-3), (I-85.3)+(V-4), (I-85.3)+(V-5), (I-85.3)+(V-6), (I-85.3)+(IX-A1), (I-85.3)+(IX-A2), (I-85.3)+(IX-A3), and (I-85.3)+(IX-A4).

(I-86.1)+(II-0), (I-86.1)+(II-1), (I-86.1)+(II-2), (I-86.1)+(II-3), (I-86.1)+(II-4), (I-86.1)+(II-5), (I-86.1)+(II-6), (I-86.1)+(II-9), (I-86.1)+(II-12), (I-86.1)+(III-1), (I-86.1)+(III-4), (I-86.1)+(III-10), (I-86.1)+(III-11), (I-86.1)+(IV-1), (I-86.1)+(IV-2), (I-86.1)+(IV-3), (I-86.1)+(IV-4), (I-86.1)+(IV-5), (I-86.1)+(b-1), (I-86.1)+(b-2), (I-86.1)+(b-3), (I-86.1)+(b-4), (I-86.1)+(b-5), (I-86.1)+(b-6), (I-86.1)+(b-7), (I-86.1)+(b-8), (I-86.1)+(b-9), (I-86.1)+(b-10), (I-86.1)+(b-11), (I-86.1)+(b-12), (I-86.1)+(b-13), (I-86.1)+(b-14), (I-86.1)+(S3-1), (I-86.1)+(S3-2), (I-86.1)+(S3-3), (I-86.1)+(S3-4), (I-86.1)+(S3-5), (I-86.1)+(h-1), (I-86.1)+(h-2), (I-86.1)+(V-1), (I-86.1)+(V-2), (I-86.1)+(V-3), (I-86.1)+(V-4), (I-86.1)+(V-5), (I-86.1)+(V-6), (I-86.1)+(IX-A1), (I-86.1)+(IX-A2), (I-86.1)+(IX-A3), and (I-86.1)+(IX-A4).

(I-86.2)+(II-0), (I-86.2)+(II-1), (I-86.2)+(II-2), (I-86.2)+(II-3), (I-86.2)+(II-4), (I-86.2)+(II-5), (I-86.2)+(II-6), (I-86.2)+(II-9), (I-86.2)+(II-12), (I-86.2)+(II-1), (I-86.2)+(III-4), (I-86.2)+(III-10), (I-86.2)+(III-11), (I-86.2)+(IV-1), (I-86.2)+(IV-2), (I-86.2)+(IV-3), (I-86.2)+(IV-4), (I-86.2)+(IV-5), (I-86.2)+(b-1), (I-86.2)+(b-2), (I-86.2)+(b-3), (I-86.2)+(b-4), (I-86.2)+(b-5), (I-86.2)+(b-6), (I-86.2)+(b-7), (I-86.2)+(b-8), (I-86.2)+(b-9), (I-86.2)+(b-10), (I-86.2)+(b-11), (I-86.2)+(b-12), (I-86.2)+(b-13), (I-86.2)+(b-14), (I-86.2)+(S3-1), (I-86.2)+(S3-2), (I-86.2)+(S3-3), (I-86.2)+(S3-4), (I-86.2)+(S3-5), (I-86.2)+(h-1), (I-86.2)+(h-2), (I-86.2)+(V-1), (I-86.2)+(V-2), (I-86.2)+(V-3), (I-86.2)+(V-4), (I-86.2)+(V-5), (I-86.2)+(V-6), (I-86.2)+(IX-A1), (I-86.2)+(IX-A2), (I-86.2)+(IX-A3), and (I-86.2)+(IX-A4).

(I-86.3)+(II-0), (I-86.3)+(II-1), (I-86.3)+(II-2), (I-86.3)+(II-3), (I-86.3)+(II-4), (I-86.3)+(II-5), (I-86.3)+(II-6), (I-86.3)+(II-9), (I-86.3)+(II-12), (I-86.3)+(III-1), (I-86.3)+(III-4), (I-86.3)+(III-10), (I-86.3)+(III-11), (I-86.3)+(IV-1), (I-86.3)+(IV-2), (I-86.3)+(IV-3), (I-86.3)+(IV-4), (I-86.3)+(IV-5), (I-86.3)+(b-1), (I-86.3)+(b-2), (I-86.3)+(b-3), (I-86.3)+(b-4), (I-86.3)+(b-5), (I-86.3)+(b-6), (I-86.3)+(b-7), (I-86.3)+(b-8), (I-86.3)+(b-9), (I-86.3)+(b-10), (I-86.3)+(b-11), (I-86.3)+(b-12), (I-86.3)+(b-13), (I-86.3)+(b-14), (I-86.3)+(S3-1), (I-86.3)+(S3-2), (I-86.3)+(S3-3), (I-86.3)+(S3-4), (I-86.3)+(S3-5), (I-86.3)+(h-1), (I-86.3)+(h-2), (I-86.3)+(V-1), (I-86.3)+(V-2), (I-86.3)+(V-3), (I-86.3)+(V-4), (I-86.3)+(V-5), (I-86.3)+(V-6), (I-86.3)+(IX-A1), (I-86.3)+(IX-A2), (I-86.3)+(IX-A3), and (I-86.3)+(IX-A4).

(I-87.1)+(II-0), (I-87.1)+(II-1), (I-87.1)+(II-2), (I-87.1)+(II-3), (I-87.1)+(II-4), (I-87.1)+(II-5), (I-87.1)+(II-6), (I-87.1)+(II-9), (I-87.1)+(II-12), (I-87.1)+(III-1), (I-87.1)+(III-4), (I-87.1)+(III-10), (I-87.1)+(III-11), (I-87.1)+(IV-1), (I-87.1)+(IV-2), (I-87.1)+(IV-3), (I-87.1)+(IV-4), (I-87.1)+(IV-5), (I-87.1)+(b-1), (I-87.1)+(b-2), (I-87.1)+(b-3), (I-87.1)+(b-4), (I-87.1)+(b-5), (I-87.1)+(b-6), (I-87.1)+(b-7), (I-87.1)+(b-8), (I-87.1)+(b-9), (I-87.1)+(b-10), (I-87.1)+(b-11), (I-87.1)+(b-12), (I-87.1)+(b-13), (I-87.1)+(b-14), (I-87.1)+(S3-1), (I-87.1)+(S3-2), (I-87.1)+(S3-3), (I-87.1)+(S3-4), (I-87.1)+(S3-5), (I-87.1)+(h-1), (I-87.1)+(h-2), (I-87.1)+(V-1), (I-87.1)+(V-2), (I-87.1)+(V-3), (I-87.1)+(V-4), (I-87.1)+(V-5), (I-87.1)+(V-6), (I-87.1)+(IX-A1), (I-87.1)+(IX-A2), (I-87.1)+(IX-A3), and (I-87.1)+(IX-A4).

(I-87.2)+(II-0), (I-87.2)+(II-1), (I-87.2)+(II-2), (I-87.2)+(II-3), (I-87.2)+(II-4), (I-87.2)+(II-5), (I-87.2)+(II-6), (I-87.2)+(II-9), (I-87.2)+(II-12), (I-87.2)+(III-1), (I-87.2)+(III-4), (I-87.2)+(III-10), (I-87.2)+(III-11), (I-87.2)+(IV-1), (I-87.2)+(IV-2), (I-87.2)+(IV-3), (I-87.2)+(IV-4), (I-87.2)+(IV-5), (I-87.2)+(b-1), (I-87.2)+(b-2), (I-87.2)+(b-3), (I-87.2)+(b-4), (I-87.2)+(b-5), (I-87.2)+(b-6), (I-87.2)+(b-7), (I-87.2)+(b-8), (I-87.2)+(b-9), (I-87.2)+(b-10), (I-87.2)+(b-11), (I-87.2)+(b-12), (I-87.2)+(b-13), (I-87.2)+(b-14), (I-87.2)+(S3-1), (I-87.2)+(S3-2), (I-87.2)+(S3-3), (I-87.2)+(S3-4), (I-87.2)+(S3-5), (I-87.2)+(h-1), (I-87.2)+(h-2), (I-87.2)+(V-1), (I-87.2)+(V-2), (I-87.2)+(V-3), (I-87.2)+(V-4), (I-87.2)+(V-5), (I-87.2)+(V-6), (I-87.2)+(IX-A1), (I-87.2)+(IX-A2), (I-87.2)+(IX-A3), and (I-87.2)+(IX-A4).

(I-87.3)+(II-0), (I-87.3)+(II-1), (I-87.3)+(II-2), (I-87.3)+(II-3), (I-87.3)+(II-4), (I-87.3)+(II-5), (I-87.3)+(II-6), (I-87.3)+(II-9), (I-87.3)+(II-12), (I-87.3)+(III-1), (I-87.3)+(III-4), (I-87.3)+(III-10), (I-87.3)+(III-11), (I-87.3)+(IV-1), (I-87.3)+(IV-2), (I-87.3)+(IV-3), (I-87.3)+(IV-4), (I-87.3)+(IV-5), (I-87.3)+(b-1), (I-87.3)+(b-2), (I-87.3)+(b-3), (I-87.3)+(b-4), (I-87.3)+(b-5), (I-87.3)+(b-6), (I-87.3)+(b-7), (I-87.3)+(b-8), (I-87.3)+(b-9), (I-87.3)+(b-10), (I-87.3)+(b-11), (I-87.3)+(b-12), (I-87.3)+(b-13), (I-87.3)+(b-14), (I-87.3)+(S3-1), (I-87.3)+(S3-2), (I-87.3)+(S3-3), (I-87.3)+(S3-4), (I-87.3)+(S3-5), (I-87.3)+(h-1), (I-87.3)+(h-2), (I-87.3)+(V-1), (I-87.3)+(V-2), (I-87.3)+(V-3), (I-87.3)+(V-4), (I-87.3)+(V-5), (I-87.3)+(V-6), (I-87.3)+(IX-A1), (I-87.3)+(IX-A2), (I-87.3)+(IX-A3), and (I-87.3)+(IX-A4).

(I-88.1)+(II-0), (I-88.1)+(II-1), (I-88.1)+(II-2), (I-88.1)+(II-3), (I-88.1)+(II-4), (I-88.1)+(II-5), (I-88.1)+(II-6), (I-88.1)+(II-9), (I-88.1)+(II-12), (I-88.1)+(III-1), (I-88.1)+(III-4), (I-88.1)+(III-10), (I-88.1)+(III-11), (I-88.1)+(IV-1), (I-88.1)+(IV-2), (I-88.1)+(IV-3), (I-88.1)+(IV-4), (I-88.1)+(IV-5), (I-88.1)+(b-1), (I-88.1)+(b-2), (I-88.1)+(b-3), (I-88.1)+(b-4), (I-88.1)+(b-5), (I-88.1)+(b-6), (I-88.1)+(b-7), (I-88.1)+(b-8), (I-88.1)+(b-9), (I-88.1)+(b-10), (I-88.1)+(b-11), (I-88.1)+(b-12), (I-88.1)+(b-13), (I-88.1)+(b-14), (I-88.1)+(S3-1), (I-88.1)+(S3-2), (I-88.1)+(S3-3), (I-88.1)+(S3-4), (I-88.1)+(S3-5), (I-88.1)+(h-1), (I-88.1)+(h-2), (I-88.1)+(V-1), (I-88.1)+(V-2), (I-88.1)+(V-3), (I-88.1)+(V-4), (I-88.1)+(V-5), (I-88.1)+(V-6), (I-88.1)+(IX-A1), (I-88.1)+(IX-A2), (I-88.1)+(IX-A3), and (I-88.1)+(IX-A4).

(I-88.2)+(II-0), (I-88.2)+(II-1), (I-88.2)+(II-2), (I-88.2)+(II-3), (I-88.2)+(II-4), (I-88.2)+(II-5), (I-88.2)+(II-6), (I-88.2)+(II-9), (I-88.2)+(II-12), (I-88.2)+(II-1), (I-88.2)+(III-4), (I-88.2)+(III-10), (I-88.2)+(III-11), (I-88.2)+(IV-1), (I-88.2)+(IV-2), (I-88.2)+(IV-3), (I-88.2)+(IV-4), (I-88.2)+(IV-5), (I-88.2)+(b-1), (I-88.2)+(b-2), (I-88.2)+(b-3), (I-88.2)+(b-4), (I-88.2)+(b-5), (I-88.2)+(b-6), (I-88.2)+(b-7), (I-88.2)+(b-8), (I-88.2)+(b-9), (I-88.2)+(b-10), (I-88.2)+(b-11), (I-88.2)+(b-12), (I-88.2)+(b-13), (I-88.2)+(b-14), (I-88.2)+(S3-1), (I-88.2)+(S3-2), (I-88.2)+(S3-3), (I-88.2)+(S3-4), (I-88.2)+(S3-5), (I-88.2)+(h-1), (I-88.2)+(h-2), (I-88.2)+(V-1), (I-88.2)+(V-2), (I-88.2)+(V-3), (I-88.2)+(V-4), (I-88.2)+(V-5), (I-88.2)+(V-6), (I-88.2)+(IX-A1), (I-88.2)+(IX-A2), (I-88.2)+(IX-A3), and (I-88.2)+(IX-A4).

(I-88.3)+(II-0), (I-88.3)+(II-1), (I-88.3)+(II-2), (I-88.3)+(II-3), (I-88.3)+(II-4), (I-88.3)+(II-5), (I-88.3)+(II-6), (I-88.3)+(II-9), (I-88.3)+(II-12), (I-88.3)+(III-1), (I-88.3)+(III-4), (I-88.3)+(III-10), (I-88.3)+(III-11), (I-88.3)+(IV-1), (I-88.3)+(IV-2), (I-88.3)+(IV-3), (I-88.3)+(IV-4), (I-88.3)+(IV-5), (I-88.3)+(b-1), (I-88.3)+(b-2), (I-88.3)+(b-3), (I-88.3)+(b-4), (I-88.3)+(b-5), (I-88.3)+(b-6), (I-88.3)+(b-7), (I-88.3)+(b-8), (I-88.3)+(b-9), (I-88.3)+(b-10), (I-88.3)+(b-11), (I-88.3)+(b-12), (I-88.3)+(b-13), (I-88.3)+(b-14), (I-88.3)+(S3-1), (I-88.3)+(S3-2), (I-88.3)+(S3-3), (I-88.3)+(S3-4), (I-88.3)+(S3-5), (I-88.3)+(h-1), (I-88.3)+(h-2), (I-88.3)+(V-1), (I-88.3)+(V-2), (I-88.3)+(V-3), (I-88.3)+(V-4), (I-88.3)+(V-5), (I-88.3)+(V-6), (I-88.3)+(IX-A1), (I-88.3)+(IX-A2), (I-88.3)+(IX-A3), and (I-88.3)+(IX-A4).

(I-89.1)+(II-0), (I-89.1)+(II-1), (I-89.1)+(II-2), (I-89.1)+(II-3), (I-89.1)+(II-4), (I-89.1)+(II-5), (I-89.1)+(II-6), (I-89.1)+(II-9), (I-89.1)+(II-12), (I-89.1)+(III-1), (I-89.1)+(III-4), (I-89.1)+(III-10), (I-89.1)+(III-11), (I-89.1)+(IV-1), (I-89.1)+(IV-2), (I-89.1)+(IV-3), (I-89.1)+(IV-4), (I-89.1)+(IV-5), (I-89.1)+(b-1), (I-89.1)+(b-2), (I-89.1)+(b-3), (I-89.1)+(b-4), (I-89.1)+(b-5), (I-89.1)+(b-6), (I-89.1)+(b-7), (I-89.1)+(b-8), (I-89.1)+(b-9), (I-89.1)+(b-10), (I-89.1)+(b-11), (I-89.1)+(b-12), (I-89.1)+(b-13), (I-89.1)+(b-14), (I-89.1)+(S3-1), (I-89.1)+(S3-2), (I-89.1)+(S3-3), (I-89.1)+(S3-4), (I-89.1)+(S3-5), (I-89.1)+(h-1), (I-89.1)+(h-2), (I-89.1)+(V-1), (I-89.1)+(V-2), (I-89.1)+(V-3), (I-89.1)+(V-4), (I-89.1)+(V-5), (I-89.1)+(V-6), (I-89.1)+(IX-A1), (I-89.1)+(IX-A2), (I-89.1)+(IX-A3), and (I-89.1)+(IX-A4).

(I-89.2)+(II-0), (I-89.2)+(II-1), (I-89.2)+(II-2), (I-89.2)+(II-3), (I-89.2)+(II-4), (I-89.2)+(II-5), (I-89.2)+(II-6), (I-89.2)+(II-9), (I-89.2)+(II-12), (I-89.2)+(III-1), (I-89.2)+(III-4), (I-89.2)+(III-10), (I-89.2)+(III-11), (I-89.2)+(IV-1), (I-89.2)+(IV-2), (I-89.2)+(IV-3), (I-89.2)+(IV-4), (I-89.2)+(IV-5), (I-89.2)+(b-1), (I-89.2)+(b-2), (I-89.2)+(b-3), (I-89.2)+(b-4), (I-89.2)+(b-5), (I-89.2)+(b-6), (I-89.2)+(b-7), (I-89.2)+(b-8), (I-89.2)+(b-9), (I-89.2)+(b-10), (I-89.2)+(b-11), (I-89.2)+(b-12), (I-89.2)+(b-13), (I-89.2)+(b-14), (I-89.2)+(S3-1), (I-89.2)+(S3-2), (I-89.2)+(S3-3), (I-89.2)+(S3-4), (I-89.2)+(S3-5), (I-89.2)+(h-1), (I-89.2)+(h-2), (I-89.2)+(V-1), (I-89.2)+(V-2), (I-89.2)+(V-3), (I-89.2)+(V-4), (I-89.2)+(V-5), (I-89.2)+(V-6), (I-89.2)+(IX-A1), (I-89.2)+(IX-A2), (I-89.2)+(IX-A3), and (I-89.2)+(IX-A4).

(I-89.3)+(II-0), (I-89.3)+(II-1), (I-89.3)+(II-2), (I-89.3)+(II-3), (I-89.3)+(II-4), (I-89.3)+(II-5), (I-89.3)+(II-6), (I-89.3)+(II-9), (I-89.3)+(II-12), (I-89.3)+(III-1), (I-89.3)+(III-4), (I-89.3)+(III-10), (I-89.3)+(III-11), (I-89.3)+(IV-1), (I-89.3)+(IV-2), (I-89.3)+(IV-3), (I-89.3)+(IV-4), (I-89.3)+(IV-5), (I-89.3)+(b-1), (I-89.3)+(b-2), (I-89.3)+(b-3), (I-89.3)+(b-4), (I-89.3)+(b-5), (I-89.3)+(b-6), (I-89.3)+(b-7), (I-89.3)+(b-8), (I-89.3)+(b-9), (I-89.3)+(b-10), (I-89.3)+(b-11), (I-89.3)+(b-12), (I-89.3)+(b-13), (I-89.3)+(b-14), (I-89.3)+(S3-1), (I-89.3)+(S3-2), (I-89.3)+(S3-3), (I-89.3)+(S3-4), (I-89.3)+(S3-5), (I-89.3)+(h-1), (I-89.3)+(h-2), (I-89.3)+(V-1), (I-89.3)+(V-2), (I-89.3)+(V-3), (I-89.3)+(V-4), (I-89.3)+(V-5), (I-89.3)+(V-6), (I-89.3)+(IX-A1), (I-89.3)+(IX-A2), (I-89.3)+(IX-A3), and (I-89.3)+(IX-A4).

(I-90.1)+(II-0), (I-90.1)+(II-1), (I-90.1)+(II-2), (I-90.1)+(II-3), (I-90.1)+(II-4), (I-90.1)+(II-5), (I-90.1)+(II-6), (I-90.1)+(II-9), (I-90.1)+(II-12), (I-90.1)+(III-1), (I-90.1)+(III-4), (I-90.1)+(III-10), (I-90.1)+(III-11), (I-90.1)+(IV-1), (I-90.1)+(IV-2), (I-90.1)+(IV-3), (I-90.1)+(IV-4), (I-90.1)+(IV-5), (I-90.1)+(b-1), (I-90.1)+(b-2), (I-90.1)+(b-3), (I-90.1)+(b-4), (I-90.1)+(b-5), (I-90.1)+(b-6), (I-90.1)+(b-7), (I-90.1)+(b-8), (I-90.1)+(b-9), (I-90.1)+(b-10), (I-90.1)+(b-11), (I-90.1)+(b-12), (I-90.1)+(b-13), (I-90.1)+(b-14), (I-90.1)+(S3-1), (I-90.1)+(S3-2), (I-90.1)+(S3-3), (I-90.1)+(S3-4), (I-90.1)+(S3-5), (I-90.1)+(h-1), (I-90.1)+(h-2), (I-90.1)+(V-1), (I-90.1)+(V-2), (I-90.1)+(V-3), (I-90.1)+(V-4), (I-90.1)+(V-5), (I-90.1)+(V-6), (I-90.1)+(IX-A1), (I-90.1)+(IX-A2), (I-90.1)+(IX-A3), and (I-90.1)+(IX-A4).

(I-90.2)+(II-0), (I-90.2)+(II-1), (I-90.2)+(II-2), (I-90.2)+(II-3), (I-90.2)+(II-4), (I-90.2)+(II-5), (I-90.2)+(II-6), (I-90.2)+(II-9), (I-90.2)+(II-12), (I-90.2)+(III-1), (I-90.2)+(III-4), (I-90.2)+(III-10), (I-90.2)+(III-11), (I-90.2)+(IV-1), (I-90.2)+(IV-2), (I-90.2)+(IV-3), (I-90.2)+(IV-4), (I-90.2)+(IV-5), (I-90.2)+(b-1), (I-90.2)+(b-2), (I-90.2)+(b-3), (I-90.2)+(b-4), (I-90.2)+(b-5), (I-90.2)+(b-6), (I-90.2)+(b-7), (I-90.2)+(b-8), (I-90.2)+(b-9), (I-90.2)+(b-10), (I-90.2)+(b-11), (I-90.2)+(b-12), (I-90.2)+(b-13), (I-90.2)+(b-14), (I-90.2)+(S3-1), (I-90.2)+(S3-2), (I-90.2)+(S3-3), (I-90.2)+(S3-4), (I-90.2)+(S3-5), (I-90.2)+(h-1), (I-90.2)+(h-2), (I-90.2)+(V-1), (I-90.2)+(V-2), (I-90.2)+(V-3), (I-90.2)+(V-4), (I-90.2)+(V-5), (I-90.2)+(V-6), (I-90.2)+(IX-A1), (I-90.2)+(IX-A2), (I-90.2)+(IX-A3), and (I-90.2)+(IX-A4).

(I-90.3)+(II-0), (I-90.3)+(II-1), (I-90.3)+(II-2), (I-90.3)+(II-3), (I-90.3)+(II-4), (I-90.3)+(II-5), (I-90.3)+(II-6), (I-90.3)+(II-9), (I-90.3)+(II-12), (I-90.3)+(III-1), (I-90.3)+(III-4), (I-90.3)+(III-10), (I-90.3)+(III-11), (I-90.3)+(IV-1), (I-90.3)+(IV-2), (I-90.3)+(IV-3), (I-90.3)+(IV-4), (I-90.3)+(IV-5), (I-90.3)+(b-1), (I-90.3)+(b-2), (I-90.3)+(b-3), (I-90.3)+(b-4), (I-90.3)+(b-5), (I-90.3)+(b-6), (I-90.3)+(b-7), (I-90.3)+(b-8), (I-90.3)+(b-9), (I-90.3)+(b-10), (I-90.3)+(b-11), (I-90.3)+(b-12), (I-90.3)+(b-13), (I-90.3)+(b-14), (I-90.3)+(S3-1), (I-90.3)+(S3-2), (I-90.3)+(S3-3), (I-90.3)+(S3-4), (I-90.3)+(S3-5), (I-90.3)+(h-1), (I-90.3)+(h-2), (I-90.3)+(V-1), (I-90.3)+(V-2), (I-90.3)+(V-3), (I-90.3)+(V-4), (I-90.3)+(V-5), (I-90.3)+(V-6), (I-90.3)+(IX-A1), (I-90.3)+(IX-A2), (I-90.3)+(IX-A3), and (I-90.3)+(IX-A4).

(I-91.1)+(II-0), (I-91.1)+(II-1), (I-91.1)+(II-2), (I-91.1)+(II-3), (I-91.1)+(II-4), (I-91.1)+(II-5), (I-91.1)+(II-6), (I-91.1)+(II-9), (I-91.1)+(II-12), (I-91.1)+(III-1), (I-91.1)+(III-4), (I-91.1)+(III-10), (I-91.1)+(III-11), (I-91.1)+(IV-1), (I-91.1)+(IV-2), (I-91.1)+(IV-3), (I-91.1)+(IV-4), (I-91.1)+(IV-5), (I-91.1)+(b-1), (I-91.1)+(b-2), (I-91.1)+(b-3), (I-91.1)+(b-4), (I-91.1)+(b-5), (I-91.1)+(b-6), (I-91.1)+(b-7), (I-91.1)+(b-8), (I-91.1)+(b-9), (I-91.1)+(b-10), (I-91.1)+(b-11), (I-91.1)+(b-12), (I-91.1)+(b-13), (I-91.1)+(b-14), (I-91.1)+(S3-1), (I-91.1)+(S3-2), (I-91.1)+(S3-3), (I-91.1)+(S3-4), (I-91.1)+(S3-5), (I-91.1)+(h-1), (I-91.1)+(h-2), (I-91.1)+(V-1), (I-91.1)+(V-2), (I-91.1)+(V-3), (I-91.1)+(V-4), (I-91.1)+(V-5), (I-91.1)+(V-6), (I-91.1)+(IX-A1), (I-91.1)+(IX-A2), (I-91.1)+(IX-A3), and (I-91.1)+(IX-A4).

(I-91.2)+(II-0), (I-91.2)+(II-1), (I-91.2)+(II-2), (I-91.2)+(II-3), (I-91.2)+(II-4), (I-91.2)+(II-5), (I-91.2)+(II-6), (I-91.2)+(II-9), (I-91.2)+(II-12), (I-91.2)+(III-1), (I-91.2)+(III-4), (I-91.2)+(III-10), (I-91.2)+(III-11), (I-91.2)+(IV-1), (I-91.2)+(IV-2), (I-91.2)+(IV-3), (I-91.2)+(IV-4), (I-91.2)+(IV-5), (I-91.2)+(b-1), (I-91.2)+(b-2), (I-91.2)+(b-3), (I-91.2)+(b-4), (I-91.2)+(b-5), (I-91.2)+(b-6), (I-91.2)+(b-7), (I-91.2)+(b-8), (I-91.2)+(b-9), (I-91.2)+(b-10), (I-91.2)+(b-11), (I-91.2)+(b-12), (I-91.2)+(b-13), (I-91.2)+(b-14), (I-91.2)+(S3-1), (I-91.2)+(S3-2), (I-91.2)+(S3-3), (I-91.2)+(S3-4), (I-91.2)+(S3-5), (I-91.2)+(h-1), (I-91.2)+(h-2), (I-91.2)+(V-1), (I-91.2)+(V-2), (I-91.2)+(V-3), (I-91.2)+(V-4), (I-91.2)+(V-5), (I-91.2)+(V-6), (I-91.2)+(IX-A1), (I-91.2)+(IX-A2), (I-91.2)+(IX-A3), and (I-91.2)+(IX-A4).

(I-91.3)+(II-0), (I-91.3)+(II-1), (I-91.3)+(II-2), (I-91.3)+(II-3), (I-91.3)+(II-4), (I-91.3)+(II-5), (I-91.3)+(II-6), (I-91.3)+(II-9), (I-91.3)+(II-12), (I-91.3)+(III-1), (I-91.3)+(III-4), (I-91.3)+(III-10), (I-91.3)+(III-11), (I-91.3)+(IV-1), (I-91.3)+(IV-2), (I-91.3)+(IV-3), (I-91.3)+(IV-4), (I-91.3)+(IV-5), (I-91.3)+(b-1), (I-91.3)+(b-2), (I-91.3)+(b-3), (I-91.3)+(b-4), (I-91.3)+(b-5), (I-91.3)+(b-6), (I-91.3)+(b-7), (I-91.3)+(b-8), (I-91.3)+(b-9), (I-91.3)+(b-10), (I-91.3)+(b-11), (I-91.3)+(b-12), (I-91.3)+(b-13), (I-91.3)+(b-14), (I-91.3)+(S3-1), (I-91.3)+(S3-2), (I-91.3)+(S3-3), (I-91.3)+(S3-4), (I-91.3)+(S3-5), (I-91.3)+(h-1), (I-91.3)+(h-2), (I-91.3)+(V-1), (I-91.3)+(V-2), (I-91.3)+(V-3), (I-91.3)+(V-4), (I-91.3)+(V-5), (I-91.3)+(V-6), (I-91.3)+(IX-A1), (I-91.3)+(IX-A2), (I-91.3)+(IX-A3), and (I-91.3)+(IX-A4).

(I-92.1)+(II-0), (I-92.1)+(II-1), (I-92.1)+(II-2), (I-92.1)+(II-3), (I-92.1)+(II-4), (I-92.1)+(II-5), (I-92.1)+(II-6), (I-92.1)+(II-9), (I-92.1)+(II-12), (I-92.1)+(III-1), (I-92.1)+(III-4), (I-92.1)+(III-10), (I-92.1)+(III-11), (I-92.1)+(IV-1), (I-92.1)+(IV-2), (I-92.1)+(IV-3), (I-92.1)+(IV-4), (I-92.1)+(IV-5), (I-92.1)+(b-1), (I-92.1)+(b-2), (I-92.1)+(b-3), (I-92.1)+(b-4), (I-92.1)+(b-5), (I-92.1)+(b-6), (I-92.1)+(b-7), (I-92.1)+(b-8), (I-92.1)+(b-9), (I-92.1)+(b-10), (I-92.1)+(b-11), (I-92.1)+(b-12), (I-92.1)+(b-13), (I-92.1)+(b-14), (I-92.1)+(S3-1), (I-92.1)+(S3-2), (I-92.1)+(S3-3), (I-92.1)+(S3-4), (I-92.1)+(S3-5), (I-92.1)+(h-1), (I-92.1)+(h-2), (I-92.1)+(V-1), (I-92.1)+(V-2), (I-92.1)+(V-3), (I-92.1)+(V-4), (I-92.1)+(V-5), (I-92.1)+(V-6), (I-92.1)+(IX-A1), (I-92.1)+(IX-A2), (I-92.1)+(IX-A3), and (I-92.1)+(IX-A4).

(I-92.2)+(II-0), (I-92.2)+(II-1), (I-92.2)+(II-2), (I-92.2)+(II-3), (I-92.2)+(II-4), (I-92.2)+(II-5), (I-92.2)+(II-6), (I-92.2)+(II-9), (I-92.2)+(II-12), (I-92.2)+(III-1), (I-92.2)+(III-4), (I-92.2)+(III-10), (I-92.2)+(III-11), (I-92.2)+(IV-1), (I-92.2)+(IV-2), (I-92.2)+(IV-3), (I-92.2)+(IV-4), (I-92.2)+(IV-5), (I-92.2)+(b-1), (I-92.2)+(b-2), (I-92.2)+(b-3), (I-92.2)+(b-4), (I-92.2)+(b-5), (I-92.2)+(b-6), (I-92.2)+(b-7), (I-92.2)+(b-8), (I-92.2)+(b-9), (I-92.2)+(b-10), (I-92.2)+(b-11), (I-92.2)+(b-12), (I-92.2)+(b-13), (I-92.2)+(b-14), (I-92.2)+(S3-1), (I-92.2)+(S3-2), (I-92.2)+(S3-3), (I-92.2)+(S3-4), (I-92.2)+(S3-5), (I-92.2)+(h-1), (I-92.2)+(h-2), (I-92.2)+(V-1), (I-92.2)+(V-2), (I-92.2)+(V-3), (I-92.2)+(V-4), (I-92.2)+(V-5), (I-92.2)+(V-6), (I-92.2)+(IX-A1), (I-92.2)+(IX-A2), (I-92.2)+(IX-A3), and (I-92.2)+(IX-A4).

(I-92.3)+(II-0), (I-92.3)+(II-1), (I-92.3)+(II-2), (I-92.3)+(II-3), (I-92.3)+(II-4), (I-92.3)+(II-5), (I-92.3)+(II-6), (I-92.3)+(II-9), (I-92.3)+(II-12), (I-92.3)+(II-1), (I-92.3)+(III-4), (I-92.3)+(III-10), (I-92.3)+(III-11), (I-92.3)+(IV-1), (I-92.3)+(IV-2), (I-92.3)+(IV-3), (I-92.3)+(IV-4), (I-92.3)+(IV-5), (I-92.3)+(b-1), (I-92.3)+(b-2), (I-92.3)+(b-3), (I-92.3)+(b-4), (I-92.3)+(b-5), (I-92.3)+(b-6), (I-92.3)+(b-7), (I-92.3)+(b-8), (I-92.3)+(b-9), (I-92.3)+(b-10), (I-92.3)+(b-11), (I-92.3)+(b-12), (I-92.3)+(b-13), (I-92.3)+(b-14), (I-92.3)+(S3-1), (I-92.3)+(S3-2), (I-92.3)+(S3-3), (I-92.3)+(S3-4), (I-92.3)+(S3-5), (I-92.3)+(h-1), (I-92.3)+(h-2), (I-92.3)+(V-1), (I-92.3)+(V-2), (I-92.3)+(V-3), (I-92.3)+(V-4), (I-92.3)+(V-5), (I-92.3)+(V-6), (I-92.3)+(IX-A1), (I-92.3)+(IX-A2), (I-92.3)+(IX-A3), and (I-92.3)+(IX-A4).

(I-93.1)+(II-0), (I-93.1)+(II-1), (I-93.1)+(II-2), (I-93.1)+(II-3), (I-93.1)+(II-4), (I-93.1)+(II-5), (I-93.1)+(II-6), (I-93.1)+(II-9), (I-93.1)+(II-12), (I-93.1)+(III-1), (I-93.1)+(III-4), (I-93.1)+(III-10), (I-93.1)+(III-11), (I-93.1)+(IV-1), (I-93.1)+(IV-2), (I-93.1)+(IV-3), (I-93.1)+(IV-4), (I-93.1)+(IV-5), (I-93.1)+(b-1), (I-93.1)+(b-2), (I-93.1)+(b-3), (I-93.1)+(b-4), (I-93.1)+(b-5), (I-93.1)+(b-6), (I-93.1)+(b-7), (I-93.1)+(b-8), (I-93.1)+(b-9), (I-93.1)+(b-10), (I-93.1)+(b-11), (I-93.1)+(b-12), (I-93.1)+(b-13), (I-93.1)+(b-14), (I-93.1)+(S3-1), (I-93.1)+(S3-2), (I-93.1)+(S3-3), (I-93.1)+(S3-4), (I-93.1)+(S3-5), (I-93.1)+(h-1), (I-93.1)+(h-2), (I-93.1)+(V-1), (I-93.1)+(V-2), (I-93.1)+(V-3), (I-93.1)+(V-4), (I-93.1)+(V-5), (I-93.1)+(V-6), (I-93.1)+(IX-A1), (I-93.1)+(IX-A2), (I-93.1)+(IX-A3), and (I-93.1)+(IX-A4).

(I-93.2)+(II-0), (I-93.2)+(II-1), (I-93.2)+(II-2), (I-93.2)+(II-3), (I-93.2)+(II-4), (I-93.2)+(II-5), (I-93.2)+(II-6), (I-93.2)+(II-9), (I-93.2)+(II-12), (I-93.2)+(III-1), (I-93.2)+(III-4), (I-93.2)+(III-10), (I-93.2)+(III-11), (I-93.2)+(IV-1), (I-93.2)+(IV-2), (I-93.2)+(IV-3), (I-93.2)+(IV-4), (I-93.2)+(IV-5), (I-93.2)+(b-1), (I-93.2)+(b-2), (I-93.2)+(b-3), (I-93.2)+(b-4), (I-93.2)+(b-5), (I-93.2)+(b-6), (I-93.2)+(b-7), (I-93.2)+(b-8), (I-93.2)+(b-9), (I-93.2)+(b-10), (I-93.2)+(b-11), (I-93.2)+(b-12), (I-93.2)+(b-13), (I-93.2)+(b-14), (I-93.2)+(S3-1), (I-93.2)+(S3-2), (I-93.2)+(S3-3), (I-93.2)+(S3-4), (I-93.2)+(S3-5), (I-93.2)+(h-1), (I-93.2)+(h-2), (I-93.2)+(V-1), (I-93.2)+(V-2), (I-93.2)+(V-3), (I-93.2)+(V-4), (I-93.2)+(V-5), (I-93.2)+(V-6), (I-93.2)+(IX-A1), (I-93.2)+(IX-A2), (I-93.2)+(IX-A3), and (I-93.2)+(IX-A4).

(I-93.3)+(II-0), (I-93.3)+(II-1), (I-93.3)+(II-2), (I-93.3)+(II-3), (I-93.3)+(II-4), (I-93.3)+(II-5), (I-93.3)+(II-6), (I-93.3)+(II-9), (I-93.3)+(II-12), (I-93.3)+(II-1), (I-93.3)+(III-4), (I-93.3)+(III-10), (I-93.3)+(III-11), (I-93.3)+(IV-1), (I-93.3)+(IV-2), (I-93.3)+(IV-3), (I-93.3)+(IV-4), (I-93.3)+(IV-5), (I-93.3)+(b-1), (I-93.3)+(b-2), (I-93.3)+(b-3), (I-93.3)+(b-4), (I-93.3)+(b-5), (I-93.3)+(b-6), (I-93.3)+(b-7), (I-93.3)+(b-8), (I-93.3)+(b-9), (I-93.3)+(b-10), (I-93.3)+(b-11), (I-93.3)+(b-12), (I-93.3)+(b-13), (I-93.3)+(b-14), (I-93.3)+(S3-1), (I-93.3)+(S3-2), (I-93.3)+(S3-3), (I-93.3)+(S3-4), (I-93.3)+(S3-5), (I-93.3)+(h-1), (I-93.3)+(h-2), (I-93.3)+(V-1), (I-93.3)+(V-2), (I-93.3)+(V-3), (I-93.3)+(V-4), (I-93.3)+(V-5), (I-93.3)+(V-6), (I-93.3)+(IX-A1), (I-93.3)+(IX-A2), (I-93.3)+(IX-A3), and (I-93.3)+(IX-A4).

(I-94.1)+(II-0), (I-94.1)+(II-1), (I-94.1)+(II-2), (I-94.1)+(II-3), (I-94.1)+(II-4), (I-94.1)+(II-5), (I-94.1)+(II-6), (I-94.1)+(II-9), (I-94.1)+(II-12), (I-94.1)+(III-1), (I-94.1)+(III-4), (I-94.1)+(III-10), (I-94.1)+(III-11), (I-94.1)+(IV-1), (I-94.1)+(IV-2), (I-94.1)+(IV-3), (I-94.1)+(IV-4), (I-94.1)+(IV-5), (I-94.1)+(b-1), (I-94.1)+(b-2), (I-94.1)+(b-3), (I-94.1)+(b-4), (I-94.1)+(b-5), (I-94.1)+(b-6), (I-94.1)+(b-7), (I-94.1)+(b-8), (I-94.1)+(b-9), (I-94.1)+(b-10), (I-94.1)+(b-11), (I-94.1)+(b-12), (I-94.1)+(b-13), (I-94.1)+(b-14), (I-94.1)+(S3-1), (I-94.1)+(S3-2), (I-94.1)+(S3-3), (I-94.1)+(S3-4), (I-94.1)+(S3-5), (I-94.1)+(h-1), (I-94.1)+(h-2), (I-94.1)+(V-1), (I-94.1)+(V-2), (I-94.1)+(V-3), (I-94.1)+(V-4), (I-94.1)+(V-5), (I-94.1)+(V-6), (I-94.1)+(IX-A1), (I-94.1)+(IX-A2), (I-94.1)+(IX-A3), and (I-94.1)+(IX-A4).

(I-94.2)+(II-0), (I-94.2)+(II-1), (I-94.2)+(II-2), (I-94.2)+(II-3), (I-94.2)+(II-4), (I-94.2)+(II-5), (I-94.2)+(II-6), (I-94.2)+(II-9), (I-94.2)+(II-12), (I-94.2)+(III-1), (I-94.2)+(III-4), (I-94.2)+(III-10), (I-94.2)+(III-11), (I-94.2)+(IV-1), (I-94.2)+(IV-2), (I-94.2)+(IV-3), (I-94.2)+(IV-4), (I-94.2)+(IV-5), (I-94.2)+(b-1), (I-94.2)+(b-2), (I-94.2)+(b-3), (I-94.2)+(b-4), (I-94.2)+(b-5), (I-94.2)+(b-6), (I-94.2)+(b-7), (I-94.2)+(b-8), (I-94.2)+(b-9), (I-94.2)+(b-10), (I-94.2)+(b-11), (I-94.2)+(b-12), (I-94.2)+(b-13), (I-94.2)+(b-14), (I-94.2)+(S3-1), (I-94.2)+(S3-2), (I-94.2)+(S3-3), (I-94.2)+(S3-4), (I-94.2)+(S3-5), (I-94.2)+(h-1), (I-94.2)+(h-2), (I-94.2)+(V-1), (I-94.2)+(V-2), (I-94.2)+(V-3), (I-94.2)+(V-4), (I-94.2)+(V-5), (I-94.2)+(V-6), (I-94.2)+(IX-A1), (I-94.2)+(IX-A2), (I-94.2)+(IX-A3), and (I-94.2)+(IX-A4).

(I-94.3)+(II-0), (I-94.3)+(II-1), (I-94.3)+(II-2), (I-94.3)+(II-3), (I-94.3)+(II-4), (I-94.3)+(II-5), (I-94.3)+(II-6), (I-94.3)+(II-9), (I-94.3)+(II-12), (I-94.3)+(III-1), (I-94.3)+(III-4), (I-94.3)+(III-10), (I-94.3)+(III-11), (I-94.3)+(IV-1), (I-94.3)+(IV-2), (I-94.3)+(IV-3), (I-94.3)+(IV-4), (I-94.3)+(IV-5), (I-94.3)+(b-1), (I-94.3)+(b-2), (I-94.3)+(b-3), (I-94.3)+(b-4), (I-94.3)+(b-5), (I-94.3)+(b-6), (I-94.3)+(b-7), (I-94.3)+(b-8), (I-94.3)+(b-9), (I-94.3)+(b-10), (I-94.3)+(b-11), (I-94.3)+(b-12), (I-94.3)+(b-13), (I-94.3)+(b-14), (I-94.3)+(S3-1), (I-94.3)+(S3-2), (I-94.3)+(S3-3), (I-94.3)+(S3-4), (I-94.3)+(S3-5), (I-94.3)+(h-1), (I-94.3)+(h-2), (I-94.3)+(V-1), (I-94.3)+(V-2), (I-94.3)+(V-3), (I-94.3)+(V-4), (I-94.3)+(V-5), (I-94.3)+(V-6), (I-94.3)+(IX-A1), (I-94.3)+(IX-A2), (I-94.3)+(IX-A3), and (I-94.3)+(IX-A4).

(I-95.1)+(II-0), (I-95.1)+(II-1), (I-95.1)+(II-2), (I-95.1)+(II-3), (I-95.1)+(II-4), (I-95.1)+(II-5), (I-95.1)+(II-6), (I-95.1)+(II-9), (I-95.1)+(II-12), (I-95.1)+(III-1), (I-95.1)+(III-4), (I-95.1)+(III-10), (I-95.1)+(III-11), (I-95.1)+(IV-1), (I-95.1)+(IV-2), (I-95.1)+(IV-3), (I-95.1)+(IV-4), (I-95.1)+(IV-5), (I-95.1)+(b-1), (I-95.1)+(b-2), (I-95.1)+(b-3), (I-95.1)+(b-4), (I-95.1)+(b-5), (I-95.1)+(b-6), (I-95.1)+(b-7), (I-95.1)+(b-8), (I-95.1)+(b-9), (I-95.1)+(b-10), (I-95.1)+(b-11), (I-95.1)+(b-12), (I-95.1)+(b-13), (I-95.1)+(b-14), (I-95.1)+(S3-1), (I-95.1)+(S3-2), (I-95.1)+(S3-3), (I-95.1)+(S3-4), (I-95.1)+(S3-5), (I-95.1)+(h-1), (I-95.1)+(h-2), (I-95.1)+(V-1), (I-95.1)+(V-2), (I-95.1)+(V-3), (I-95.1)+(V-4), (I-95.1)+(V-5), (I-95.1)+(V-6), (I-95.1)+(IX-A1), (I-95.1)+(IX-A2), (I-95.1)+(IX-A3), and (I-95.1)+(IX-A4).

(I-95.2)+(II-0), (I-95.2)+(II-1), (I-95.2)+(II-2), (I-95.2)+(II-3), (I-95.2)+(II-4), (I-95.2)+(II-5), (I-95.2)+(II-6), (I-95.2)+(II-9), (I-95.2)+(II-12), (I-95.2)+(III-1), (I-95.2)+(III-4), (I-95.2)+(III-10), (I-95.2)+(III-11), (I-95.2)+(IV-1), (I-95.2)+(IV-2), (I-95.2)+(IV-3), (I-95.2)+(IV-4), (I-95.2)+(IV-5), (I-95.2)+(b-1), (I-95.2)+(b-2), (I-95.2)+(b-3), (I-95.2)+(b-4), (I-95.2)+(b-5), (I-95.2)+(b-6), (I-95.2)+(b-7), (I-95.2)+(b-8), (I-95.2)+(b-9), (I-95.2)+(b-10), (I-95.2)+(b-11), (I-95.2)+(b-12), (I-95.2)+(b-13), (I-95.2)+(b-14), (I-95.2)+(S3-1), (I-95.2)+(S3-2), (I-95.2)+(S3-3), (I-95.2)+(S3-4), (I-95.2)+(S3-5), (I-95.2)+(h-1), (I-95.2)+(h-2), (I-95.2)+(V-1), (I-95.2)+(V-2), (I-95.2)+(V-3), (I-95.2)+(V-4), (I-95.2)+(V-5), (I-95.2)+(V-6), (I-95.2)+(IX-A1), (I-95.2)+(IX-A2), (I-95.2)+(IX-A3), and (I-95.2)+(IX-A4).

(I-95.3)+(II-0), (I-95.3)+(II-1), (I-95.3)+(II-2), (I-95.3)+(II-3), (I-95.3)+(II-4), (I-95.3)+(II-5), (I-95.3)+(II-6), (I-95.3)+(II-9), (I-95.3)+(II-12), (I-95.3)+(III-1), (I-95.3)+(III-4), (I-95.3)+(III-10), (I-95.3)+(III-11), (I-95.3)+(IV-1), (I-95.3)+(IV-2), (I-95.3)+(IV-3), (I-95.3)+(IV-4), (I-95.3)+(IV-5), (I-95.3)+(b-1), (I-95.3)+(b-2), (I-95.3)+(b-3), (I-95.3)+(b-4), (I-95.3)+(b-5), (I-95.3)+(b-6), (I-95.3)+(b-7), (I-95.3)+(b-8), (I-95.3)+(b-9), (I-95.3)+(b-10), (I-95.3)+(b-11), (I-95.3)+(b-12), (I-95.3)+(b-13), (I-95.3)+(b-14), (I-95.3)+(S3-1), (I-95.3)+(S3-2), (I-95.3)+(S3-3), (I-95.3)+(S3-4), (I-95.3)+(S3-5), (I-95.3)+(h-1), (I-95.3)+(h-2), (I-95.3)+(V-1), (I-95.3)+(V-2), (I-95.3)+(V-3), (I-95.3)+(V-4), (I-95.3)+(V-5), (I-95.3)+(V-6), (I-95.3)+(IX-A1), (I-95.3)+(IX-A2), (I-95.3)+(IX-A3), and (I-95.3)+(IX-A4).

(I-96.1)+(II-0), (I-96.1)+(II-1), (I-96.1)+(II-2), (I-96.1)+(II-3), (I-96.1)+(II-4), (I-96.1)+(II-5), (I-96.1)+(II-6), (I-96.1)+(II-9), (I-96.1)+(II-12), (I-96.1)+(III-1), (I-96.1)+(III-4), (I-96.1)+(III-10), (I-96.1)+(III-11), (I-96.1)+(IV-1), (I-96.1)+(IV-2), (I-96.1)+(IV-3), (I-96.1)+(IV-4), (I-96.1)+(IV-5), (I-96.1)+(b-1), (I-96.1)+(b-2), (I-96.1)+(b-3), (I-96.1)+(b-4), (I-96.1)+(b-5), (I-96.1)+(b-6), (I-96.1)+(b-7), (I-96.1)+(b-8), (I-96.1)+(b-9), (I-96.1)+(b-10), (I-96.1)+(b-11), (I-96.1)+(b-12), (I-96.1)+(b-13), (I-96.1)+(b-14), (I-96.1)+(S3-1), (I-96.1)+(S3-2), (I-96.1)+(S3-3), (I-96.1)+(S3-4), (I-96.1)+(S3-5), (I-96.1)+(h-1), (I-96.1)+(h-2), (I-96.1)+(V-1), (I-96.1)+(V-2), (I-96.1)+(V-3), (I-96.1)+(V-4), (I-96.1)+(V-5), (I-96.1)+(V-6), (I-96.1)+(IX-A1), (I-96.1)+(IX-A2), (I-96.1)+(IX-A3), and (I-96.1)+(IX-A4).

(I-96.2)+(II-0), (I-96.2)+(II-1), (I-96.2)+(II-2), (I-96.2)+(II-3), (I-96.2)+(II-4), (I-96.2)+(II-5), (I-96.2)+(II-6), (I-96.2)+(II-9), (I-96.2)+(II-12), (I-96.2)+(III-1), (I-96.2)+(III-4), (I-96.2)+(III-10), (I-96.2)+(III-11), (I-96.2)+(IV-1), (I-96.2)+(IV-2), (I-96.2)+(IV-3), (I-96.2)+(IV-4), (I-96.2)+(IV-5), (I-96.2)+(b-1), (I-96.2)+(b-2), (I-96.2)+(b-3), (I-96.2)+(b-4), (I-96.2)+(b-5), (I-96.2)+(b-6), (I-96.2)+(b-7), (I-96.2)+(b-8), (I-96.2)+(b-9), (I-96.2)+(b-10), (I-96.2)+(b-11), (I-96.2)+(b-12), (I-96.2)+(b-13), (I-96.2)+(b-14), (I-96.2)+(S3-1), (I-96.2)+(S3-2), (I-96.2)+(S3-3), (I-96.2)+(S3-4), (I-96.2)+(S3-5), (I-96.2)+(h-1), (I-96.2)+(h-2), (I-96.2)+(V-1), (I-96.2)+(V-2), (I-96.2)+(V-3), (I-96.2)+(V-4), (I-96.2)+(V-5), (I-96.2)+(V-6), (I-96.2)+(IX-A1), (I-96.2)+(IX-A2), (I-96.2)+(IX-A3), and (I-96.2)+(IX-A4).

(I-96.3)+(II-0), (I-96.3)+(II-1), (I-96.3)+(II-2), (I-96.3)+(II-3), (I-96.3)+(II-4), (I-96.3)+(II-5), (I-96.3)+(II-6), (I-96.3)+(II-9), (I-96.3)+(II-12), (I-96.3)+(III-1), (I-96.3)+(III-4), (I-96.3)+(III-10), (I-96.3)+(III-11), (I-96.3)+(IV-1), (I-96.3)+(IV-2), (I-96.3)+(IV-3), (I-96.3)+(IV-4), (I-96.3)+(IV-5), (I-96.3)+(b-1), (I-96.3)+(b-2), (I-96.3)+(b-3), (I-96.3)+(b-4), (I-96.3)+(b-5), (I-96.3)+(b-6), (I-96.3)+(b-7), (I-96.3)+(b-8), (I-96.3)+(b-9), (I-96.3)+(b-10), (I-96.3)+(b-11), (I-96.3)+(b-12), (I-96.3)+(b-13), (I-96.3)+(b-14), (I-96.3)+(S3-1), (I-96.3)+(S3-2), (I-96.3)+(S3-3), (I-96.3)+(S3-4), (I-96.3)+(S3-5), (I-96.3)+(h-1), (I-96.3)+(h-2), (I-96.3)+(V-1), (I-96.3)+(V-2), (I-96.3)+(V-3), (I-96.3)+(V-4), (I-96.3)+(V-5), (I-96.3)+(V-6), (I-96.3)+(IX-A1), (I-96.3)+(IX-A2), (I-96.3)+(IX-A3), and (I-96.3)+(IX-A4).

(I-97.1)+(II-0), (I-97.1)+(II-1), (I-97.1)+(II-2), (I-97.1)+(II-3), (I-97.1)+(II-4), (I-97.1)+(II-5), (I-97.1)+(II-6), (I-97.1)+(II-9), (I-97.1)+(II-12), (I-97.1)+(III-1), (I-97.1)+(III-4), (I-97.1)+(III-10), (I-97.1)+(III-11), (I-97.1)+(IV-1), (I-97.1)+(IV-2), (I-97.1)+(IV-3), (I-97.1)+(IV-4), (I-97.1)+(IV-5), (I-97.1)+(b-1), (I-97.1)+(b-2), (I-97.1)+(b-3), (I-97.1)+(b-4), (I-97.1)+(b-5), (I-97.1)+(b-6), (I-97.1)+(b-7), (I-97.1)+(b-8), (I-97.1)+(b-9), (I-97.1)+(b-10), (I-97.1)+(b-11), (I-97.1)+(b-12), (I-97.1)+(b-13), (I-97.1)+(b-14), (I-97.1)+(S3-1), (I-97.1)+(S3-2), (I-97.1)+(S3-3), (I-97.1)+(S3-4), (I-97.1)+(S3-5), (I-97.1)+(h-1), (I-97.1)+(h-2), (I-97.1)+(V-1), (I-97.1)+(V-2), (I-97.1)+(V-3), (I-97.1)+(V-4), (I-97.1)+(V-5), (I-97.1)+(V-6), (I-97.1)+(IX-A1), (I-97.1)+(IX-A2), (I-97.1)+(IX-A3), and (I-97.1)+(IX-A4).

(I-97.2)+(II-0), (I-97.2)+(II-1), (I-97.2)+(II-2), (I-97.2)+(II-3), (I-97.2)+(II-4), (I-97.2)+(II-5), (I-97.2)+(II-6), (I-97.2)+(II-9), (I-97.2)+(II-12), (I-97.2)+(III-1), (I-97.2)+(III-4), (I-97.2)+(III-10), (I-97.2)+(III-11), (I-97.2)+(IV-1), (I-97.2)+(IV-2), (I-97.2)+(IV-3), (I-97.2)+(IV-4), (I-97.2)+(IV-5), (I-97.2)+(b-1), (I-97.2)+(b-2), (I-97.2)+(b-3), (I-97.2)+(b-4), (I-97.2)+(b-5), (I-97.2)+(b-6), (I-97.2)+(b-7), (I-97.2)+(b-8), (I-97.2)+(b-9), (I-97.2)+(b-10), (I-97.2)+(b-11), (I-97.2)+(b-12), (I-97.2)+(b-13), (I-97.2)+(b-14), (I-97.2)+(S3-1), (I-97.2)+(S3-2), (I-97.2)+(S3-3), (I-97.2)+(S3-4), (I-97.2)+(S3-5), (I-97.2)+(h-1), (I-97.2)+(h-2), (I-97.2)+(V-1), (I-97.2)+(V-2), (I-97.2)+(V-3), (I-97.2)+(V-4), (I-97.2)+(V-5), (I-97.2)+(V-6), (I-97.2)+(IX-A1), (I-97.2)+(IX-A2), (I-97.2)+(IX-A3), and (I-97.2)+(IX-A4).

(I-97.3)+(II-0), (I-97.3)+(II-1), (I-97.3)+(II-2), (I-97.3)+(II-3), (I-97.3)+(II-4), (I-97.3)+(II-5), (I-97.3)+(II-6), (I-97.3)+(II-9), (I-97.3)+(II-12), (I-97.3)+(III-1), (I-97.3)+(III-4), (I-97.3)+(III-10), (I-97.3)+(III-11), (I-97.3)+(IV-1), (I-97.3)+(IV-2), (I-97.3)+(IV-3), (I-97.3)+(IV-4), (I-97.3)+(IV-5), (I-97.3)+(b-1), (I-97.3)+(b-2), (I-97.3)+(b-3), (I-97.3)+(b-4), (I-97.3)+(b-5), (I-97.3)+(b-6), (I-97.3)+(b-7), (I-97.3)+(b-8), (I-97.3)+(b-9), (I-97.3)+(b-10), (I-97.3)+(b-11), (I-97.3)+(b-12), (I-97.3)+(b-13), (I-97.3)+(b-14), (I-97.3)+(S3-1), (I-97.3)+(S3-2), (I-97.3)+(S3-3), (I-97.3)+(S3-4), (I-97.3)+(S3-5), (I-97.3)+(h-1), (I-97.3)+(h-2), (I-97.3)+(V-1), (I-97.3)+(V-2), (I-97.3)+(V-3), (I-97.3)+(V-4), (I-97.3)+(V-5), (I-97.3)+(V-6), (I-97.3)+(IX-A1), (I-97.3)+(IX-A2), (I-97.3)+(IX-A3), and (I-97.3)+(IX-A4).

(I-98.1)+(II-0), (I-98.1)+(II-1), (I-98.1)+(II-2), (I-98.1)+(II-3), (I-98.1)+(II-4), (I-98.1)+(II-5), (I-98.1)+(II-6), (I-98.1)+(II-9), (I-98.1)+(II-12), (I-98.1)+(II-1), (I-98.1)+(III-4), (I-98.1)+(III-10), (I-98.1)+(III-11), (I-98.1)+(IV-1), (I-98.1)+(IV-2), (I-98.1)+(IV-3), (I-98.1)+(IV-4), (I-98.1)+(IV-5), (I-98.1)+(b-1), (I-98.1)+(b-2), (I-98.1)+(b-3), (I-98.1)+(b-4), (I-98.1)+(b-5), (I-98.1)+(b-6), (I-98.1)+(b-7), (I-98.1)+(b-8), (I-98.1)+(b-9), (I-98.1)+(b-10), (I-98.1)+(b-11), (I-98.1)+(b-12), (I-98.1)+(b-13), (I-98.1)+(b-14), (I-98.1)+(S3-1), (I-98.1)+(S3-2), (I-98.1)+(S3-3), (I-98.1)+(S3-4), (I-98.1)+(S3-5), (I-98.1)+(h-1), (I-98.1)+(h-2), (I-98.1)+(V-1), (I-98.1)+(V-2), (I-98.1)+(V-3), (I-98.1)+(V-4), (I-98.1)+(V-5), (I-98.1)+(V-6), (I-98.1)+(IX-A1), (I-98.1)+(IX-A2), (I-98.1)+(IX-A3), and (I-98.1)+(IX-A4).

(I-98.2)+(II-0), (I-98.2)+(II-1), (I-98.2)+(II-2), (I-98.2)+(II-3), (I-98.2)+(II-4), (I-98.2)+(II-5), (I-98.2)+(II-6), (I-98.2)+(II-9), (I-98.2)+(II-12), (I-98.2)+(III-1), (I-98.2)+(III-4), (I-98.2)+(III-10), (I-98.2)+(III-11), (I-98.2)+(IV-1), (I-98.2)+(IV-2), (I-98.2)+(IV-3), (I-98.2)+(IV-4), (I-98.2)+(IV-5), (I-98.2)+(b-1), (I-98.2)+(b-2), (I-98.2)+(b-3), (I-98.2)+(b-4), (I-98.2)+(b-5), (I-98.2)+(b-6), (I-98.2)+(b-7), (I-98.2)+(b-8), (I-98.2)+(b-9), (I-98.2)+(b-10), (I-98.2)+(b-11), (I-98.2)+(b-12), (I-98.2)+(b-13), (I-98.2)+(b-14), (I-98.2)+(S3-1), (I-98.2)+(S3-2), (I-98.2)+(S3-3), (I-98.2)+(S3-4), (I-98.2)+(S3-5), (I-98.2)+(h-1), (I-98.2)+(h-2), (I-98.2)+(V-1), (I-98.2)+(V-2), (I-98.2)+(V-3), (I-98.2)+(V-4), (I-98.2)+(V-5), (I-98.2)+(V-6), (I-98.2)+(IX-A1), (I-98.2)+(IX-A2), (I-98.2)+(IX-A3), and (I-98.2)+(IX-A4).

(I-98.3)+(II-0), (I-98.3)+(II-1), (I-98.3)+(II-2), (I-98.3)+(II-3), (I-98.3)+(II-4), (I-98.3)+(II-5), (I-98.3)+(II-6), (I-98.3)+(II-9), (I-98.3)+(II-12), (I-98.3)+(III-1), (I-98.3)+(III-4), (I-98.3)+(III-10), (I-98.3)+(III-11), (I-98.3)+(IV-1), (I-98.3)+(IV-2), (I-98.3)+(IV-3), (I-98.3)+(IV-4), (I-98.3)+(IV-5), (I-98.3)+(b-1), (I-98.3)+(b-2), (I-98.3)+(b-3), (I-98.3)+(b-4), (I-98.3)+(b-5), (I-98.3)+(b-6), (I-98.3)+(b-7), (I-98.3)+(b-8), (I-98.3)+(b-9), (I-98.3)+(b-10), (I-98.3)+(b-11), (I-98.3)+(b-12), (I-98.3)+(b-13), (I-98.3)+(b-14), (I-98.3)+(S3-1), (I-98.3)+(S3-2), (I-98.3)+(S3-3), (I-98.3)+(S3-4), (I-98.3)+(S3-5), (I-98.3)+(h-1), (I-98.3)+(h-2), (I-98.3)+(V-1), (I-98.3)+(V-2), (I-98.3)+(V-3), (I-98.3)+(V-4), (I-98.3)+(V-5), (I-98.3)+(V-6), (I-98.3)+(IX-A1), (I-98.3)+(IX-A2), (I-98.3)+(IX-A3), and (I-98.3)+(IX-A4).

(I-99.1)+(II-0), (I-99.1)+(II-1), (I-99.1)+(II-2), (I-99.1)+(II-3), (I-99.1)+(II-4), (I-99.1)+(II-5), (I-99.1)+(II-6), (I-99.1)+(II-9), (I-99.1)+(II-12), (I-99.1)+(III-1), (I-99.1)+(III-4), (I-99.1)+(III-10), (I-99.1)+(III-11), (I-99.1)+(IV-1), (I-99.1)+(IV-2), (I-99.1)+(IV-3), (I-99.1)+(IV-4), (I-99.1)+(IV-5), (I-99.1)+(b-1), (I-99.1)+(b-2), (I-99.1)+(b-3), (I-99.1)+(b-4), (I-99.1)+(b-5), (I-99.1)+(b-6), (I-99.1)+(b-7), (I-99.1)+(b-8), (I-99.1)+(b-9), (I-99.1)+(b-10), (I-99.1)+(b-11), (I-99.1)+(b-12), (I-99.1)+(b-13), (I-99.1)+(b-14), (I-99.1)+(S3-1), (I-99.1)+(S3-2), (I-99.1)+(S3-3), (I-99.1)+(S3-4), (I-99.1)+(S3-5), (I-99.1)+(h-1), (I-99.1)+(h-2), (I-99.1)+(V-1), (I-99.1)+(V-2), (I-99.1)+(V-3), (I-99.1)+(V-4), (I-99.1)+(V-5), (I-99.1)+(V-6), (I-99.1)+(IX-A1), (I-99.1)+(IX-A2), (I-99.1)+(IX-A3), and (I-99.1)+(IX-A4).

(I-99.2)+(II-0), (I-99.2)+(II-1), (I-99.2)+(II-2), (I-99.2)+(II-3), (I-99.2)+(II-4), (I-99.2)+(II-5), (I-99.2)+(II-6), (I-99.2)+(II-9), (I-99.2)+(II-12), (I-99.2)+(III-1), (I-99.2)+(III-4), (I-99.2)+(III-10), (I-99.2)+(III-11), (I-99.2)+(IV-1), (I-99.2)+(IV-2), (I-99.2)+(IV-3), (I-99.2)+(IV-4), (I-99.2)+(IV-5), (I-99.2)+(b-1), (I-99.2)+(b-2), (I-99.2)+(b-3), (I-99.2)+(b-4), (I-99.2)+(b-5), (I-99.2)+(b-6), (I-99.2)+(b-7), (I-99.2)+(b-8), (I-99.2)+(b-9), (I-99.2)+(b-10), (I-99.2)+(b-11), (I-99.2)+(b-12), (I-99.2)+(b-13), (I-99.2)+(b-14), (I-99.2)+(S3-1), (I-99.2)+(S3-2), (I-99.2)+(S3-3), (I-99.2)+(S3-4), (I-99.2)+(S3-5), (I-99.2)+(h-1), (I-99.2)+(h-2), (I-99.2)+(V-1), (I-99.2)+(V-2), (I-99.2)+(V-3), (I-99.2)+(V-4), (I-99.2)+(V-5), (I-99.2)+(V-6), (I-99.2)+(IX-A1), (I-99.2)+(IX-A2), (I-99.2)+(IX-A3), and (I-99.2)+(IX-A4).

(I-99.3)+(II-0), (I-99.3)+(II-1), (I-99.3)+(II-2), (I-99.3)+(II-3), (I-99.3)+(II-4), (I-99.3)+(II-5), (I-99.3)+(II-6), (I-99.3)+(II-9), (I-99.3)+(II-12), (I-99.3)+(III-1), (I-99.3)+(III-4), (I-99.3)+(III-10), (I-99.3)+(III-11), (I-99.3)+(IV-1), (I-99.3)+(IV-2), (I-99.3)+(IV-3), (I-99.3)+(IV-4), (I-99.3)+(IV-5), (I-99.3)+(b-1), (I-99.3)+(b-2), (I-99.3)+(b-3), (I-99.3)+(b-4), (I-99.3)+(b-5), (I-99.3)+(b-6), (I-99.3)+(b-7), (I-99.3)+(b-8), (I-99.3)+(b-9), (I-99.3)+(b-10), (I-99.3)+(b-11), (I-99.3)+(b-12), (I-99.3)+(b-13), (I-99.3)+(b-14), (I-99.3)+(S3-1), (I-99.3)+(S3-2), (I-99.3)+(S3-3), (I-99.3)+(S3-4), (I-99.3)+(S3-5), (I-99.3)+(h-1), (I-99.3)+(h-2), (I-99.3)+(V-1), (I-99.3)+(V-2), (I-99.3)+(V-3), (I-99.3)+(V-4), (I-99.3)+(V-5), (I-99.3)+(V-6), (I-99.3)+(IX-A1), (I-99.3)+(IX-A2), (I-99.3)+(IX-A3), and (I-99.3)+(IX-A4).

(I-100.1)+(II-0), (I-100.1)+(II-1), (I-100.1)+(II-2), (I-100.1)+(II-3), (I-100.1)+(II-4), (I-100.1)+(II-5), (I-100.1)+(II-6), (I-100.1)+(II-9), (I-100.1)+(II-12), (I-100.1)+(III-1), (I-100.1)+(III-4), (I-100.1)+(III-10), (I-100.1)+(III-11), (I-100.1)+(IV-1), (I-100.1)+(IV-2), (I-100.1)+(IV-3), (I-100.1)+(IV-4), (I-100.1)+(IV-5), (I-100.1)+(b-1), (I-100.1)+(b-2), (I-100.1)+(b-3), (I-100.1)+(b-4), (I-100.1)+(b-5), (I-100.1)+(b-6), (I-100.1)+(b-7), (I-100.1)+(b-8), (I-100.1)+(b-9), (I-100.1)+(b-10), (I-100.1)+(b-11), (I-100.1)+(b-12), (I-100.1)+(b-13), (I-100.1)+(b-14), (I-100.1)+(S3-1), (I-100.1)+(S3-2), (I-100.1)+(S3-3), (I-100.1)+(S3-4), (I-100.1)+(S3-5), (I-100.1)+(h-1), (I-100.1)+(h-2), (I-100.1)+(V-1), (I-100.1)+(V-2), (I-100.1)+(V-3), (I-100.1)+(V-4), (I-100.1)+(V-5), (I-100.1)+(V-6), (I-100.1)+(IX-A1), (I-100.1)+(IX-A2), (I-100.1)+(IX-A3), and (I-100.1)+(IX-A4).

(I-100.2)+(II-0), (I-100.2)+(II-1), (I-100.2)+(II-2), (I-100.2)+(II-3), (I-100.2)+(II-4), (I-100.2)+(II-5), (I-100.2)+(II-6), (I-100.2)+(II-9), (I-100.2)+(II-12), (I-100.2)+(III-1), (I-100.2)+(III-4), (I-100.2)+(III-10), (I-100.2)+(III-11), (I-100.2)+(IV-1), (I-100.2)+(IV-2), (I-100.2)+(IV-3), (I-100.2)+(IV-4), (I-100.2)+(IV-5), (I-100.2)+(b-1), (I-100.2)+(b-2), (I-100.2)+(b-3), (I-100.2)+(b-4), (I-100.2)+(b-5), (I-100.2)+(b-6), (I-100.2)+(b-7), (I-100.2)+(b-8), (I-100.2)+(b-9), (I-100.2)+(b-10), (I-100.2)+(b-11), (I-100.2)+(b-12), (I-100.2)+(b-13), (I-100.2)+(b-14), (I-100.2)+(S3-1), (I-100.2)+(S3-2), (I-100.2)+(S3-3), (I-100.2)+(S3-4), (I-100.2)+(S3-5), (I-100.2)+(h-1), (I-100.2)+(h-2), (I-100.2)+(V-1), (I-100.2)+(V-2), (I-100.2)+(V-3), (I-100.2)+(V-4), (I-100.2)+(V-5), (I-100.2)+(V-6), (I-100.2)+(IX-A1), (I-100.2)+(IX-A2), (I-100.2)+(IX-A3), and (I-100.2)+(IX-A4).

(I-100.3)+(II-0), (I-100.3)+(II-1), (I-100.3)+(II-2), (I-100.3)+(II-3), (I-100.3)+(II-4), (I-100.3)+(II-5), (I-100.3)+(II-6), (I-100.3)+(II-9), (I-100.3)+(II-12), (I-100.3)+(III-1), (I-100.3)+(III-4), (I-100.3)+(III-10), (I-100.3)+(III-11), (I-100.3)+(IV-1), (I-100.3)+(IV-2), (I-100.3)+(IV-3), (I-100.3)+(IV-4), (I-100.3)+(IV-5), (I-100.3)+(b-1), (I-100.3)+(b-2), (I-100.3)+(b-3), (I-100.3)+(b-4), (I-100.3)+(b-5), (I-100.3)+(b-6), (I-100.3)+(b-7), (I-100.3)+(b-8), (I-100.3)+(b-9), (I-100.3)+(b-10), (I-100.3)+(b-11), (I-100.3)+(b-12), (I-100.3)+(b-13), (I-100.3)+(b-14), (I-100.3)+(S3-1), (I-100.3)+(S3-2), (I-100.3)+(S3-3), (I-100.3)+(S3-4), (I-100.3)+(S3-5), (I-100.3)+(h-1), (I-100.3)+(h-2), (I-100.3)+(V-1), (I-100.3)+(V-2), (I-100.3)+(V-3), (I-100.3)+(V-4), (I-100.3)+(V-5), (I-100.3)+(V-6), (I-100.3)+(IX-A1), (I-100.3)+(IX-A2), (I-100.3)+(IX-A3), and (I-100.3)+(IX-A4).

(I-101.1)+(II-0), (I-101.1)+(II-1), (I-101.1)+(II-2), (I-101.1)+(II-3), (I-101.1)+(II-4), (I-101.1)+(II-5), (I-101.1)+(II-6), (I-101.1)+(II-9), (I-101.1)+(II-12), (I-101.1)+(III-1), (I-101.1)+(III-4), (I-101.1)+(III-10), (I-101.1)+(III-11), (I-101.1)+(IV-1), (I-101.1)+(IV-2), (I-101.1)+(IV-3), (I-101.1)+(IV-4), (I-101.1)+(IV-5), (I-101.1)+(b-1), (I-101.1)+(b-2), (I-101.1)+(b-3), (I-101.1)+(b-4), (I-101.1)+(b-5), (I-101.1)+(b-6), (I-101.1)+(b-7), (I-101.1)+(b-8), (I-101.1)+(b-9), (I-101.1)+(b-10), (I-101.1)+(b-11), (I-101.1)+(b-12), (I-101.1)+(b-13), (I-101.1)+(b-14), (I-101.1)+(S3-1), (I-101.1)+(S3-2), (I-101.1)+(S3-3), (I-101.1)+(S3-4), (I-101.1)+(S3-5), (I-101.1)+(h-1), (I-101.1)+(h-2), (I-101.1)+(V-1), (I-101.1)+(V-2), (I-101.1)+(V-3), (I-101.1)+(V-4), (I-101.1)+(V-5), (I-101.1)+(V-6), (I-101.1)+(IX-A1), (I-101.1)+(IX-A2), (I-101.1)+(IX-A3), and (I-101.1)+(IX-A4).

(I-101.2)+(II-0), (I-101.2)+(II-1), (I-101.2)+(II-2), (I-101.2)+(II-3), (I-101.2)+(II-4), (I-101.2)+(II-5), (I-101.2)+(II-6), (I-101.2)+(II-9), (I-101.2)+(II-12), (I-101.2)+(III-1), (I-101.2)+(III-4), (I-101.2)+(III-10), (I-101.2)+(III-11), (I-101.2)+(IV-1), (I-101.2)+(IV-2), (I-101.2)+(IV-3), (I-101.2)+(IV-4), (I-101.2)+(IV-5), (I-101.2)+(b-1), (I-101.2)+(b-2), (I-101.2)+(b-3), (I-101.2)+(b-4), (I-101.2)+(b-5), (I-101.2)+(b-6), (I-101.2)+(b-7), (I-101.2)+(b-8), (I-101.2)+(b-9), (I-101.2)+(b-10), (I-101.2)+(b-11), (I-101.2)+(b-12), (I-101.2)+(b-13), (I-101.2)+(b-14), (I-101.2)+(S3-1), (I-101.2)+(S3-2), (I-101.2)+(S3-3), (I-101.2)+(S3-4), (I-101.2)+(S3-5), (I-101.2)+(h-1), (I-101.2)+(h-2), (I-101.2)+(V-1), (I-101.2)+(V-2), (I-101.2)+(V-3), (I-101.2)+(V-4), (I-101.2)+(V-5), (I-101.2)+(V-6), (I-101.2)+(IX-A1), (I-101.2)+(IX-A2), (I-101.2)+(IX-A3), and (I-101.2)+(IX-A4).

(I-101.3)+(II-0), (I-101.3)+(II-1), (I-101.3)+(II-2), (I-101.3)+(II-3), (I-101.3)+(II-4), (I-101.3)+(II-5), (I-101.3)+(II-6), (I-101.3)+(II-9), (I-101.3)+(II-12), (I-101.3)+(III-1), (I-101.3)+(III-4), (I-101.3)+(III-10), (I-101.3)+(III-11), (I-101.3)+(IV-1), (I-101.3)+(IV-2), (I-101.3)+(IV-3), (I-101.3)+(IV-4), (I-101.3)+(IV-5), (I-101.3)+(b-1), (I-101.3)+(b-2), (I-101.3)+(b-3), (I-101.3)+(b-4), (I-101.3)+(b-5), (I-101.3)+(b-6), (I-101.3)+(b-7), (I-101.3)+(b-8), (I-101.3)+(b-9), (I-101.3)+(b-10), (I-101.3)+(b-11), (I-101.3)+(b-12), (I-101.3)+(b-13), (I-101.3)+(b-14), (I-101.3)+(S3-1), (I-101.3)+(S3-2), (I-101.3)+(S3-3), (I-101.3)+(S3-4), (I-101.3)+(S3-5), (I-101.3)+(h-1), (I-101.3)+(h-2), (I-101.3)+(V-1), (I-101.3)+(V-2), (I-101.3)+(V-3), (I-101.3)+(V-4), (I-101.3)+(V-5), (I-101.3)+(V-6), (I-101.3)+(IX-A1), (I-101.3)+(IX-A2), (I-101.3)+(IX-A3), and (I-101.3)+(IX-A4).

(I-102.1)+(II-0), (I-102.1)+(II-1), (I-102.1)+(II-2), (I-102.1)+(II-3), (I-102.1)+(II-4), (I-102.1)+(II-5), (I-102.1)+(II-6), (I-102.1)+(II-9), (I-102.1)+(II-12), (I-102.1)+(III-1), (I-102.1)+(III-4), (I-102.1)+(III-10), (I-102.1)+(III-11), (I-102.1)+(IV-1), (I-102.1)+(IV-2), (I-102.1)+(IV-3), (I-102.1)+(IV-4), (I-102.1)+(IV-5), (I-102.1)+(b-1), (I-102.1)+(b-2), (I-102.1)+(b-3), (I-102.1)+(b-4), (I-102.1)+(b-5), (I-102.1)+(b-6), (I-102.1)+(b-7), (I-102.1)+(b-8), (I-102.1)+(b-9), (I-102.1)+(b-10), (I-102.1)+(b-11), (I-102.1)+(b-12), (I-102.1)+(b-13), (I-102.1)+(b-14), (I-102.1)+(S3-1), (I-102.1)+(S3-2), (I-102.1)+(S3-3), (I-102.1)+(S3-4), (I-102.1)+(S3-5), (I-102.1)+(h-1), (I-102.1)+(h-2), (I-102.1)+(V-1), (I-102.1)+(V-2), (I-102.1)+(V-3), (I-102.1)+(V-4), (I-102.1)+(V-5), (I-102.1)+(V-6), (I-102.1)+(IX-A1), (I-102.1)+(IX-A2), (I-102.1)+(IX-A3), and (I-102.1)+(IX-A4).

(I-102.2)+(II-0), (I-102.2)+(II-1), (I-102.2)+(II-2), (I-102.2)+(II-3), (I-102.2)+(II-4), (I-102.2)+(II-5), (I-102.2)+(II-6), (I-102.2)+(II-9), (I-102.2)+(II-12), (I-102.2)+(III-1), (I-102.2)+(III-4), (I-102.2)+(II-10), (I-102.2)+(III-11), (I-102.2)+(IV-1), (I-102.2)+(IV-2), (I-102.2)+(IV-3), (I-102.2)+(IV-4), (I-102.2)+(IV-5), (I-102.2)+(b-1), (I-102.2)+(b-2), (I-102.2)+(b-3), (I-102.2)+(b-4), (I-102.2)+(b-5), (I-102.2)+(b-6), (I-102.2)+(b-7), (I-102.2)+(b-8), (I-102.2)+(b-9), (I-102.2)+(b-10), (I-102.2)+(b-11), (I-102.2)+(b-12), (I-102.2)+(b-13), (I-102.2)+(b-14), (I-102.2)+(S3-1), (I-102.2)+(S3-2), (I-102.2)+(S3-3), (I-102.2)+(S3-4), (I-102.2)+(S3-5), (I-102.2)+(h-1), (I-102.2)+(h-2), (I-102.2)+(V-1), (I-102.2)+(V-2), (I-102.2)+(V-3), (I-102.2)+(V-4), (I-102.2)+(V-5), (I-102.2)+(V-6), (I-102.2)+(IX-A1), (I-102.2)+(IX-A2), (I-102.2)+(IX-A3), and (I-102.2)+(IX-A4).

(I-102.3)+(II-0), (I-102.3)+(II-1), (I-102.3)+(II-2), (I-102.3)+(II-3), (I-102.3)+(II-4), (I-102.3)+(II-5), (I-102.3)+(II-6), (I-102.3)+(II-9), (I-102.3)+(II-12), (I-102.3)+(III-1), (I-102.3)+(III-4), (I-102.3)+(III-10), (I-102.3)+(III-11), (I-102.3)+(IV-1), (I-102.3)+(IV-2), (I-102.3)+(IV-3), (I-102.3)+(IV-4), (I-102.3)+(IV-5), (I-102.3)+(b-1), (I-102.3)+(b-2), (I-102.3)+(b-3), (I-102.3)+(b-4), (I-102.3)+(b-5), (I-102.3)+(b-6), (I-102.3)+(b-7), (I-102.3)+(b-8), (I-102.3)+(b-9), (I-102.3)+(b-10), (I-102.3)+(b-11), (I-102.3)+(b-12), (I-102.3)+(b-13), (I-102.3)+(b-14), (I-102.3)+(S3-1), (I-102.3)+(S3-2), (I-102.3)+(S3-3), (I-102.3)+(S3-4), (I-102.3)+(S3-5), (I-102.3)+(h-1), (I-102.3)+(h-2), (I-102.3)+(V-1), (I-102.3)+(V-2), (I-102.3)+(V-3), (I-102.3)+(V-4), (I-102.3)+(V-5), (I-102.3)+(V-6), (I-102.3)+(IX-A1), (I-102.3)+(IX-A2), (I-102.3)+(IX-A3), and (I-102.3)+(IX-A4).

(I-103.1)+(II-0), (I-103.1)+(II-1), (I-103.1)+(II-2), (I-103.1)+(II-3), (I-103.1)+(II-4), (I-103.1)+(II-5), (I-103.1)+(II-6), (I-103.1)+(II-9), (I-103.1)+(II-12), (I-103.1)+(III-1), (I-103.1)+(III-4), (I-103.1)+(III-10), (I-103.1)+(III-11), (I-103.1)+(IV-1), (I-103.1)+(IV-2), (I-103.1)+(IV-3), (I-103.1)+(IV-4), (I-103.1)+(IV-5), (I-103.1)+(b-1), (I-103.1)+(b-2), (I-103.1)+(b-3), (I-103.1)+(b-4), (I-103.1)+(b-5), (I-103.1)+(b-6), (I-103.1)+(b-7), (I-103.1)+(b-8), (I-103.1)+(b-9), (I-103.1)+(b-10), (I-103.1)+(b-11), (I-103.1)+(b-12), (I-103.1)+(b-13), (I-103.1)+(b-14), (I-103.1)+(S3-1), (I-103.1)+(S3-2), (I-103.1)+(S3-3), (I-103.1)+(S3-4), (I-103.1)+(S3-5), (I-103.1)+(h-1), (I-103.1)+(h-2), (I-103.1)+(V-1), (I-103.1)+(V-2), (I-103.1)+(V-3), (I-103.1)+(V-4), (I-103.1)+(V-5), (I-103.1)+(V-6), (I-103.1)+(IX-A1), (I-103.1)+(IX-A2), (I-103.1)+(IX-A3), and (I-103.1)+(IX-A4).

(I-103.2)+(II-0), (I-103.2)+(II-1), (I-103.2)+(II-2), (I-103.2)+(II-3), (I-103.2)+(II-4), (I-103.2)+(II-5), (I-103.2)+(II-6), (I-103.2)+(II-9), (I-103.2)+(II-12), (I-103.2)+(III-1), (I-103.2)+(III-4), (I-103.2)+(III-10), (I-103.2)+(III-11), (I-103.2)+(IV-1), (I-103.2)+(IV-2), (I-103.2)+(IV-3), (I-103.2)+(IV-4), (I-103.2)+(IV-5), (I-103.2)+(b-1), (I-103.2)+(b-2), (I-103.2)+(b-3), (I-103.2)+(b-4), (I-103.2)+(b-5), (I-103.2)+(b-6), (I-103.2)+(b-7), (I-103.2)+(b-8), (I-103.2)+(b-9), (I-103.2)+(b-10), (I-103.2)+(b-11), (I-103.2)+(b-12), (I-103.2)+(b-13), (I-103.2)+(b-14), (I-103.2)+(S3-1), (I-103.2)+(S3-2), (I-103.2)+(S3-3), (I-103.2)+(S3-4), (I-103.2)+(S3-5), (I-103.2)+(h-1), (I-103.2)+(h-2), (I-103.2)+(V-1), (I-103.2)+(V-2), (I-103.2)+(V-3), (I-103.2)+(V-4), (I-103.2)+(V-5), (I-103.2)+(V-6), (I-103.2)+(IX-A1), (I-103.2)+(IX-A2), (I-103.2)+(IX-A3), and (I-103.2)+(IX-A4).

(I-103.3)+(II-0), (I-103.3)+(II-1), (I-103.3)+(II-2), (I-103.3)+(II-3), (I-103.3)+(II-4), (I-103.3)+(II-5), (I-103.3)+(II-6), (I-103.3)+(II-9), (I-103.3)+(II-12), (I-103.3)+(III-1), (I-103.3)+(III-4), (I-103.3)+(III-10), (I-103.3)+(III-11), (I-103.3)+(IV-1), (I-103.3)+(IV-2), (I-103.3)+(IV-3), (I-103.3)+(IV-4), (I-103.3)+(IV-5), (I-103.3)+(b-1), (I-103.3)+(b-2), (I-103.3)+(b-3), (I-103.3)+(b-4), (I-103.3)+(b-5), (I-103.3)+(b-6), (I-103.3)+(b-7), (I-103.3)+(b-8), (I-103.3)+(b-9), (I-103.3)+(b-10), (I-103.3)+(b-11), (I-103.3)+(b-12), (I-103.3)+(b-13), (I-103.3)+(b-14), (I-103.3)+(S3-1), (I-103.3)+(S3-2), (I-103.3)+(S3-3), (I-103.3)+(S3-4), (I-103.3)+(S3-5), (I-103.3)+(h-1), (I-103.3)+(h-2), (I-103.3)+(V-1), (I-103.3)+(V-2), (I-103.3)+(V-3), (I-103.3)+(V-4), (I-103.3)+(V-5), (I-103.3)+(V-6), (I-103.3)+(IX-A1), (I-103.3)+(IX-A2), (I-103.3)+(IX-A3), and (I-103.3)+(IX-A4).

(I-104.1)+(II-0), (I-104.1)+(II-1), (I-104.1)+(II-2), (I-104.1)+(II-3), (I-104.1)+(II-4), (I-104.1)+(II-5), (I-104.1)+(II-6), (I-104.1)+(II-9), (I-104.1)+(II-12), (I-104.1)+(III-1), (I-104.1)+(III-4), (I-104.1)+(III-10), (I-104.1)+(III-11), (I-104.1)+(IV-1), (I-104.1)+(IV-2), (I-104.1)+(IV-3), (I-104.1)+(IV-4), (I-104.1)+(IV-5), (I-104.1)+(b-1), (I-104.1)+(b-2), (I-104.1)+(b-3), (I-104.1)+(b-4), (I-104.1)+(b-5), (I-104.1)+(b-6), (I-104.1)+(b-7), (I-104.1)+(b-8), (I-104.1)+(b-9), (I-104.1)+(b-10), (I-104.1)+(b-11), (I-104.1)+(b-12), (I-104.1)+(b-13), (I-104.1)+(b-14), (I-104.1)+(S3-1), (I-104.1)+(S3-2), (I-104.1)+(S3-3), (I-104.1)+(S3-4), (I-104.1)+(S3-5), (I-104.1)+(h-1), (I-104.1)+(h-2), (I-104.1)+(V-1), (I-104.1)+(V-2), (I-104.1)+(V-3), (I-104.1)+(V-4), (I-104.1)+(V-5), (I-104.1)+(V-6), (I-104.1)+(IX-A1), (I-104.1)+(IX-A2), (I-104.1)+(IX-A3), and (I-104.1)+(IX-A4).

(I-104.2)+(II-0), (I-104.2)+(II-1), (I-104.2)+(II-2), (I-104.2)+(II-3), (I-104.2)+(II-4), (I-104.2)+(II-5), (I-104.2)+(II-6), (I-104.2)+(II-9), (I-104.2)+(II-12), (I-104.2)+(III-1), (I-104.2)+(III-4), (I-104.2)+(III-10), (I-104.2)+(III-11), (I-104.2)+(IV-1), (I-104.2)+(IV-2), (I-104.2)+(IV-3), (I-104.2)+(IV-4), (I-104.2)+(IV-5), (I-104.2)+(b-1), (I-104.2)+(b-2), (I-104.2)+(b-3), (I-104.2)+(b-4), (I-104.2)+(b-5), (I-104.2)+(b-6), (I-104.2)+(b-7), (I-104.2)+(b-8), (I-104.2)+(b-9), (I-104.2)+(b-10), (I-104.2)+(b-11), (I-104.2)+(b-12), (I-104.2)+(b-13), (I-104.2)+(b-14), (I-104.2)+(S3-1), (I-104.2)+(S3-2), (I-104.2)+(S3-3), (I-104.2)+(S3-4), (I-104.2)+(S3-5), (I-104.2)+(h-1), (I-104.2)+(h-2), (I-104.2)+(V-1), (I-104.2)+(V-2), (I-104.2)+(V-3), (I-104.2)+(V-4), (I-104.2)+(V-5), (I-104.2)+(V-6), (I-104.2)+(IX-A1), (I-104.2)+(IX-A2), (I-104.2)+(IX-A3), and (I-104.2)+(IX-A4).

(I-104.3)+(II-0), (I-104.3)+(II-1), (I-104.3)+(II-2), (I-104.3)+(II-3), (I-104.3)+(II-4), (I-104.3)+(II-5), (I-104.3)+(II-6), (I-104.3)+(II-9), (I-104.3)+(II-12), (I-104.3)+(III-1), (I-104.3)+(III-4), (I-104.3)+(III-10), (I-104.3)+(III-11), (I-104.3)+(IV-1), (I-104.3)+(IV-2), (I-104.3)+(IV-3), (I-104.3)+(IV-4), (I-104.3)+(IV-5), (I-104.3)+(b-1), (I-104.3)+(b-2), (I-104.3)+(b-3), (I-104.3)+(b-4), (I-104.3)+(b-5), (I-104.3)+(b-6), (I-104.3)+(b-7), (I-104.3)+(b-8), (I-104.3)+(b-9), (I-104.3)+(b-10), (I-104.3)+(b-11), (I-104.3)+(b-12), (I-104.3)+(b-13), (I-104.3)+(b-14), (I-104.3)+(S3-1), (I-104.3)+(S3-2), (I-104.3)+(S3-3), (I-104.3)+(S3-4), (I-104.3)+(S3-5), (I-104.3)+(h-1), (I-104.3)+(h-2), (I-104.3)+(V-1), (I-104.3)+(V-2), (I-104.3)+(V-3), (I-104.3)+(V-4), (I-104.3)+(V-5), (I-104.3)+(V-6), (I-104.3)+(IX-A1), (I-104.3)+(IX-A2), (I-104.3)+(IX-A3), and (I-104.3)+(IX-A4).

(I-105.1)+(II-0), (I-105.1)+(II-1), (I-105.1)+(II-2), (I-105.1)+(II-3), (I-105.1)+(II-4), (I-105.1)+(II-5), (I-105.1)+(II-6), (I-105.1)+(II-9), (I-105.1)+(II-12), (I-105.1)+(III-1), (I-105.1)+(III-4), (I-105.1)+(III-10), (I-105.1)+(III-11), (I-105.1)+(IV-1), (I-105.1)+(IV-2), (I-105.1)+(IV-3), (I-105.1)+(IV-4), (I-105.1)+(IV-5), (I-105.1)+(b-1), (I-105.1)+(b-2), (I-105.1)+(b-3), (I-105.1)+(b-4), (I-105.1)+(b-5), (I-105.1)+(b-6), (I-105.1)+(b-7), (I-105.1)+(b-8), (I-105.1)+(b-9), (I-105.1)+(b-10), (I-105.1)+(b-11), (I-105.1)+(b-12), (I-105.1)+(b-13), (I-105.1)+(b-14), (I-105.1)+(S3-1), (I-105.1)+(S3-2), (I-105.1)+(S3-3), (I-105.1)+(S3-4), (I-105.1)+(S3-5), (I-105.1)+(h-1), (I-105.1)+(h-2), (I-105.1)+(V-1), (I-105.1)+(V-2), (I-105.1)+(V-3), (I-105.1)+(V-4), (I-105.1)+(V-5), (I-105.1)+(V-6), (I-105.1)+(IX-A1), (I-105.1)+(IX-A2), (I-105.1)+(IX-A3), and (I-105.1)+(IX-A4).

(I-105.2)+(II-0), (I-105.2)+(II-1), (I-105.2)+(II-2), (I-105.2)+(II-3), (I-105.2)+(II-4), (I-105.2)+(II-5), (I-105.2)+(II-6), (I-105.2)+(II-9), (I-105.2)+(II-12), (I-105.2)+(III-1), (I-105.2)+(III-4), (I-105.2)+(III-10), (I-105.2)+(III-11), (I-105.2)+(IV-1), (I-105.2)+(IV-2), (I-105.2)+(IV-3), (I-105.2)+(IV-4), (I-105.2)+(IV-5), (I-105.2)+(b-1), (I-105.2)+(b-2), (I-105.2)+(b-3), (I-105.2)+(b-4), (I-105.2)+(b-5), (I-105.2)+(b-6), (I-105.2)+(b-7), (I-105.2)+(b-8), (I-105.2)+(b-9), (I-105.2)+(b-10), (I-105.2)+(b-11), (I-105.2)+(b-12), (I-105.2)+(b-13), (I-105.2)+(b-14), (I-105.2)+(S3-1), (I-105.2)+(S3-2), (I-105.2)+(S3-3), (I-105.2)+(S3-4), (I-105.2)+(S3-5), (I-105.2)+(h-1), (I-105.2)+(h-2), (I-105.2)+(V-1), (I-105.2)+(V-2), (I-105.2)+(V-3), (I-105.2)+(V-4), (I-105.2)+(V-5), (I-105.2)+(V-6), (I-105.2)+(IX-A1), (I-105.2)+(IX-A2), (I-105.2)+(IX-A3), and (I-105.2)+(IX-A4).

(I-105.3)+(II-0), (I-105.3)+(II-1), (I-105.3)+(II-2), (I-105.3)+(II-3), (I-105.3)+(II-4), (I-105.3)+(II-5), (I-105.3)+(II-6), (I-105.3)+(II-9), (I-105.3)+(II-12), (I-105.3)+(III-1), (I-105.3)+(III-4), (I-105.3)+(III-10), (I-105.3)+(III-11), (I-105.3)+(IV-1), (I-105.3)+(IV-2), (I-105.3)+(IV-3), (I-105.3)+(IV-4), (I-105.3)+(IV-5), (I-105.3)+(b-1), (I-105.3)+(b-2), (I-105.3)+(b-3), (I-105.3)+(b-4), (I-105.3)+(b-5), (I-105.3)+(b-6), (I-105.3)+(b-7), (I-105.3)+(b-8), (I-105.3)+(b-9), (I-105.3)+(b-10), (I-105.3)+(b-11), (I-105.3)+(b-12), (I-105.3)+(b-13), (I-105.3)+(b-14), (I-105.3)+(S3-1), (I-105.3)+(S3-2), (I-105.3)+(S3-3), (I-105.3)+(S3-4), (I-105.3)+(S3-5), (I-105.3)+(h-1), (I-105.3)+(h-2), (I-105.3)+(V-1), (I-105.3)+(V-2), (I-105.3)+(V-3), (I-105.3)+(V-4), (I-105.3)+(V-5), (I-105.3)+(V-6), (I-105.3)+(IX-A1), (I-105.3)+(IX-A2), (I-105.3)+(IX-A3), and (I-105.3)+(IX-A4).

(I-106.1)+(II-0), (I-106.1)+(II-1), (I-106.1)+(II-2), (I-106.1)+(II-3), (I-106.1)+(II-4), (I-106.1)+(II-5), (I-106.1)+(II-6), (I-106.1)+(II-9), (I-106.1)+(II-12), (I-106.1)+(III-1), (I-106.1)+(III-4), (I-106.1)+(III-10), (I-106.1)+(III-11), (I-106.1)+(IV-1), (I-106.1)+(IV-2), (I-106.1)+(IV-3), (I-106.1)+(IV-4), (I-106.1)+(IV-5), (I-106.1)+(b-1), (I-106.1)+(b-2), (I-106.1)+(b-3), (I-106.1)+(b-4), (I-106.1)+(b-5), (I-106.1)+(b-6), (I-106.1)+(b-7), (I-106.1)+(b-8), (I-106.1)+(b-9), (I-106.1)+(b-10), (I-106.1)+(b-11), (I-106.1)+(b-12), (I-106.1)+(b-13), (I-106.1)+(b-14), (I-106.1)+(S3-1), (I-106.1)+(S3-2), (I-106.1)+(S3-3), (I-106.1)+(S3-4), (I-106.1)+(S3-5), (I-106.1)+(h-1), (I-106.1)+(h-2), (I-106.1)+(V-1), (I-106.1)+(V-2), (I-106.1)+(V-3), (I-106.1)+(V-4), (I-106.1)+(V-5), (I-106.1)+(V-6), (I-106.1)+(IX-A1), (I-106.1)+(IX-A2), (I-106.1)+(IX-A3), and (I-106.1)+(IX-A4).

(I-106.2)+(II-0), (I-106.2)+(II-1), (I-106.2)+(II-2), (I-106.2)+(II-3), (I-106.2)+(II-4), (I-106.2)+(II-5), (I-106.2)+(II-6), (I-106.2)+(II-9), (I-106.2)+(II-12), (I-106.2)+(III-1), (I-106.2)+(III-4), (I-106.2)+(III-10), (I-106.2)+(III-11), (I-106.2)+(IV-1), (I-106.2)+(IV-2), (I-106.2)+(IV-3), (I-106.2)+(IV-4), (I-106.2)+(IV-5), (I-106.2)+(b-1), (I-106.2)+(b-2), (I-106.2)+(b-3), (I-106.2)+(b-4), (I-106.2)+(b-5), (I-106.2)+(b-6), (I-106.2)+(b-7), (I-106.2)+(b-8), (I-106.2)+(b-9), (I-106.2)+(b-10), (I-106.2)+(b-11), (I-106.2)+(b-12), (I-106.2)+(b-13), (I-106.2)+(b-14), (I-106.2)+(S3-1), (I-106.2)+(S3-2), (I-106.2)+(S3-3), (I-106.2)+(S3-4), (I-106.2)+(S3-5), (I-106.2)+(h-1), (I-106.2)+(h-2), (I-106.2)+(V-1), (I-106.2)+(V-2), (I-106.2)+(V-3), (I-106.2)+(V-4), (I-106.2)+(V-5), (I-106.2)+(V-6), (I-106.2)+(IX-A1), (I-106.2)+(IX-A2), (I-106.2)+(IX-A3), and (I-106.2)+(IX-A4).

(I-106.3)+(II-0), (I-106.3)+(II-1), (I-106.3)+(II-2), (I-106.3)+(II-3), (I-106.3)+(II-4), (I-106.3)+(II-5), (I-106.3)+(II-6), (I-106.3)+(II-9), (I-106.3)+(II-12), (I-106.3)+(III-1), (I-106.3)+(III-4), (I-106.3)+(III-10), (I-106.3)+(III-11), (I-106.3)+(IV-1), (I-106.3)+(IV-2), (I-106.3)+(IV-3), (I-106.3)+(IV-4), (I-106.3)+(IV-5), (I-106.3)+(b-1), (I-106.3)+(b-2), (I-106.3)+(b-3), (I-106.3)+(b-4), (I-106.3)+(b-5), (I-106.3)+(b-6), (I-106.3)+(b-7), (I-106.3)+(b-8), (I-106.3)+(b-9), (I-106.3)+(b-10), (I-106.3)+(b-11), (I-106.3)+(b-12), (I-106.3)+(b-13), (I-106.3)+(b-14), (I-106.3)+(S3-1), (I-106.3)+(S3-2), (I-106.3)+(S3-3), (I-106.3)+(S3-4), (I-106.3)+(S3-5), (I-106.3)+(h-1), (I-106.3)+(h-2), (I-106.3)+(V-1), (I-106.3)+(V-2), (I-106.3)+(V-3), (I-106.3)+(V-4), (I-106.3)+(V-5), (I-106.3)+(V-6), (I-106.3)+(IX-A1), (I-106.3)+(IX-A2), (I-106.3)+(IX-A3), and (I-106.3)+(IX-A4).

(I-107.1)+(II-0), (I-107.1)+(II-1), (I-107.1)+(II-2), (I-107.1)+(II-3), (I-107.1)+(II-4), (I-107.1)+(II-5), (I-107.1)+(II-6), (I-107.1)+(II-9), (I-107.1)+(II-12), (I-107.1)+(III-1), (I-107.1)+(III-4), (I-107.1)+(III-10), (I-107.1)+(III-11), (I-107.1)+(IV-1), (I-107.1)+(IV-2), (I-107.1)+(IV-3), (I-107.1)+(IV-4), (I-107.1)+(IV-5), (I-107.1)+(b-1), (I-107.1)+(b-2), (I-107.1)+(b-3), (I-107.1)+(b-4), (I-107.1)+(b-5), (I-107.1)+(b-6), (I-107.1)+(b-7), (I-107.1)+(b-8), (I-107.1)+(b-9), (I-107.1)+(b-10), (I-107.1)+(b-11), (I-107.1)+(b-12), (I-107.1)+(b-13), (I-107.1)+(b-14), (I-107.1)+(S3-1), (I-107.1)+(S3-2), (I-107.1)+(S3-3), (I-107.1)+(S3-4), (I-107.1)+(S3-5), (I-107.1)+(h-1), (I-107.1)+(h-2), (I-107.1)+(V-1), (I-107.1)+(V-2), (I-107.1)+(V-3), (I-107.1)+(V-4), (I-107.1)+(V-5), (I-107.1)+(V-6), (I-107.1)+(IX-A1), (I-107.1)+(IX-A2), (I-107.1)+(IX-A3), and (I-107.1)+(IX-A4).

(I-107.2)+(II-0), (I-107.2)+(II-1), (I-107.2)+(II-2), (I-107.2)+(II-3), (I-107.2)+(II-4), (I-107.2)+(II-5), (I-107.2)+(II-6), (I-107.2)+(II-9), (I-107.2)+(II-12), (I-107.2)+(III-1), (I-107.2)+(III-4), (I-107.2)+(III-10), (I-107.2)+(III-11), (I-107.2)+(IV-1), (I-107.2)+(IV-2), (I-107.2)+(IV-3), (I-107.2)+(IV-4), (I-107.2)+(IV-5), (I-107.2)+(b-1), (I-107.2)+(b-2), (I-107.2)+(b-3), (I-107.2)+(b-4), (I-107.2)+(b-5), (I-107.2)+(b-6), (I-107.2)+(b-7), (I-107.2)+(b-8), (I-107.2)+(b-9), (I-107.2)+(b-10), (I-107.2)+(b-11), (I-107.2)+(b-12), (I-107.2)+(b-13), (I-107.2)+(b-14), (I-107.2)+(S3-1), (I-107.2)+(S3-2), (I-107.2)+(S3-3), (I-107.2)+(S3-4), (I-107.2)+(S3-5), (I-107.2)+(h-1), (I-107.2)+(h-2), (I-107.2)+(V-1), (I-107.2)+(V-2), (I-107.2)+(V-3), (I-107.2)+(V-4), (I-107.2)+(V-5), (I-107.2)+(V-6), (I-107.2)+(IX-A1), (I-107.2)+(IX-A2), (I-107.2)+(IX-A3), and (I-107.2)+(IX-A4).

(I-107.3)+(II-0), (I-107.3)+(II-1), (I-107.3)+(II-2), (I-107.3)+(II-3), (I-107.3)+(II-4), (I-107.3)+(II-5), (I-107.3)+(II-6), (I-107.3)+(II-9), (I-107.3)+(II-12), (I-107.3)+(III-1), (I-107.3)+(III-4), (I-107.3)+(III-10), (I-107.3)+(III-11), (I-107.3)+(IV-1), (I-107.3)+(IV-2), (I-107.3)+(IV-3), (I-107.3)+(IV-4), (I-107.3)+(IV-5), (I-107.3)+(b-1), (I-107.3)+(b-2), (I-107.3)+(b-3), (I-107.3)+(b-4), (I-107.3)+(b-5), (I-107.3)+(b-6), (I-107.3)+(b-7), (I-107.3)+(b-8), (I-107.3)+(b-9), (I-107.3)+(b-10), (I-107.3)+(b-11), (I-107.3)+(b-12), (I-107.3)+(b-13), (I-107.3)+(b-14), (I-107.3)+(S3-1), (I-107.3)+(S3-2), (I-107.3)+(S3-3), (I-107.3)+(S3-4), (I-107.3)+(S3-5), (I-107.3)+(h-1), (I-107.3)+(h-2), (I-107.3)+(V-1), (I-107.3)+(V-2), (I-107.3)+(V-3), (I-107.3)+(V-4), (I-107.3)+(V-5), (I-107.3)+(V-6), (I-107.3)+(IX-A1), (I-107.3)+(IX-A2), (I-107.3)+(IX-A3), and (I-107.3)+(IX-A4).

(I-108.1)+(II-0), (I-108.1)+(II-1), (I-108.1)+(II-2), (I-108.1)+(II-3), (I-108.1)+(II-4), (I-108.1)+(II-5), (I-108.1)+(II-6), (I-108.1)+(II-9), (I-108.1)+(II-12), (I-108.1)+(III-1), (I-108.1)+(III-4), (I-108.1)+(III-10), (I-108.1)+(III-11), (I-108.1)+(IV-1), (I-108.1)+(IV-2), (I-108.1)+(IV-3), (I-108.1)+(IV-4), (I-108.1)+(IV-5), (I-108.1)+(b-1), (I-108.1)+(b-2), (I-108.1)+(b-3), (I-108.1)+(b-4), (I-108.1)+(b-5), (I-108.1)+(b-6), (I-108.1)+(b-7), (I-108.1)+(b-8), (I-108.1)+(b-9), (I-108.1)+(b-10), (I-108.1)+(b-11), (I-108.1)+(b-12), (I-108.1)+(b-13), (I-108.1)+(b-14), (I-108.1)+(S3-1), (I-108.1)+(S3-2), (I-108.1)+(S3-3), (I-108.1)+(S3-4), (I-108.1)+(S3-5), (I-108.1)+(h-1), (I-108.1)+(h-2), (I-108.1)+(V-1), (I-108.1)+(V-2), (I-108.1)+(V-3), (I-108.1)+(V-4), (I-108.1)+(V-5), (I-108.1)+(V-6), (I-108.1)+(IX-A1), (I-108.1)+(IX-A2), (I-108.1)+(IX-A3), and (I-108.1)+(IX-A4).

(I-108.2)+(II-0), (I-108.2)+(II-1), (I-108.2)+(II-2), (I-108.2)+(II-3), (I-108.2)+(II-4), (I-108.2)+(II-5), (I-108.2)+(II-6), (I-108.2)+(II-9), (I-108.2)+(II-12), (I-108.2)+(III-1), (I-108.2)+(III-4), (I-108.2)+(III-10), (I-108.2)+(III-11), (I-108.2)+(IV-1), (I-108.2)+(IV-2), (I-108.2)+(IV-3), (I-108.2)+(IV-4), (I-108.2)+(IV-5), (I-108.2)+(b-1), (I-108.2)+(b-2), (I-108.2)+(b-3), (I-108.2)+(b-4), (I-108.2)+(b-5), (I-108.2)+(b-6), (I-108.2)+(b-7), (I-108.2)+(b-8), (I-108.2)+(b-9), (I-108.2)+(b-10), (I-108.2)+(b-11), (I-108.2)+(b-12), (I-108.2)+(b-13), (I-108.2)+(b-14), (I-108.2)+(S3-1), (I-108.2)+(S3-2), (I-108.2)+(S3-3), (I-108.2)+(S3-4), (I-108.2)+(S3-5), (I-108.2)+(h-1), (I-108.2)+(h-2), (I-108.2)+(V-1), (I-108.2)+(V-2), (I-108.2)+(V-3), (I-108.2)+(V-4), (I-108.2)+(V-5), (I-108.2)+(V-6), (I-108.2)+(IX-A1), (I-108.2)+(IX-A2), (I-108.2)+(IX-A3), and (I-108.2)+(IX-A4).

(I-108.3)+(II-0), (I-108.3)+(II-1), (I-108.3)+(II-2), (I-108.3)+(II-3), (I-108.3)+(II-4), (I-108.3)+(II-5), (I-108.3)+(II-6), (I-108.3)+(II-9), (I-108.3)+(II-12), (I-108.3)+(III-1), (I-108.3)+(III-4), (I-108.3)+(III-10), (I-108.3)+(III-11), (I-108.3)+(IV-1), (I-108.3)+(IV-2), (I-108.3)+(IV-3), (I-108.3)+(IV-4), (I-108.3)+(IV-5), (I-108.3)+(b-1), (I-108.3)+(b-2), (I-108.3)+(b-3), (I-108.3)+(b-4), (I-108.3)+(b-5), (I-108.3)+(b-6), (I-108.3)+(b-7), (I-108.3)+(b-8), (I-108.3)+(b-9), (I-108.3)+(b-10), (I-108.3)+(b-11), (I-108.3)+(b-12), (I-108.3)+(b-13), (I-108.3)+(b-14), (I-108.3)+(S3-1), (I-108.3)+(S3-2), (I-108.3)+(S3-3), (I-108.3)+(S3-4), (I-108.3)+(S3-5), (I-108.3)+(h-1), (I-108.3)+(h-2), (I-108.3)+(V-1), (I-108.3)+(V-2), (I-108.3)+(V-3), (I-108.3)+(V-4), (I-108.3)+(V-5), (I-108.3)+(V-6), (I-108.3)+(IX-A1), (I-108.3)+(IX-A2), (I-108.3)+(IX-A3), and (I-108.3)+(IX-A4).

The safeners (group B compounds) of the formulae (II)-(IX) are suitable for reducing phytotoxic effects which may occur when herbicides (A) are used in crops of useful plants, while having no major adverse effect on the activity of these herbicidal active compounds against harmful plants. By virtue of these properties, it is possible to extend the field of application of customary crop protection compositions considerably, for example to crops in which it has hitherto been possible to employ the herbicides not at all or only to a limited extent.

Depending on indication and herbicidal active compound used, the required application rates of the safeners can vary within wide limits and are generally in the range from 0.001 to 5 kg, preferably from 0.005 to 2.5 kg, of active compound per hectare.

The herbicidal active compounds (A) and the safeners (B) can be applied together (for example as a readymix or by the tank mix method) or sequentially in any desired order, for example by atomizing, pouring or spraying, or by broadcasting granules. The weight ratio of herbicide (A):safener (B) may vary within wide limits and is preferably in the range from 1:10 000 to 10 000:1, in particular from 1:1000 to 1000:1. The optimum amounts of herbicide and safener depend in each case on the type of herbicide used and the type of safener used and on the nature and the development stage of the plant stock to be treated and can be determined in each individual case by simple routine preliminary experiments.

Depending on their properties, the safeners (B) contained in the herbicide/safener combination according to the invention can be used for pretreating the seed of the crop plant (for example for seed dressing) or introduced into the seed furrows prior to sowing or used together with the herbicide before or after emergence of the plants. Pre-emergence treatment includes not only the treatment of the area under cultivation (including, if appropriate, water present on the area under cultivation, for example in the case of rice applications) before sowing, but also the treatment of the sown soil which does not yet sustain vegetation. Preferred is the application together with the herbicide. Tank mixes or readymixes may be employed for this purpose.

In a preferred embodiment, the seed (for example grains, seed or vegetative propagation organs, such as tubers or shoot parts with buds) or seedlings are pretreated with the safeners (B), if appropriate in combination with other agrochemically active compounds. For pretreating the seed, the active compounds can be applied to the seed, for example, by dressing, or the active compounds and the seed can be introduced into water or other solvents, and the active compounds can be taken up, for example, by adduct formation or diffusion in a dip process or by swelling or pregermination. For the pretreatment of seedlings, the young plants can be brought into contact with the safeners, if appropriate in combination with other agrochemically active compounds, for example by spraying, dipping or watering, and then be transplanted and, if appropriate, be subjected to a post-treatment with the herbicides (A).

The treatment of the seed or the seedlings can be carried out using the safeners (B) alone or together with other agrochemically active compounds, such as fungicides, insecticides or agents for fortifying the plant, for fertilizing or for promoting the swelling and germination processes. Here, the safeners may, after the pretreatment application, be applied once more before, after or together with one or more herbicides of the formula (I) optionally in combination with other known herbicides. By pretreating the seed or the seedlings, it is possible to achieve better long-term action of the safeners.

Accordingly, the present invention also provides a method for controlling unwanted plants in crops of plants, which method comprises applying the components (A) and (B) of the herbicide/safener combination according to the invention to the plants (for example harmful plants, such as monocotyledonous or dicotyledonous weeds or unwanted crop plants), the seed (for example grains, seeds or vegetative propagation organs, such as tubers or shoot parts with buds) or to the area on which the plants grow (for example the area under cultivation), for example together or separately. Here, it is possible to apply one or more safeners (B), preferably one or more, in particular one, compound of the formula (II), (III), (IV), (V), (VI), (VII), (VIII), and/or (IX), from the group B, before, after or simultaneously with the herbicide(s) (A) to the plants, the seed or the area on which the plants grow (for example the area under cultivation). In a preferred embodiment, the safeners (B) are used for treating the seed.

Unwanted plants are to be understood as meaning all plants growing in locations where they are unwanted. These may be, for example, harmful plants (for example monocotyledonous or dicotyledonous weeds or unwanted crop plants), including, for example, those which are resistant to certain herbicidal active compounds, such as glyphosate, atrazine, glufosinate or imidazolinone herbicides.

Monocotyledonous weeds are, for example, from the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus, Apera. Dicotyledonous weeds are, for example, from the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindemia, Lamium, Veronica, Abutilon, Emex, Datura, Viola, Galeopsis, Papaver, Centaurea, Trifolium, Ranunculus, Taraxacum, Euphorbia.

In the process according to the invention, preferably an effective amount of the components (A) and (B) is used for controlling harmful plants in crop plants, for example in farm crops of economic importance, for example monocotyledonous farm crops, such as cereals (for example wheat, barley, rye, oats), rice, corn, millet, or dicotyledonous farm crops, such as sugar beet, oilseed rape, cotton, sunflowers and legumes, for example of the genera Glycine (for example Glycine max., such as non-transgenic Glycine max. (for example conventional cultivars, such as STS cultivars) or transgenic Glycine max. (for example RR-soybeans or LL-soybeans) and crossbreeds thereof), Phaseolus, Pisum, Vicia and Arachis, or vegetable crops from various botanical groups, such as potato, leek, cabbage, carrot, tomato, onion, and also permanent crops and plantation crops, such as pome fruit and stone fruit, berry fruit, grapevine, Hevea, bananas, sugar cane, coffee, tea, citrus fruit, nut plantations, lawn, palm plantations and forest plantations.

The invention also provides for the use of the herbicide/safener combinations according to the invention for controlling unwanted vegetation, preferably in crops of plants.

The herbicide/safener combinations according to the invention can be prepared by known processes, for example as mix formulations of the individual components, if appropriate with further active compounds, additives and/or customary formulation auxiliaries, which are then applied in a customary manner diluted with water, or they can be prepared as tank mixes by jointly diluting the individual components, formulated separately or partially formulated separately, with water. It is furthermore possible to apply the individual components, formulated separately or partially formulated separately, at different times (splitting). It is also possible to apply the individual components or the herbicide/safener combinations in a plurality of portions (sequential application), for example pre-emergence applications followed by post-emergence applications or early post-emergence applications followed by medium or late post-emergence applications. Preference is given here to the joint or almost simultaneous application of the active compounds of the combination in question.

The herbicide/safener combination according to the invention can also be employed for controlling harmful plants in crops of known genetically modified plants or genetically modified plants yet to be developed. In general, the transgenic plants have particular advantageous properties, for example resistance to certain crop protection agents, resistance to plant diseases or to caustic agents of plant diseases, such as specific insects or microorganisms, such as fungi, bacteria or viruses. Other particular properties are concerned, for example, with the harvested crop with regard to quantity, quality, storability, composition and specific constituents. Thus, transgenic plants are known which have an increased starch content or a modified starch quality, or which have a different fatty acid composition or amino acid composition of the harvested crop.

Preference is given to the use of the combinations according to the invention in economically important transgenic crops of useful plants and ornamentals, for example of cereals (such as wheat, barley, rye, oats), millet, rice, cassava and corn, or else crops of sugar beet, cotton, soybean, oilseed rape, potato, tomato, pea and other vegetables.

When the combinations according to the invention are used in transgenic crops, effects in addition to the effects to be observed against harmful plants in other crops are frequently found, which are specific for application in the particular transgenic crop, for example a modified or specifically widened spectrum of weeds which can be controlled, modified application rates which may be employed for the application, preferably good combinability with the herbicides to which the transgenic crop is resistant, and an effect on growth and yield of the transgenic crop plants.

Accordingly, the invention also provides for the use of the herbicidally active composition according to the invention for controlling harmful plants in transgenic crop plants or crop plants which are tolerant as a result of selective breeding.

The herbicides (A) and the safeners (B) can, together or separately, be converted into customary formulations, for example for application by atomizing, watering, spraying and seed dressing, such as solutions, emulsions, suspensions, powders, foams, pastes, granules, aerosols, natural compounds or synthetic materials impregnated with active compounds, microcapsules in polymeric compounds. The formulations may comprise the customary auxiliaries and additives.

These formulations are prepared in a known manner, for example by mixing the active compounds with extenders, i.e. liquid solvents, pressurized liquefied gases and/or solid carriers, using, if appropriate, surfactants, i.e. emulsifiers and/or dispersants and/or foam formers.

If the extender used is water, it is also possible to employ, for example, organic solvents as auxiliary solvents. Suitable liquid solvents are essentially: aromatics, such as xylene, toluene, alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, mineral and vegetable oils, alcohols, such as butanol or glycol, and also their ethers and esters, ketones, such as acetone, methyl ethyl ketone, methyl isobutyl ketone or cyclohexanone, strongly polar solvents, such as dimethylformamide or dimethyl sulfoxide, and also water.

Suitable solid carriers are: for example ammonium salts and ground natural minerals, such as kaolins, clays, talc, chalk, quartz, attapulgite, montmorillonite or diatomaceous earth, and ground synthetic minerals, such as finely divided silica, alumina and silicates; suitable solid carriers for granules are: for example crushed and fractionated natural rocks, such as calcite, marble, pumice, sepiolite and dolomite, and also synthetic granules of inorganic and organic meals, and granules of organic material, such as sawdust, coconut shells, corn cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and protein hydrolysates; suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, and also natural phospholipids, such as cephalins and lecithins, and synthetic phospholipids, can be used in the formulations. Other possible additives are mineral and vegetable oils.

It is possible to use colorants such as inorganic pigments, for example iron oxide, titanium oxide and Prussian Blue, and organic dyes, for example alizarin dyestuffs, azo dyestuffs and metal phthalocyanine dyestuffs, and trace nutrients, such as salts of iron, manganese, boron, copper, cobalt, molybdenum and zinc.

The formulations generally comprise between 0.1 and 95 percent by weight of active compound, preferably between 0.5 and 90% by weight.

The herbicides (A) and the safeners (B), as such or in their formulations, including as a mixture with other agrochemically active compounds, such as known herbicides, can be used for controlling unwanted vegetation, for example for controlling weeds or for controlling unwanted crop plants, readymixes or tank mixes, for example, being possible.

Also possible are mixtures with other known active compounds, such as fungicides, insecticides, acaricides, nematicides, safeners, bird repellents, plant nutrients and substances which improve the soil structure, and also formulation auxiliaries and additives customary in crop protection.

The herbicides (A) and the safeners (B) can be applied as such, in the form of their formulations or the use forms prepared therefrom by further dilution, such as ready-to-use solutions, suspensions, emulsions, powders, pastes and granules. Application is carried out in a customary manner, for example by watering, spraying, atomizing, broadcasting.

The active compounds can be applied to the plants, to parts of the plants, to the seed or to the area under cultivation (soil of a field), preferably to the seed or the green plants and parts of plants and, if appropriate, additionally to the soil of the field. One possible use is the joint application of the active compounds in the form of tank mixes, where the concentrated formulations of the individual active compounds, in optimized formulations, are jointly mixed with water in the tank and the resulting spray liquor is applied.

A joint formulation of the combination according to the invention of active compounds (A) and (B) has the advantage of being easier to apply since the quantities of the components are already present in the correct ratio to one another. Moreover, the auxiliaries in the formulation can be matched optimally to one another.

Suitable combination partners for the herbicide/safener combination according to the invention in mix formulations or in the tank mix are, for example, known agrochemically active compounds, such as herbicides, fungicides or insecticides, as described, for example, in Weed Research 26, 441-445 (1986), or “The Pesticide Manual”, 13th edition, The British Crop Protection Council, 2003, and the literature cited therein. The following active compounds, for example, may be mentioned as herbicides known from the literature which can be combined with the mixtures according to the invention (note: the compounds are referred to either by the “common name” according to the International Organization for Standardization (ISO) or by the chemical name, if appropriate together with a customary code number, and include in each case all use forms, such as acids, salts, esters and isomers, such as stereoisomers and optical isomers. One and in some cases a plurality of application forms is/are mentioned):

2,4-D, acetochlor, acifluorfen, acifluorfen-sodium, aclonifen, alachlor, alloxydim, alloxydim-sodium, ametryn, amicarbazone, amidosulfuron, aminopyralid, amitrole, anilofos, asulam, atrazine, azafenidin, azimsulfuron, beflubutamid, benazolin, benazolin-ethyl, benfuresate, bensulfuron-methyl, bentazone, benzfendizone, benzobicyclon, benzofenap, bifenox, bilanafos, bispyribac-sodium, bromacil, bromobutide, bromofenoxim, bromoxynil, butachlor, butafenacil, butenachlor, butralin, butroxydim, butylate, cafenstrole, carbetamide, carfentrazone-ethyl, chlomethoxyfen, chloridazon, chlorimuron-ethyl, chlornitrofen, chlorotoluron, chlorsulfuron, cinidon-ethyl, cinmethylin, cinosulfuron, clefoxydim, clethodim, clodinafop-propargyl, clomazone, clomeprop, clopyralid, cloransulam-methyl, cumyluron, cyanazine, cyclosulfamuron, cycloxydim, cyhalofop-butyl, desmedipham, dicamba, dichlobenil, dichlorprop, dichlorprop-p, diclofop-methyl, diclosulam, difenzoquat, diflufenican, diflufenzopyr, dikegulac-sodium, dimefuron, dimepiperate, dimethachlor, dimethametryn, dimethenamid, triaziflam, diquat-dibromide, dithiopyr, diuron, dymron, EPTC, esprocarb, ethalfluralin, ethametsulfuron-methyl, ethofumesate, ethoxyfen, ethoxysulfuron, etobenzanid, fenoxaprop-ethyl, fenoxaprop-p-ethyl, fentrazamide, flamprop-M-isopropyl, flamprop-M-methyl, flazasulfuron, florasulam, fluazifop, fluazifop-butyl, fluazifop-butyl, fluazolate, flucarbazone-sodium, flucetosulfuron, fluchloralin, flufenacet, flufenpyr, flumetsulam, flumiclorac-pentyl, flumioxazin, fluometuron, fluorochloridone, fluoroglycofen-ethyl, flupoxam, flupyrsulfuron-methyl-sodium, fluridone, fluroxypyr, fluroxypyr-butoxypropyl, fluroxypyr-meptyl, flurprimidol, flurtamone, fluthiacet-methyl, fomesafen, foramsulfuron, glufosinate, glufosinate-ammonium, glyphosate, halosulfuron-methyl, haloxyfop, haloxyfop-ethoxyethyl, haloxyfop-methyl, haloxyfop-P-methyl, hexazinone, imazamethabenz-methyl, imazamox, imazapic, imazapyr, imazaquin, imazethapyr, imazosulfuron, indanofan, iodosulfuron-methyl-natrium, ioxynil, isoproturon, isouron, isoxaben, isoxachlortole, isoxaflutole, ketospiradox, lactofen, lenacil, linuron, MCPA, mecoprop, mecoprop-P, mefenacet, mesosulfuron-methyl, mesotrione, metamifop, metamitron, metazachlor, methabenzthiazuron, methyldymron, metobromuron, metolachlor, metosulam, metoxuron, metribuzin, metsulfuron-methyl, molinate, monolinuron, naproanilide, napropamide, neburon, nicosulfuron, norflurazon, orbencarb, oryzalin, oxadiargyl, oxadiazon, oxasulfuron, oxaziclomefone, oxyfluorfen, paraquat, pelargonic acid, pendimethalin, pendralin, penoxsulam, pentoxazone, pethoxamid, phenmedipham, picloram, picolinafen, pinoxaden, piperophos, pretilachlor, primisulfuron-methyl, profluazol, profoxydim, prometryn, propachlor, propanil, propaquizafop, propisochlor, propoxycarbazonesodium, propyzamide, prosulfocarb, prosulfuron, pyraclonil, pyraflufen-ethyl, pyrazolate, pyrazosulfuron-ethyl, pyrazoxyfen, pyribenzoxim, pyributicarb, pyridafol, pyridate, pyriftalid, pyriminobac-methyl, pyrithiobac-sodium, quinclorac, quinmerac, quinoclamine, quizalofop-ethyl, quizalofop-P-ethyl, quizalofop-P-tefuryl, rimsulfuron, sethoxydim, simazine, simetryn, S-metolachlor, sulcotrione, sulfentrazone, sulfometuron-methyl, sulfosate, sulfosulfuron, tebuthiuron, tepraloxydim, terbuthylazine, terbutryn, thenylchlor, thiazopyr, thifensulfuron-methyl, thiobencarb, tiocarbazil, tralkoxydim, triallate, triasulfuron, tribenuron-methyl, triclopyr, tridiphane, trifloxysulfuron, trifluralin, triflusulfuron-methyl and tritosulfuron.

Of particular advantage as combination partners for the herbicide/safener combination of the invention in mixture formulations or in a tank mix are 2,4-D, acetochlor, alachlor, amidosulfuron, aminopyralid, atrazine, bispyribac-sodium, bromoxynil, cafenstrole, carfentrazone-ethyl, chlorimuron-ethyl, chlorotoluron, chlorsulfuron, cinosulfuron, clefoxydim, clethodim, clodinafop-propargyl, clomazone, cloransulam-methyl, cyanazine, cyclosulfamuron, cyhalofop-butyl, dicamba, dichlobenil, diclofop-methyl, diflufenican, diflufenzopyr, dimethenamid, diquat-dibromide, diuron, EPTC, fenoxaprop-ethyl, fenoxaprop-P-ethyl, fentrazamide, flamprop-M-methyl, flazasulfuron, florasulam, fluazifop, fluazifop-butyl, fluazifop-butyl, flucarbazone-sodium, flucetosulfuron, flufenacet, flumetsulam, fluoroglycofen-ethyl, flupyrsulfuron-methyl-sodium, fluroxypyr, fluroxypyr-butoxypropyl, fluroxypyr-meptyl, flurtamone, fluthiacet-methyl, foramsulfuron, glufosinate, glufosinate-ammonium, glyphosate, halosulfuron-methyl, haloxyfop, haloxyfop-ethoxyethyl, haloxyfop-methyl, haloxyfop-P-methyl, imazamethabenz-methyl, imazamox, imazapic, imazapyr, imazaquin, imazethapyr, imazosulfuron, indanofan, iodosulfuron-methyl-natrium, ioxynil, isoproturon, isoxachlortole, isoxaflutole, linuron, MCPA, mecoprop, mecoprop-P, mefenacet, mesosulfuron-methyl, mesotrione, metolachlor, metribuzin, metsulfuron-methyl, nicosulfuron, norflurazon, oxadiargyl, oxadiazon, oxasulfuron, oxyfluorfen, paraquat, penoxsulam, picolinafen, pinoxaden, pretilachlor, primisulfuron-methyl, propachlor, propoxycarbazone-sodium, prosulfuron, pyraclonil, pyrazosulfuron-ethyl, pyriftalid, quinclorac, quinmerac, quizalofop-ethyl, quizalofop-P-ethyl, quizalofop-P-tefuryl, rimsulfuron, sethoxydim, simazine, S-metolachlor, sulcotrione, sulfentrazone, sulfosulfuron, tepraloxydim, terbuthylazine, thifensulfuron-methyl, triasulfuron, tribenuron-methyl, and tritosulfuron.

Especially advantageous as combination partners for the herbicide/safener combination of the invention in mixture formulations or in a tank mix are atrazine, fenoxaprop-ethyl, glufosinate, glufosinate-ammonium, glyphosate, isoxaflutole, mesosulfuron-methyl, mesotrione, and S-metolachlor.

Extremely advantageous as a combination partner for the herbicide/safener combination of the invention in mixture formulations or in a tank mix is isoxaflutole.

For application, formulations which are present in a commercial form can, if appropriate, be diluted in a customary manner using, for example, water. Preparations in the form of dusts, soil granules and granules for broadcasting and also sprayable solutions are usually not diluted any further with further inert substances prior to the application.

### BIOLOGICAL EXAMPLES

1. Pre-Emergence Action Against Weeds

Seeds or rhizome pieces of monocotyledonous and dicotyledonous weed plants were placed in sandy loam soil in cardboard pots and covered with soil. The active compounds (A) and (B), formulated in the form of wettable powders or emulsion concentrates, were then applied to the surface of the covering soil in various dosages as aqueous suspensions or emulsions using a water application rate of 300 to 800 I/ha (converted).

After the treatment, the pots were placed in a greenhouse and kept under good growth conditions for the weeds. Optical scoring of the damage to the plants or emerged plants was carried out after emergence of the test plants after a trial period of 3 to 4 weeks, in comparison to untreated controls. As shown by the results, the tested herbicide/safener combinations have good herbicidal pre-emergence activity against a broad spectrum of weed grasses and broad-leaved weeds. For example, the herbicide/safener combinations of the compounds of numbers I-2.2, I-3.1, I-3.2, I-21.1, I-21.2, I-22.1, I-22.2, I-23.1, I-23.2, I-24.1, I-24.2, I-52.1, I-52.2, I-67.1, I-67.2, I-77.1, and I-77.2, and other compounds from table 1 above all with the safeners of the compounds of formulae II-1, II-9, III-1, b-11, b-14, IX-A3, very particularly with safeners of the compounds of the formulae II-1 and IX-A3, have very good herbicidal activity against harmful plants such as Sinapis alba, Chrysanthemum segetum, Avena sativa, Stellaria media, Echinochloa crus-galli, Lolium multiflorum, Setaria viridis, Abutilon theophrasti, Amaranthus retroflexus and Panicum miliaceum when applied by the pre-emergence method at an application rate of 500 g or less of herbicide (A) per hectare.

2. Post-Emergence Action Against Weeds

Seeds or rhizome pieces of monocotyledonous and dicotyledonous weeds were placed into sandy loam soil in plastic pots, covered with soil and grown in a greenhouse under good growth conditions. Three weeks after sowing, the test plants were treated at the three-leaf stage. The compounds according to the invention, formulated as wettable powders or as emulsion concentrates, were sprayed onto the green parts of the plants at various dosages using a water application rate of 300 to 800 I/ha (converted). The test plants were stood in the greenhouse under optimum growth conditions for about three to four weeks, and the action of the preparations was then scored visually in comparison to untreated controls. Post-emergence, too, the herbicide/safener combinations according to the invention have good herbicidal activity against a broad spectrum of economically important weed grasses and broad-leaved weeds. For example, the herbicide/safener combinations of compounds of numbers I-2.2, I-3.1, I-3.2, I-21.1, I-21.2, I-22.1, I-22.2, I-23.1, I-23.2, I-24.1, I-24.2, I-52.1, I-52.2, I-67.1, I-67.2, I-77.1, and I-77.2, and other compounds from table 1 above all with the safeners of the compounds of formulae II-1, II-9, III-1, b-11, b-14, IX-A3, very particularly with safeners of the compounds of the formulae II-1 and IX-A3, have very good herbicidal activity against harmful plants such as Sinapis alba, Echinochloa crus-galli, Lolium multiflorum, Chrysanthemum segetum, Setaria viridis, Abutilon theophrasti, Amaranthus retroflexus, Panicum miliaceum and Avena sativa when applied by the post-emergence method at an application rate of 500 g or less of herbicide (A) per hectare.

3. Compatibility with Crop Plants

In further greenhouse trials, seeds of a relatively large number of crop plants and weeds were placed into sandy loam soil and covered with soil. Some of the pots were immediately treated as described in Section 1, the others were placed in a greenhouse until the plants had developed two to three true leaves and were then sprayed with various dosages of the herbicide/safener combinations according to the invention, as described in Section 2. Four to five weeks after the application and standing time in the greenhouse, it was established by visual scoring that the herbicide/safener combinations tested, for example of compounds No. I-2.2, I-3.1, I-3.2, I-21.1, I-21.2, I-22.1, I-22.2, I-23.1, I-23.2, I-24.1, I-24.2, I-52.1, I-52.2, I-67.1, I-67.2, I-77.1, and I-77.2, and other compounds from table 1 above all with the safeners of the compounds of formulae II-1, II-9, III-1, b-11, b-14, IX-A3, very particularly with safeners of the compounds of the formulae II-1 and IX-A3, did not cause any damage to crop plants such as cotton, oilseed rape, sugar beet and Gramineae crops such as barley, wheat, rye, millet, corn or rice when applied by the pre-emergence method or the post-emergence method.

1. A herbicide/safener combination comprising
component (A) comprising one or more compounds of the formula (I) or salts thereof 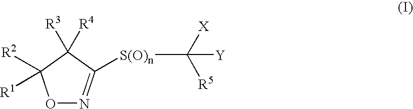
in which
R¹ and R² are each independently selected from the group consisting of H, cyano, (C₁-C₆)-alkyl, (C₂-C₆)-alkenyl, (C₂-C₆)-alkynyl, (C₃-C₈)-cycloalkyl, (C₁-C₆)-alkanoyl, (C₁-C₆)-alkoxycarbonyl, mono-((C₁-C₆)-alkyl)aminocarbonyl, and di-((C₁-C₆)-alkyl)aminocarbonyl, wherein each of the (C₁-C₆)-alkyl, (C₂-C₆)-alkenyl, (C₂-C₆)-alkynyl, (C₃-C₆)-cycloalkyl, (C₁-C₆)-alkanoyl, (C₁-C₆)-alkoxycarbonyl, mono-((C₁-C₆)-alkyl)aminocarbonyl, di-((C₁-C₆)-alkyl)aminocarbonyl radicals is unsubstituted or substituted by one or more identical or different radicals selected from the group consisting of halogen, cyano, (C₃-C₈)-cycloalkyl, —OR⁶, and —S(O)ₘR⁶, wherein m is 0, 1 or 2, R⁶ is (C₁-C₆)-alkyl, (C₂-C₆)-alkenyl, (C₂-C₆)-alkynyl or (C₃-C₆)-cycloalkyl, any of which is unsubstituted or substituted by one or more identical or different radicals selected from the group consisting of halogen and cyano,
or are each independently phenyl or heterocyclyl, wherein the heterocyclyl is saturated or unsaturated and contains one or more heteroatoms in the heterocyclic ring, wherein each of the phenyl or heterocyclyl radicals is unsubstituted or substituted by one or more identical or different radicals selected from the group consisting of (C₁-C₆)-alkyl, (C₁-C₆)-haloalkyl, halogen, cyano, (C₃-C₈)-cycloalkyl, —OC(R⁷)₃, and
—SC(R⁷)₃, wherein R⁷ in the two last-mentioned groups is, independently at each occurrence, H, F or Cl,
or R¹+R² together with the carbon atom to which they are attached form a spiro linkage of 3 to 7 carbon atoms,
R³ and R⁴ are H, (C₁-C₆)-alkyl, (C₂-C₆)-alkenyl, (C₂-C₆)-alkynyl or (C₃-C₈)-cycloalkyl, the (C₁-C₆)-alkyl, (C₂-C₆)-alkenyl, (C₂-C₆)-alkynyl or (C₃-C₈)-cycloalkyl is optionally substituted substituted by one or more identical or different radicals selected from the group consisting of halogen, nitro, cyano, (C₃-C₆)-cycloalkyl, (C₁-C₆)-alkoxy, (C₁-C₆)-haloalkoxy and (C₁-C₆)-alkylthio, or R³+R⁴ together with the carbon atom to which they are attached form a spiro linkage of 3 to 7 carbon atoms,
or
R¹+R³ together with the carbon atoms to which they are attached form a ring structure composed of 5-8 carbon atoms,
R⁵ is unsubstituted or substituted aryl, or unsubstituted or substituted heteroaryl, wherein each of the aryl or heteroaryl radicals is optionally substituted by OH, halogen, cyano, (C₁-C₆)-alkyl, (C₁-C₆)-haloalkyl, (C₂-C₆)-alkenyl, (C₂-C₆)-alkynyl, (C₃-C₆)-cycloalkyl, (C₃-C₆)-cycloalkenyl, mono-(C₁-C₆)-alkylamino, di-((C₁-C₆)-alkyl)amino, N—((C₁-C₆)-alkanoyl)amino, (C₁-C₆)-alkoxy, (C₁-C₆)-haloalkoxy, (C₃-C₆)-alkenyloxy, (C₃-C₆)-alkynyloxy, (C₃-C₆)-cycloalkoxy, (C₄-C₆)-cycloalkenyloxy, (C₁-C₆)-alkylthio, (C₁-C₆)-haloalkylthio, (C₃-C₆)-cycloalkylthio, (C₃-C₆)-alkenylthio, (C₄-C₆)-cycloalkenylthio, (C₃-C₆)-alkynylthio, (C₁-C₆)-alkanoyl, (C₂-C₆)-alkenylcarbonyl, (C₂-C₆)-alkynylcarbonyl, arylcarbonyl, (C₁-C₆)-alkoxycarbonyl, (C₃-C₆)-alkenyloxycarbonyl, (C₃-C₆)-alkynoxycarbonyl, aryloxycarbonyl, (C₁-C₆)-alkylsulfinyl, (C₁-C₆)-alkylsulfonyl, (C₁-C₆)-haloalkylsulfinyl or (C₁-C₆)-haloalkylsulfonyl, and wherein the aforementioned alkyl, alkoxy or haloalkoxy radicals are optionally linked cyclically with one another when they are in ortho position,
n is 1, or 2,
X is H or (C₁-C₄)-alkyl, and
Y is H;
and
component (B) comprising one or more safeners.

2. The herbicide/safener combination as claimed in claim 1, wherein
R¹ and R² are each independently (C₁-C₄)-alkyl, wherein each of the (C₁-C₄)-alkyl radicals is optionally substituted by one or more identical or different halogens,
R³ and R⁴ are H, methyl or ethyl,
R⁵ is an unsubstituted or substituted aryl, or unsubstituted or substituted heteroaryl, wherein each of the aryl or heteroaryl radicals is optionally substituted by one or more, identical or different radicals selected from the group consisting of halogen, cyano, ethyl, methyl, haloethyl, halomethyl, methoxy, ethoxy, trifluoromethylthio, trifluoromethylsulfinyl, trifluoromethylsulfonyl, halomethoxy and haloethoxy,
X is H,
Y is H, and
n is 2.

3. The herbicide/safener combination as claimed in claim 1, in which the one or more safeners in the component (B) are selected from the group consisting of mefenpyr-diethyl, isoxadifen-ethyl, chloquintocet-mexyl, fenclorim, dymron, and 4-cyclopropylaminocarbonyl-N-(2-methoxybenzoyl)benzenesulfonamide (N-({4-[(cyclopropylamino)carbonyl]phenyl}sulfonyl)-2-methoxybenzamide).

4. The herbicide/safener combination as claimed in claim 1, further comprising one or more additional agrochemically active compounds and/or additives and formulation auxiliaries customary in crop protection.

5. The herbicide/safener combination as claimed in claim 4, wherein the additional agrochemically active compound is a herbicide.

6. The herbicide/safener combination as claimed in claim 5, wherein the additional herbicide is atrazine, fenoxaprop-ethyl, glufosinate, glufosinate-ammonium, glyphosate, isoxaflutole, mesosulfuron-methyl, mesotrione or S-metolachlor.

7. A method for controlling unwanted plants, comprising applying the components (A) and (B) of the herbicide/safener combination as claimed in claim 1, either together or separately, to the plants, the seed or the area on which the plants grow.

8. The method as claimed in claim 7, wherein unwanted plants in crops of plants are controlled and the crops of plants are selected from the group consisting of the farm crops, vegetable crops or permanent crops and plantation crops.

9. The method as claimed in claim 7, wherein unwanted plants in crops of plants are controlled and the crops of plants are transgenic or tolerant as a result of selective breeding.

10. A method for controlling harmful plants, comprising applying the herbicide/safener combination as defined in claim 1 to the plants, the seed or the area on which the plants grow.

11. A compound of the formula (I) or a salt thereof 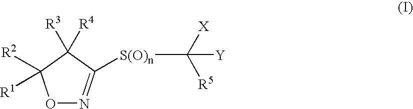
in which
R¹ and R² are each independently selected from the group consisting of H, cyano, (C₁-C₆)-alkyl, (C₂-C₆)-alkenyl, (C₂-C₆)-alkynyl, (C₃-C₈)-cycloalkyl, (C₁-C₆)-alkanoyl, (C₁-C₆)-alkoxycarbonyl, mono-((C₁-C₆)-alkyl)aminocarbonyl, and di-((C₁-C₆)-alkyl)aminocarbonyl, wherein each of the (C₁-C₆)-alkyl, (C₂-C₆)-alkenyl, (C₂-C₆)-alkynyl, (C₃-C₆)-cycloalkyl, (C₁-C₆)-alkanoyl, (C₁-C₆)-alkoxycarbonyl, mono-((C₁-C₆)-alkyl)aminocarbonyl, or di-((C₁-C₆)-alkyl)aminocarbonyl radicals is unsubstituted or substituted by one or more identical or different radicals selected from the group consisting of halogen, cyano, (C₃-C₈)-cycloalkyl, —OR⁶, and —S(O)ₘR⁶, in which m is 0, 1 or 2, R⁶ is (C₁-C₆)-alkyl, (C₂-C₆)-alkenyl, (C₂-C₆)-alkynyl or (C₃-C₆)-cycloalkyl, any of which is unsubstituted or substituted by one or more identical or different radicals selected from the group consisting of halogen and cyano,
or are each independently phenyl or heterocyclyl, wherein the heterocyclyl is saturated or unsaturated and contains one or more, wherein each of the phenyl or heterocyclyl radicals is unsubstituted or substituted by one or more identical or different radicals selected from the group consisting of (C₁-C₆)-alkyl, (C₁-C₆)-haloalkyl, halogen, cyano, (C₃-C₈)-cycloalkyl, —OC(R⁷)₃, and
—SC(R⁷)₃, wherein R⁷ in the two last-mentioned groups is, independently at each occurrence, H, F or Cl,
or R¹+R² together with the carbon atom to which they are attached form a spiro linkage of 3 to 7 carbon atoms,
R³ and R⁴ are H, (C₁-C₆)-alkyl, (C₂-C₆)-alkenyl, (C₂-C₆)-alkynyl or (C₃-C₈)-cycloalkyl, wherein the (C₁-C₆)-alkyl, (C₂-C₆)-alkenyl, (C₂-C₆)-alkynyl or (C₃-C₈)-cycloalkyl is optionally substituted by one or more identical or different radicals selected from the group consisting of halogen, nitro, cyano, (C₃-C₆)-cycloalkyl, (C₁-C₆)-alkoxy, (C₁-C₆)-haloalkoxy and (C₁-C₆)-alkylthio,
or R³+R⁴ together with the carbon atom to which they are attached form a spiro linkage of 3 to 7 carbon atoms,
or
R¹+R³ together with the carbon atoms to which they are attached form a ring structure composed of 5-8 carbon atoms,
R⁵ is a phenyl radical which is substituted with two or more substituents selected from the group consisting of OH, halogen, cyano, (C₁-C₆)-alkyl, (C₁-C₆)-haloalkyl, (C₂-C₆)-alkenyl, (C₂-C₆)-alkynyl, (C₃-C₆)-cycloalkyl, (C₃-C₆)-cycloalkenyl, mono-(C₁-C₆)-alkylamino, di-((C₁-C₆)-alkyl)amino, N—((C₁-C₆)-alkanoyl)amino, (C₁-C₆)-alkoxy, (C₁-C₆)-haloalkoxy, (C₃-C₆)-alkenyloxy, (C₃-C₆)-alkynyloxy, (C₃-C₆)-cycloalkoxy, (C₄-C₆)-cycloalkenyloxy, (C₁-C₆)-alkylthio, (C₁-C₆)-haloalkylthio, (C₃-C₆)-cycloalkylthio, (C₃-C₆)-alkenylthio, (C₄-C₆)-cycloalkenylthio, (C₃-C₆)-alkynylthio, (C₁-C₆)-alkanoyl, (C₂-C₆)-alkenylcarbonyl, (C₂-C₆)-alkynylcarbonyl, arylcarbonyl, (C₁-C₆)-alkoxycarbonyl, (C₃-C₆)-alkenyloxycarbonyl, (C₃-C₆)-alkynoxycarbonyl, aryloxycarbonyl, (C₁-C₆)-alkylsulfinyl, (C₁-C₆)-alkylsulfonyl, (C₁-C₆)-haloalkylsulfinyl and (C₁-C₆)-haloalkylsulfonyl, wherein two of the alkyl, alkoxy, or haloalkoxy radicals in ortho position are linked cyclically to one another,
n is 1, or 2,
X is H or (C₁-C₄)-alkyl, and
Y is H.

12. The compound as claimed in claim 11, wherein the two substituents of the phenyl in position R⁵ which are linked cyclically to one another are methyl, ethyl, methoxy, ethoxy, haloethoxy or halomethoxy.

13. The compound as claimed in claim 11, wherein the heterocyclyl as defined for R¹ or R² contains 1, 2, or 3 heteroatoms in the heterocyclic ring selected from the group consisting of N, O, and S.

14. The compound as claimed in claim 11, wherein the heterocyclyl as defined for R¹ or R² is an aliphatic heterocyclyl radical having 3 to 7 ring atoms or a heteroaromatic radical having 5 or 6 ring atoms.

15. The herbicide/safener combination as claimed in claim 1, wherein the heterocyclyl as defined for R¹ or R² contains 1, 2, or 3 heteroatoms in the heterocyclic ring selected from the group consisting of N, O, and S.

16. The herbicide/safener combination as claimed in claim 1, wherein the heterocyclyl as defined for R¹ or R² is an aliphatic heterocyclyl radical having 3 to 7 ring atoms or a heteroaromatic radical having 5 or 6 ring atoms.

17. The herbicide/safener combination as claimed in claim 1, wherein R⁵ is unsubstituted or substituted aryl having 6 to 14 carbon atoms, or unsubstituted or substituted heteroaryl having 1 to 9 carbon atoms and one or more heteroatoms.

18. The herbicide/safener combination as claimed in claim 17, wherein the unsubstituted or substituted heteroaryl has 1 to 4 heteroatoms.

19. The herbicide/safener combination as claimed in claim 18, wherein the heteroatoms are selected from the group consisting of N, O, and S.

20. The herbicide/safener combination as claimed in claim 2, wherein R¹ and R² are each independently (C₁-C₄)-alkyl optionally substituted by one or more identical or different halogens selected from the group consisting of chlorine, bromine and fluorine.

21. The herbicide/safener combination as claimed in claim 2, wherein R⁵ is an unsubstituted or substituted aryl having 6 to 10 carbon atoms, or an unsubstituted or substituted heteroaryl having 2 to 5 carbon atoms and 1 to 3 heteroatoms selected from the group consisting of N, O and S.
